(19) United States
(12) Patent Application Publication
(10) Pub. No.: US 2007/0016435 A1
(43) Pub. Date: Jan. 18, 2007

(54) Visualization tool

(76) Inventor: William Bevington, Atlantic Highland, NJ (US)

Correspondence Address: HUGHES HUBBARD & REED LLP, ONE BATTERY PARK PLAZA, NEW YORK, NY, 10004, US

(21) Appl. No.: 11/196,091

(22) Filed: Aug. 3, 2005

Related U.S. Application Data
(60) Provisional application No. 60/599,785, filed on Aug. 5, 2004.

(51) Int. Cl. G06Q 99/00

(52) U.S. Cl. 705/1

(57) ABSTRACT

The disclosure concerns a visualization of a result, such as the outcome of an election, in a domain such as the United States, comprising components such as states, in which each state has a “weight” corresponding to its electoral vote, and the results of the election are represented by portraying the states in relative sizes in accordance with their respective electoral votes. Also disclosed are means of varying the form of the visual representation, for testing hypotheses about the results in particular states, and for gauging the effect of issues, including issues on which the candidates in the election take differing positions. The disclosure also addresses the applicability of the same techniques to be the areas of medicine, finance, academia or transportation.

### CROSS-REFERENCE AND INCORPORATION-BY-REFERENCE

This application claims the benefit of the filing date of U.S. Provisional Application No. 60/599,785, filed Aug. 5, 2004. This application incorporates by reference the computer program listing appendix to the present submission, submitted herewith on a compact disc, in duplicate, containing source files and directories listed in attachment labeled Exhibit A.

### BACKGROUND OF THE INVENTION

1. Field of the Invention

The present invention relates to systems for visualization of amalgamated data, particularly in (but not limited to) the social sciences. The reference implementation is an Internet-based tool for visualization of United States Presidential elections, but the invention is also suitable for visualizing other current and historical events and data, including historical, military and economic matters, as well as political subject matter.

2. Description of Related Art

The current state of the art in political contest visualization is based on general views of the popular vote. Such representations are not adequate to deal with elections that are decided based on electoral votes, where the ultimate result can differ from the popular vote result, and where small changes in “swing states” can change the overall outcome. Nor does the prior art methodology allow the visualization to take into account the affect of voter attitudes on particular issues relative to the positions of candidates.

### SUMMARY OF THE INVENTION

In a particular aspect, the invention provides a visualization of an election in a domain such as the United States comprising components such as states, in which each state has a “weight” corresponding to its electoral vote, and the results of the election are represented by portraying the sates in relative sizes in accordance with their respective electoral votes. The invention provides means of varying the form of the visual representation, for testing hypotheses about the results in particular states, and for gauging the effect of issues on which the candidates take differing positions.

In a more general aspect, the invention concerns a general graphical approach for presenting a visualization of any quantitative overall result in a modeled domain, where such result has a plurality of possible outcomes, wherein the domain is comprised of components and each component has a subresult, and where the subresults may be aggregated to calculate said overall result, and each component has a weight in relation to the overall result, wherein the approach comprises representing each of said components in visual proportion to its weight, and representing the outcome of said overall result as a function of the aggregate calculation based on the subresults.

Other aspects and advantages of the invention will be more fully appreciated from the description of the drawings and detailed description that follow.

### BRIEF DESCRIPTION OF THE DRAWINGS

FIGS. 1A-1U are graphical visualizations along a timeline of the developing presidential race of 2004.

FIGS. 2A-2QQQQ are graphical visualizations of a number of historical presidential races.

FIGS. 3A-3B are graphical visualizations of the presidential race of 2000, focusing on the effect of the economy.

FIGS. 4A-4U are graphical of certain historical presidential races.

FIGS. 5A-5E are graphical of the primary and caucus elections of 2004.

FIGS. 6A-6Q are graphical visualizations of the presidential race of 2004 and certain historical elections, focusing on “swing states.”

FIGS. 7A-7AAA are graphical visualizations of the presidential race of 2000.

### DETAILED DESCRIPTION

What follows is a detailed description of certain illustrative embodiments of the invention.

This application is accompanied by a compact disc containing the complete source code for the reference implementation, called the “PIIM Elections and Voting Tool.” This code (which is incorporated herein by reference in its entirety) is designed to be operated on a Web server, and is used by accessing the Web server with a browser such as Internet Explorer, Netscape or the like.

The files that comprise the source code are listed in two attachments hereto. The first such attachment (labeled Exhibit A and incorporated herein by reference) is a file-by-file directory listing, and the second such attachment (labeled Exhibit B and incorporated herein by reference) shows the hierarchical layout of the source files and directories.

The source code and its operation will be understandable to those of ordinary skill in the art, enabling them to recreate the reference implementation and to learn and practice the principles of the invention.

Also described herein is the methodology employed in connection with creating the reference implementation. This is described in the Appendix hereto entitled “Elections & Public Opinion Project Methodology 1789-2000.”

General Description of the Tool

The visualization tool is structured to permit immediate and informative visual renderings of (U.S.) national opinion of contemporary relevant issues throughout the entire history of U.S. elections. The visualization tool allows geographic, cartogrammic, and quantitative visual renderings to be selected through a single click of the interface for any national election. In addition, for most recent elections, and primary elections, these are also provided on a generally bi-weekly analysis. A calculator function (alternate scoring device) permits immediately revised visual renderings from “what-if” alternative selections. Historical research has been collected to provide a unique categorical scoring, this scoring permits a valuable insight into the history of the U.S. in a comprehensive, contextual, and rapidly comparative manner. The scoring is accomplished by collecting historical research into “buckets” of singular issue-based aspects associated with each U.S. national election. This unique scoring method yields: a concise U.S. historical framework; ease of comparing national issues election to election, or from any election to any election, and; a database structure allowing for rapid visualization schemas through geographic, cartogrammic, or quantitative method. The core value of the visualization tool is to render subjective analysis (the “scores”) into objective comparative form (the visualizations) by utilizing the electoral voting paradigm as a filter to collect and display U.S. history. This technique of collective scoring, and then rendering these scores to either/or relationships of multiple boundary regions (maps or channels) has practical application in multiple fields of study, particularly those that require comparison both within a timeframe and across a timeframe.

This Internet-based tool allows for rapid visualization of significant amalgamated data concerning the United States Presidential elections; including all current races, as well as each of the 43 historical elections. Visualizations are based on electoral outcomes, in turn based on the Electoral College system, (instead of popular opinion percentages).

Users see how an election is really decided, and can shift between multiple modes of representation, with a key feature being rapid calculation and “what if” scenario outcomes. For example, today's candidates need 270 electoral votes to win an election, instead of 51% of the popular vote. General views of the popular vote cannot yield the potentially wide differences possible through the electoral method.

This way of viewing the election is significant because it differentiates the tool from other types of methods of tracking elections, which look at popular opinion only. It also combines many components; a deep history, methodology; polling and analysis, a hypothetical calculator and, most importantly, a myriad of unique visualizations. Currently, such a tool does not exist on the Internet.

In total, the tool features four ways of viewing electoral power; a Geographic view, a Uniform view, a Meter view, and a Value-metric view.

For the Uniform view, each square unit represents one electoral vote, so this view demonstrates how many electoral votes a state has. Unique views of this square unit representation have been created for each and every American presidential election. When a user compares this view with the traditional Geographic view, he or she can see the difference between the physical size of a state and the electoral power it actually has. The Meter view is a linear representation that shows the competition for electoral votes as a function of mathematical power.

The Value-metric view is a bi-directional bar chart in which each bar represents a state, and each bar is sized according to that state's electoral power. This Value-metric view can be represented by highest to lowest power or alphabetically by state by a single control point.

A unique feature of the Elections and Public Opinion Tool is the selectability of a “Swing State” option which is available from 1956 to present. It can be operated to highlight those states where neither party holds a clear majority.

The tool also employs the use of a so-called “Hypothetical Calculator” which enables a user to play with the outcome of each election by clicking on a state and switching it from Red (Republican), to Blue (Democrat) or vice versa. Or other parties in other historical American Presidential elections. This feature is peerless in the way it can be used to re-calculate all of the tool's four views.

Another core and unique feature of the Elections and Public Opinion Tool is the representation of issue based elections, which allow the user to look at the general “horserace” or choose from a host of issues (up to 10) for each election, and then predict an outcome is races were held purely by issue and not by candidate. Or, once one issue has been chosen, one can see which candidate would win the race based on that issue alone. The tool has a robust database that feeds this data (polling and analysis) into the tool and methodology is available for all of the elections.

Further, analogous pie visualizations track the 2004 Presidential primaries. They demonstrate how the race to be the Democratic frontrunner has changed since it began in January; and show which candidates have the most delegate votes. The Delegate Meter and Delegate Calculator work much the same way as the Meter and Hypothetical Calculator, except here a user can change the delegate count instead of the electoral outcome. The Primary view is updated each time a primary or caucus takes place and a user can see how many delegate votes each candidate will bring to the Democratic National Convention. This component is also unparalleled, as there is no other method on the Internet in which to visualize or track the primaries in this way.

Overall, this tool possesses vast applications in U.S. politics and can deployed for use in Presidential, Senatorial, Gubernatorial races, or local races. In addition, using the same visualization techniques and program technology proprietary to this web-based application, it can be deployed in the areas of medicine, finance or academia or transportation. Ultimately, this tool can be developed for use by major media outlets, such a television networks or news publications. The tool has over 3000 permutations and a myriad of endless possibilities. Best case uses of this tool include rapid assessments for analysts and decision makers, predictive visualization for application of resources to desired outcomes, and education uses to improve comprehension and resource allocation in public and private education.

Certain Visual Representations

Geographic. The party and/or candidate competition for electoral votes on a state-by-state basis, represented geographically on a political map of the United States. Note: For historical data, only those states that actually participated in a given election are represented on the map.

Uniform. This depicts the actual electoral power of a given state. Each unit-square represents 1 electoral vote, so this view demonstrates how many electoral votes a state has. Compare the Uniform view in the center-top of the screen with the Geographic view in the bottom-left of the screen to see the difference between the physical size of a given state, and the electoral power it represents. For example, while Montana is a lot bigger than New Hampshire, (and appears as such on the Geographic map), it actually appears smaller on the Uniform map. This is due to the fact that it has one less electoral vote than New Hampshire.

Meter. A party and/or candidate competition for electoral votes on a state-by-state basis, represented linearly as a function of mathematical power to contribute to electoral victory. A winning candidate requires (in 2004) at least 270 electoral votes, and this so-called “goal line” is represented as a red line bisecting the screen down the middle. The first horizontal bar represents the balance of total electoral votes between the two top candidates, in relation to the “goal line.” Beginning from the “goal line,” a smaller black bar appears underneath the winning candidate's vote total to indicate the number of electoral votes needed to change hands between the victor and the second-best competitor to alter the final outcome.

Subsequent horizontal bars represent each candidate's total votes in relation to the “goal line,” this time broken up into the states won by each given candidate. A user can choose to arrange the states order in the horizontal bars either by electoral power (increasing in electoral power from left to right), or alphabetically by name, by selecting either the “Sort by Power” or “Sort by Name” toggle in the bottom right-hand corner of the screen. “Sort by Power” is the default setting.

Value-Metric. A bi-directional bar chart showing a party and/or candidate competition for electoral votes on a state-by-state basis. Each bar represents a state, and each bar is sized according to that state's electoral power. The winning candidate's states are measured in height along a positive y-axis. The states are ordered in their appearance along the x-axis either by electoral power (decreasing in electoral power from left to right), or alphabetically by name. A user can change this ordering by selecting either the “Sort by Power” or “Sort by Name” toggle in the bottom right-hand corner of the screen. “Sort by Power” is the default setting.

### CERTAIN PREFERRED EMBODIMENTS

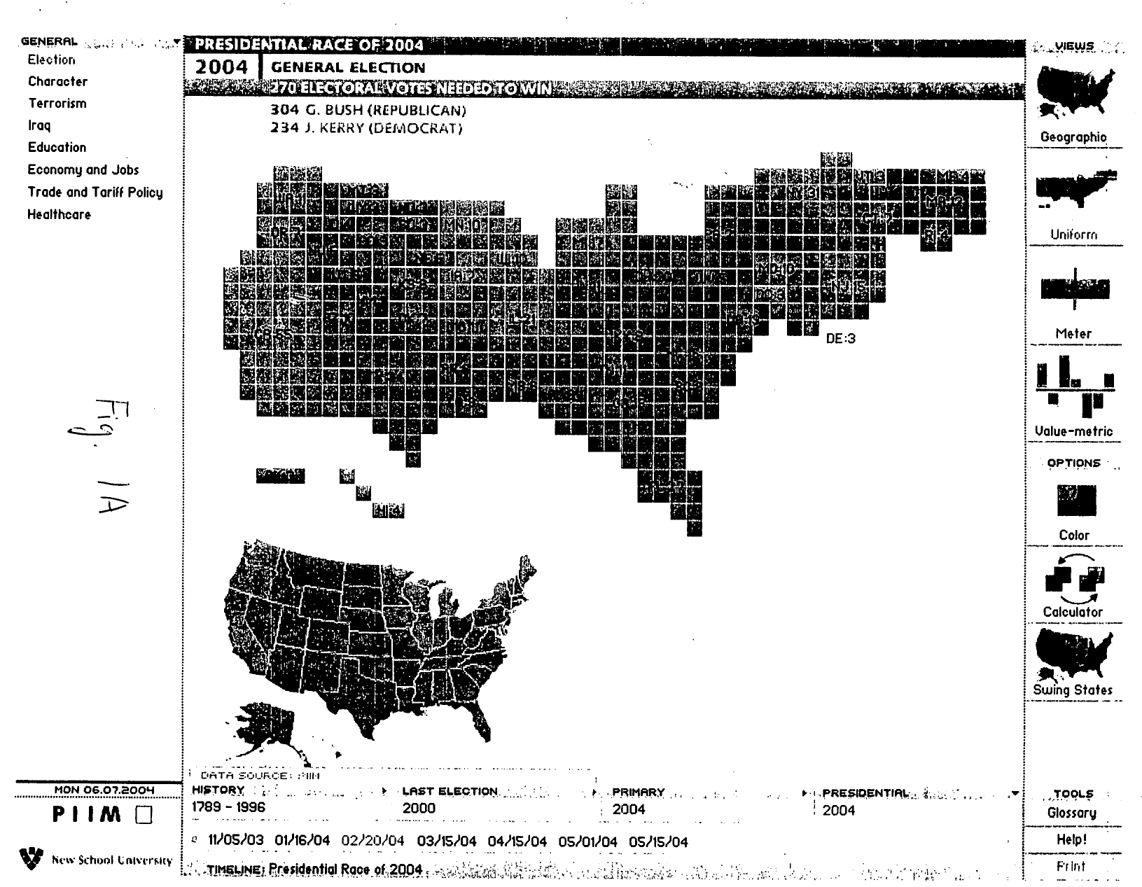

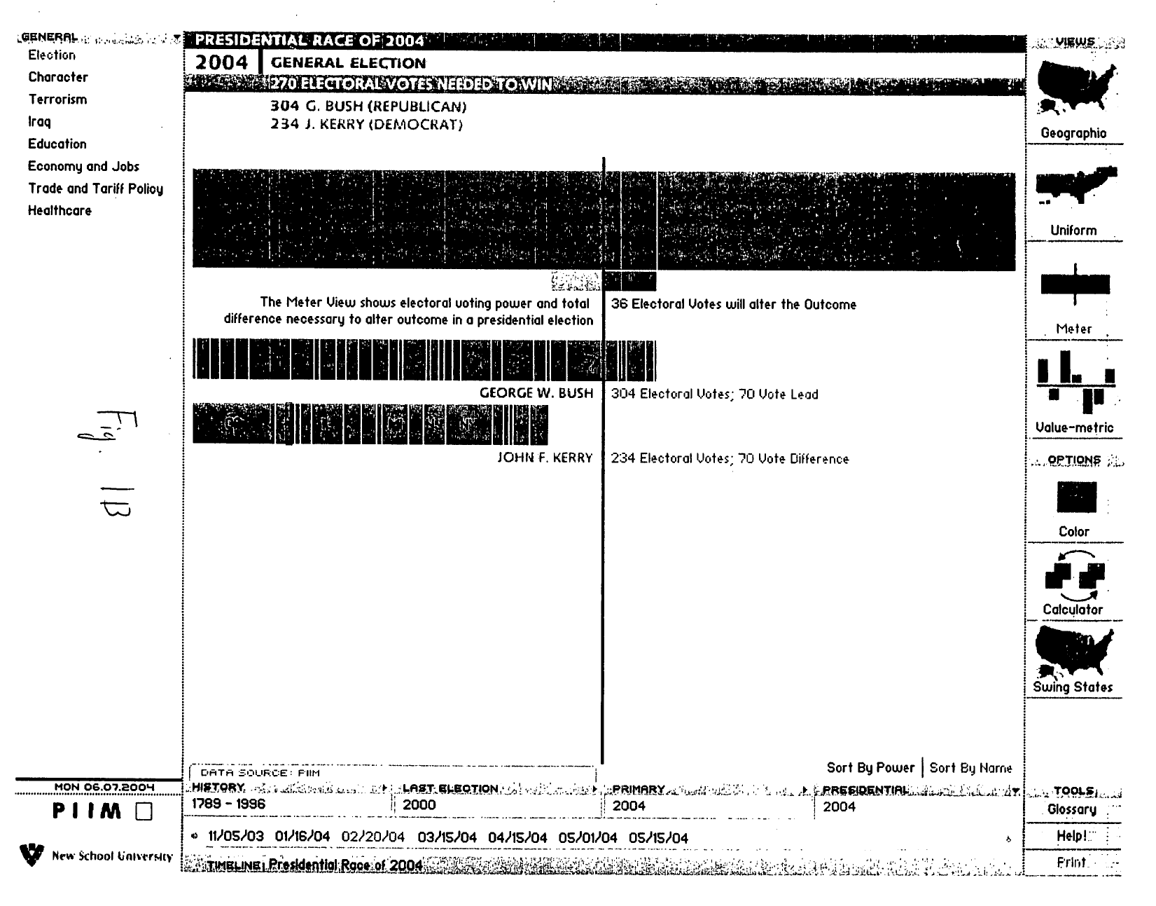

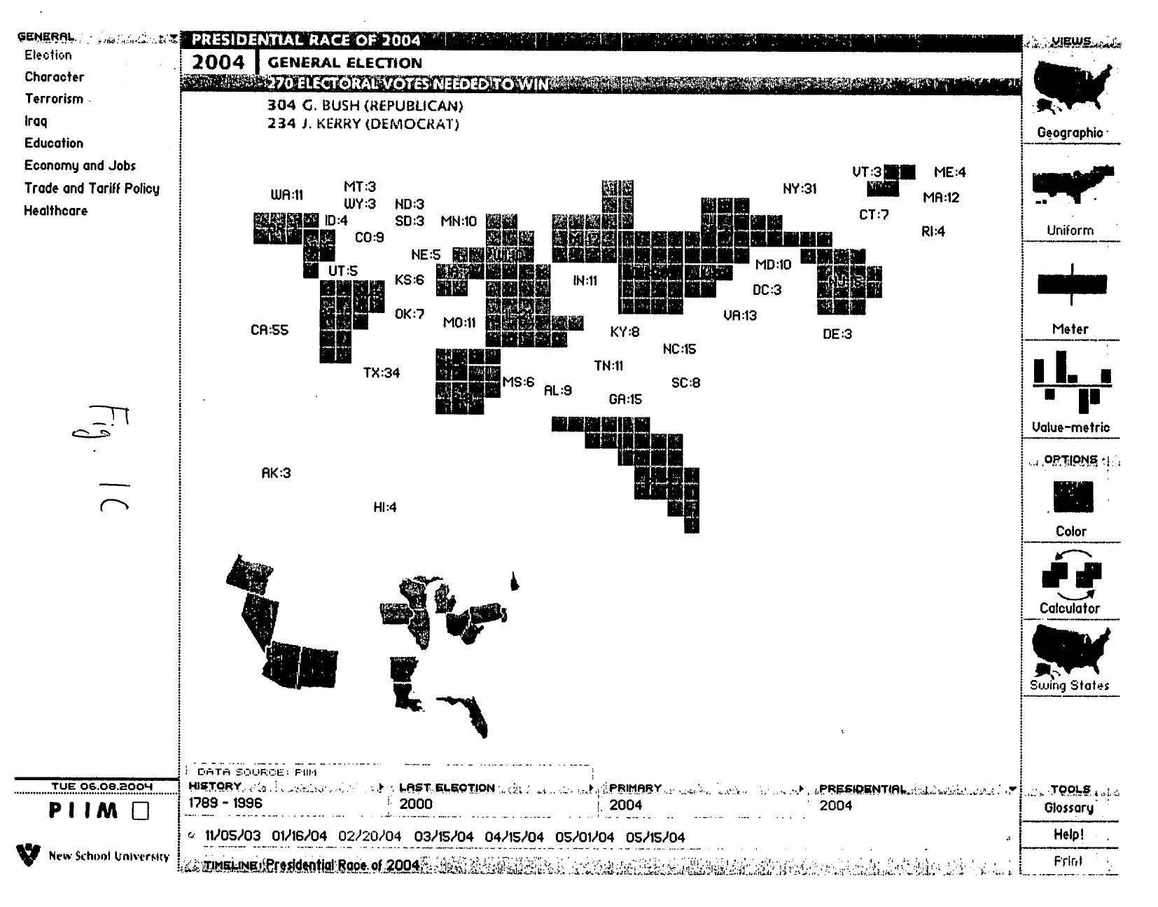

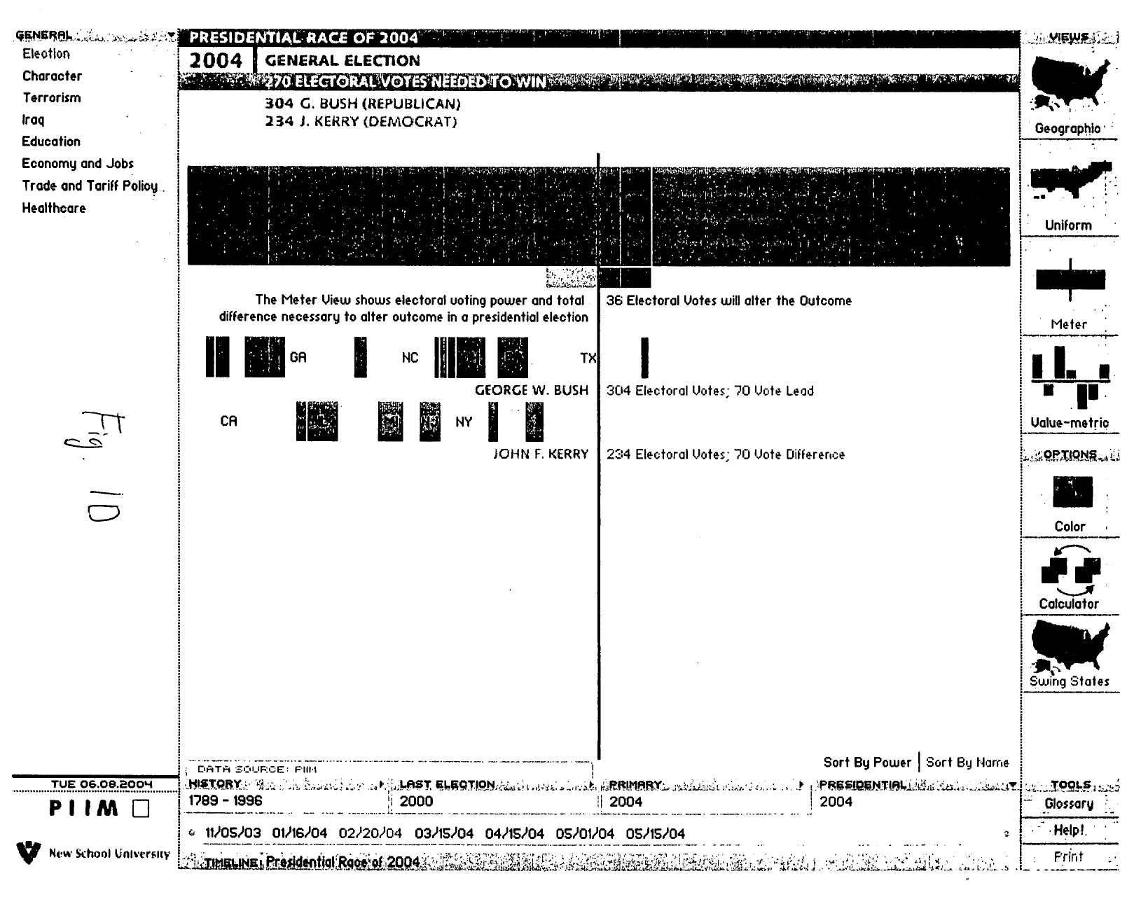

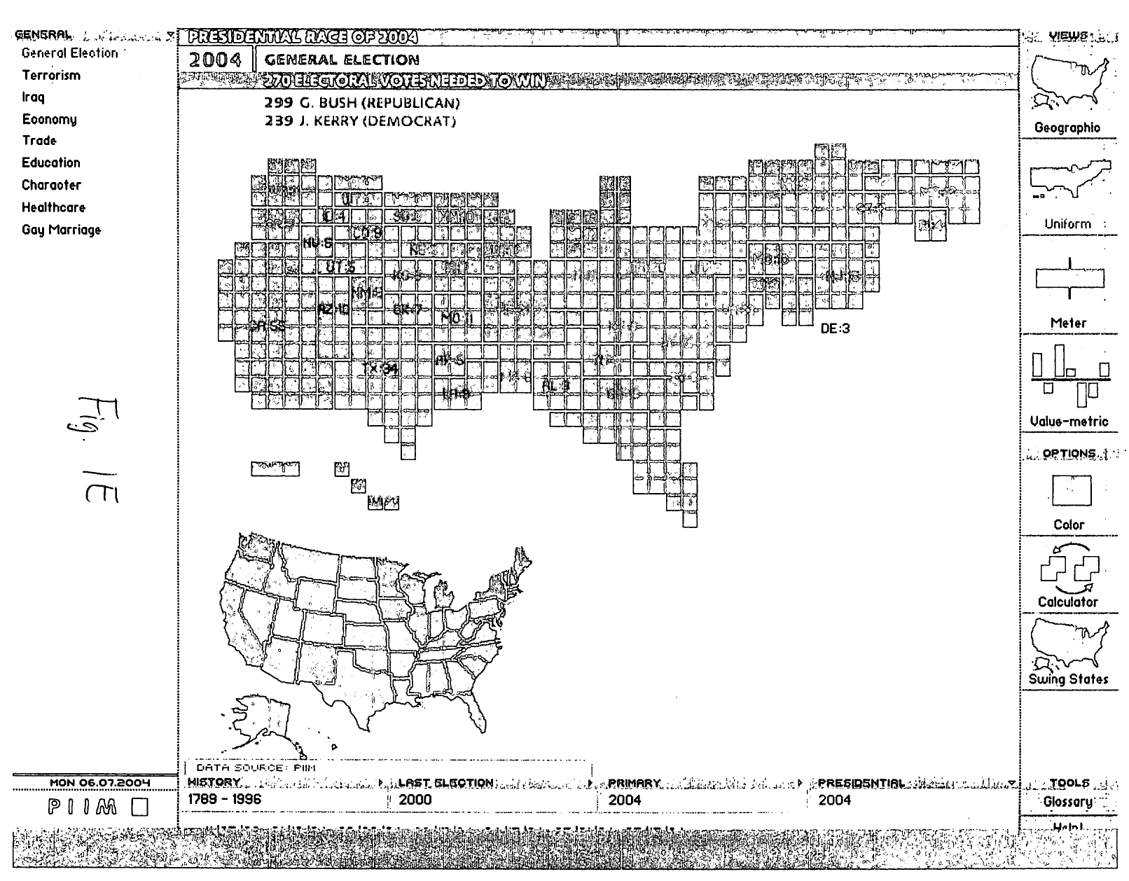

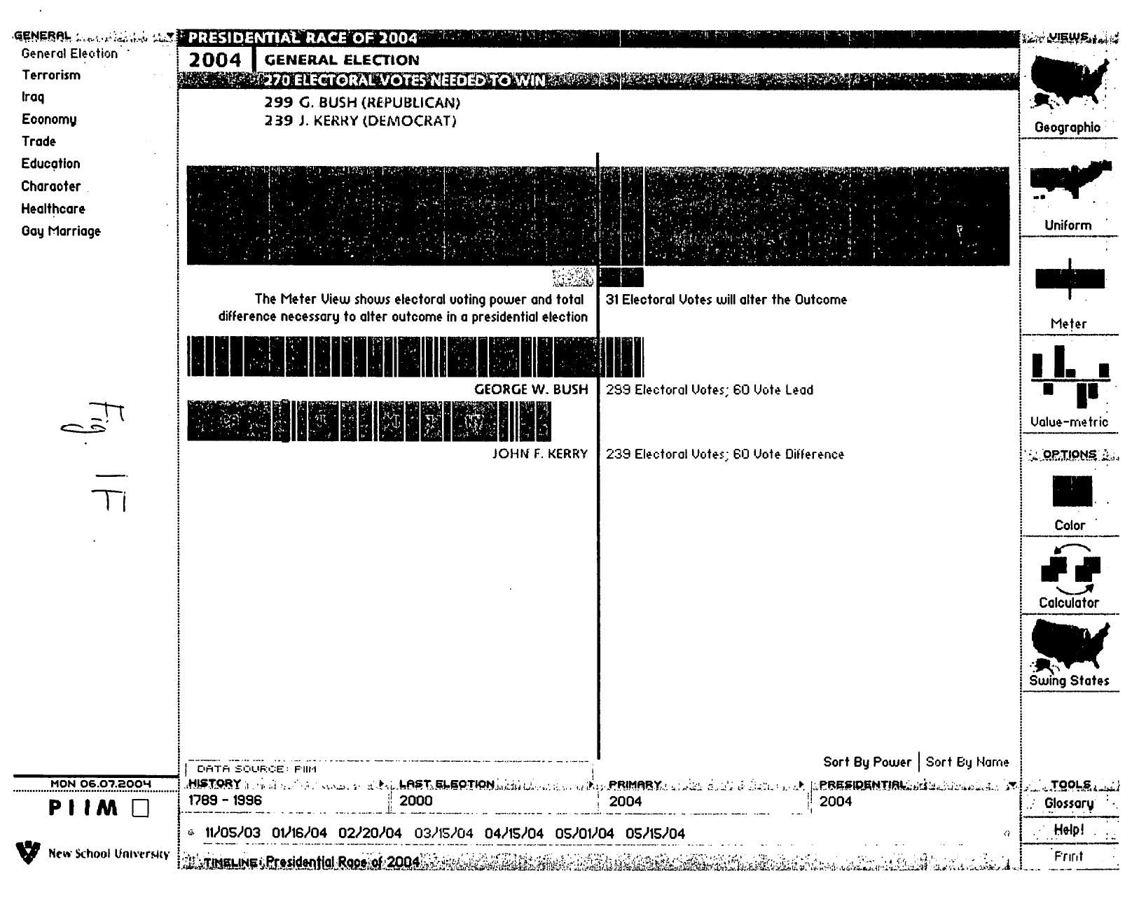

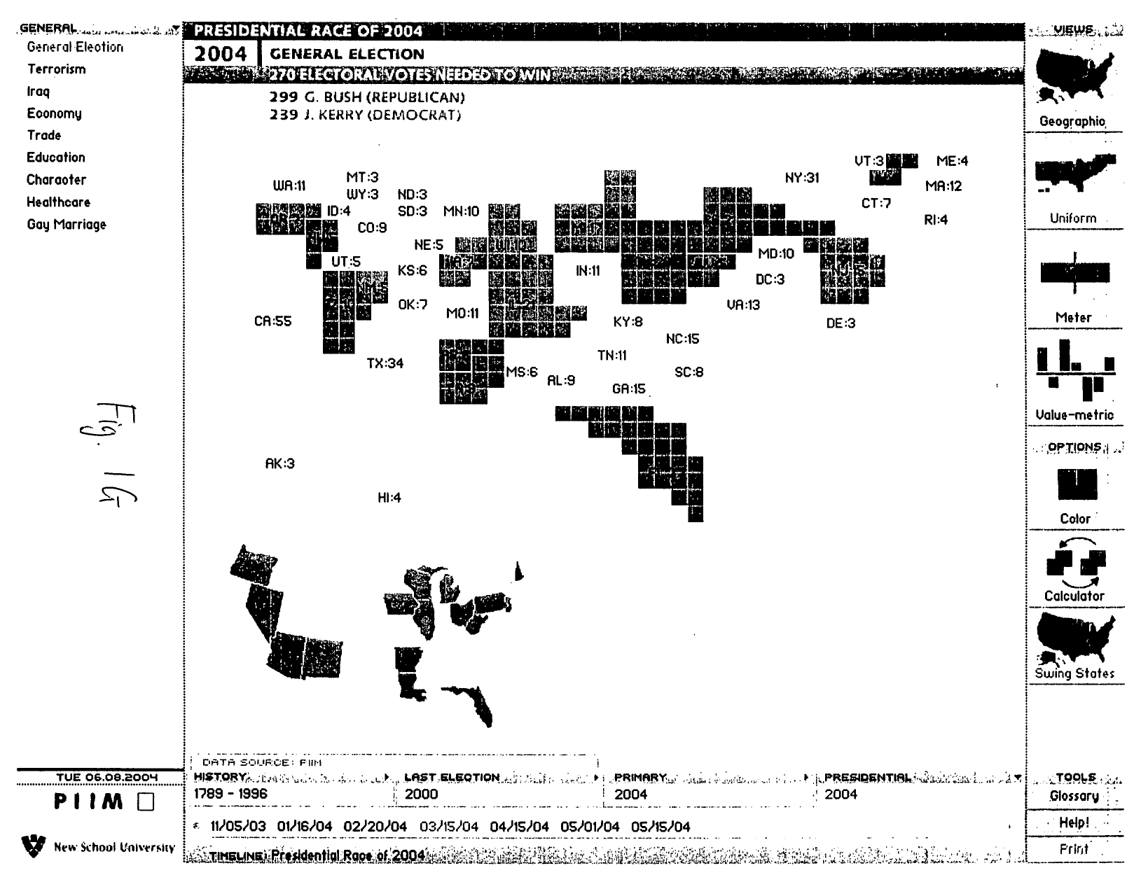

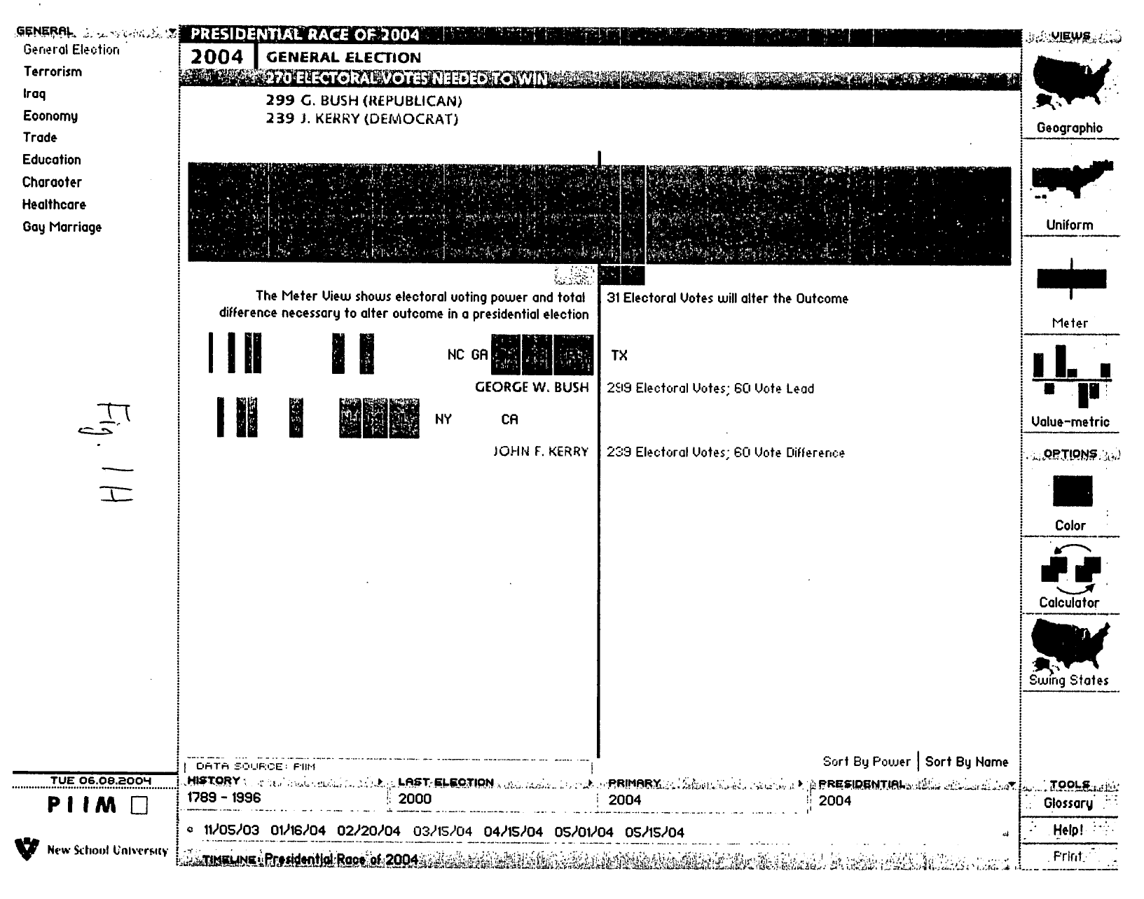

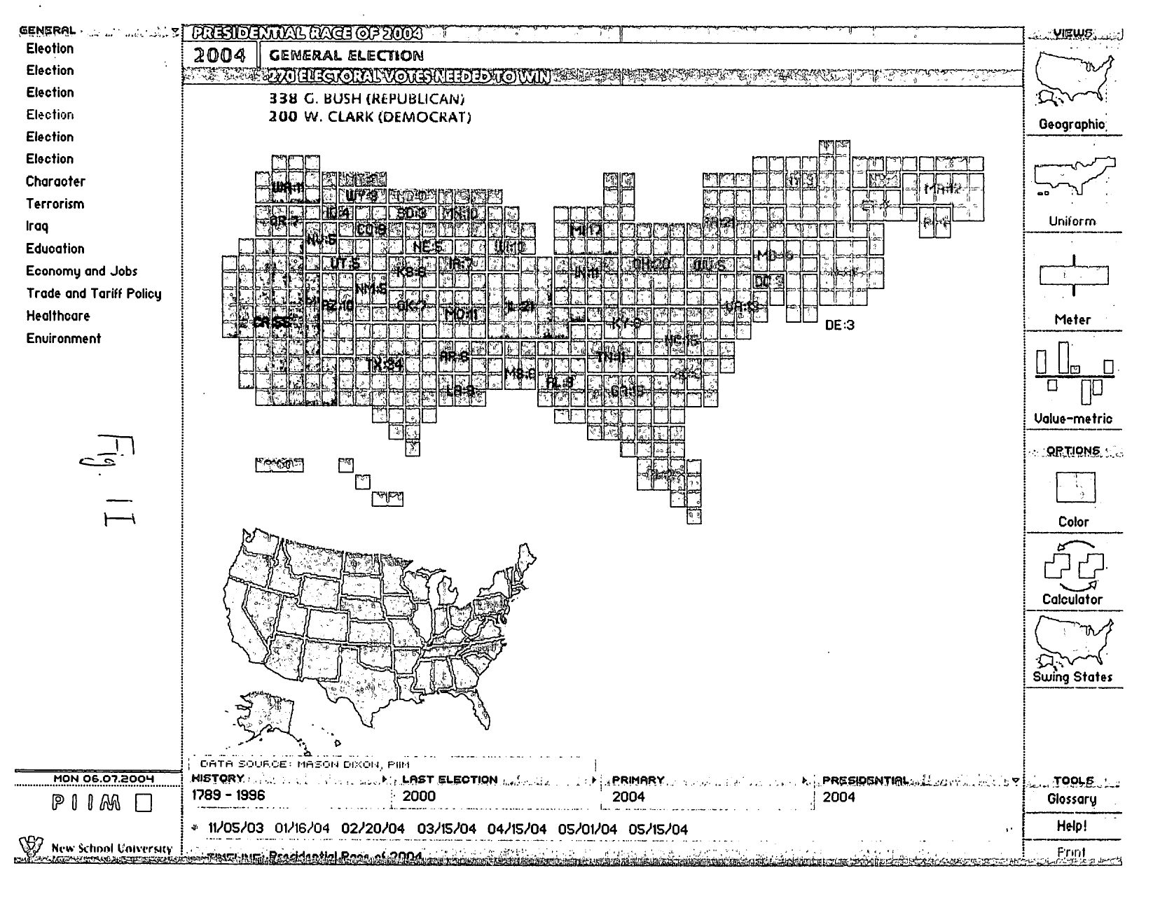

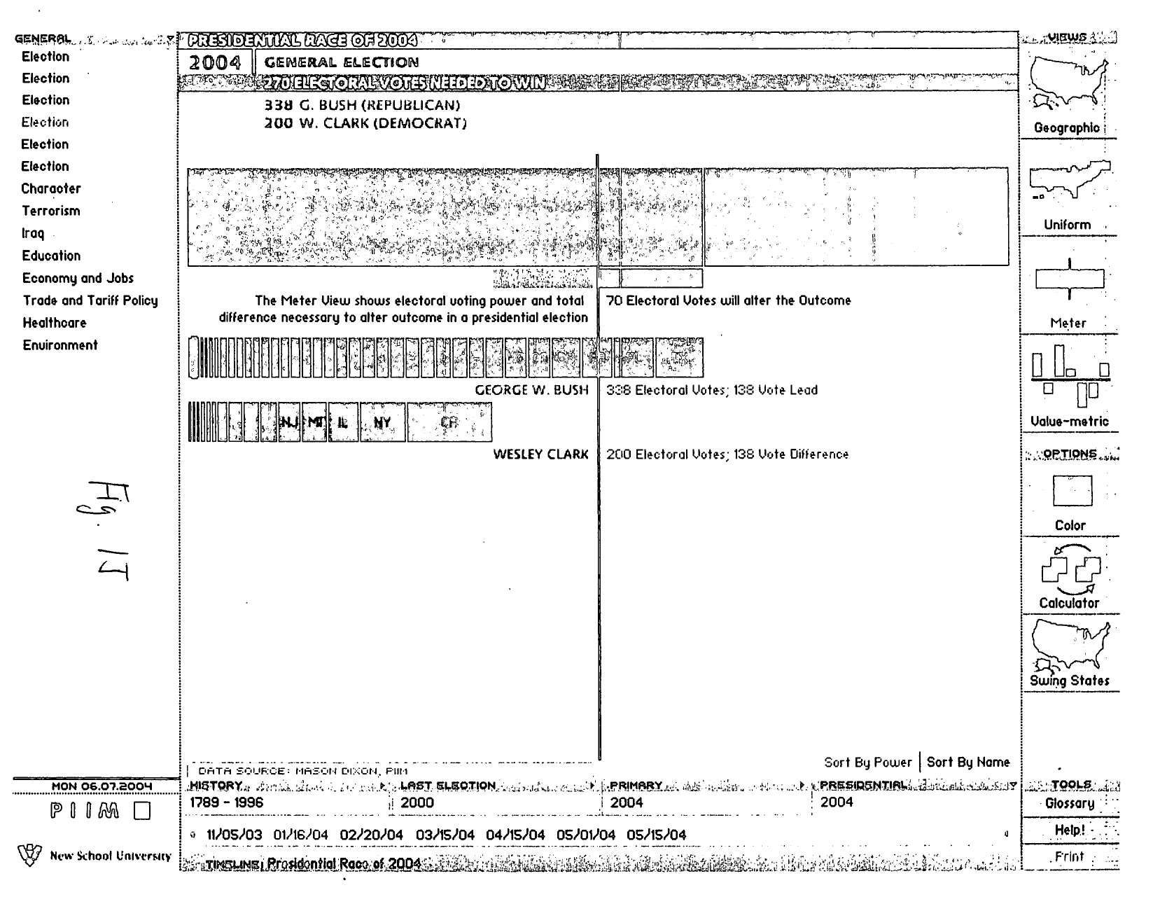

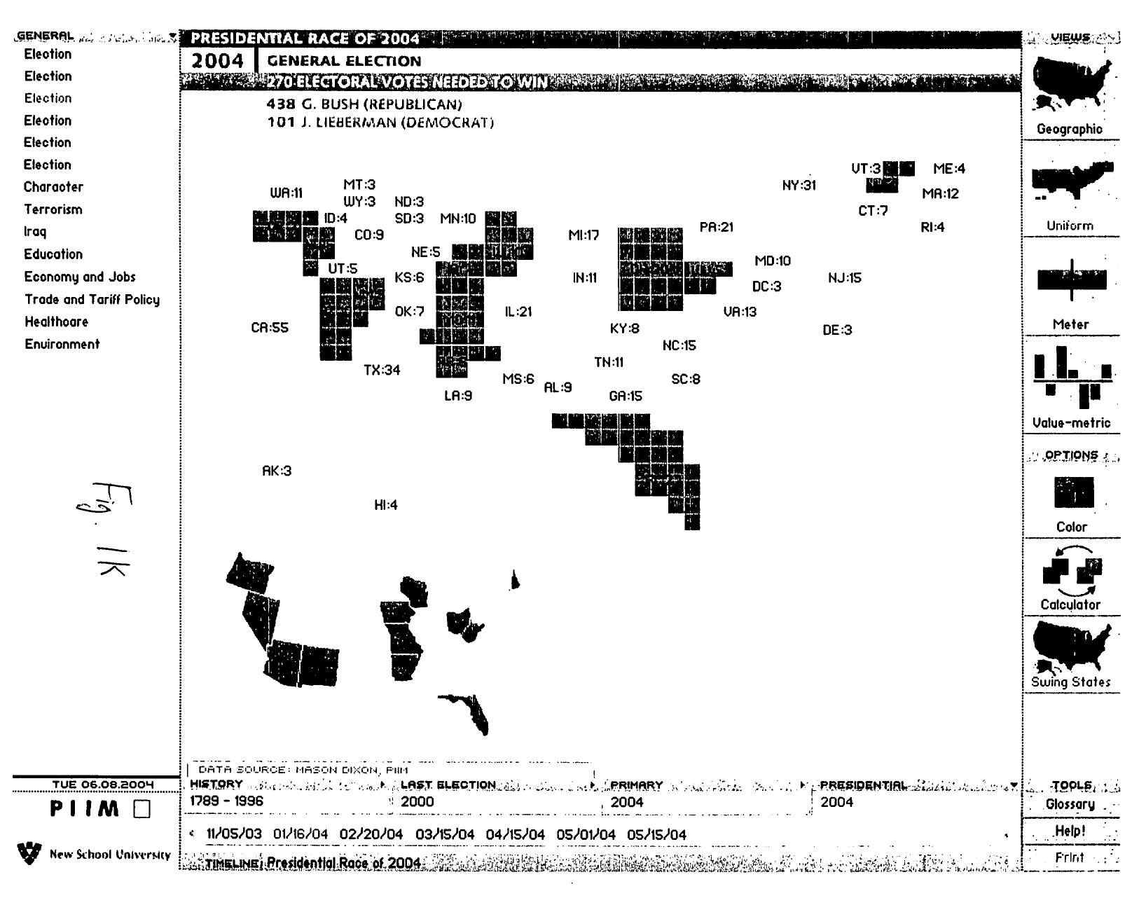

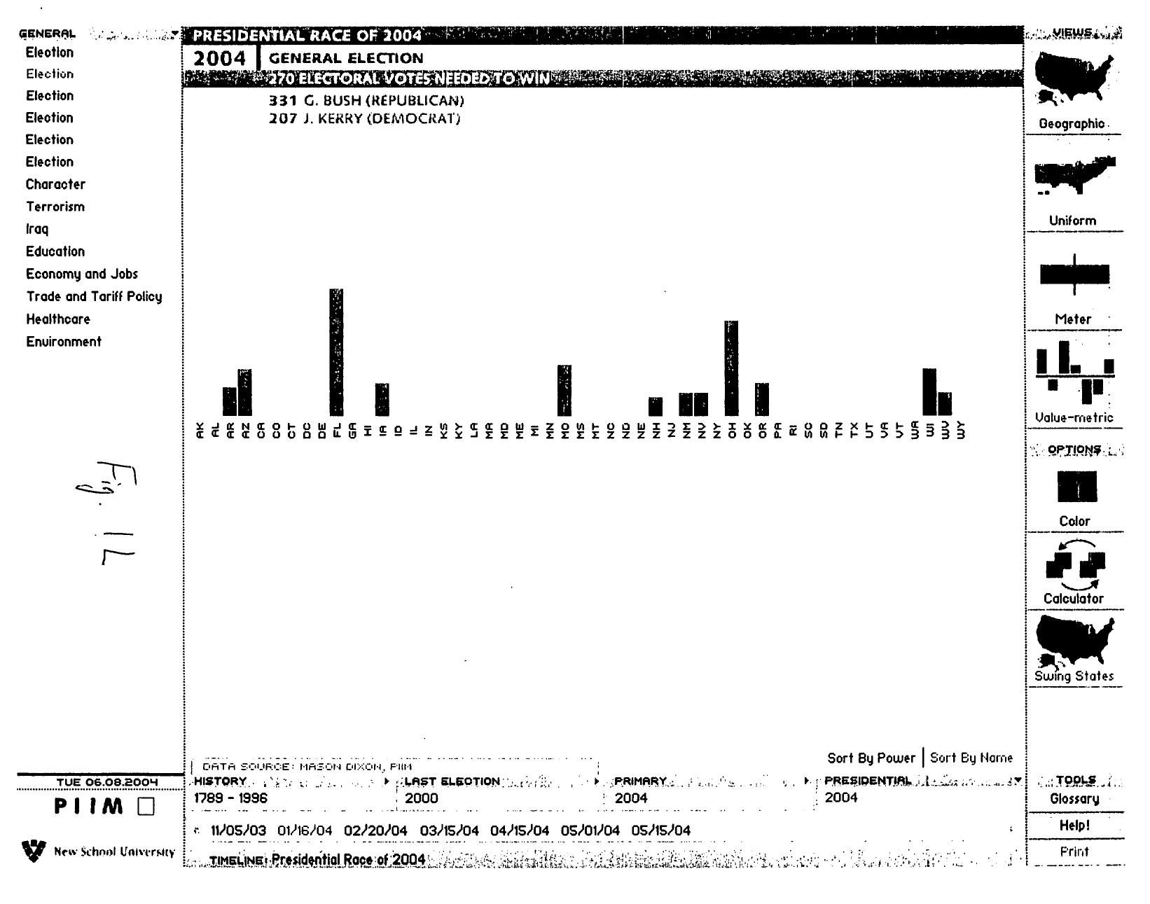

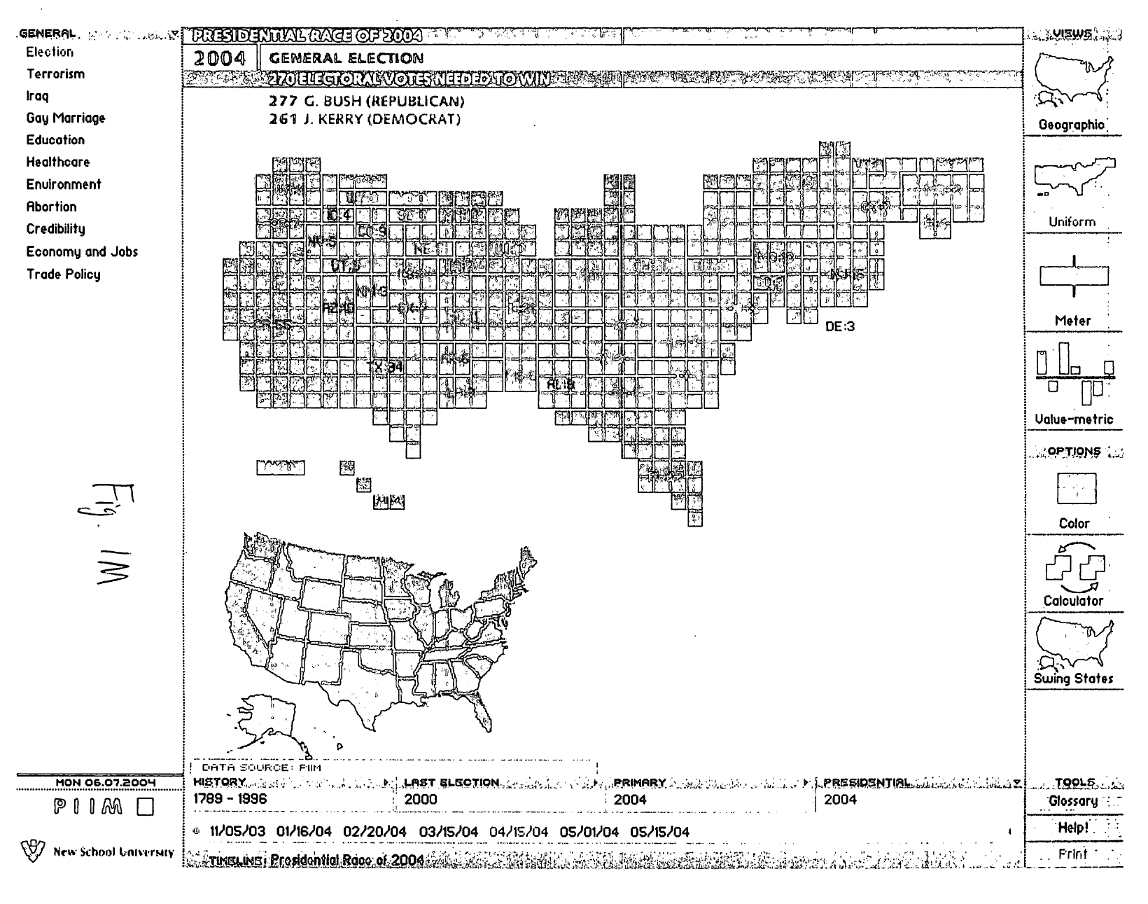

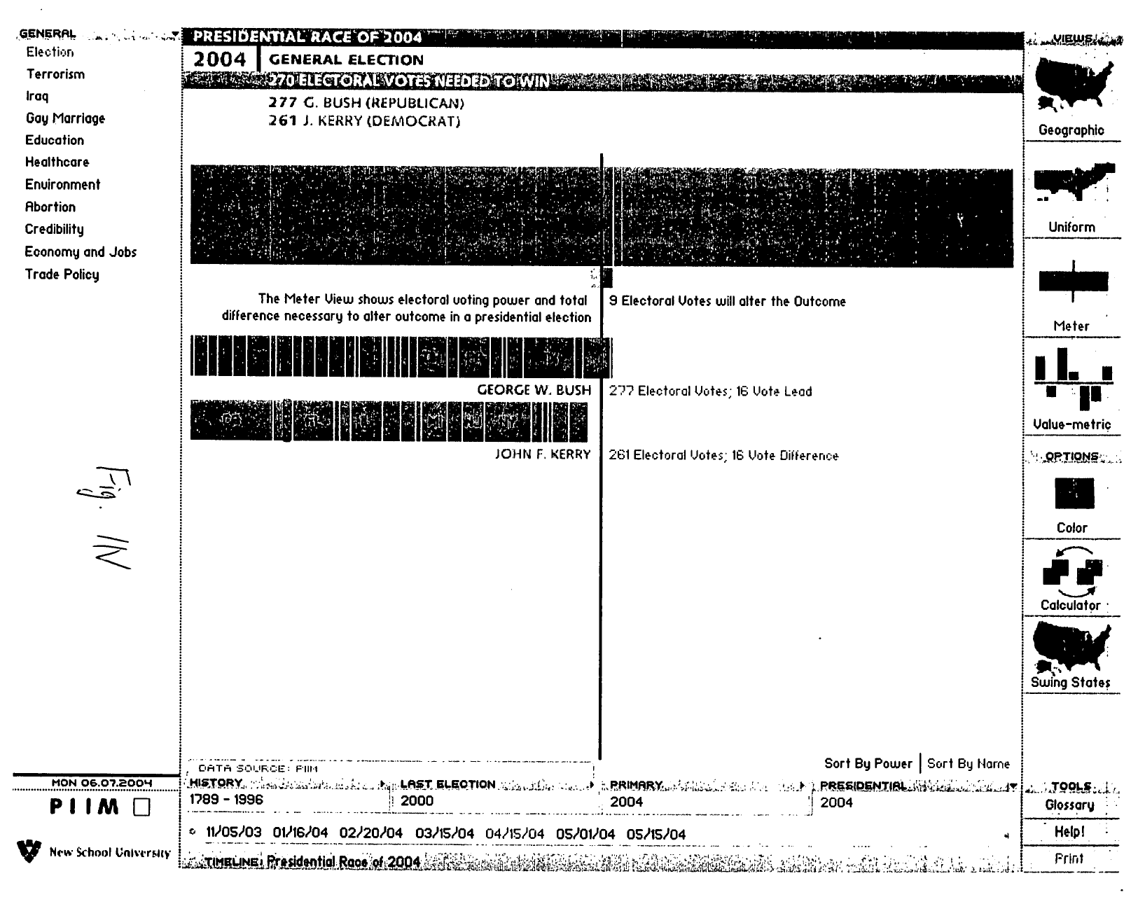

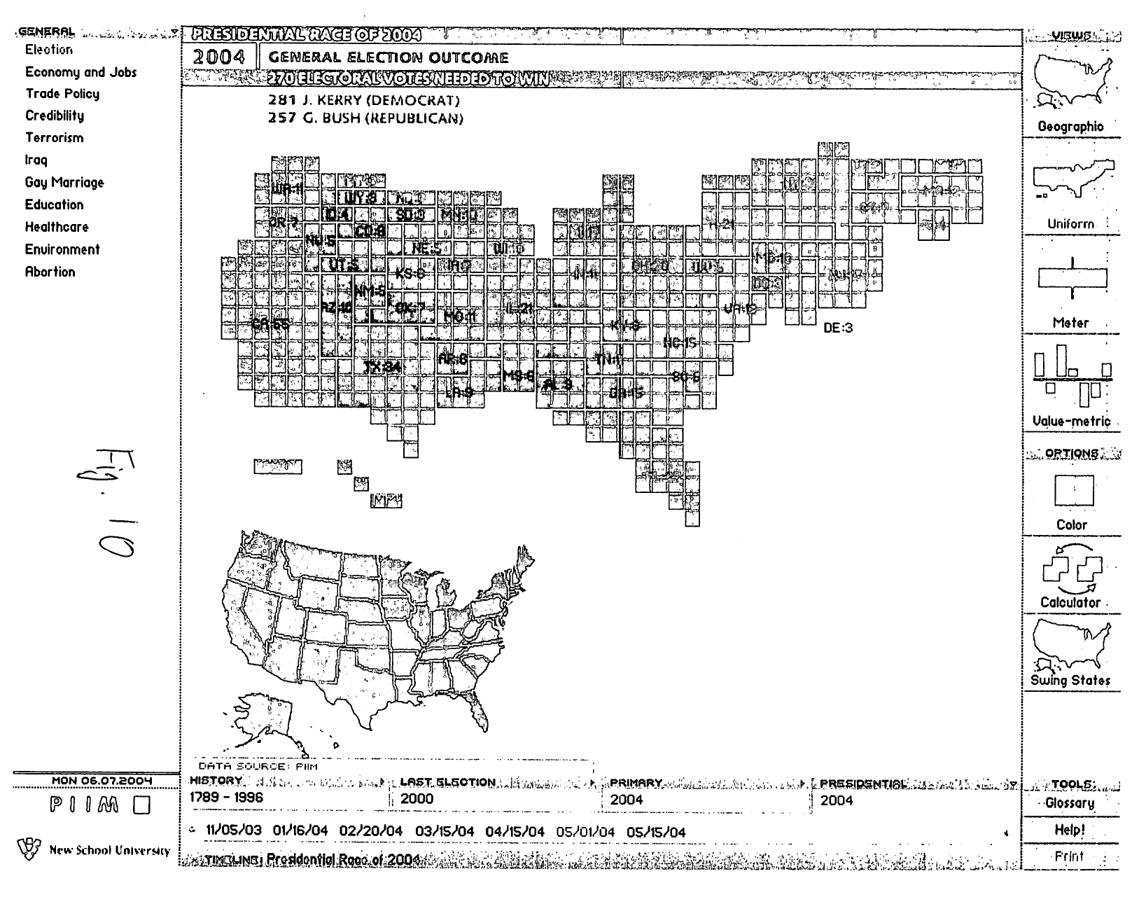

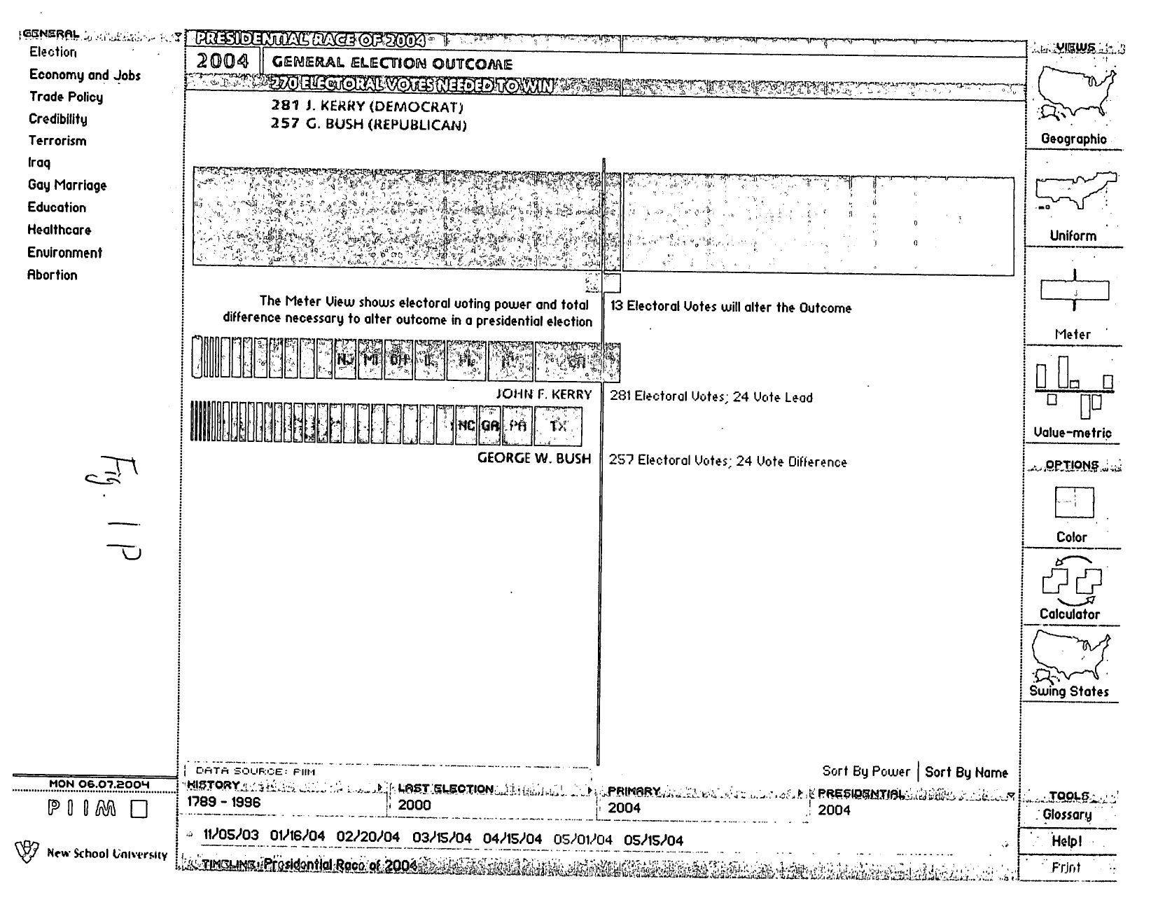

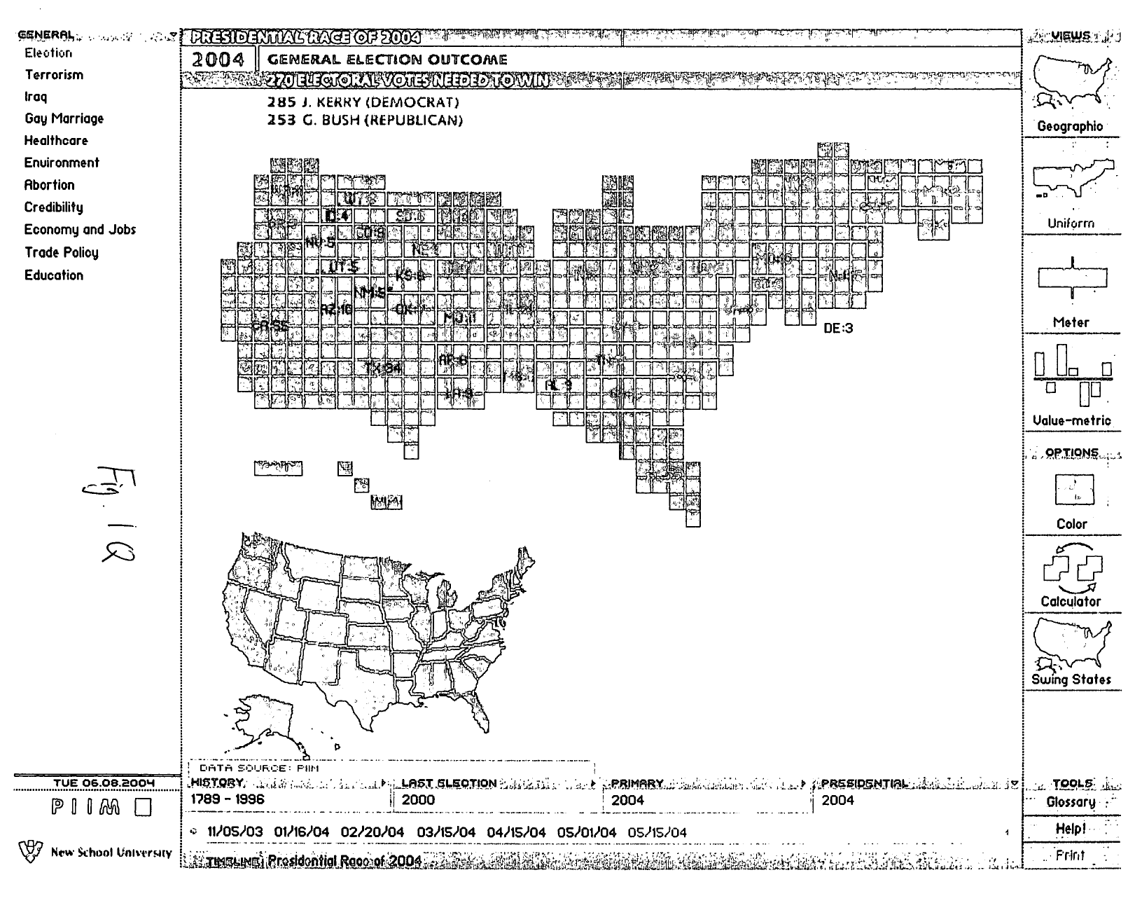

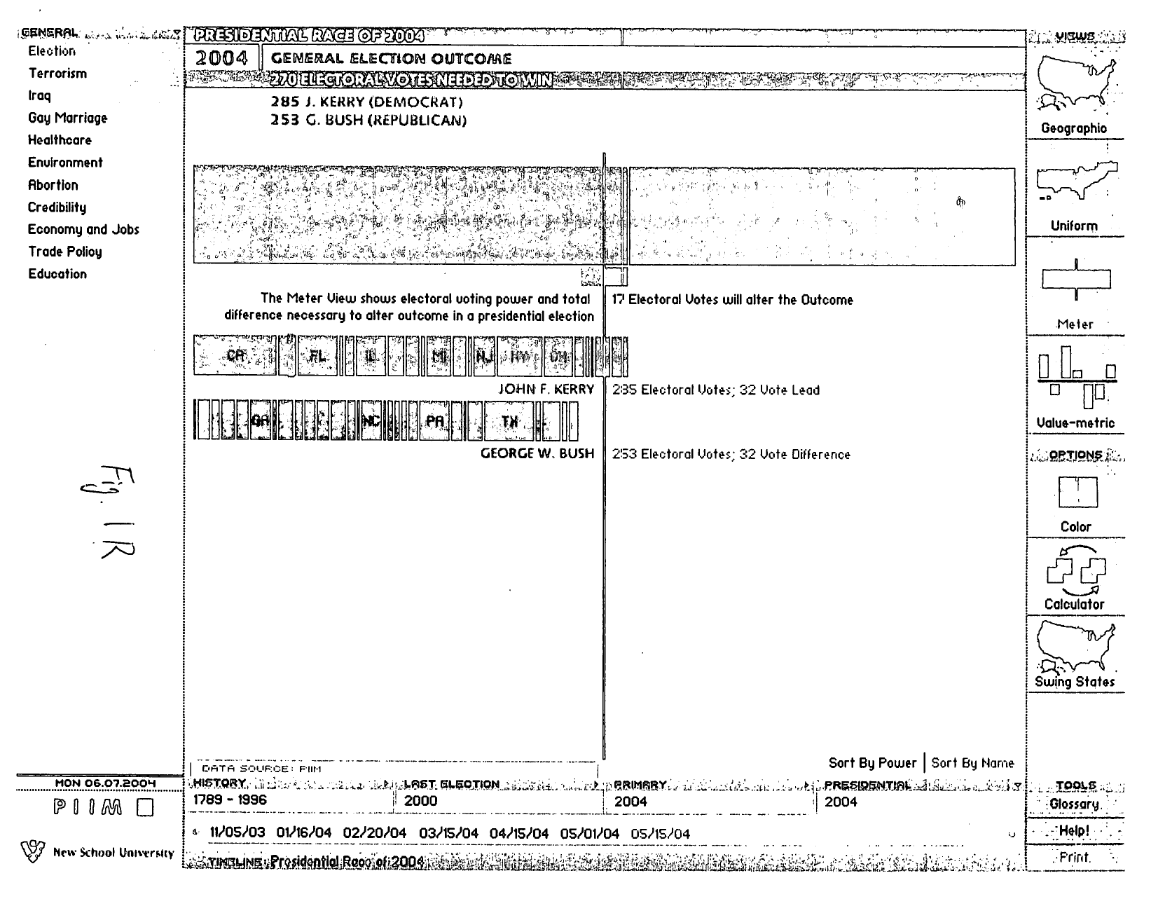

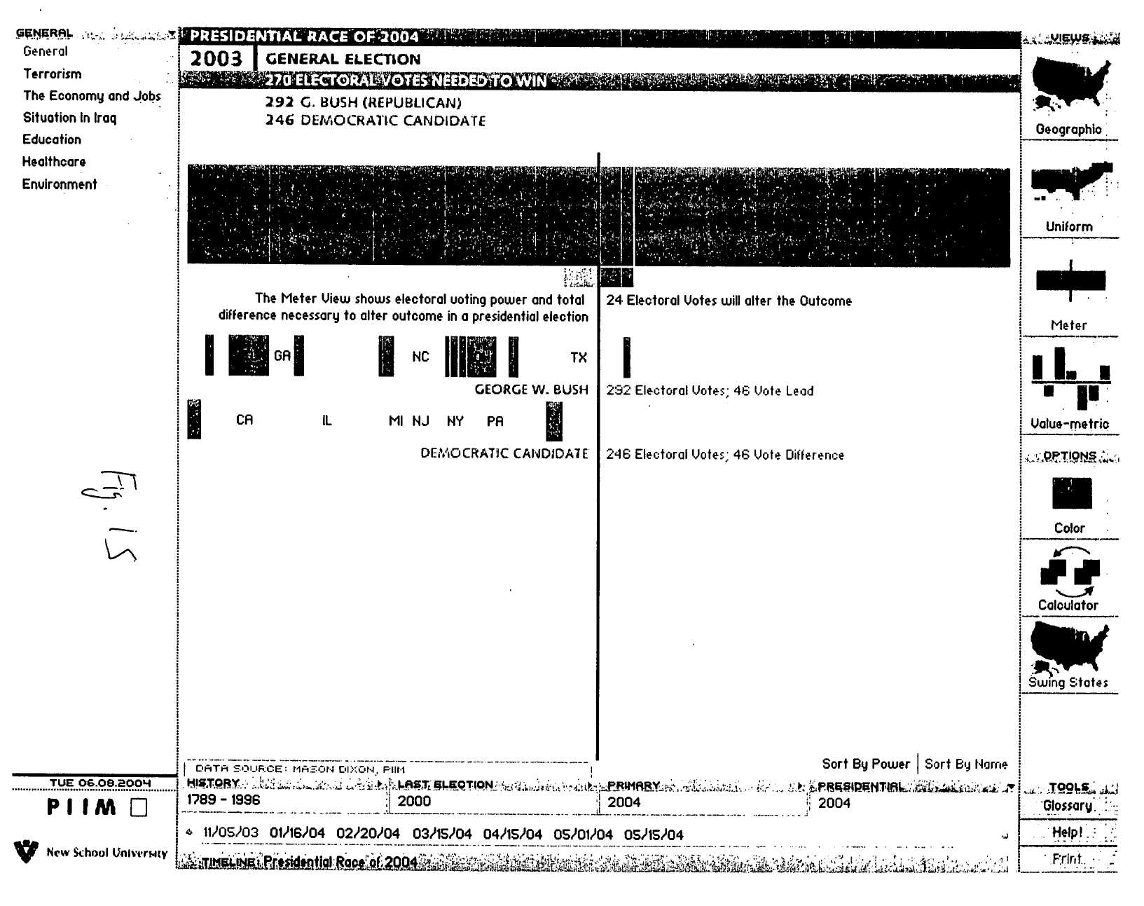

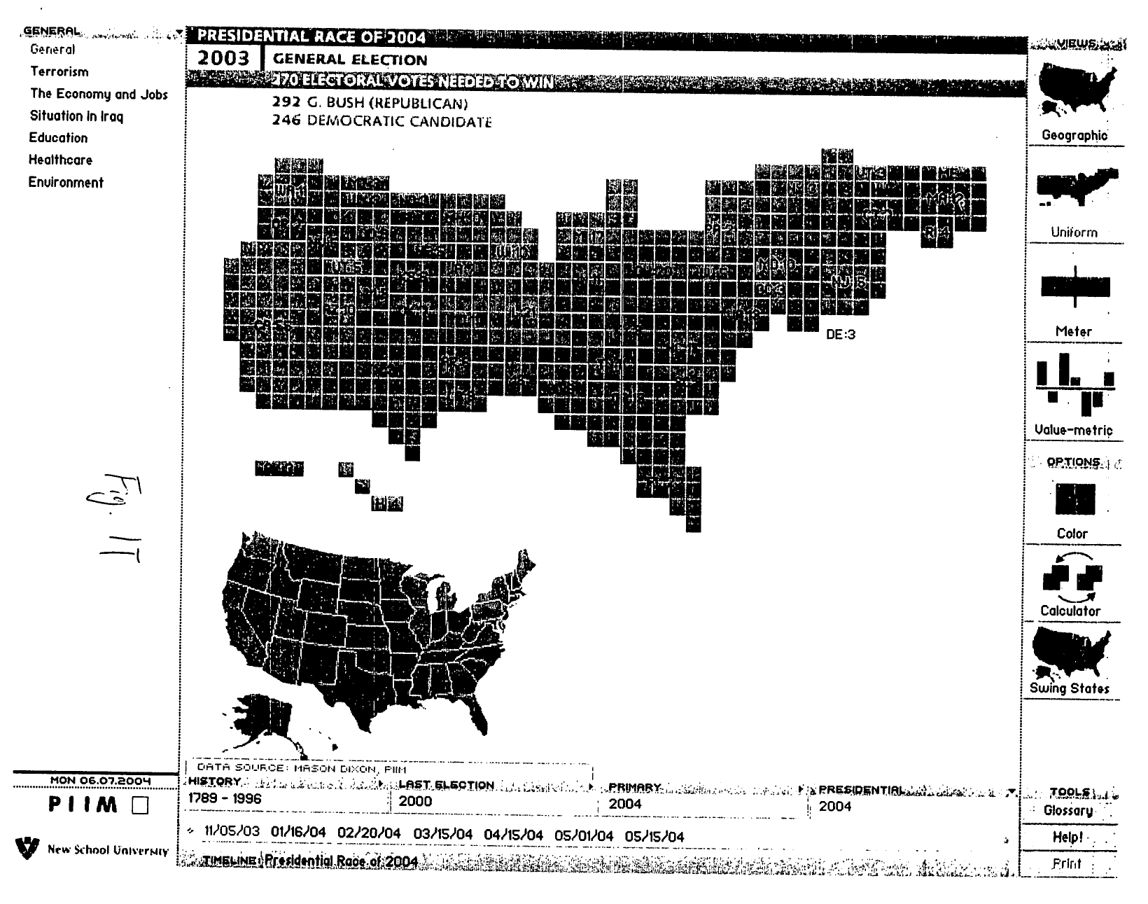

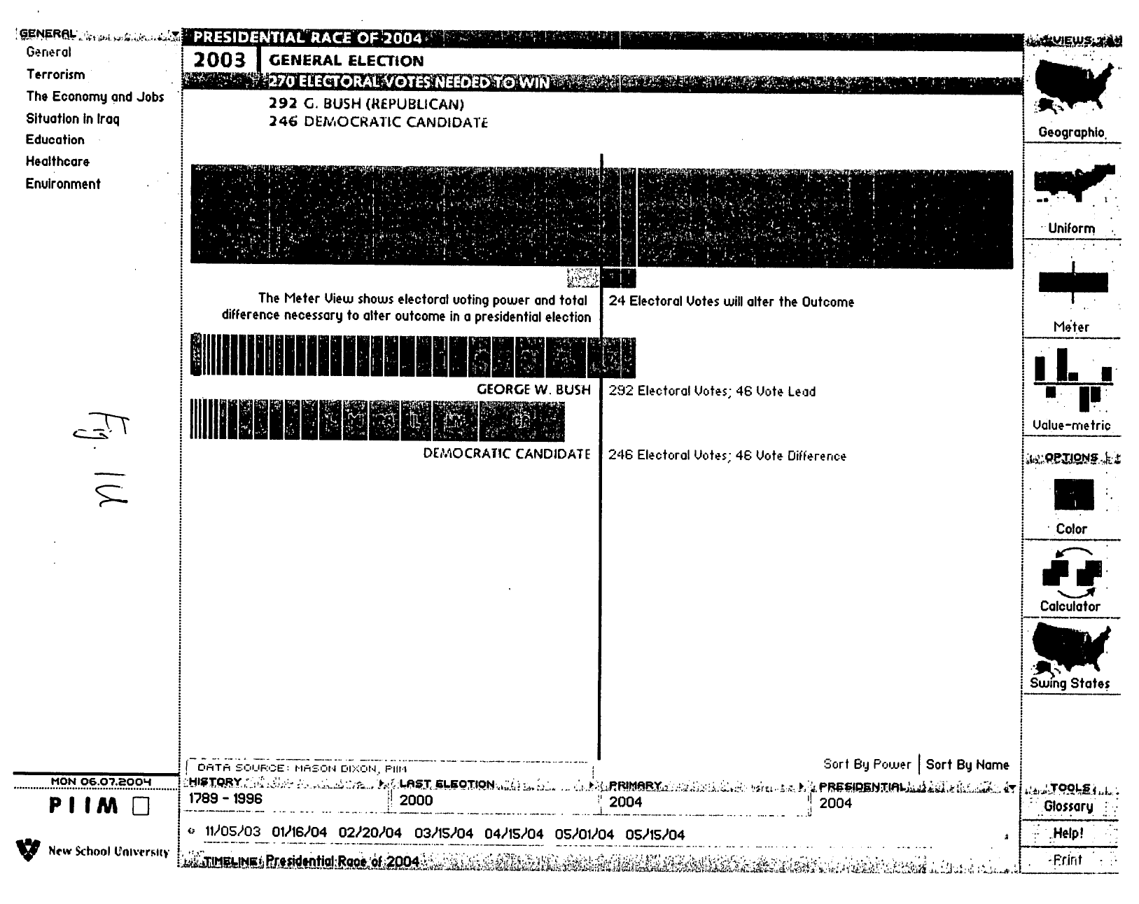

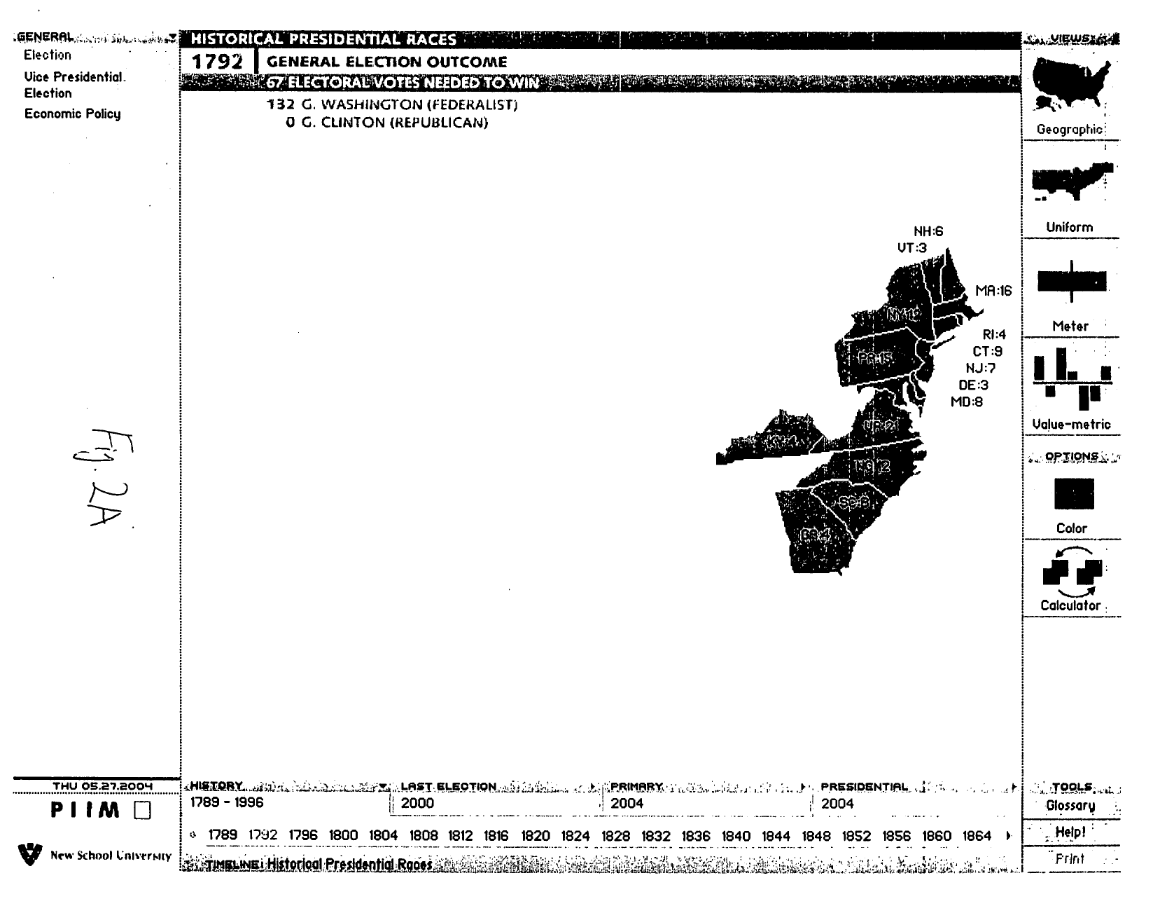

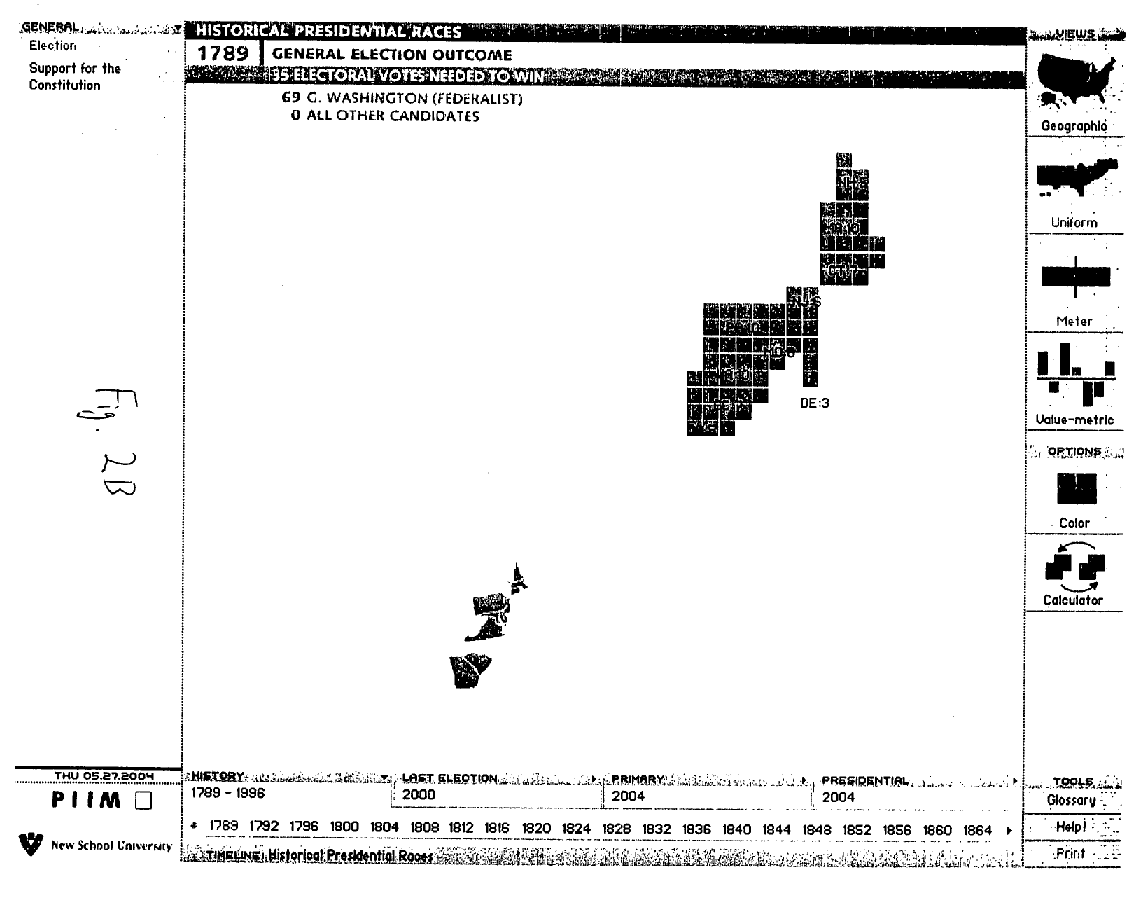

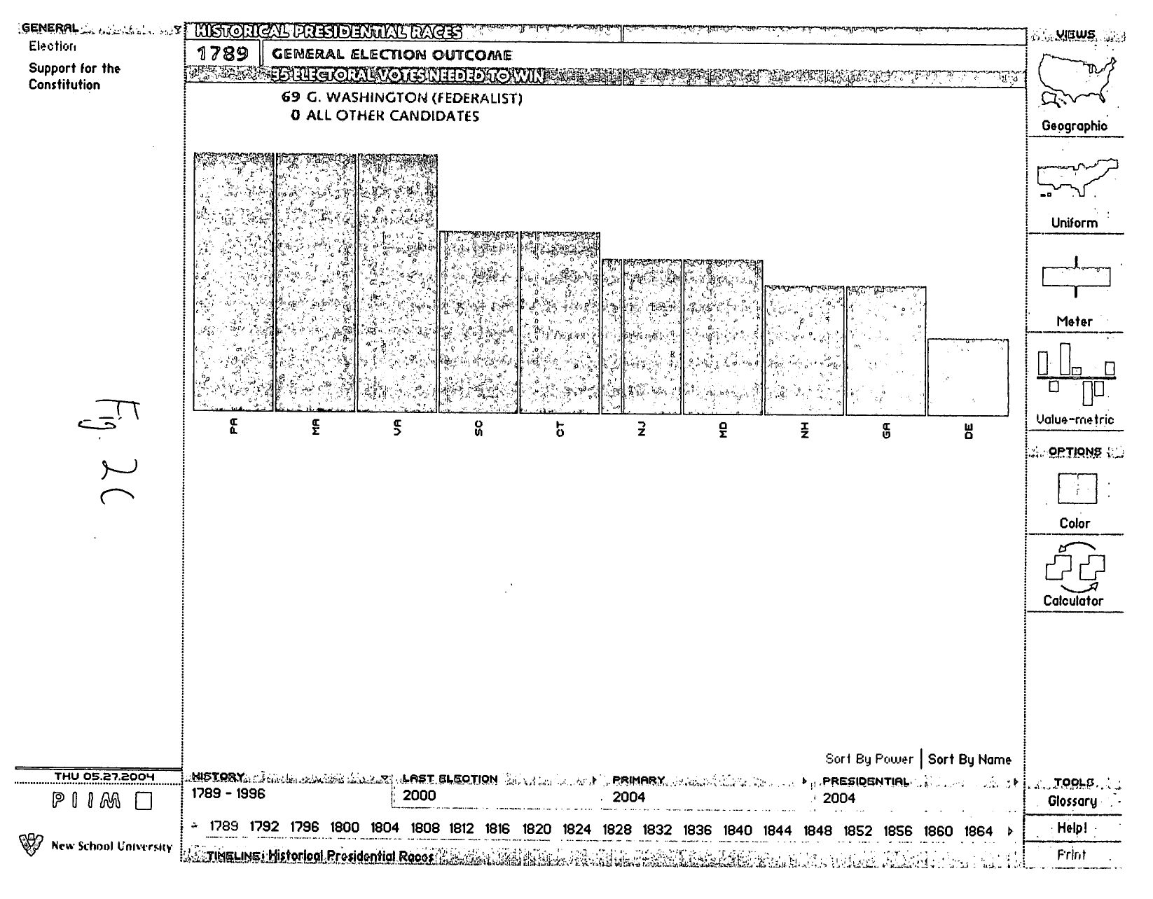

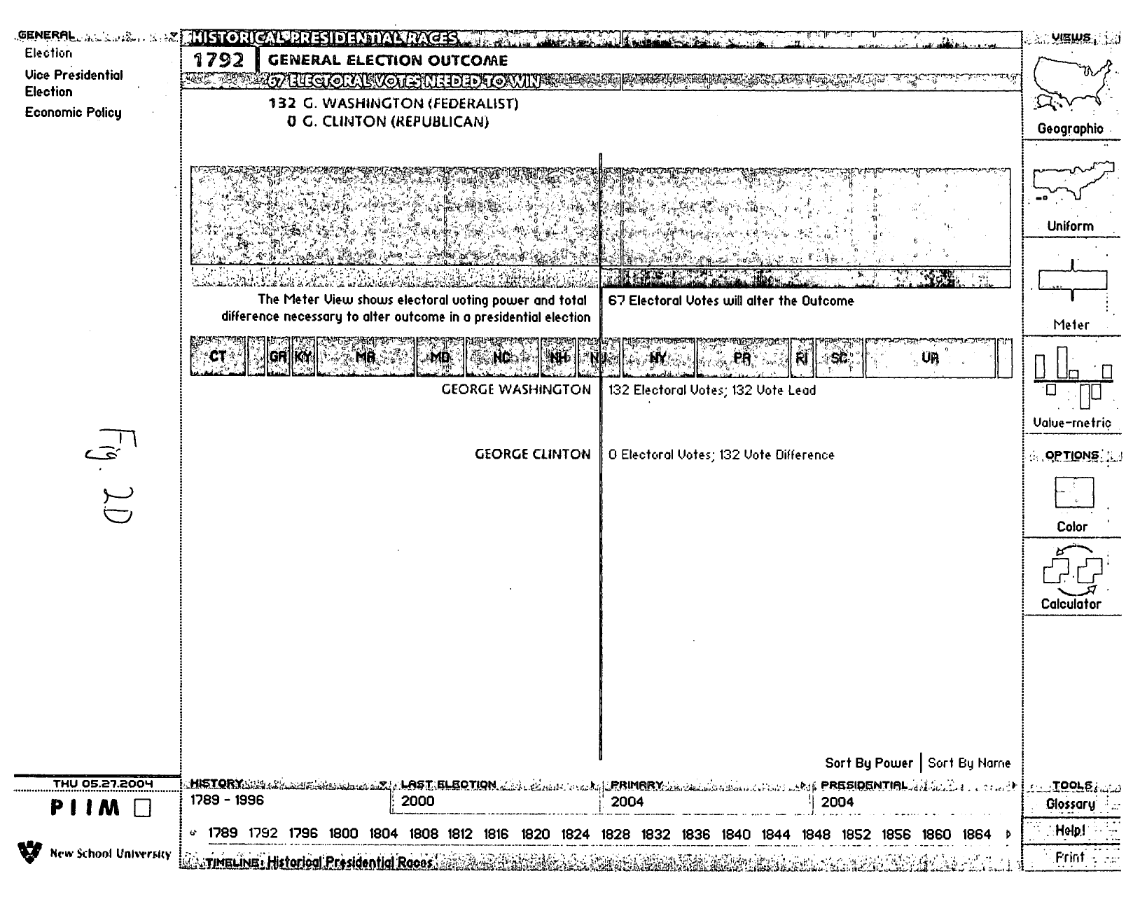

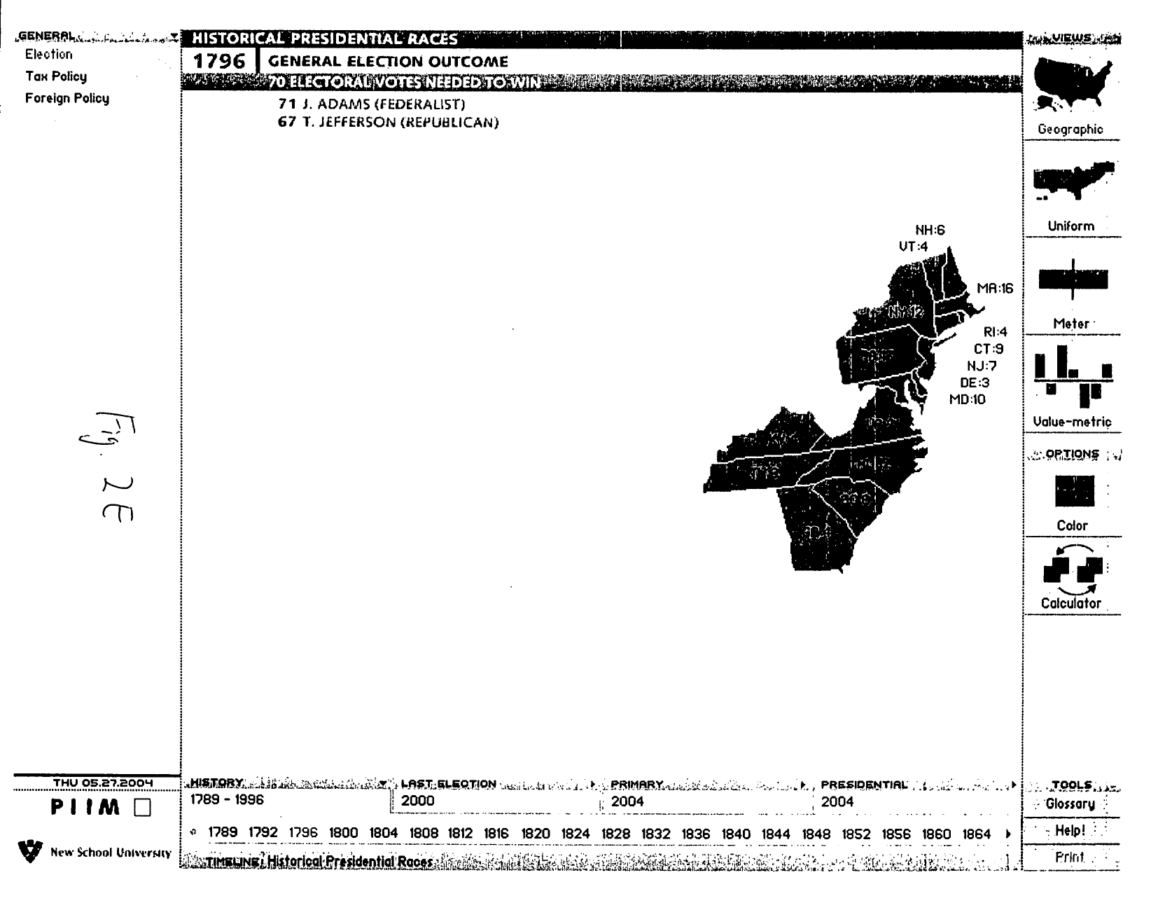

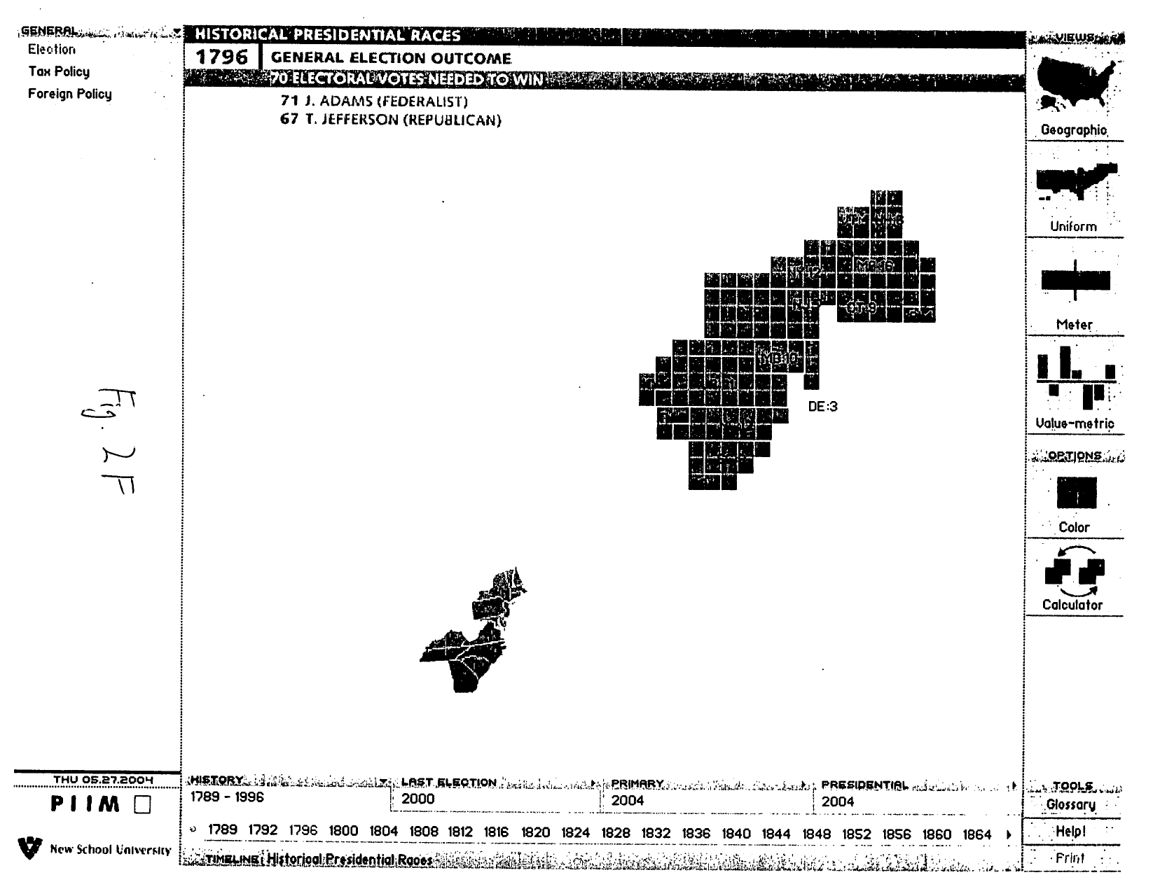

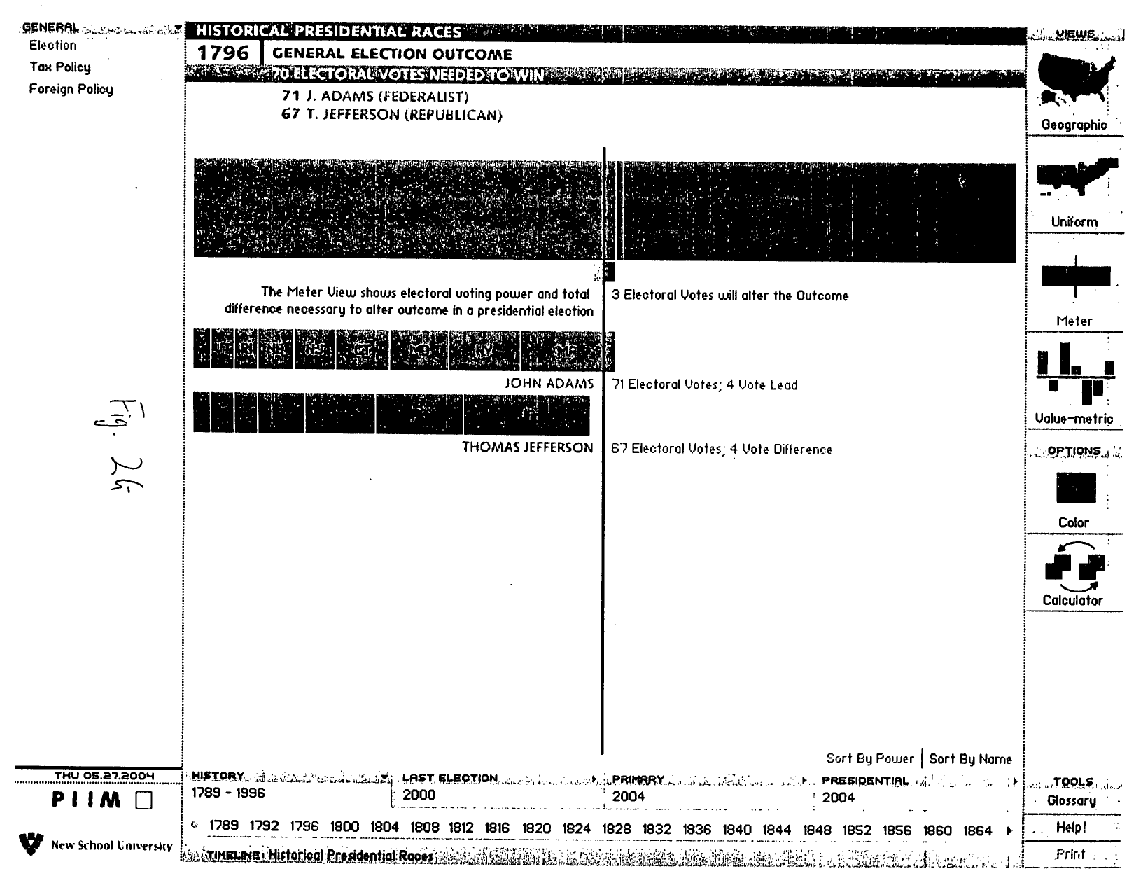

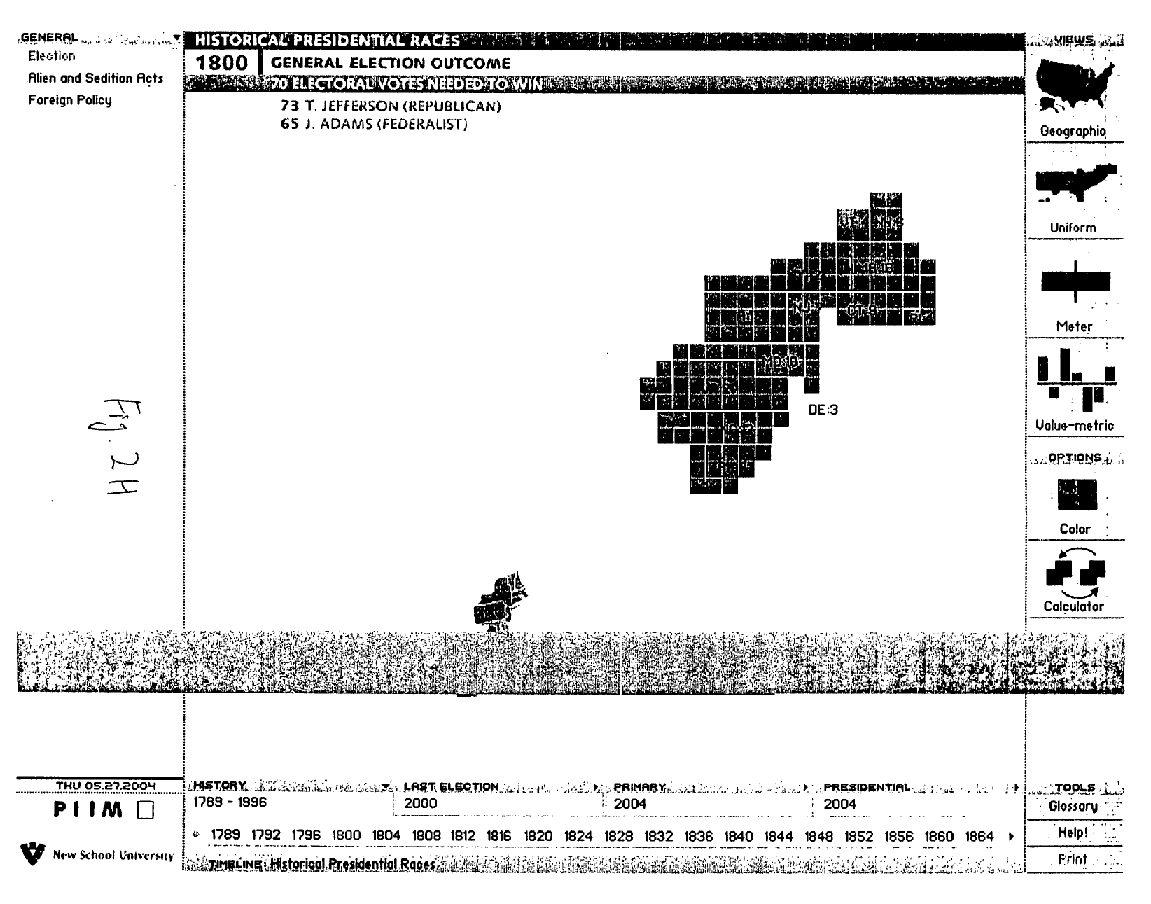

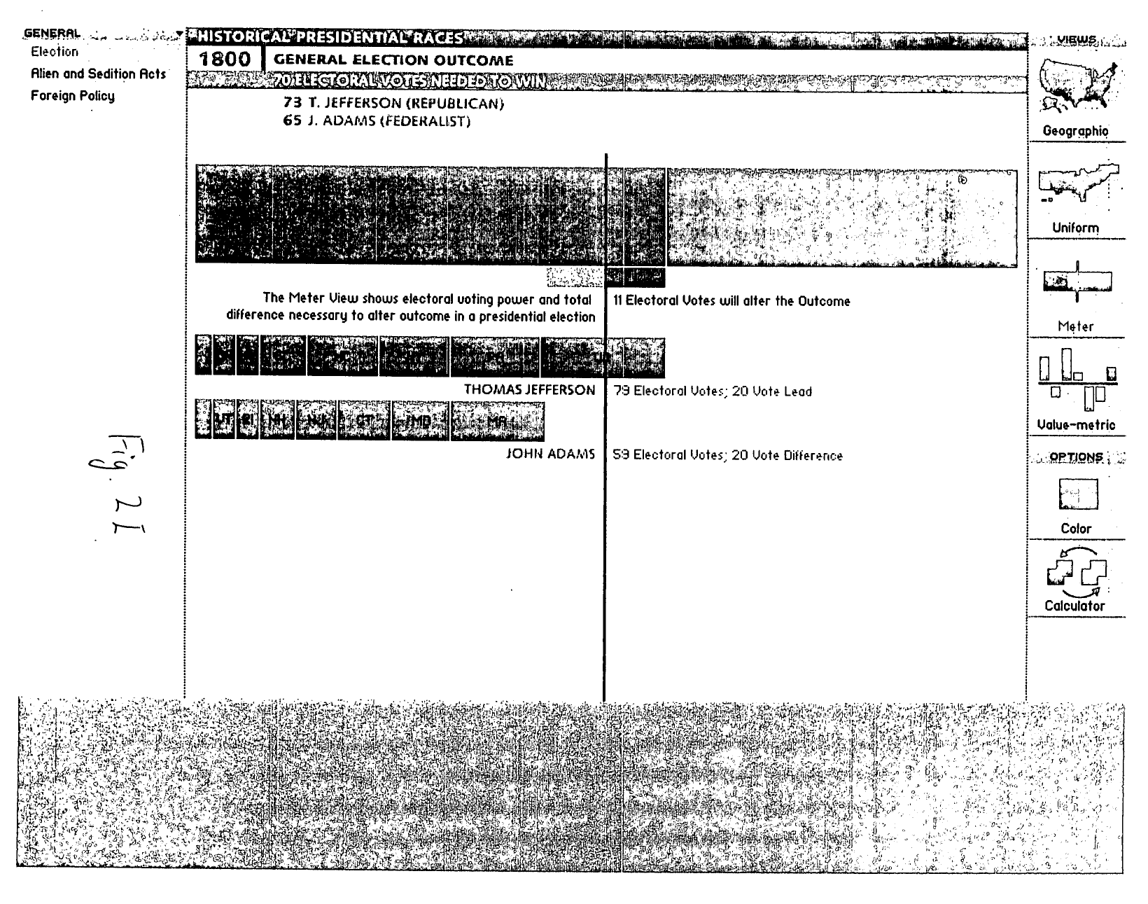

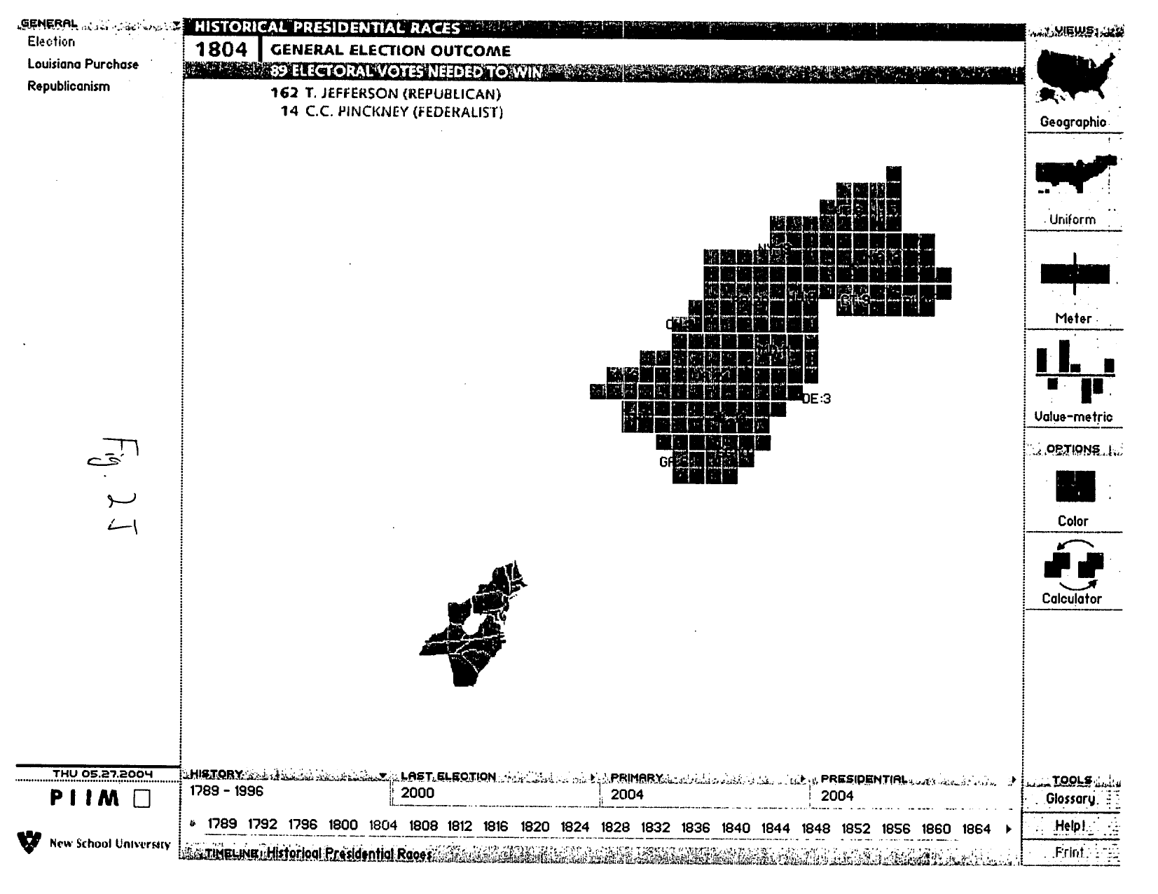

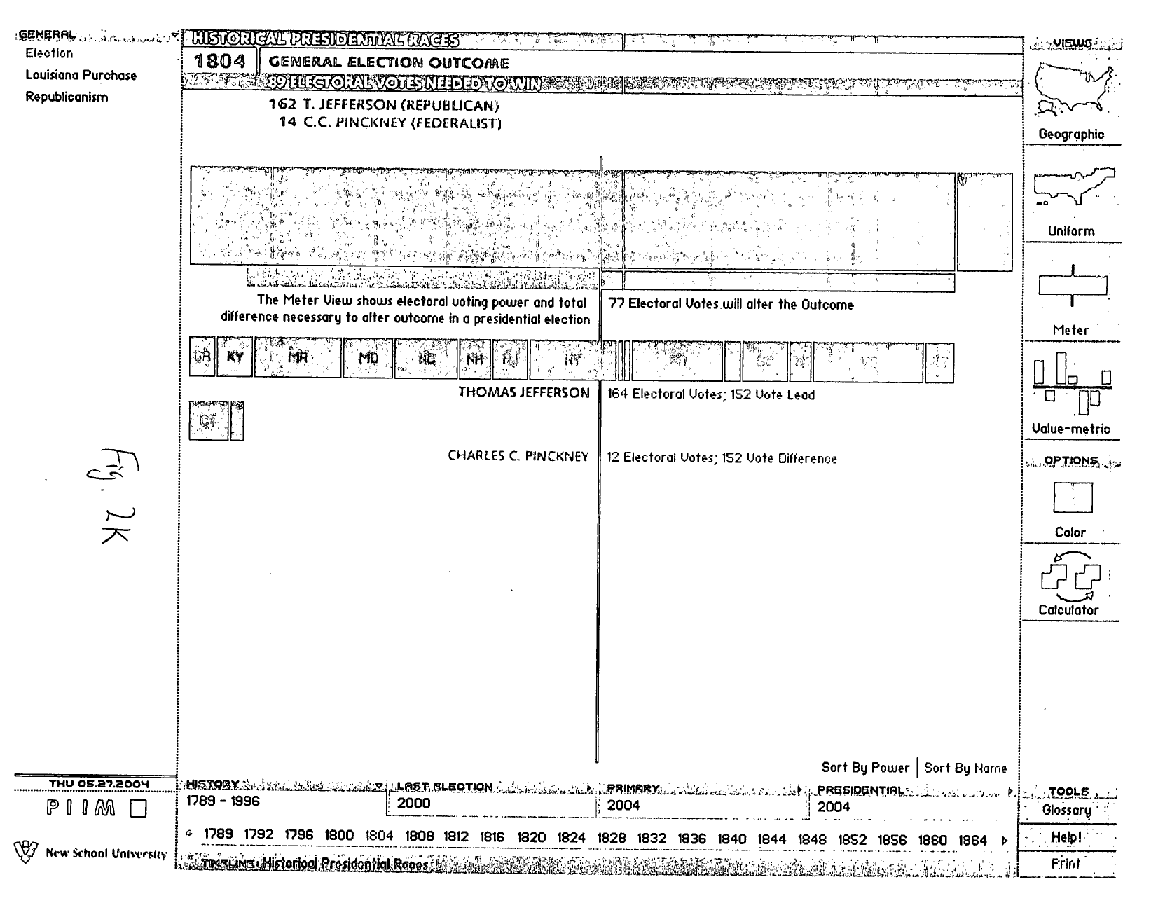

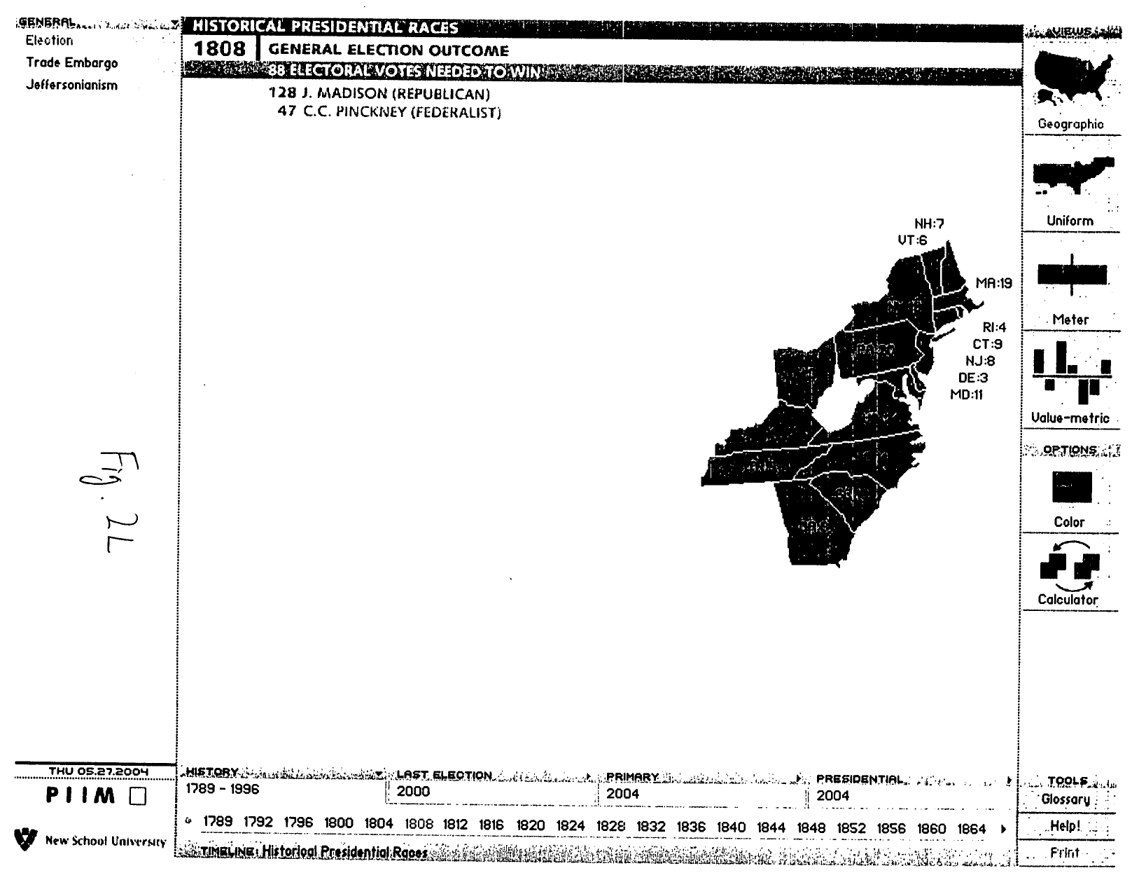

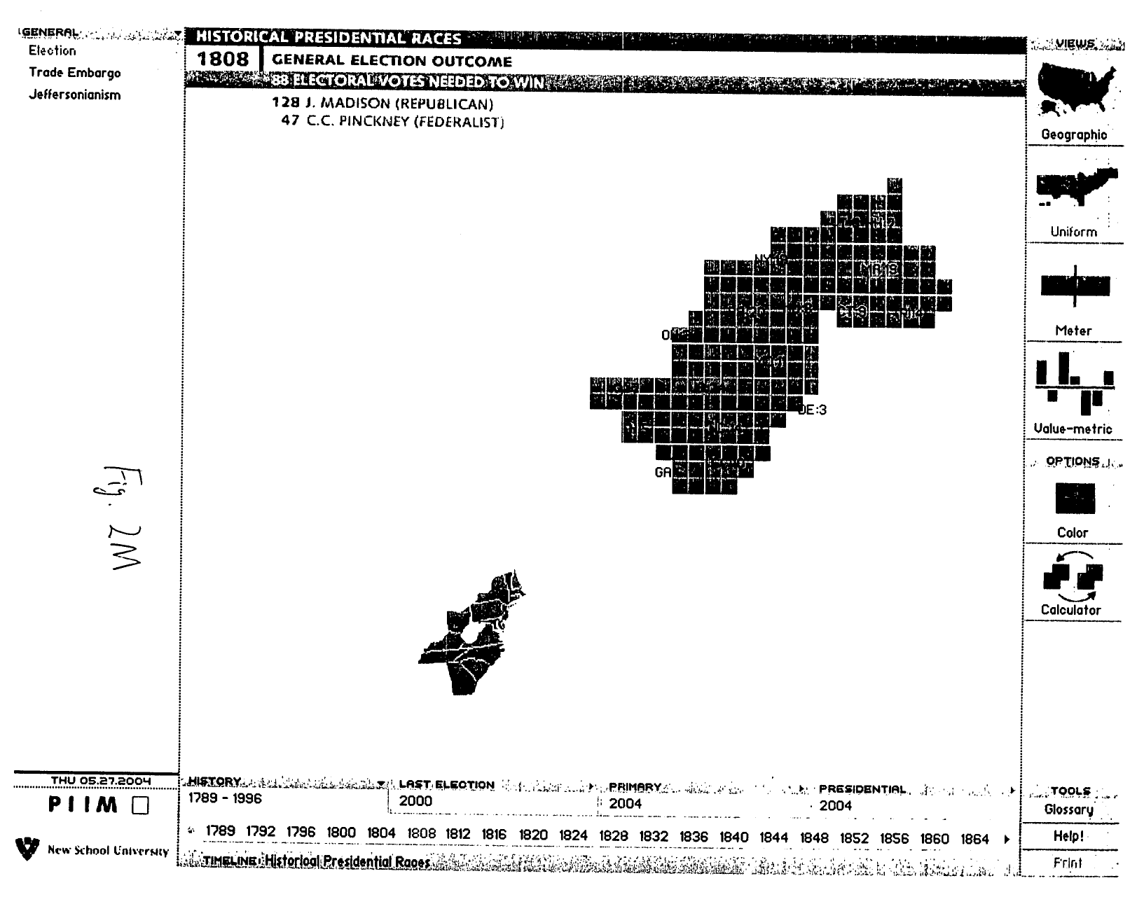

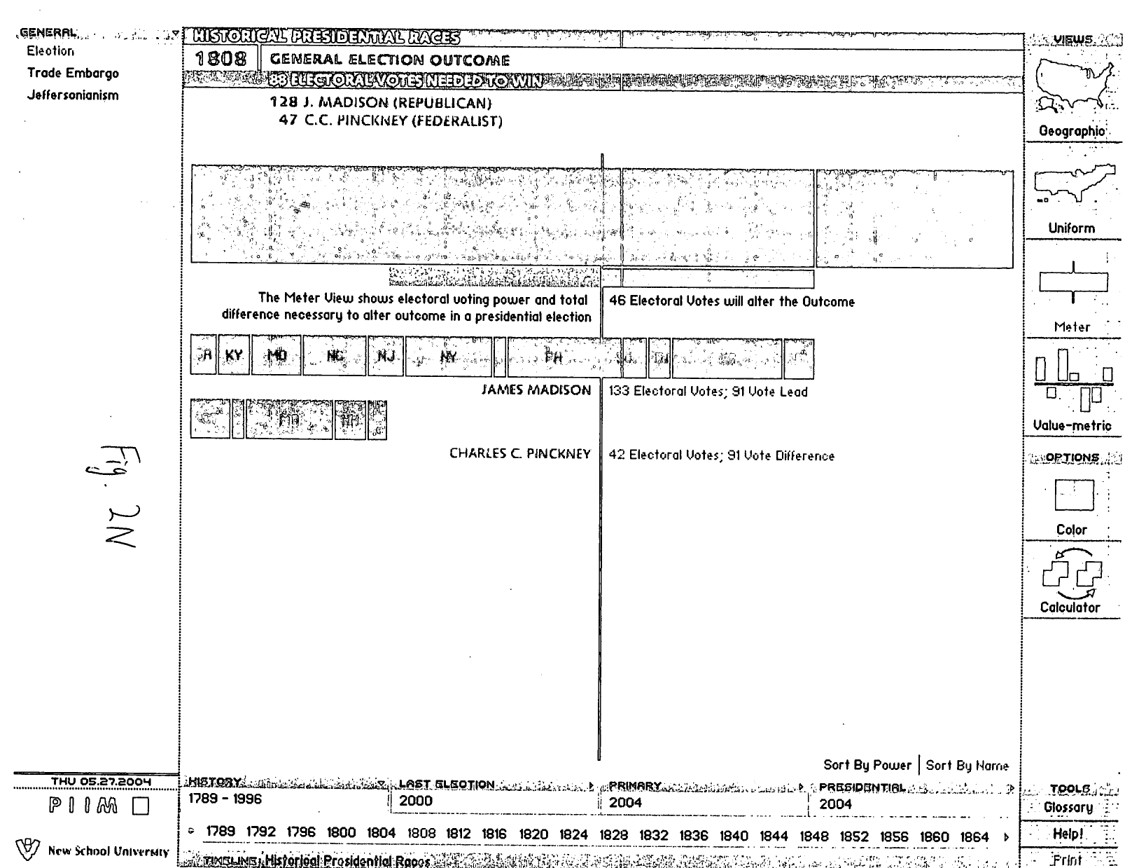

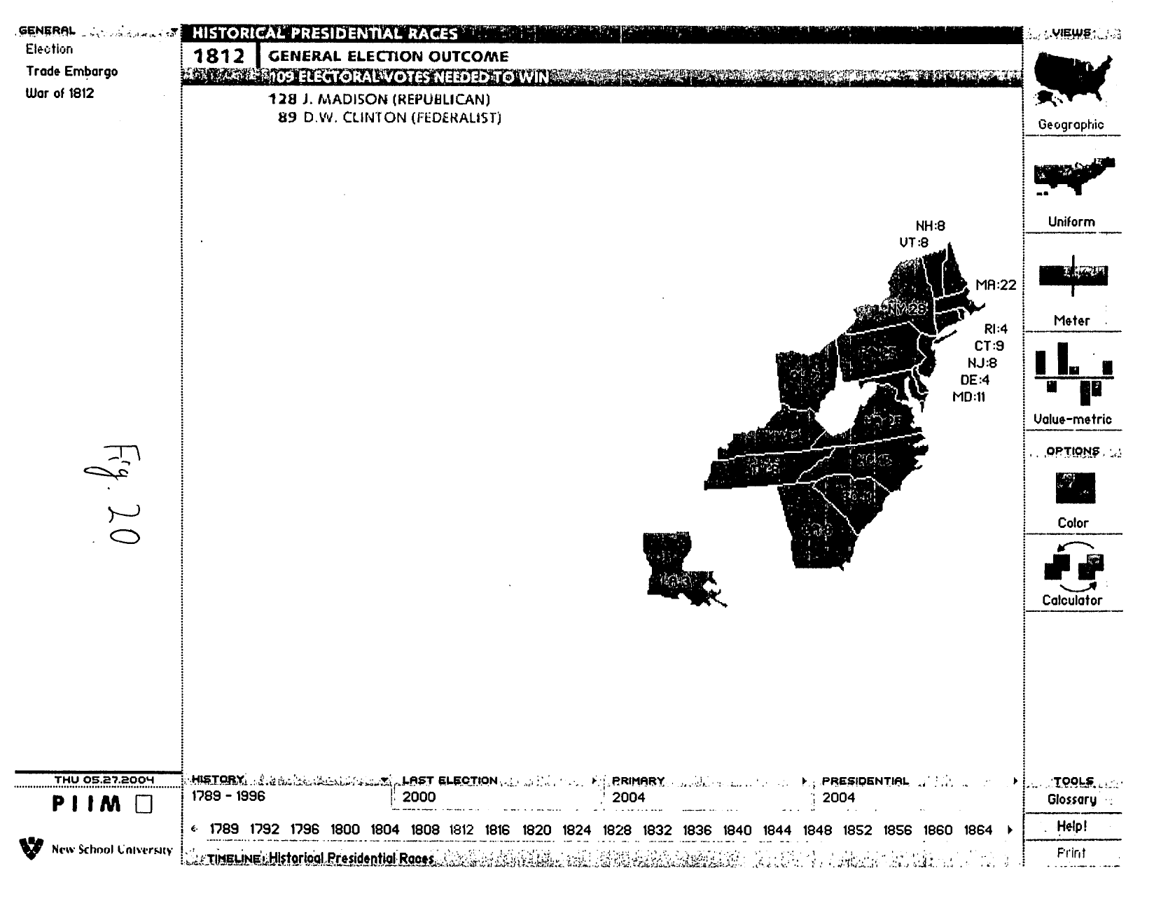

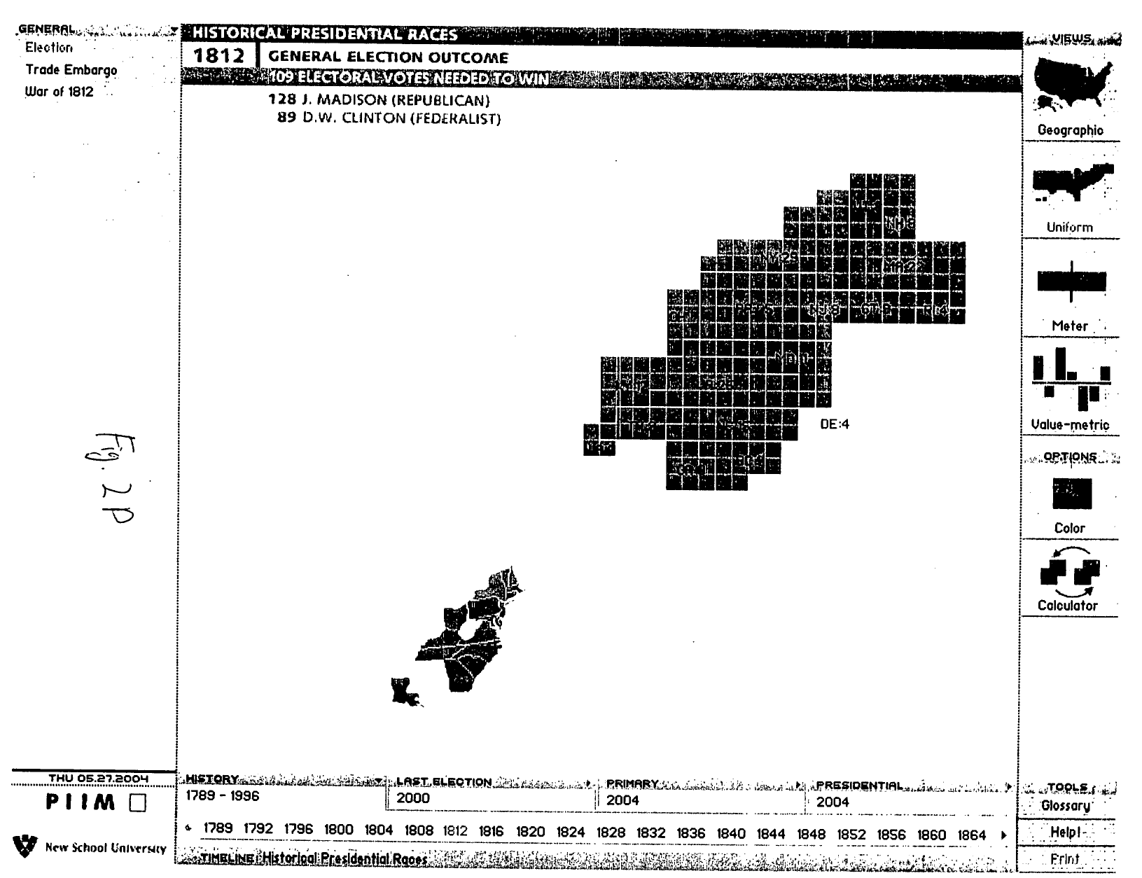

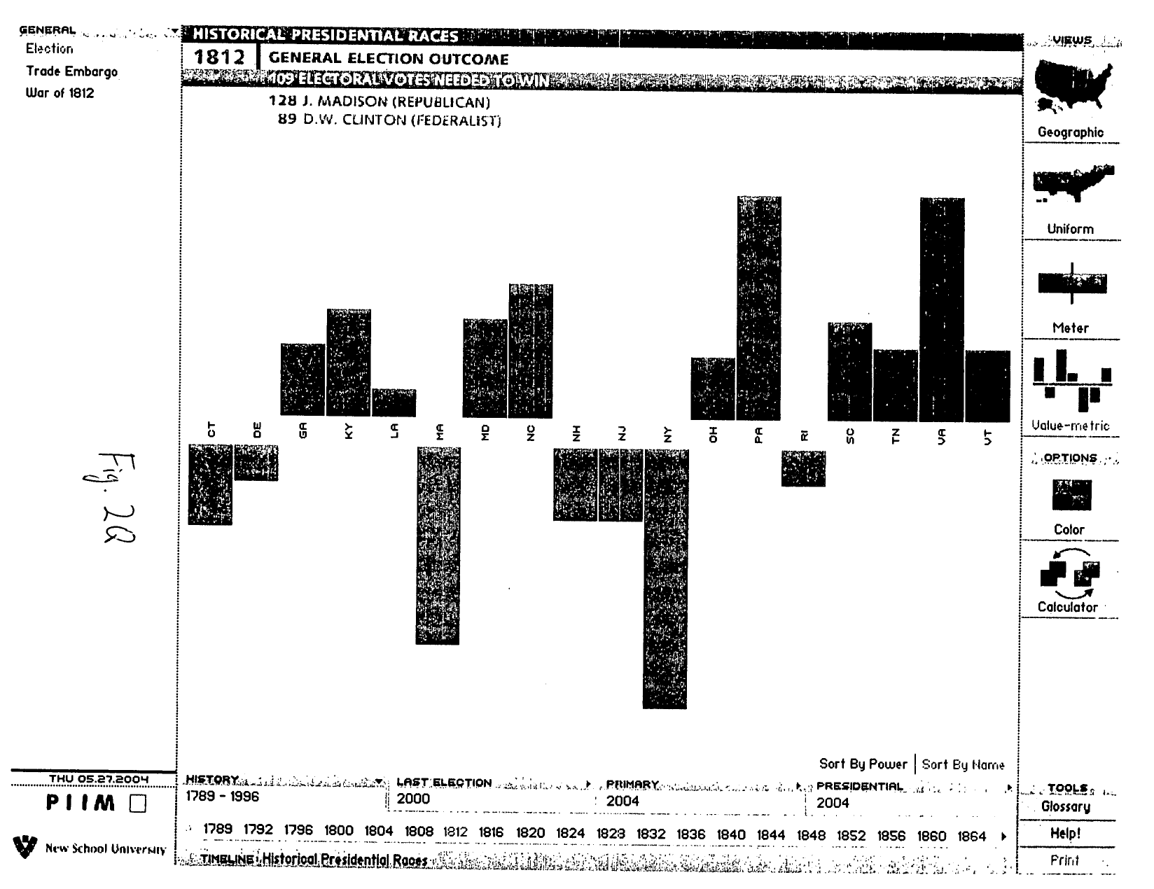

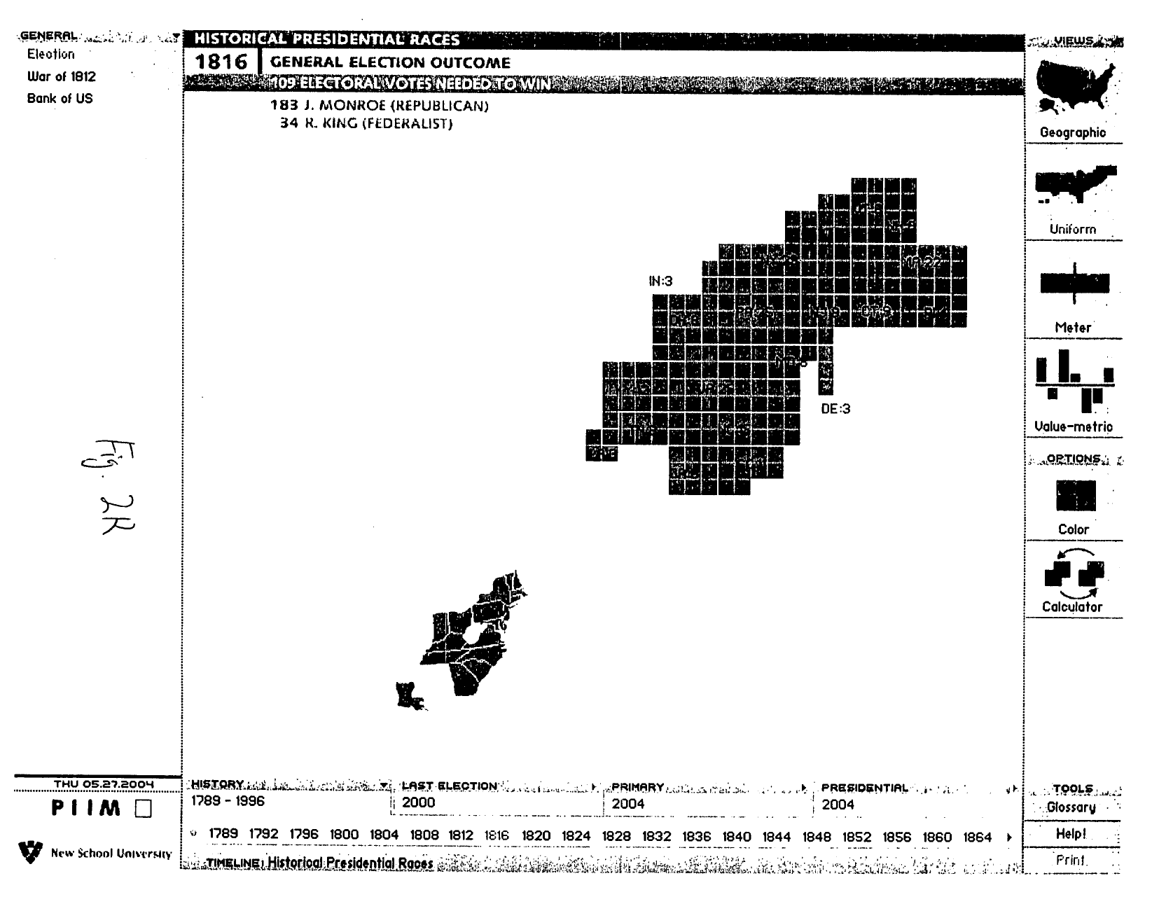

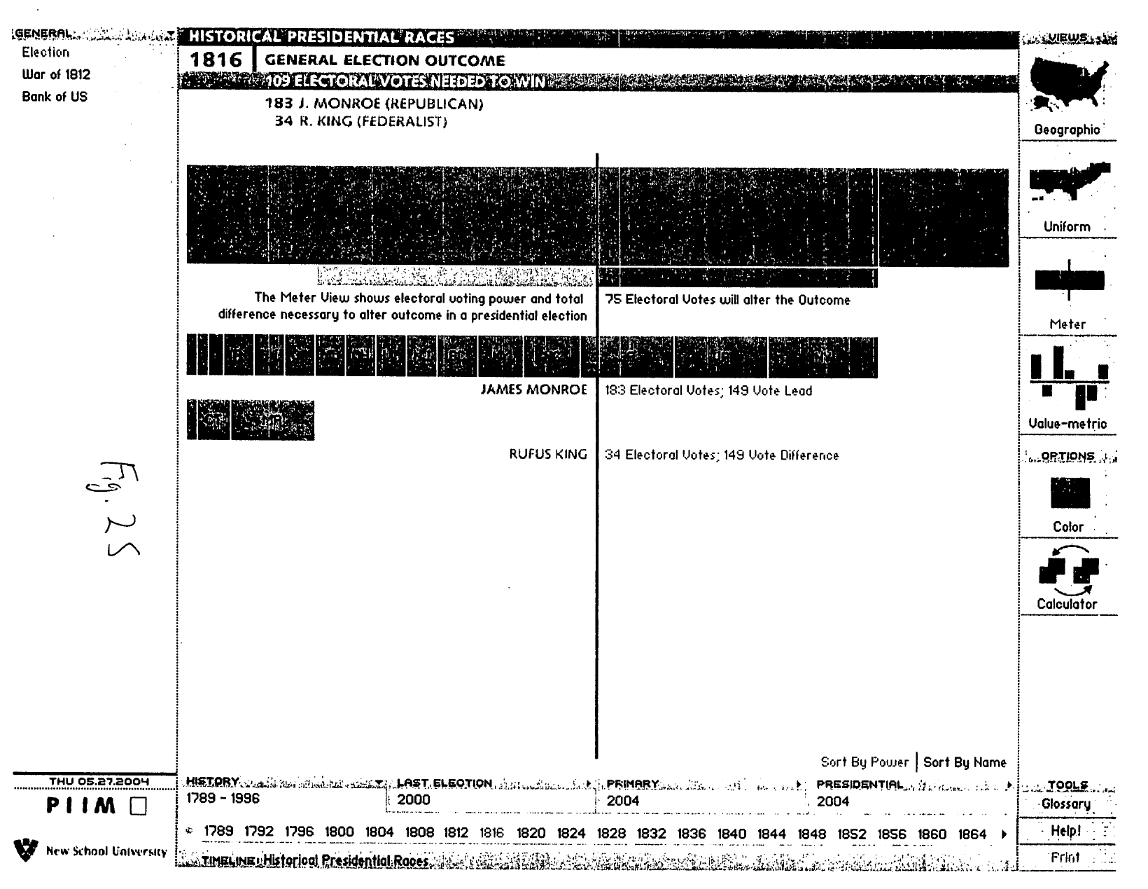

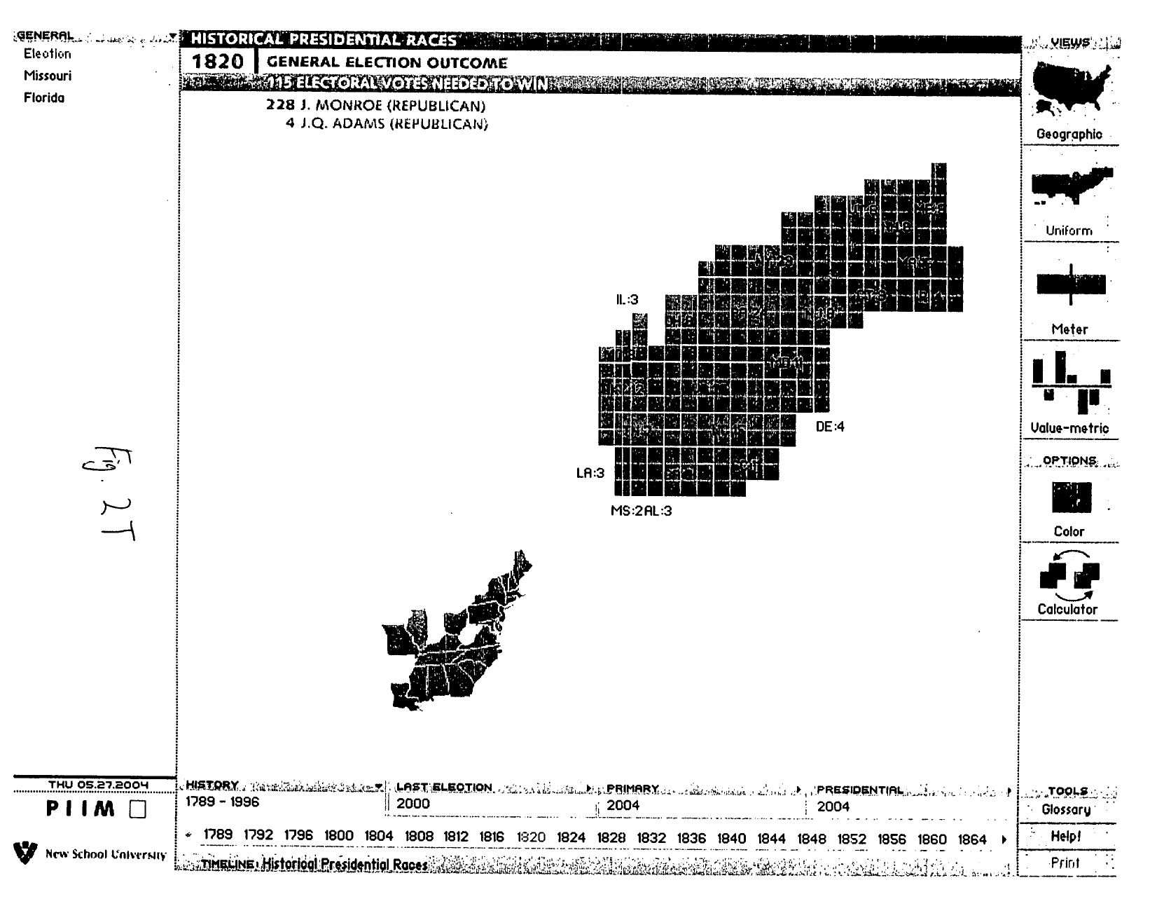

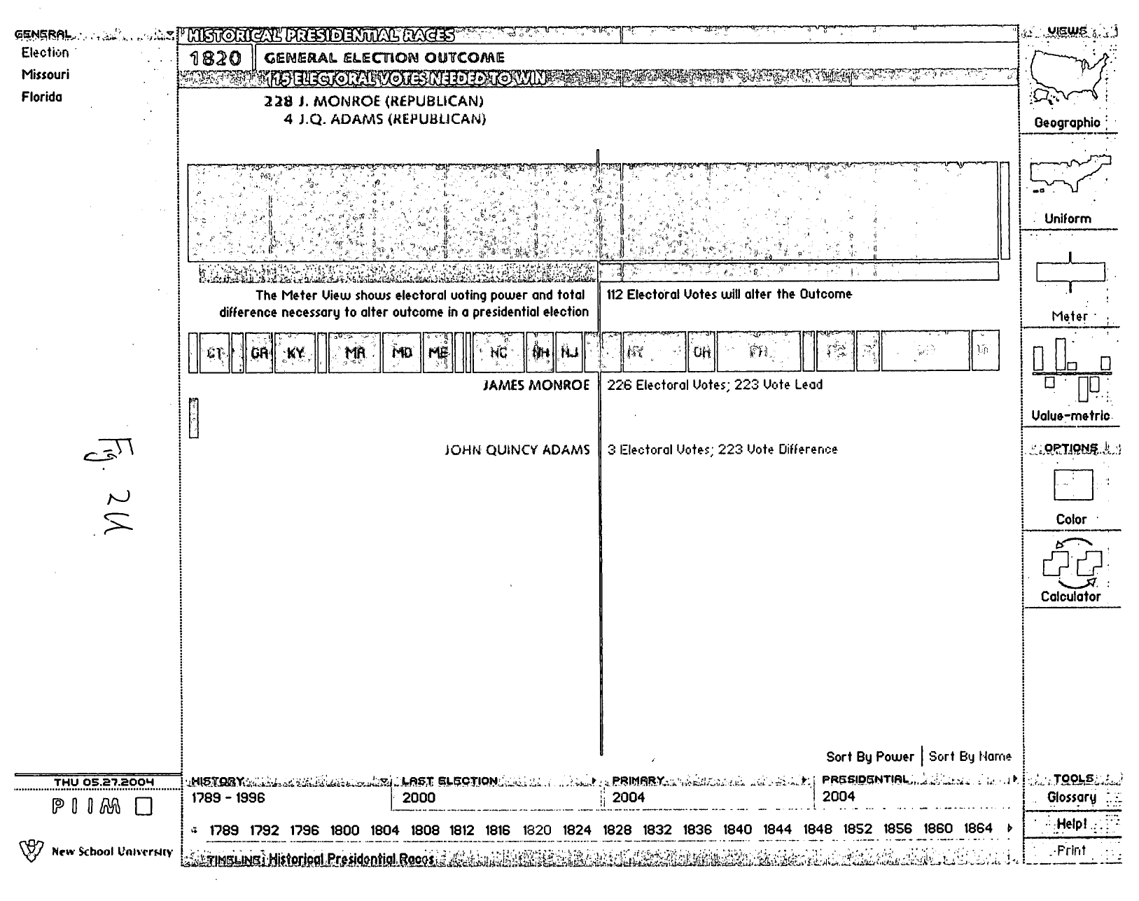

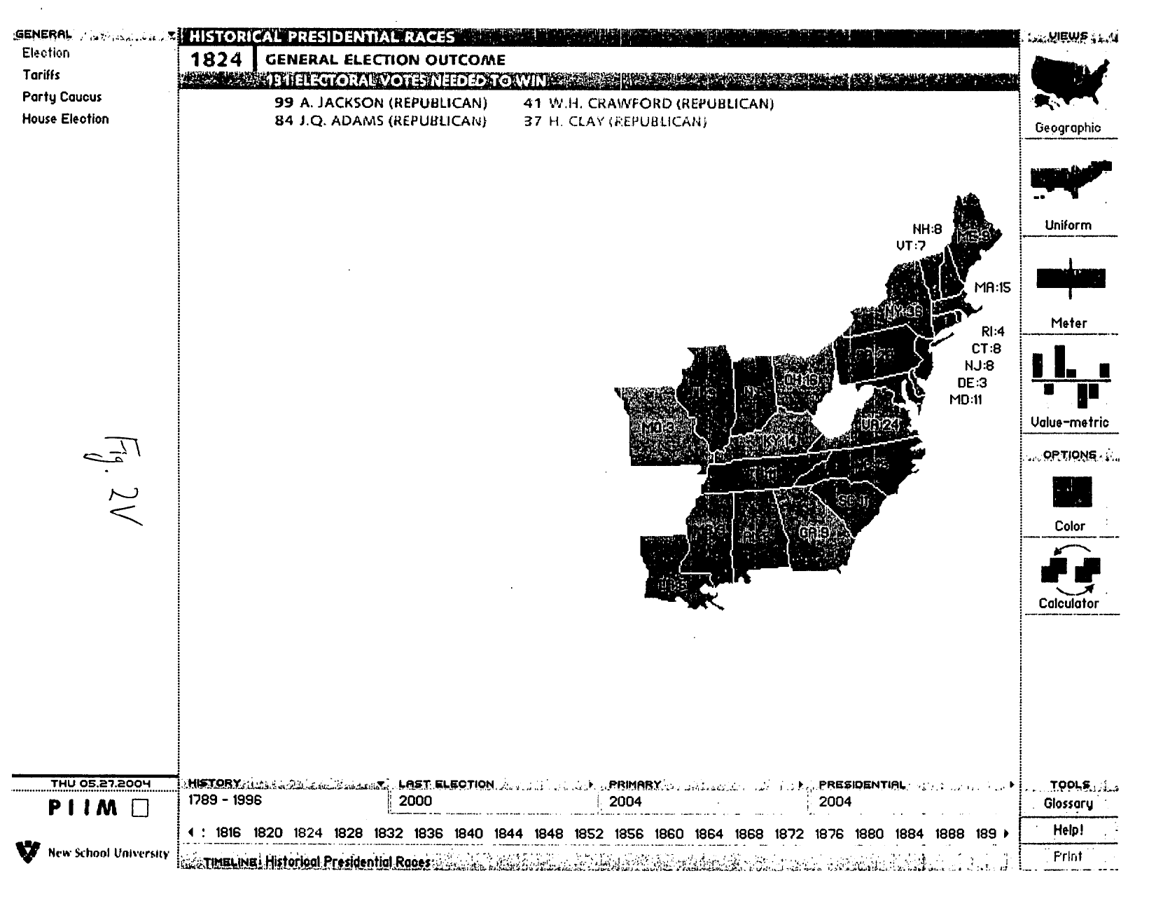

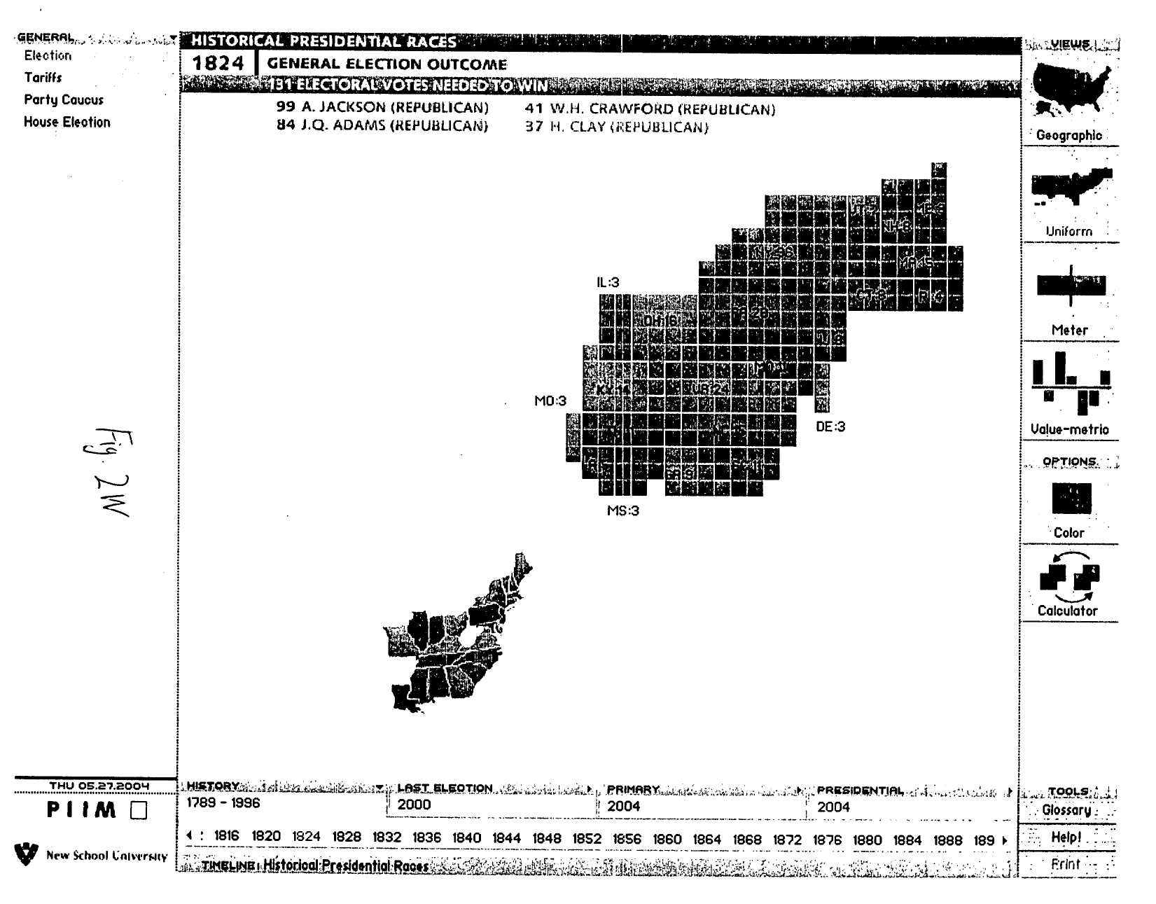

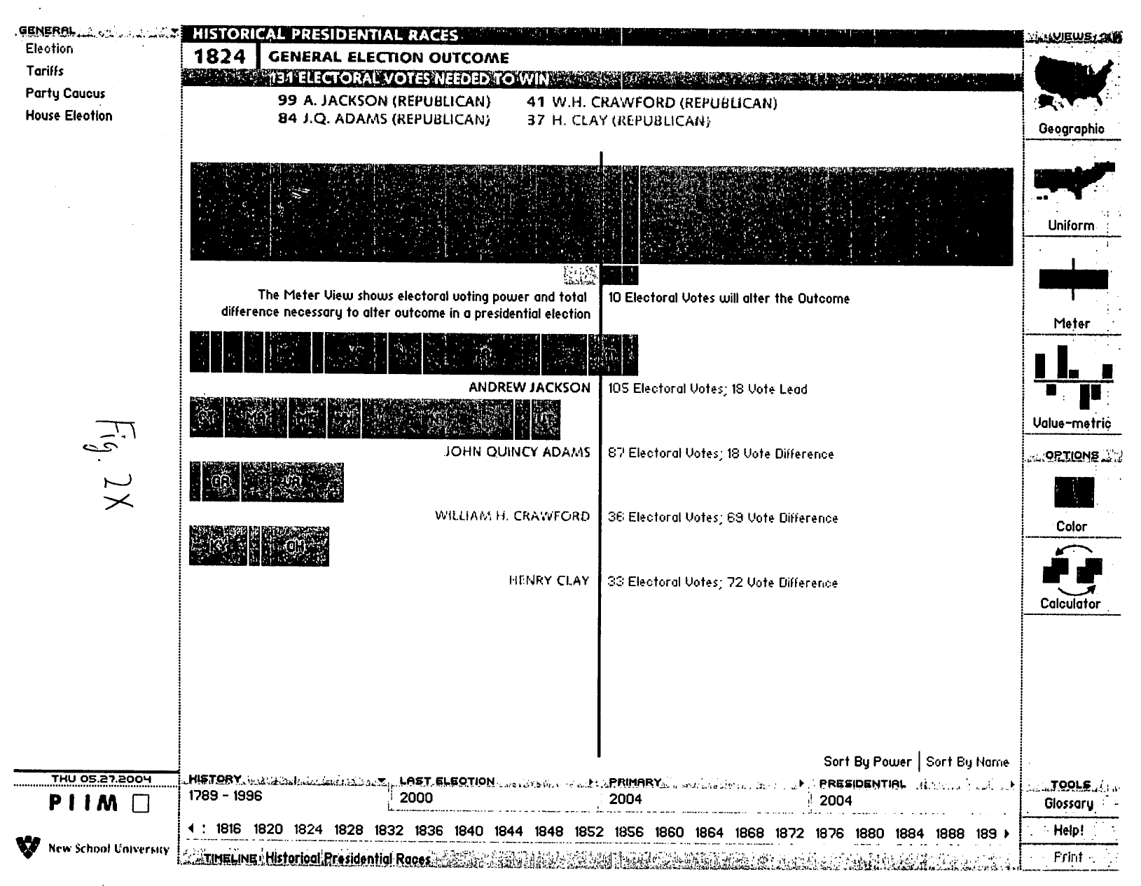

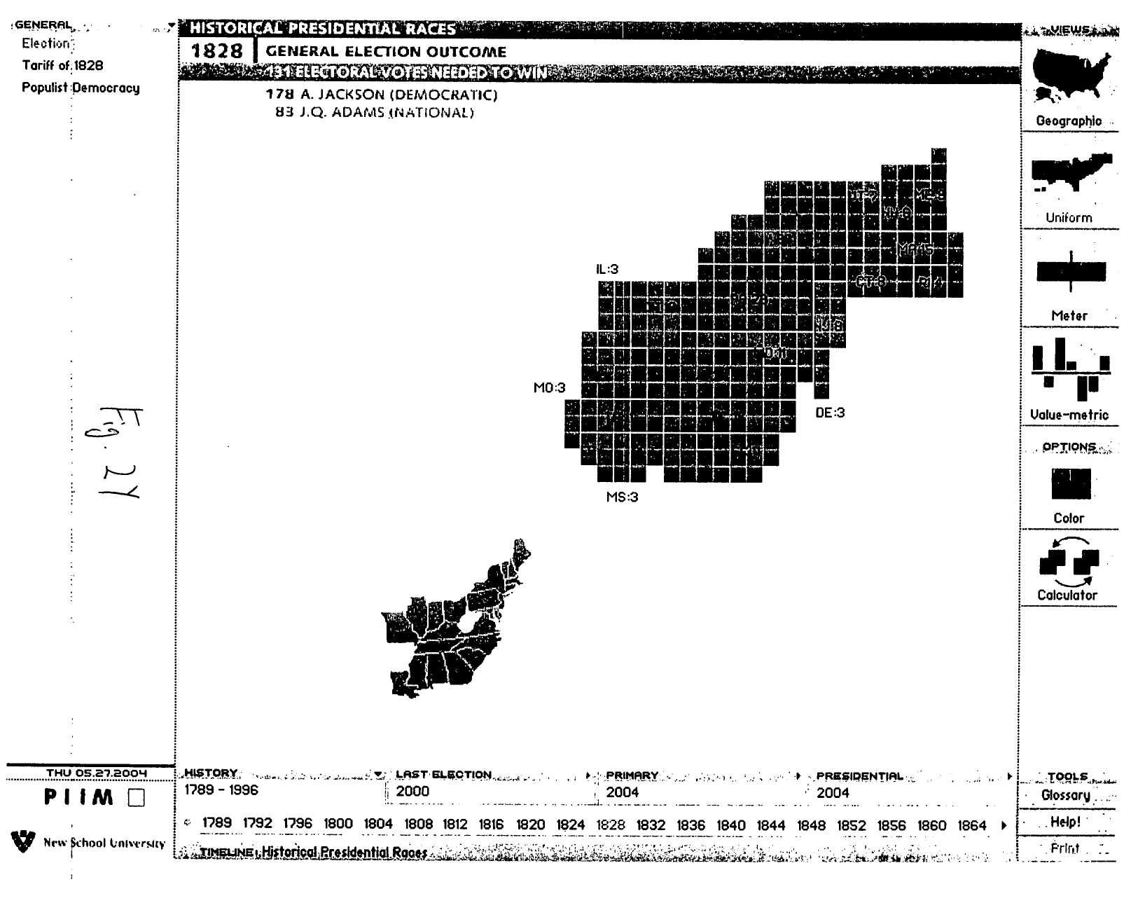

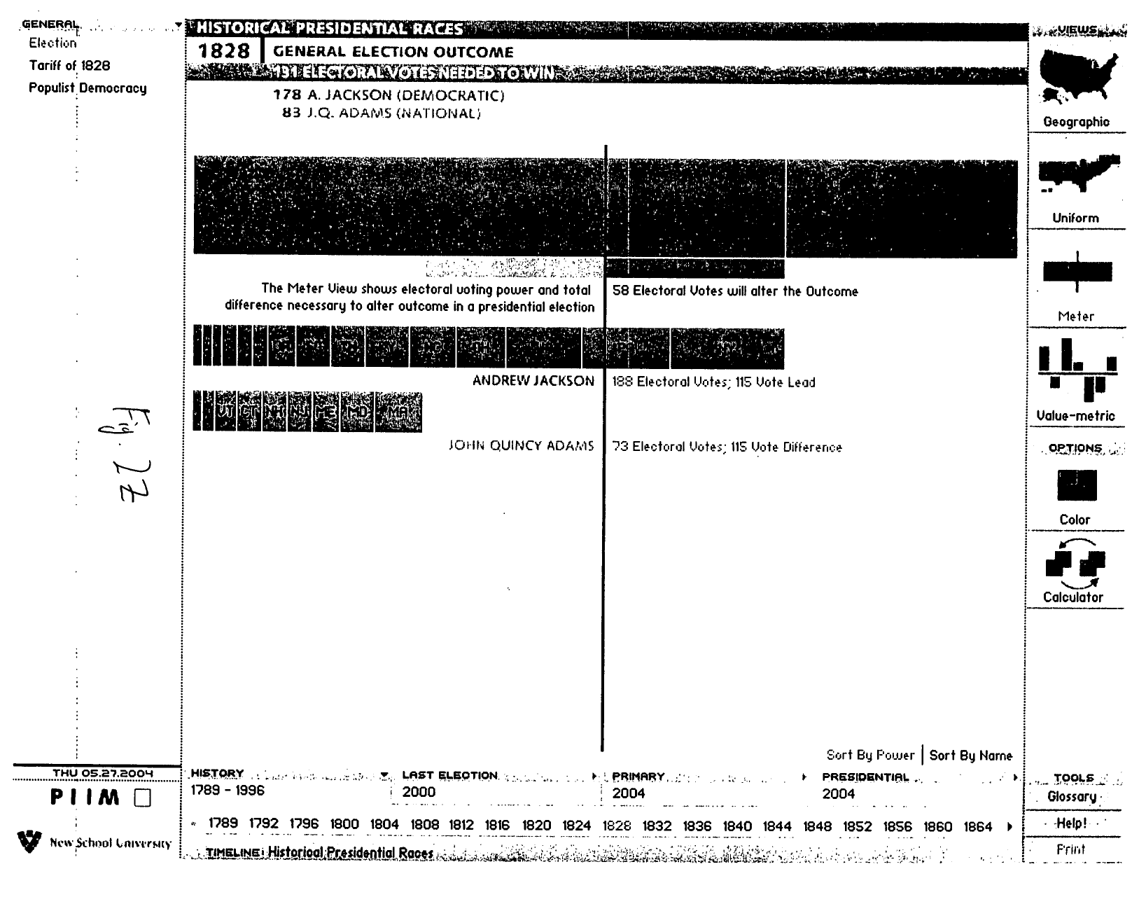

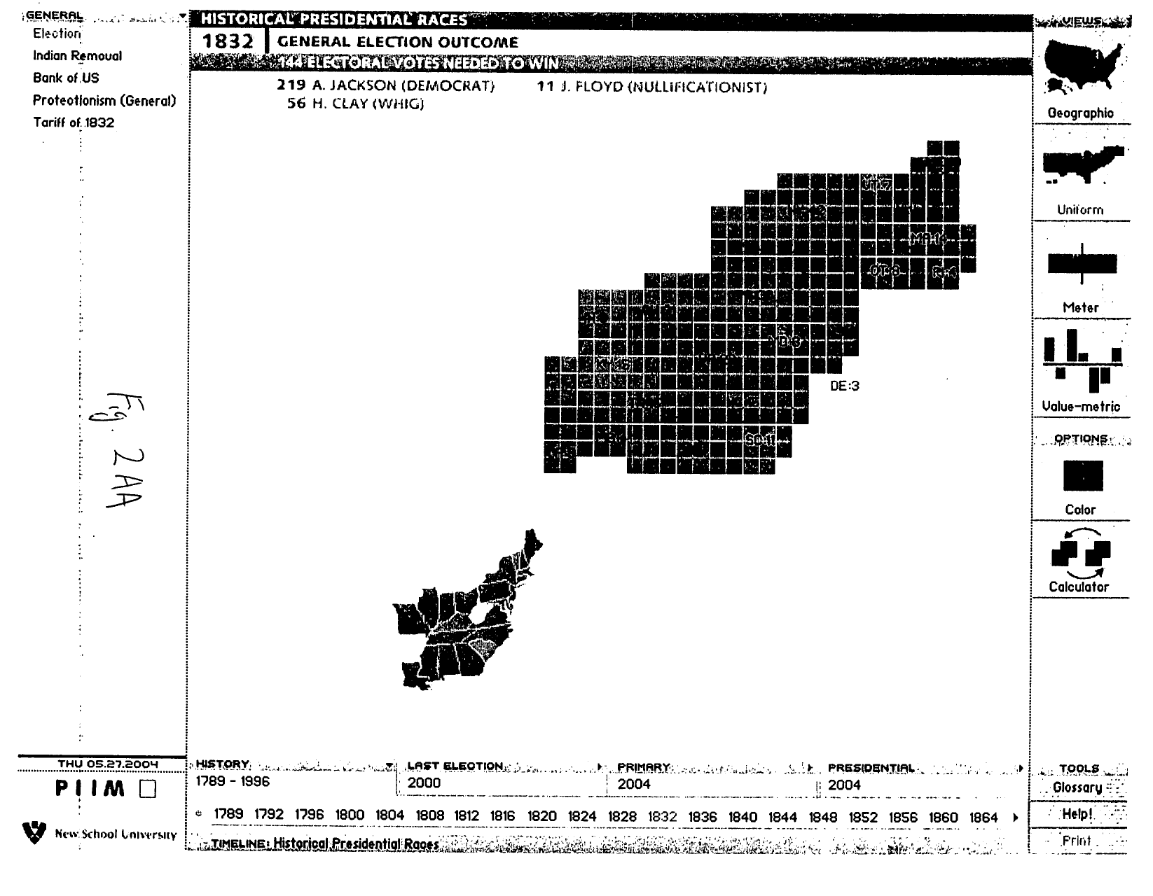

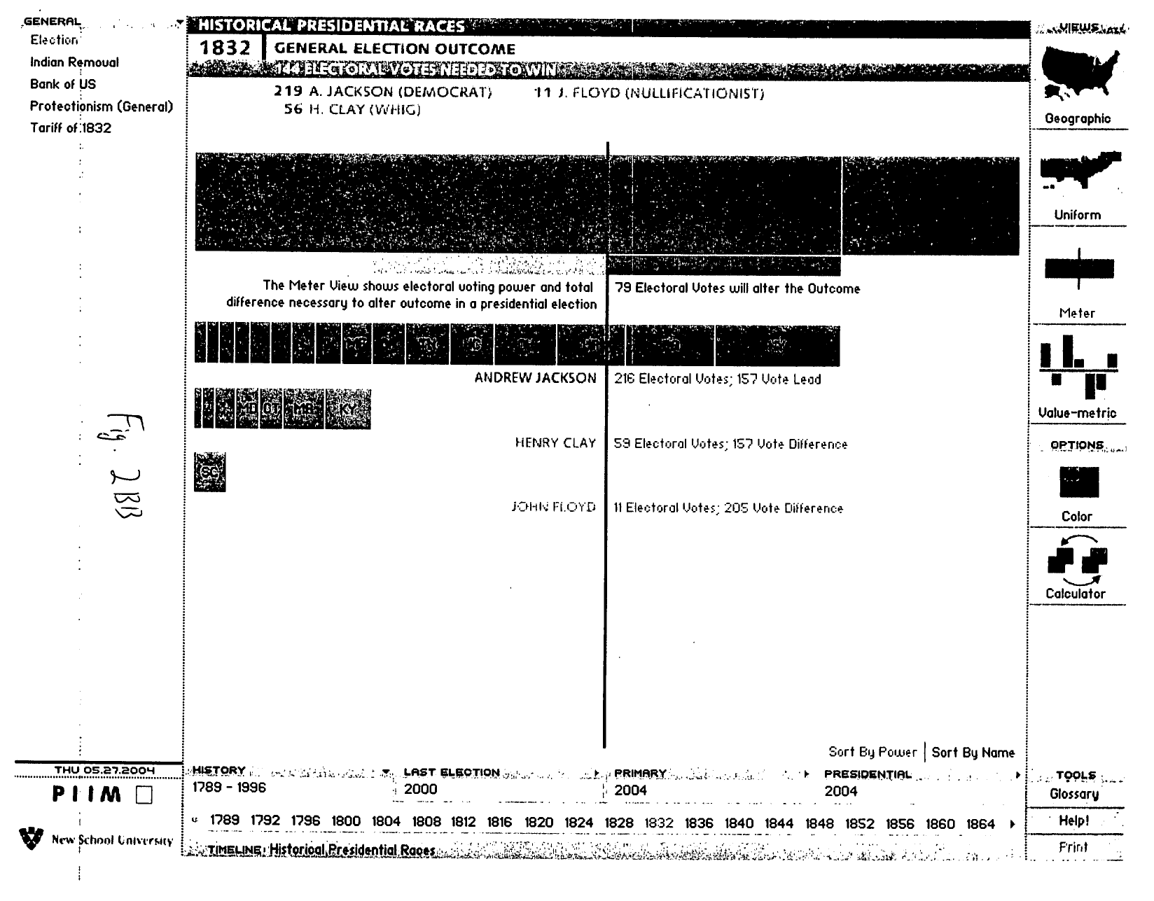

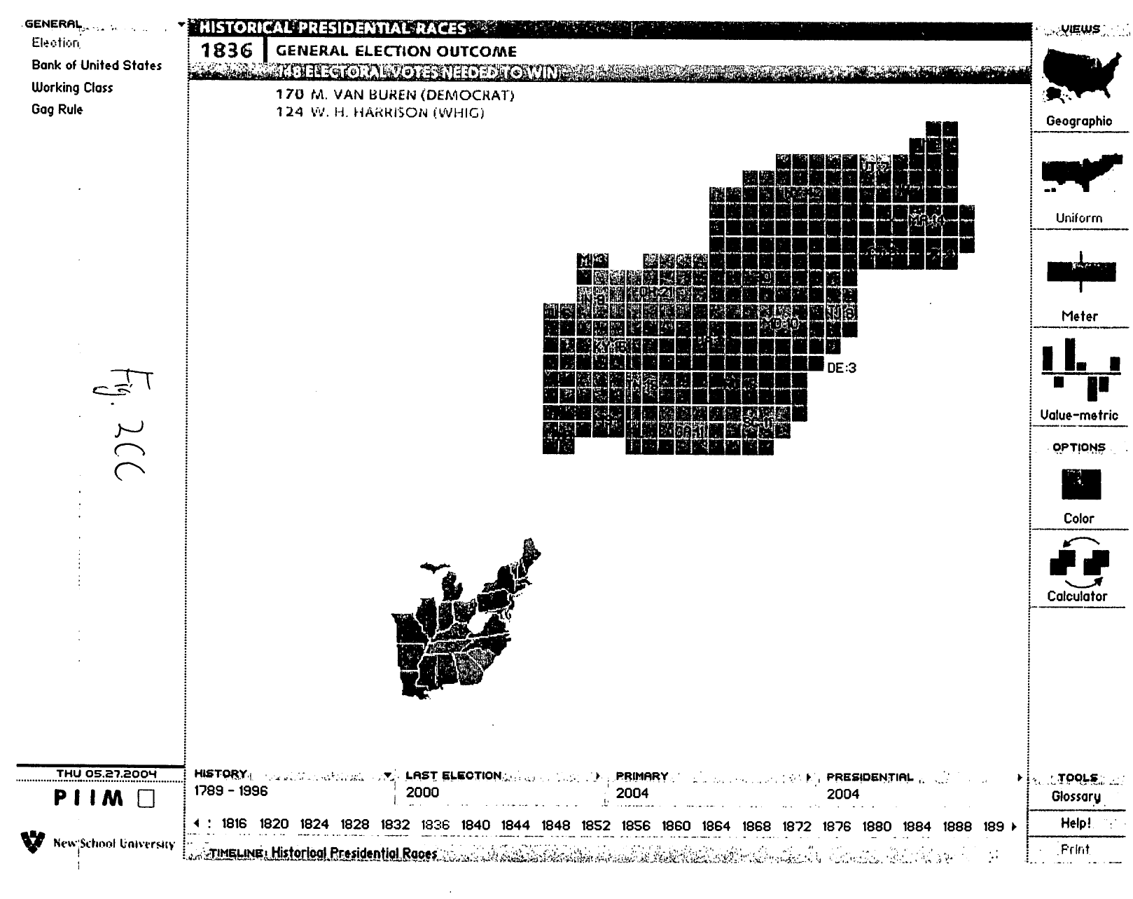

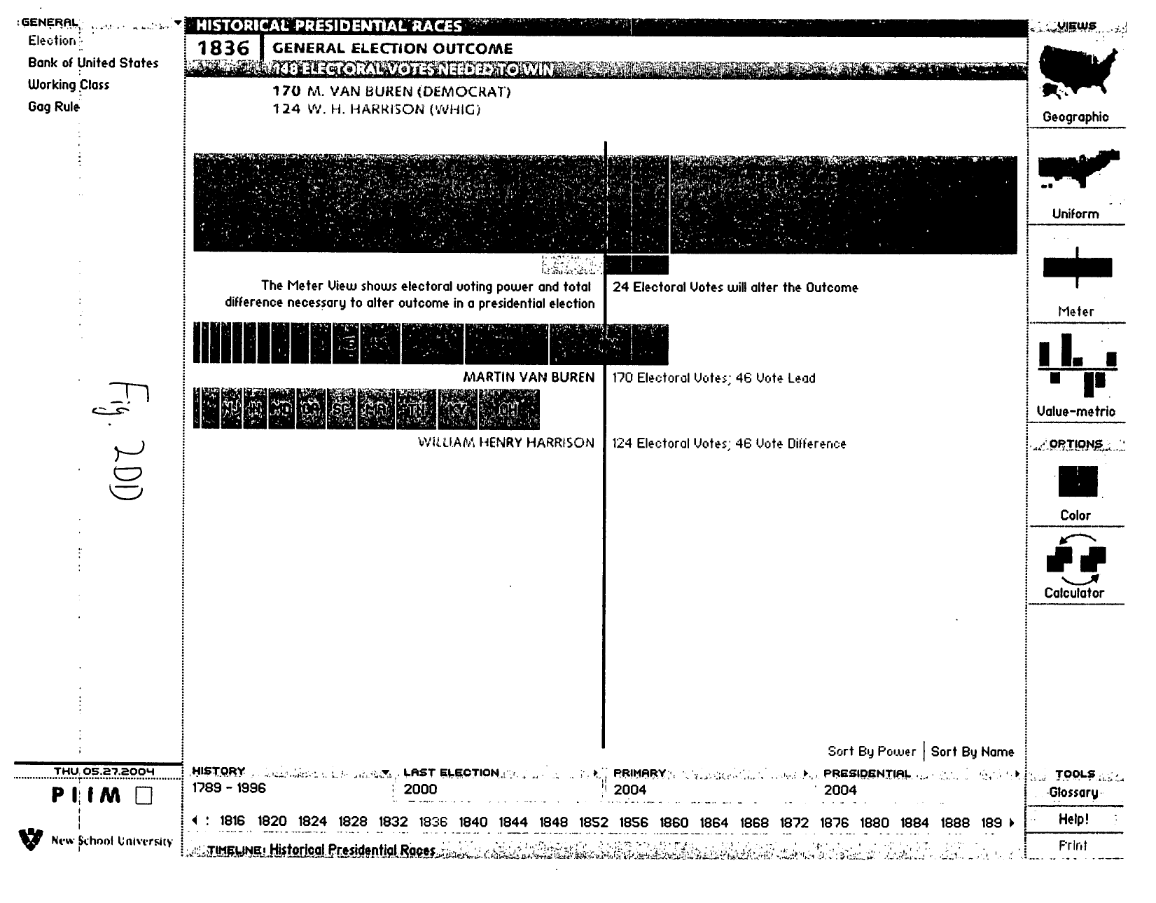

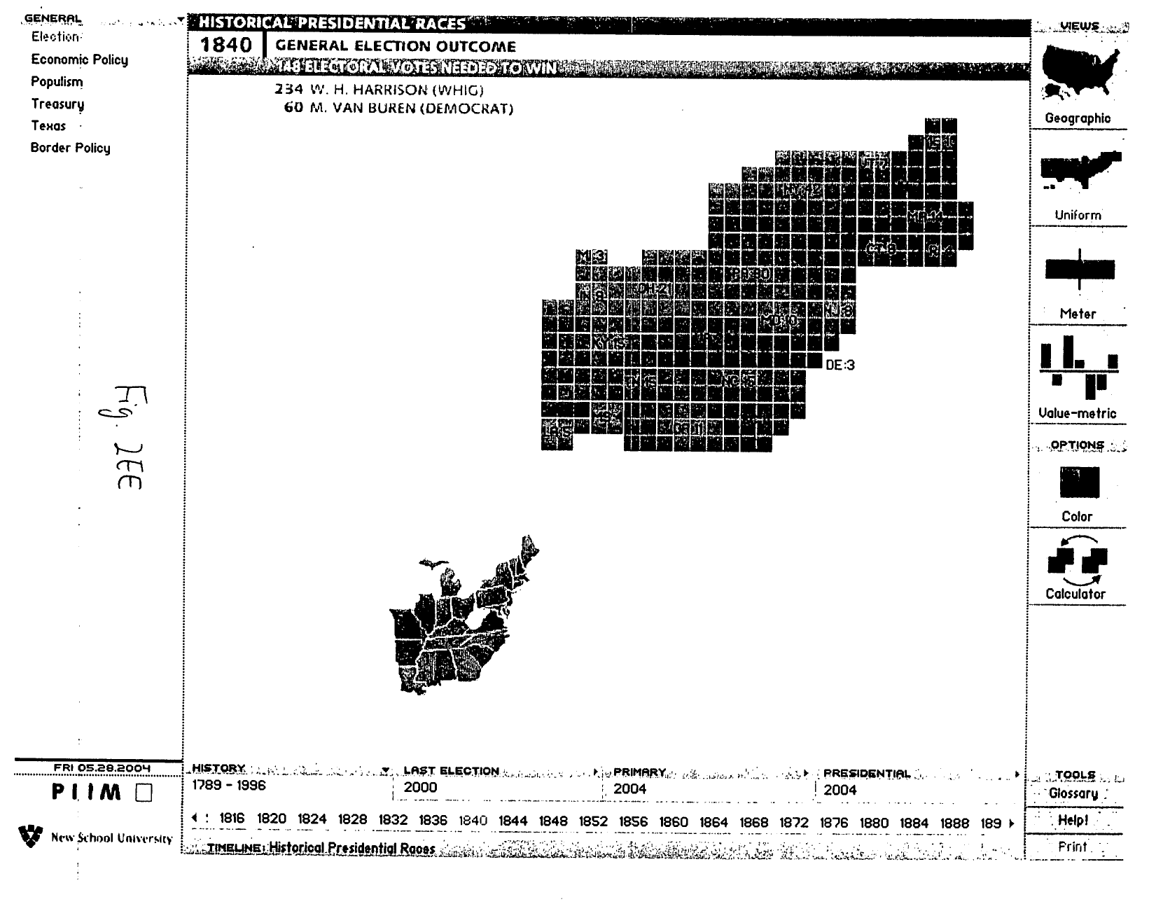

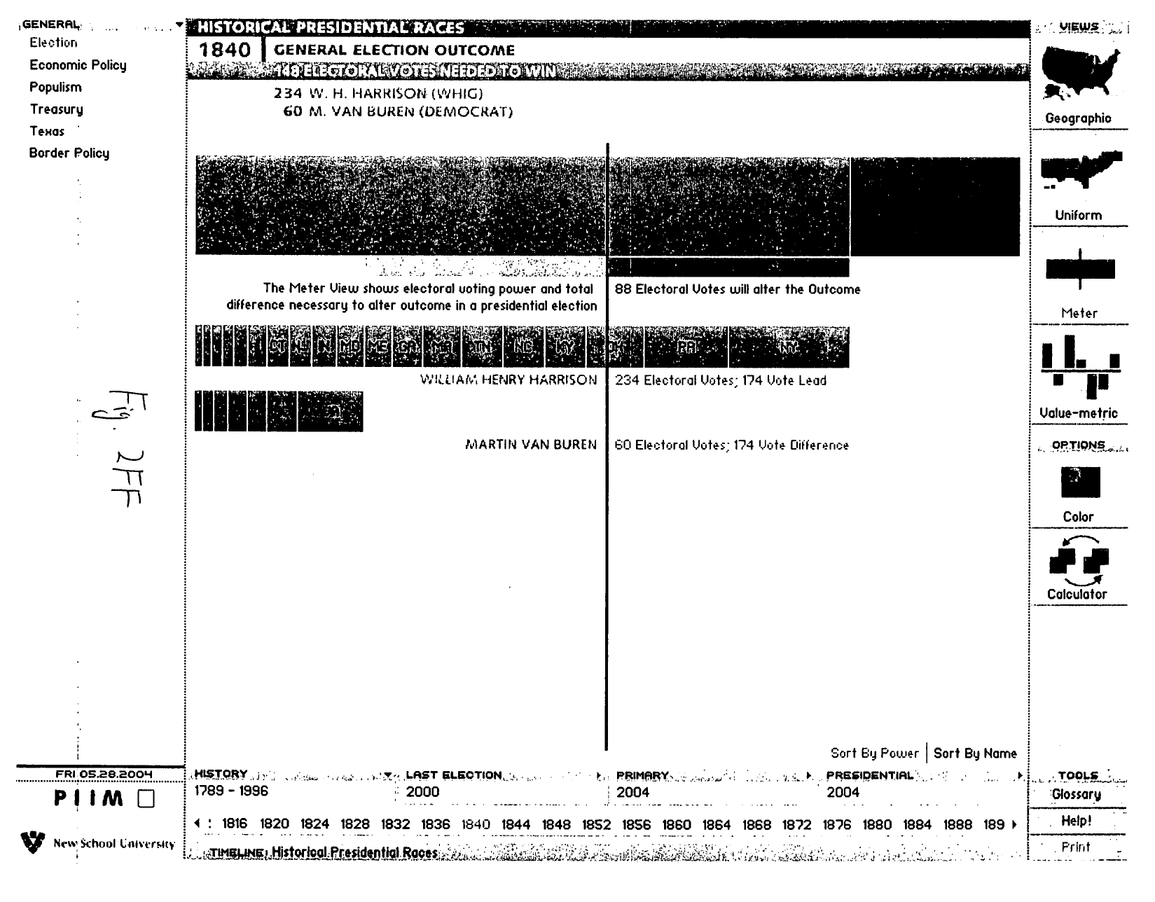

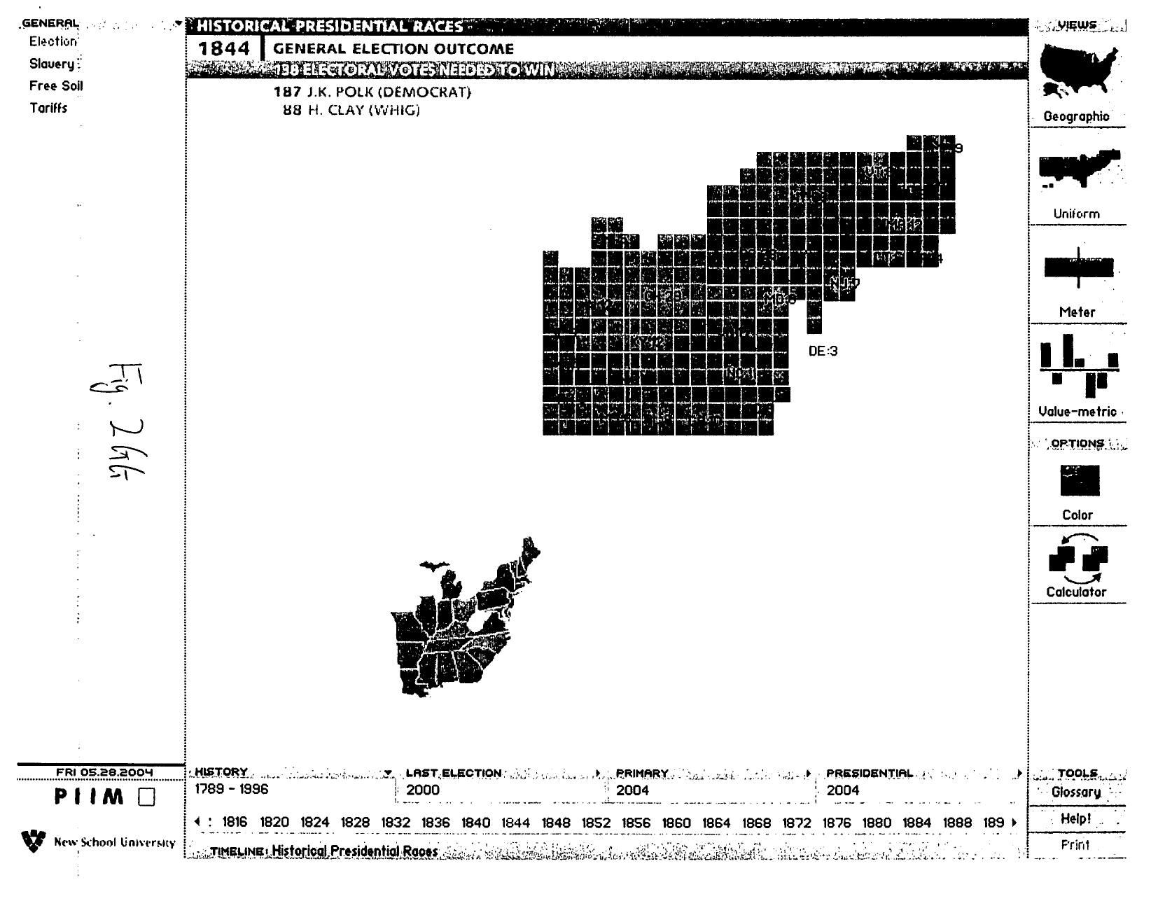

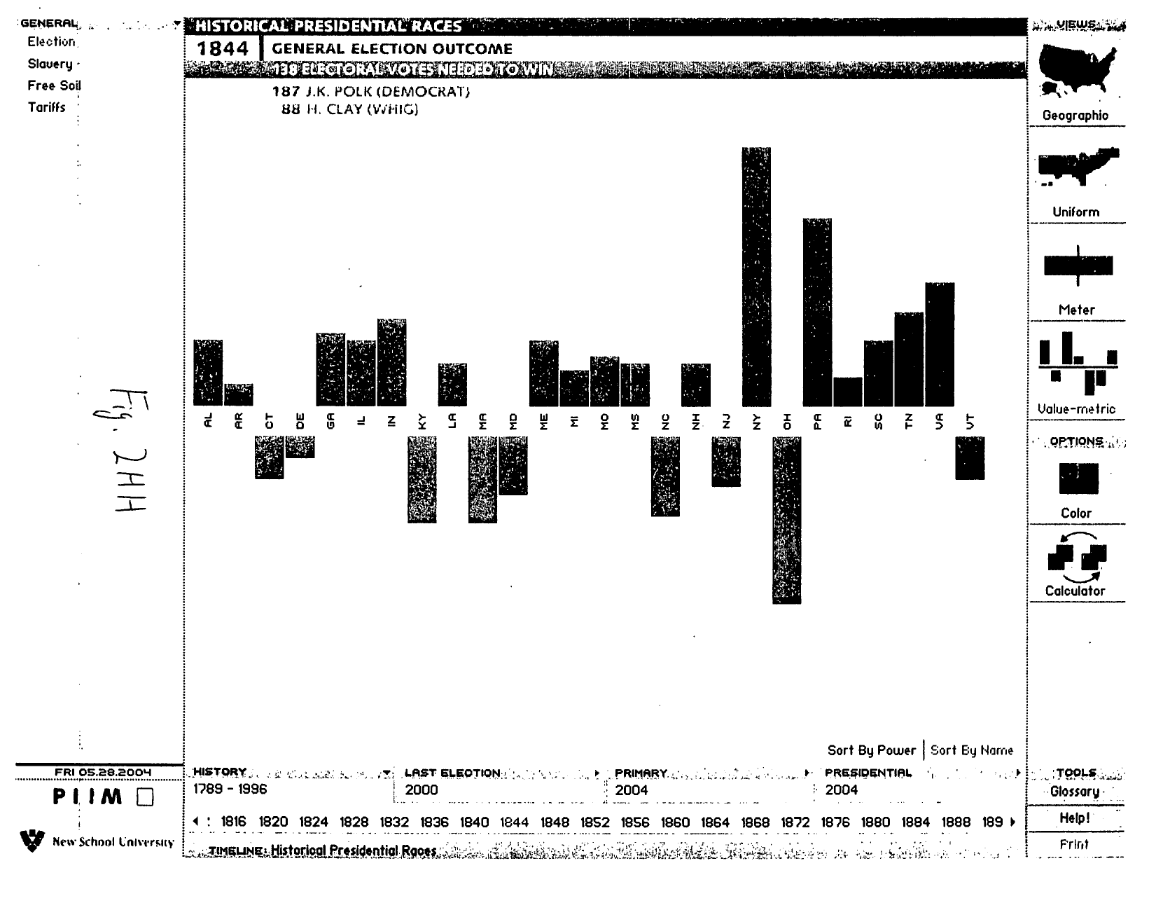

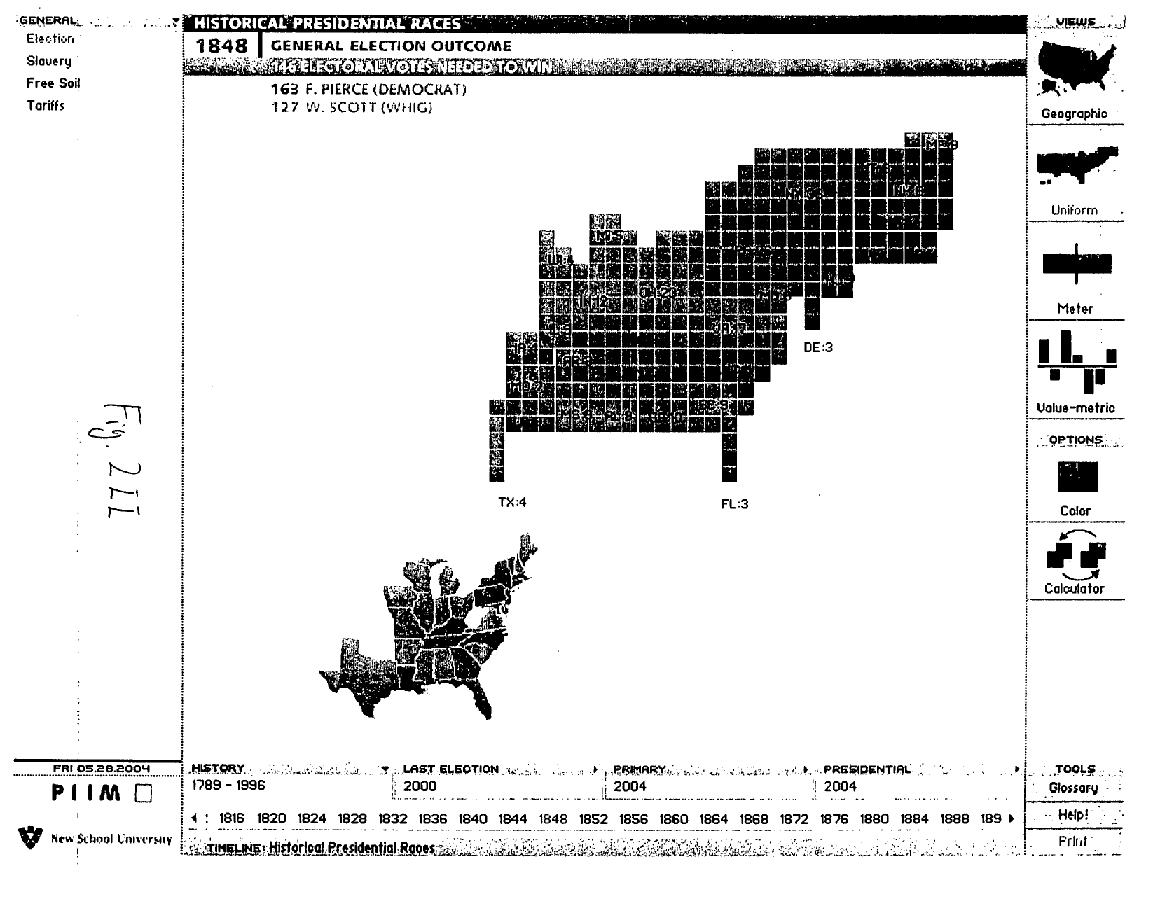

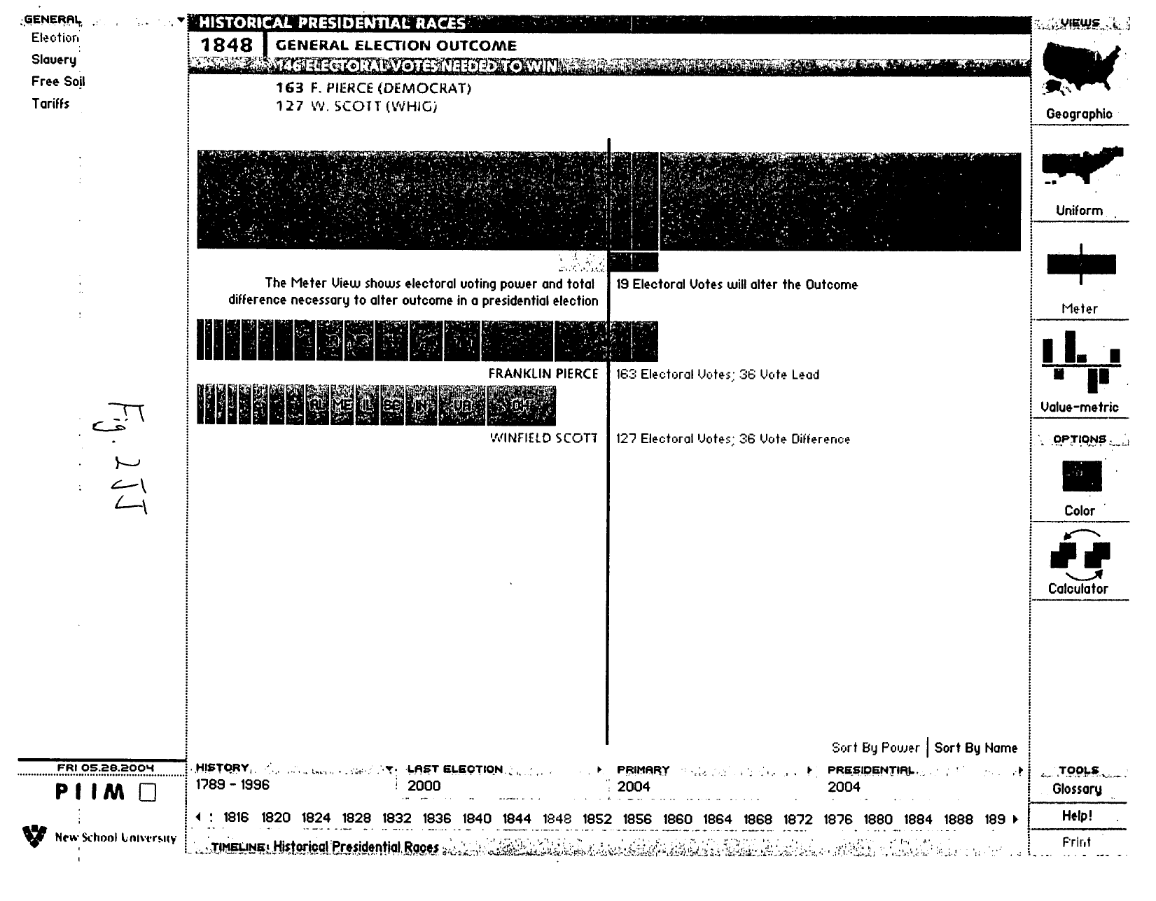

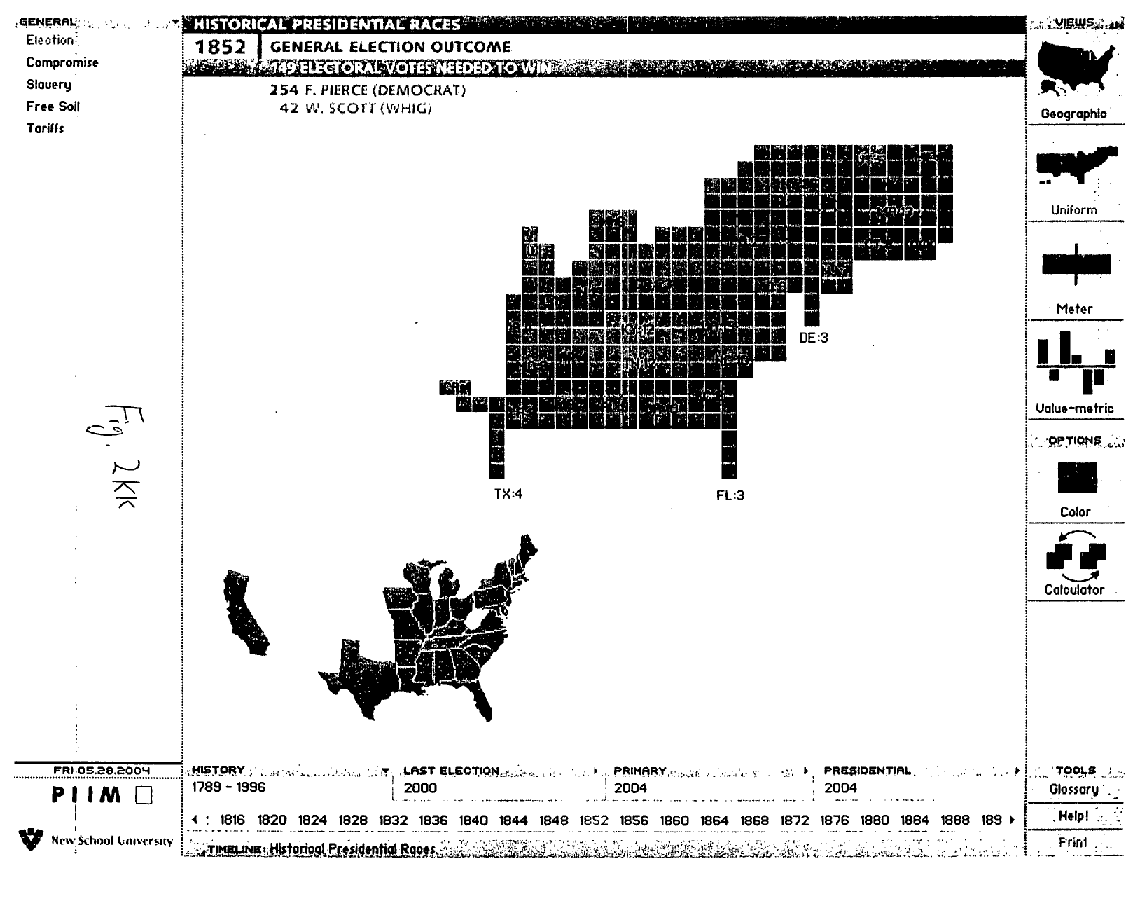

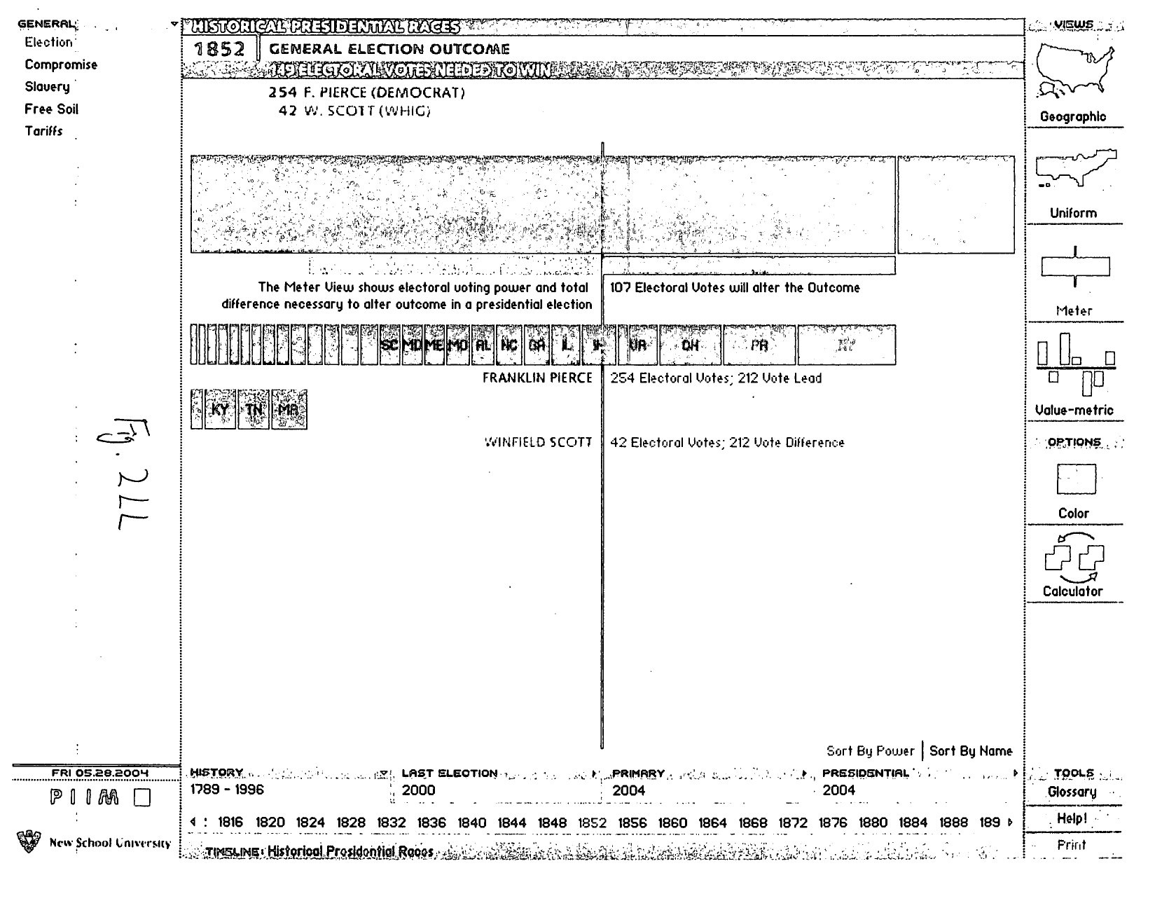

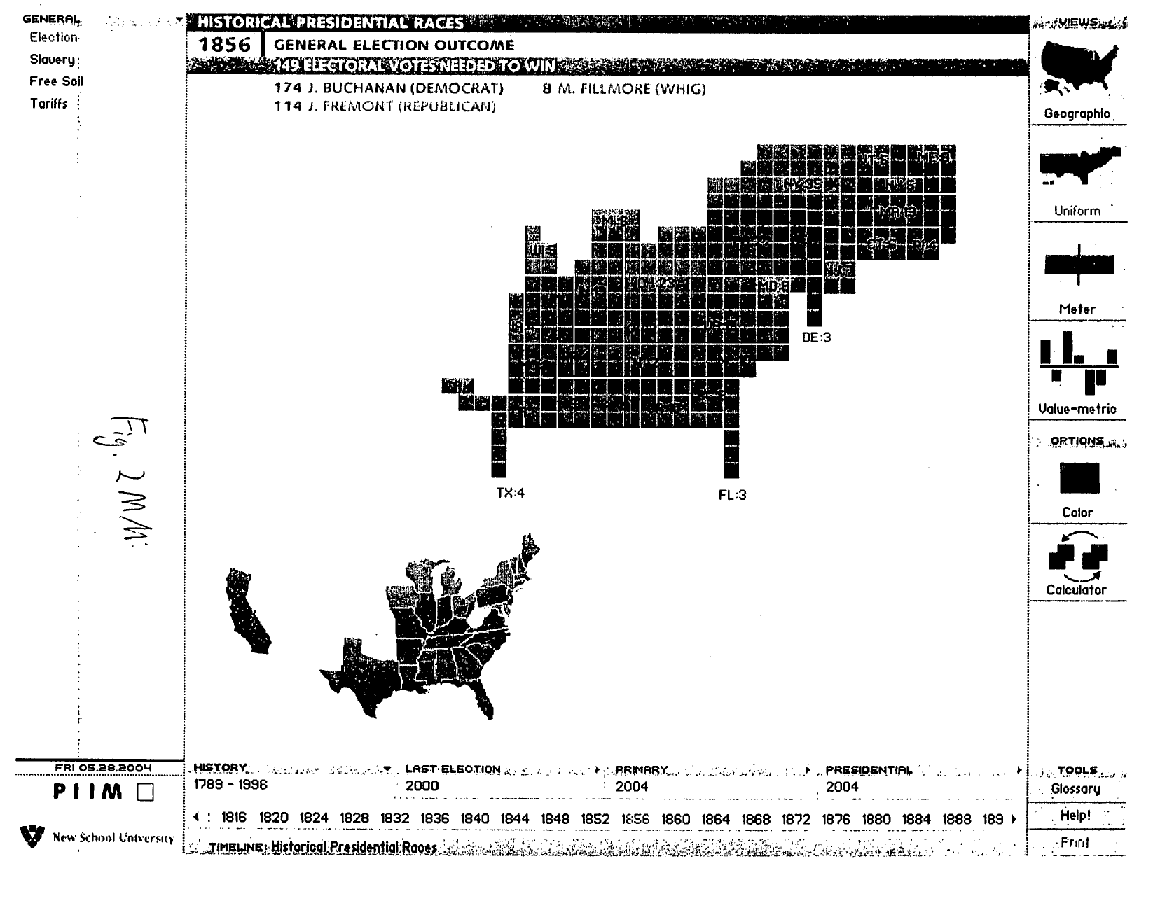

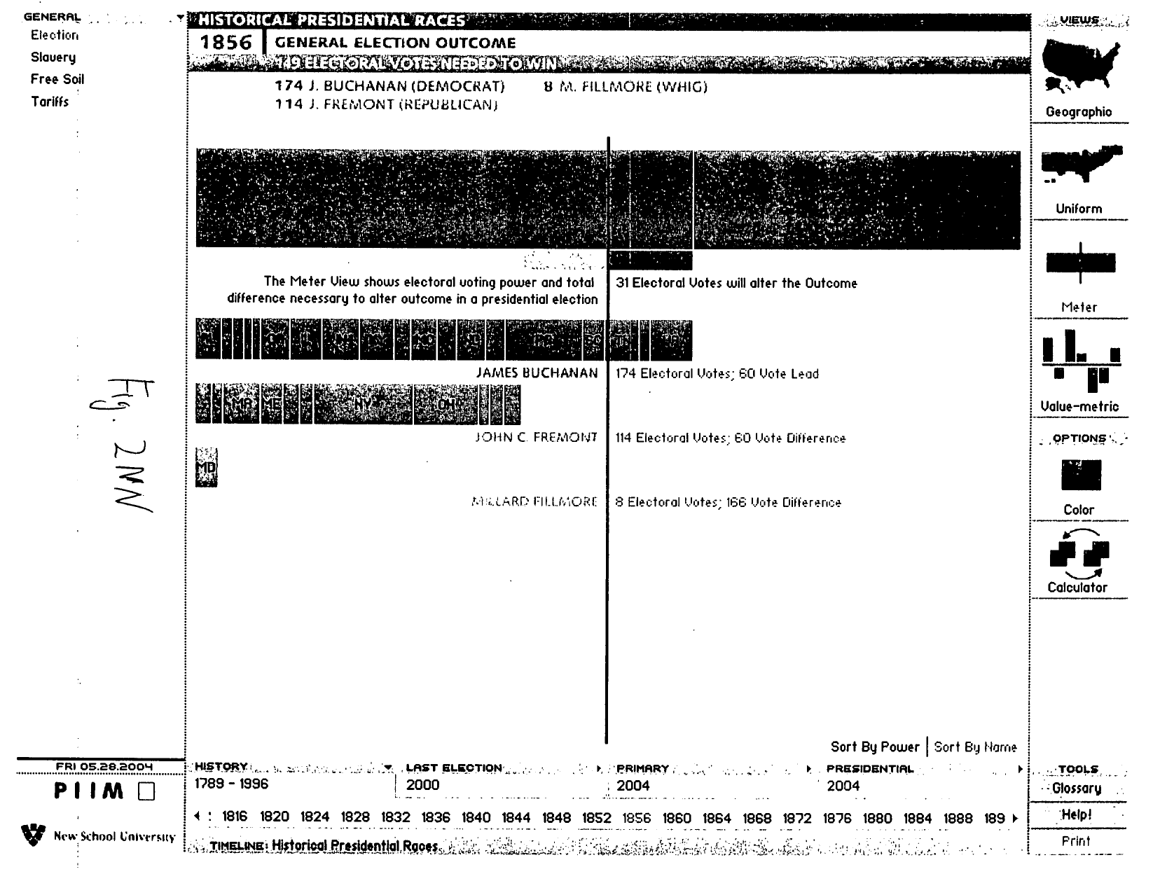

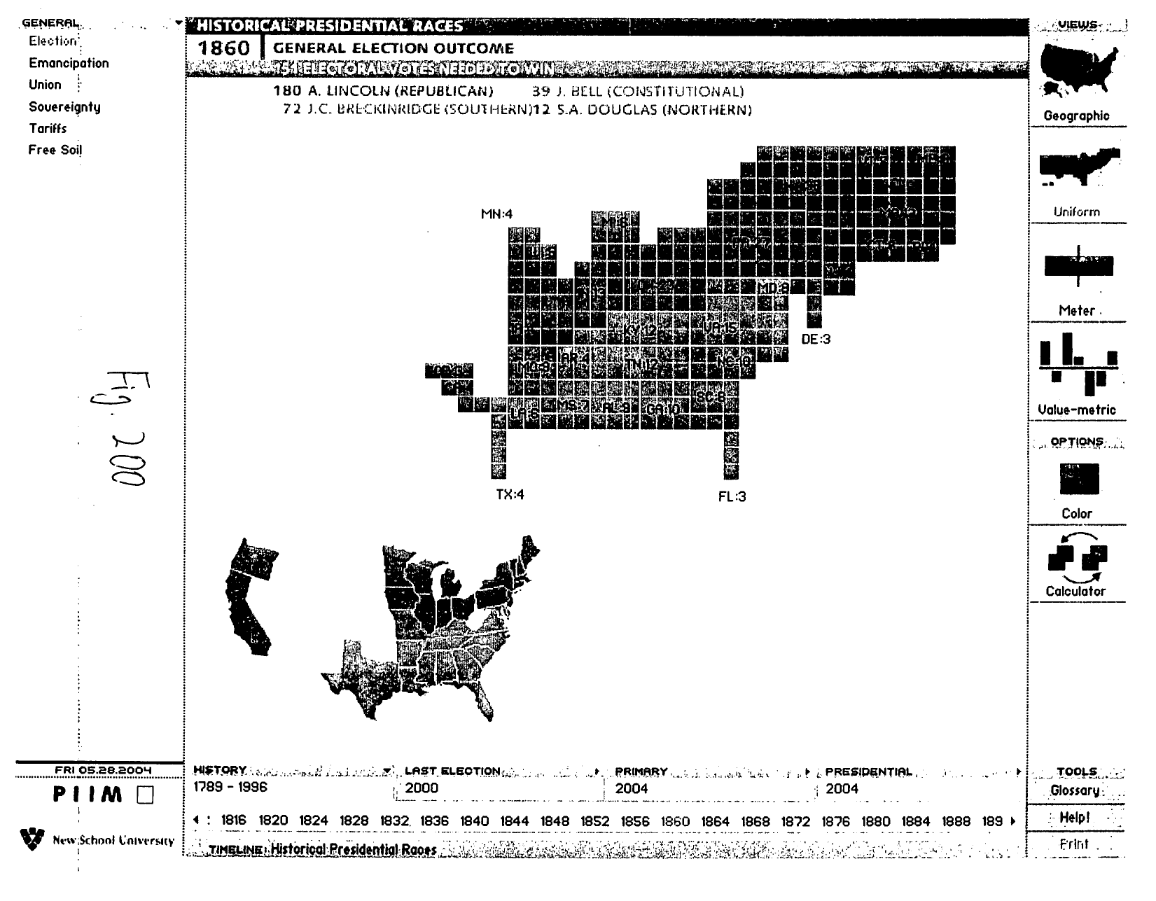

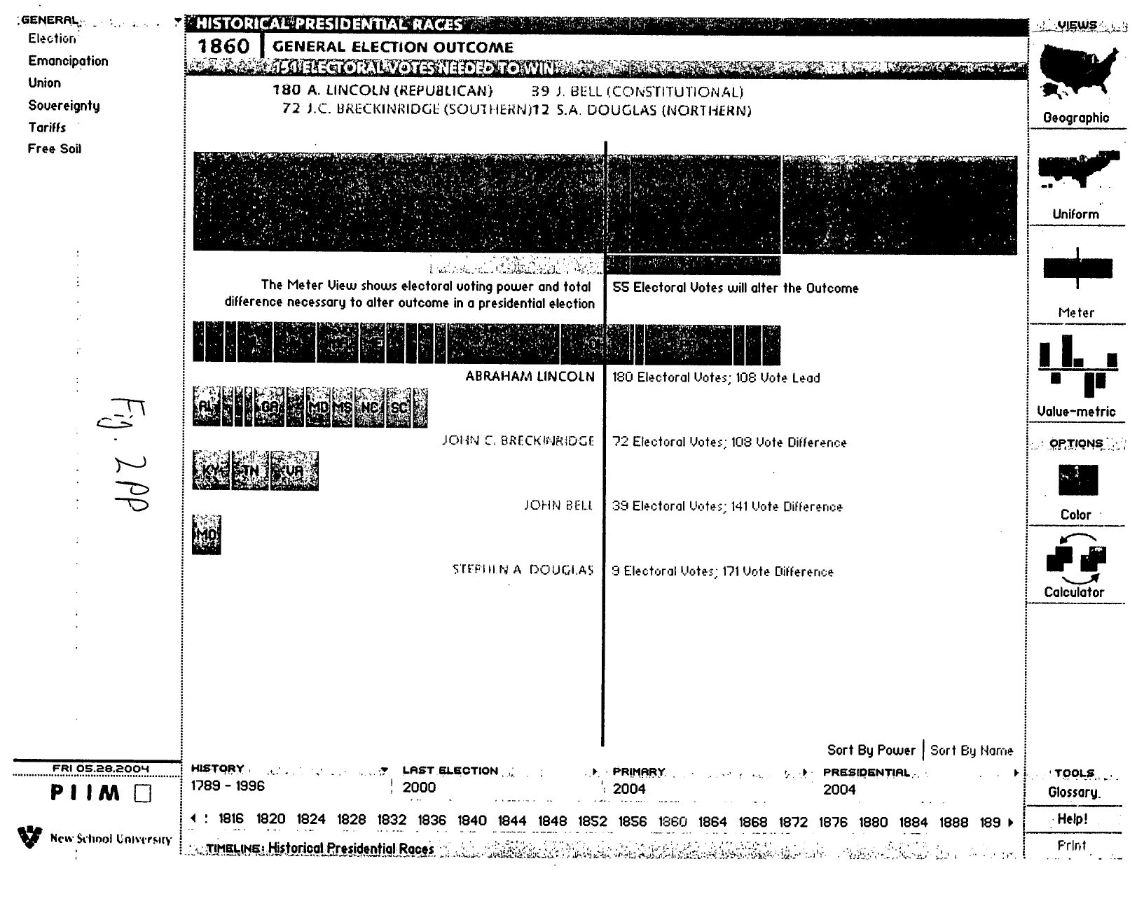

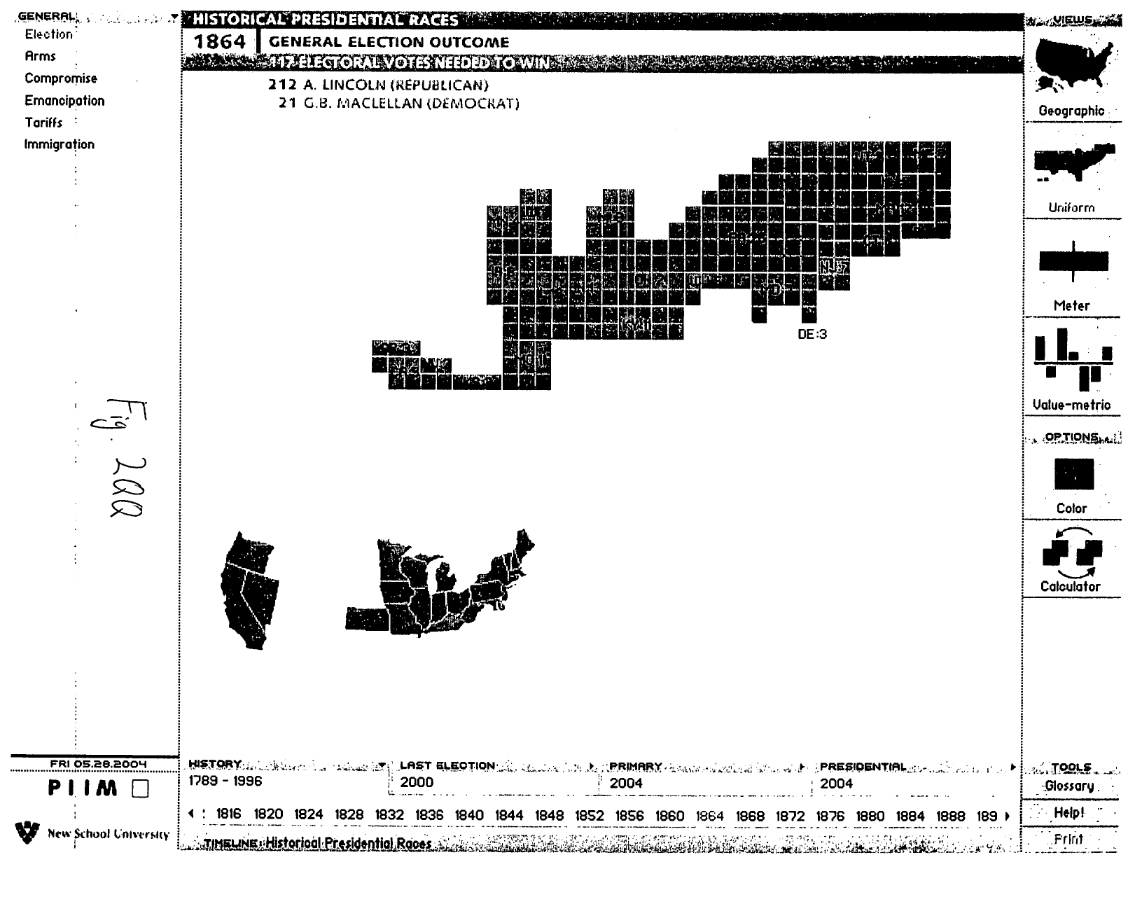

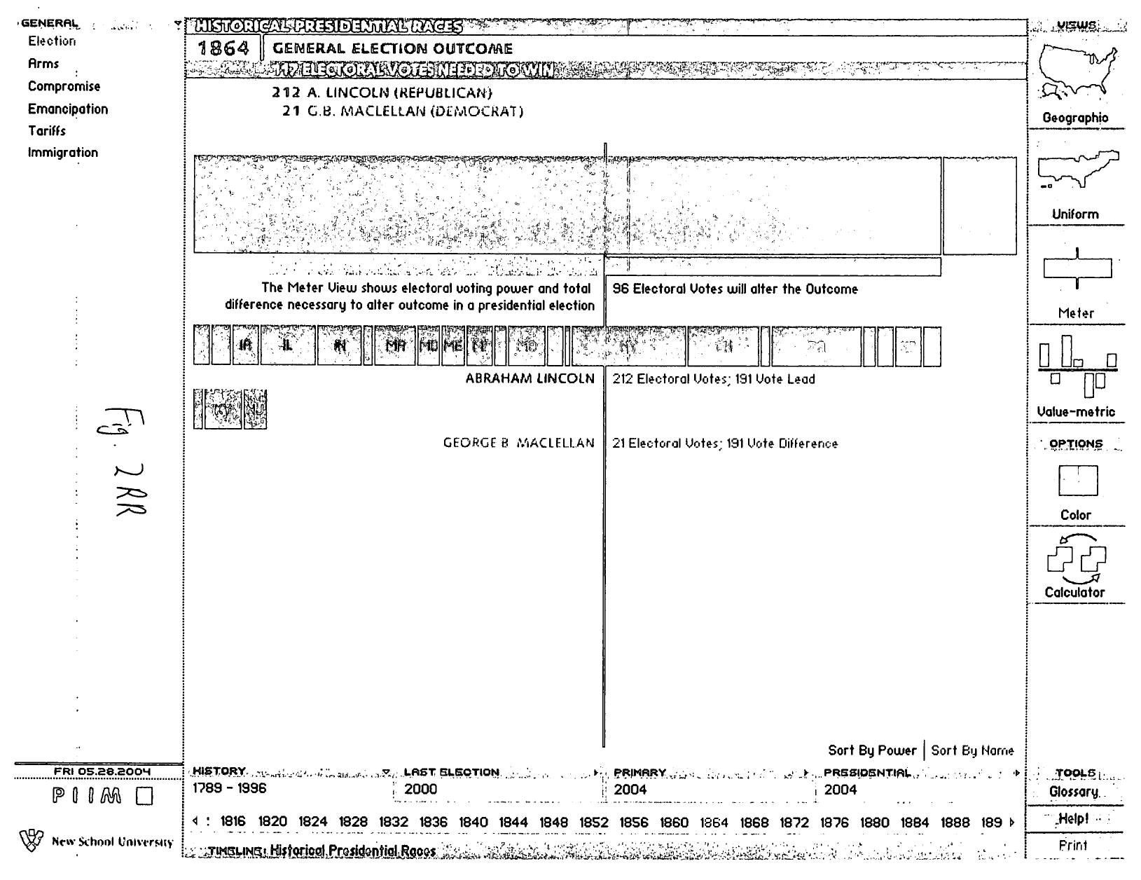

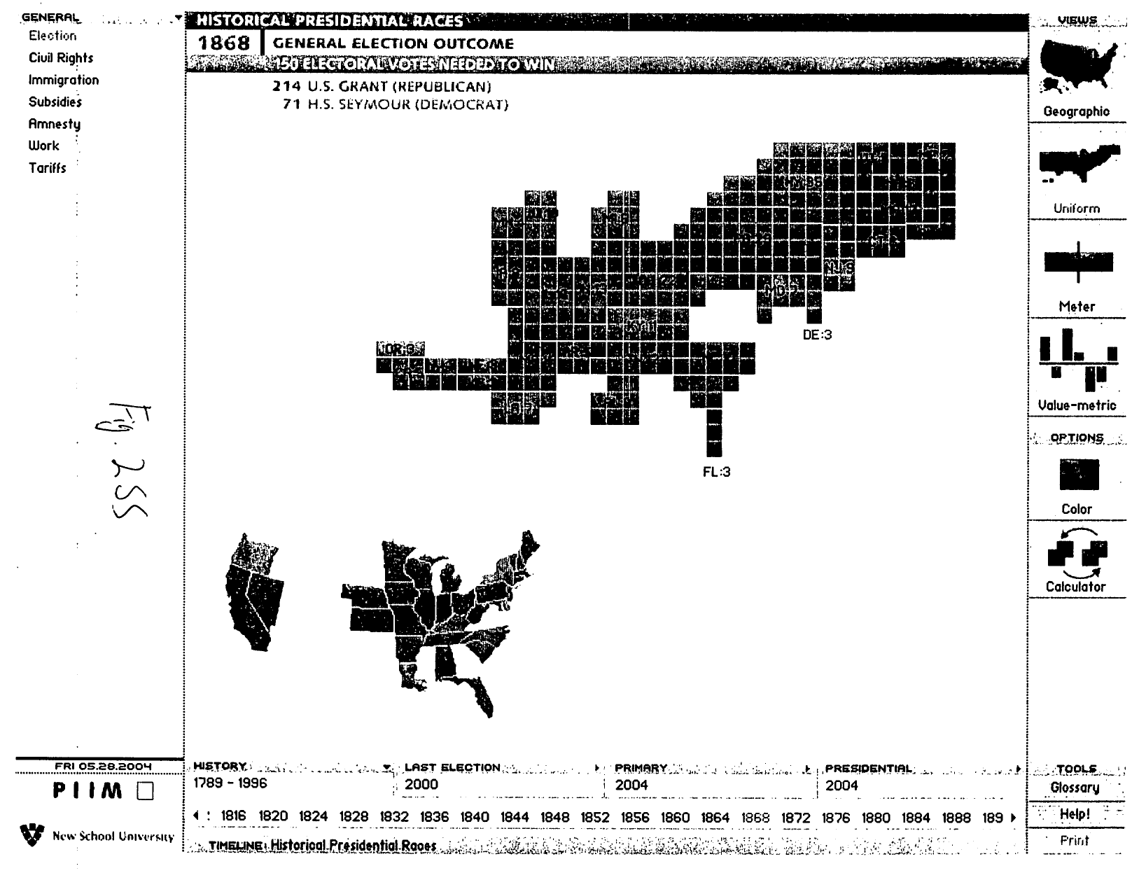

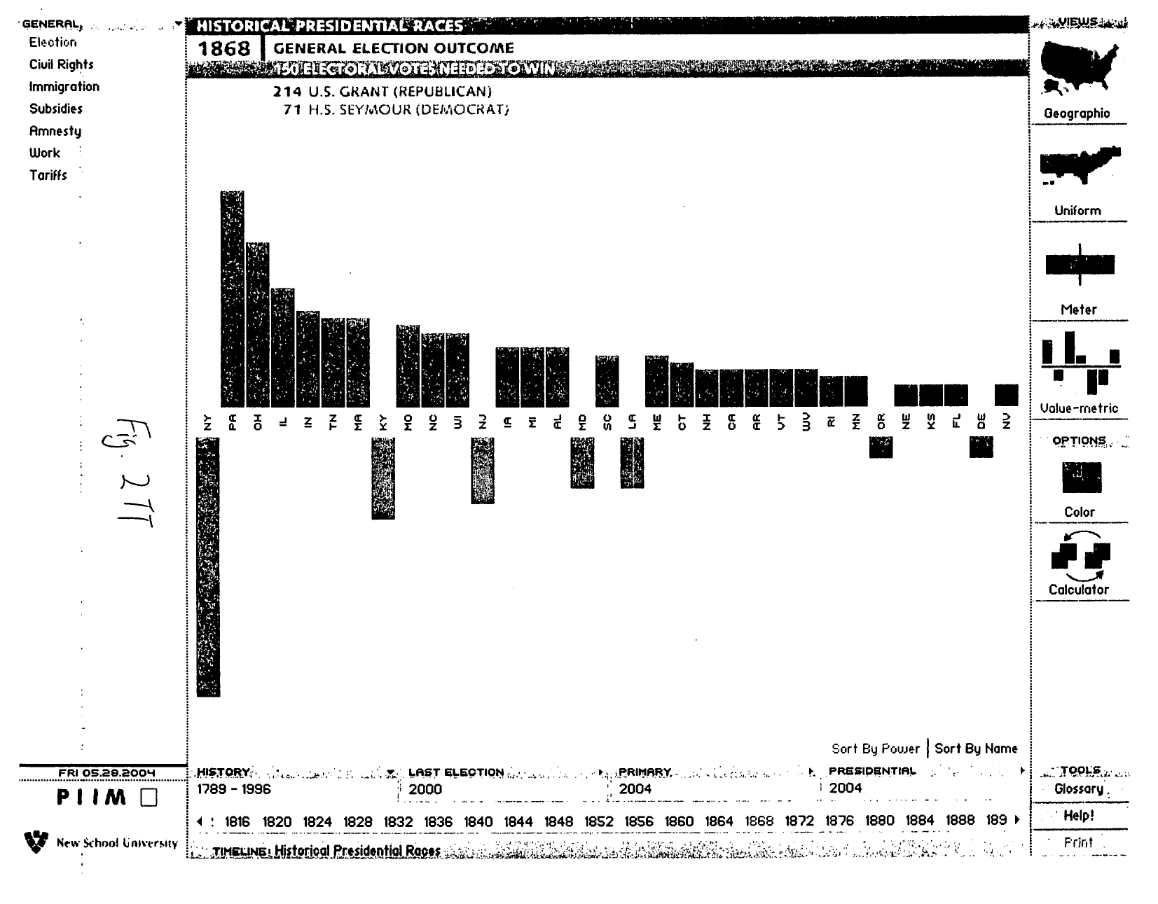

FIGS. 1A-1U are graphical visualizations in accordance with certain aspects of the invention of the projected results of presidential race of 2004, as of a series of dates from January to May 2004. The results are presented in accordance with some of the visualizations provided by the invention as described above. One can see in these figures he shifting vote tallies as one follows the time lines shown.

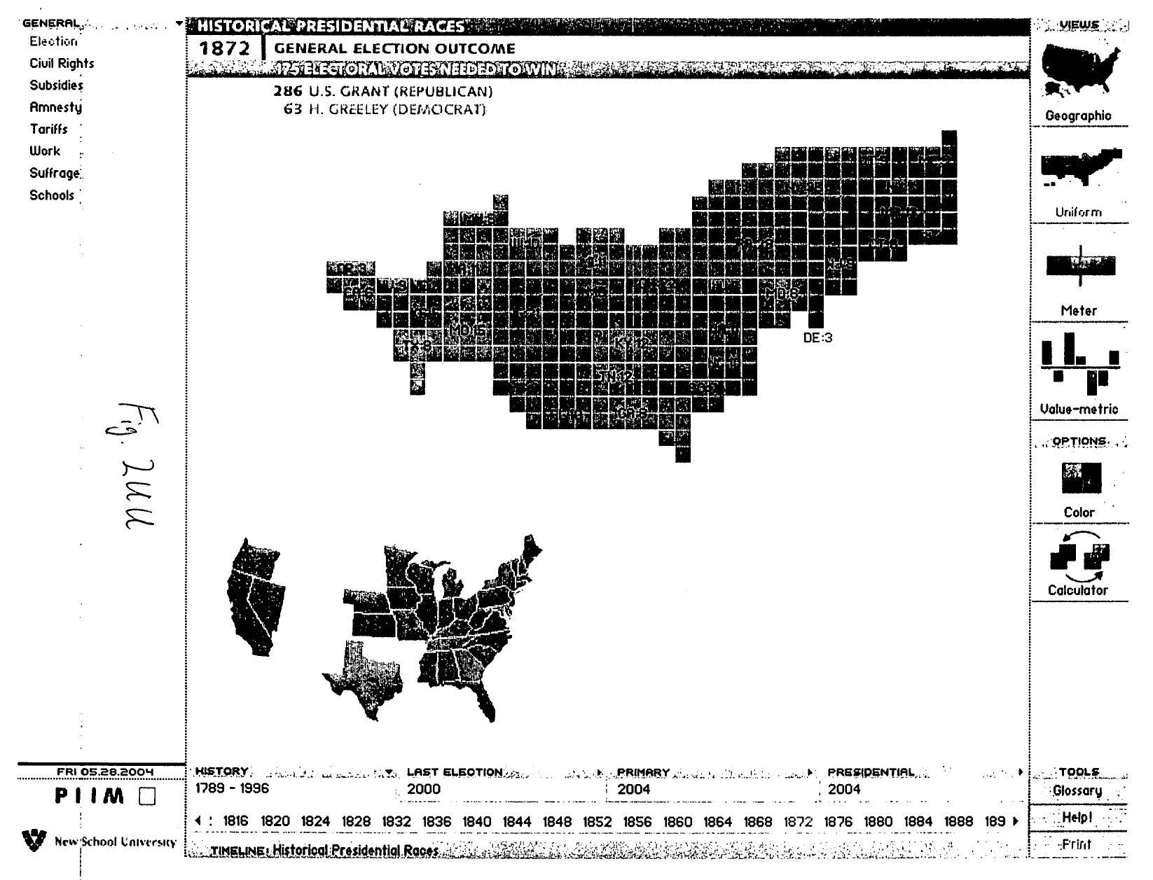

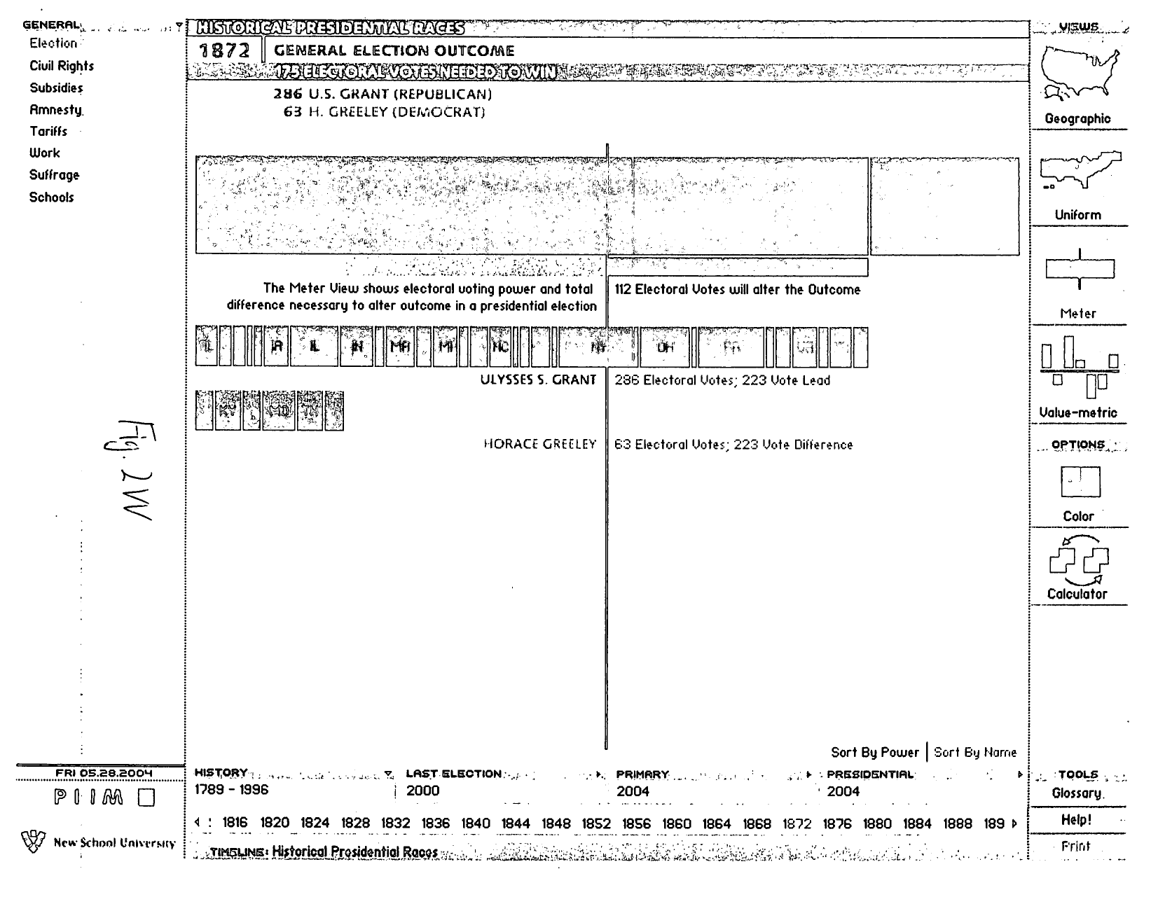

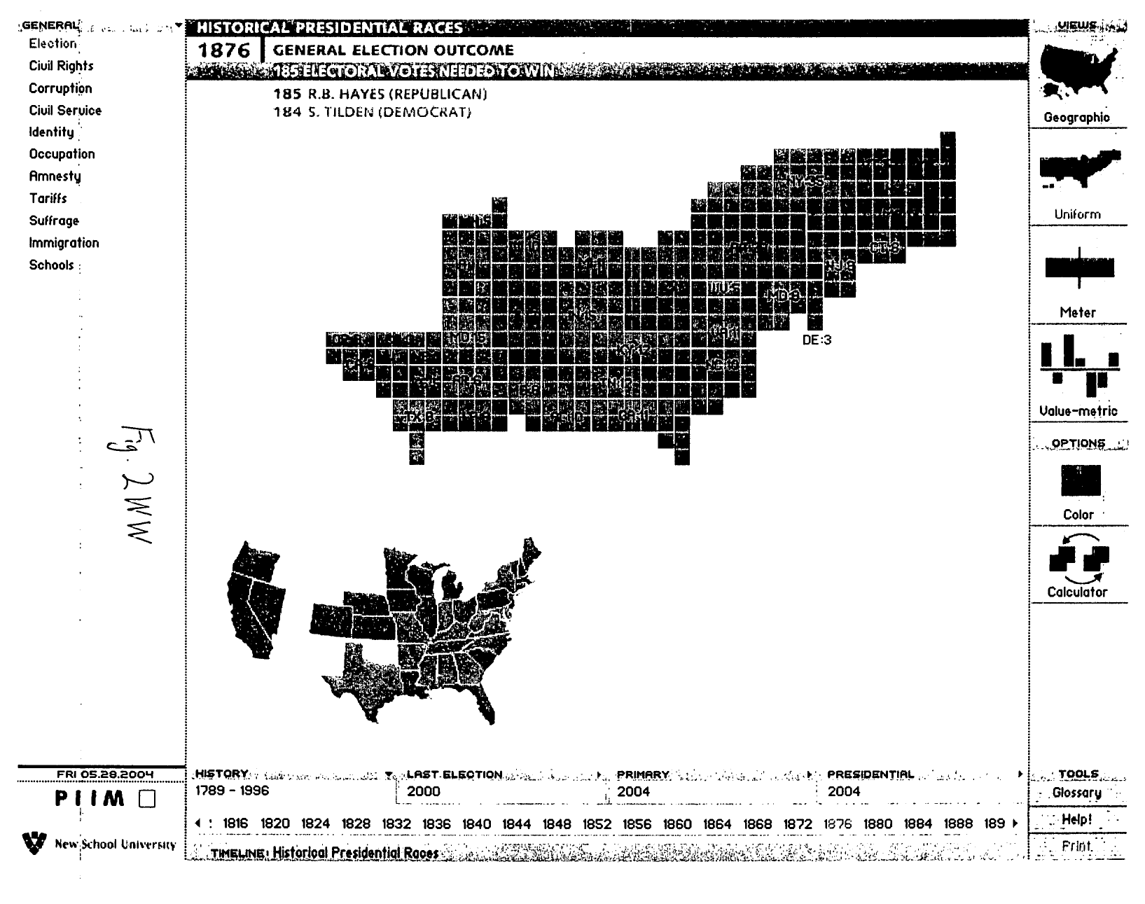

FIGS. 2A-2QQQQ are graphical visualizations in accordance with certain aspects of the invention of a number of historical presidential races. Appendix A hereto describes the methodology used for these studies.

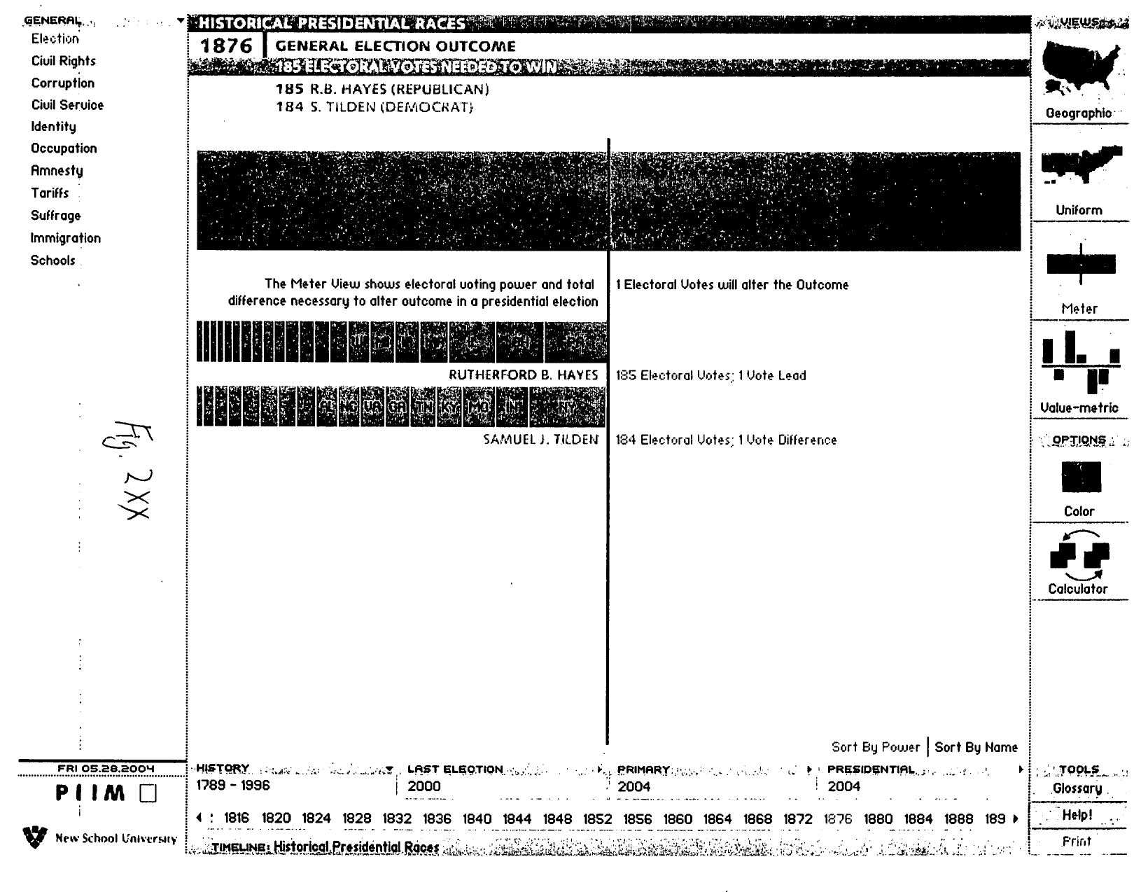

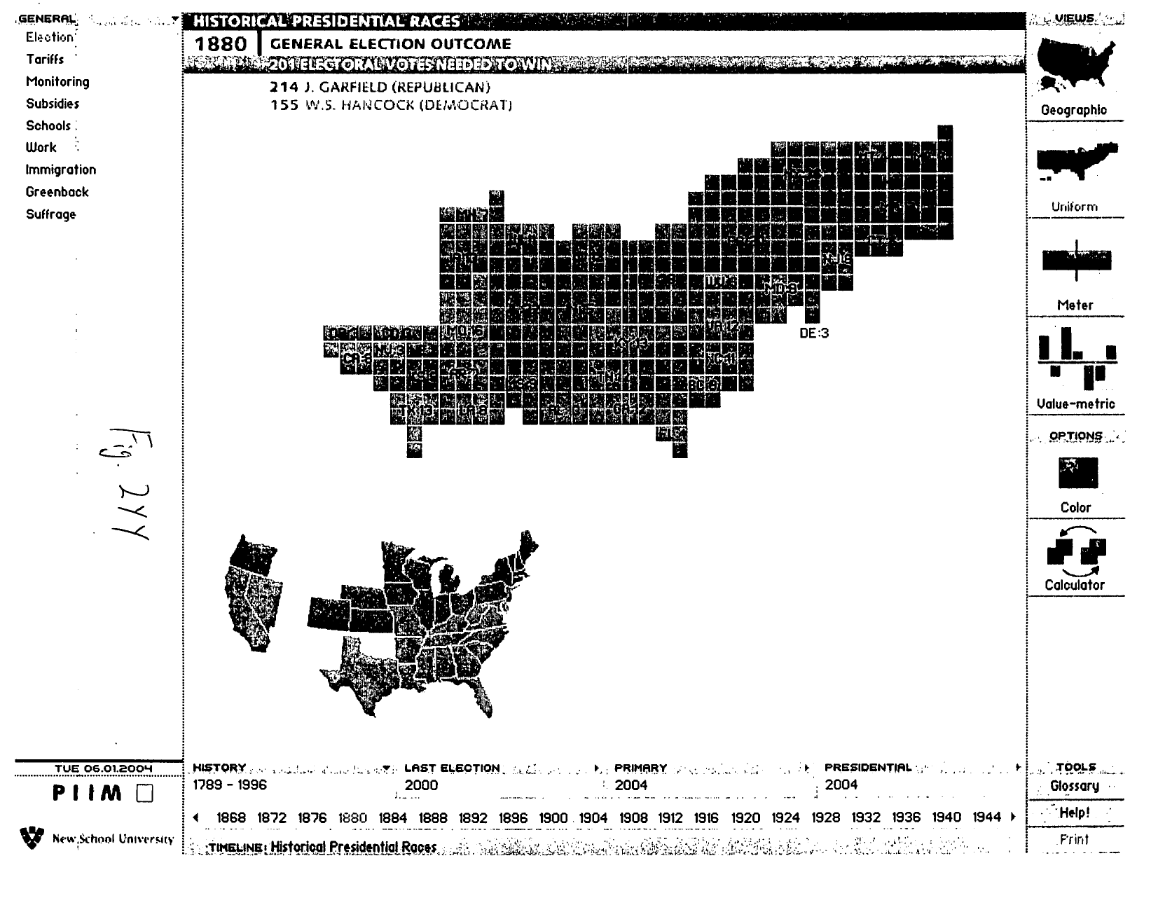

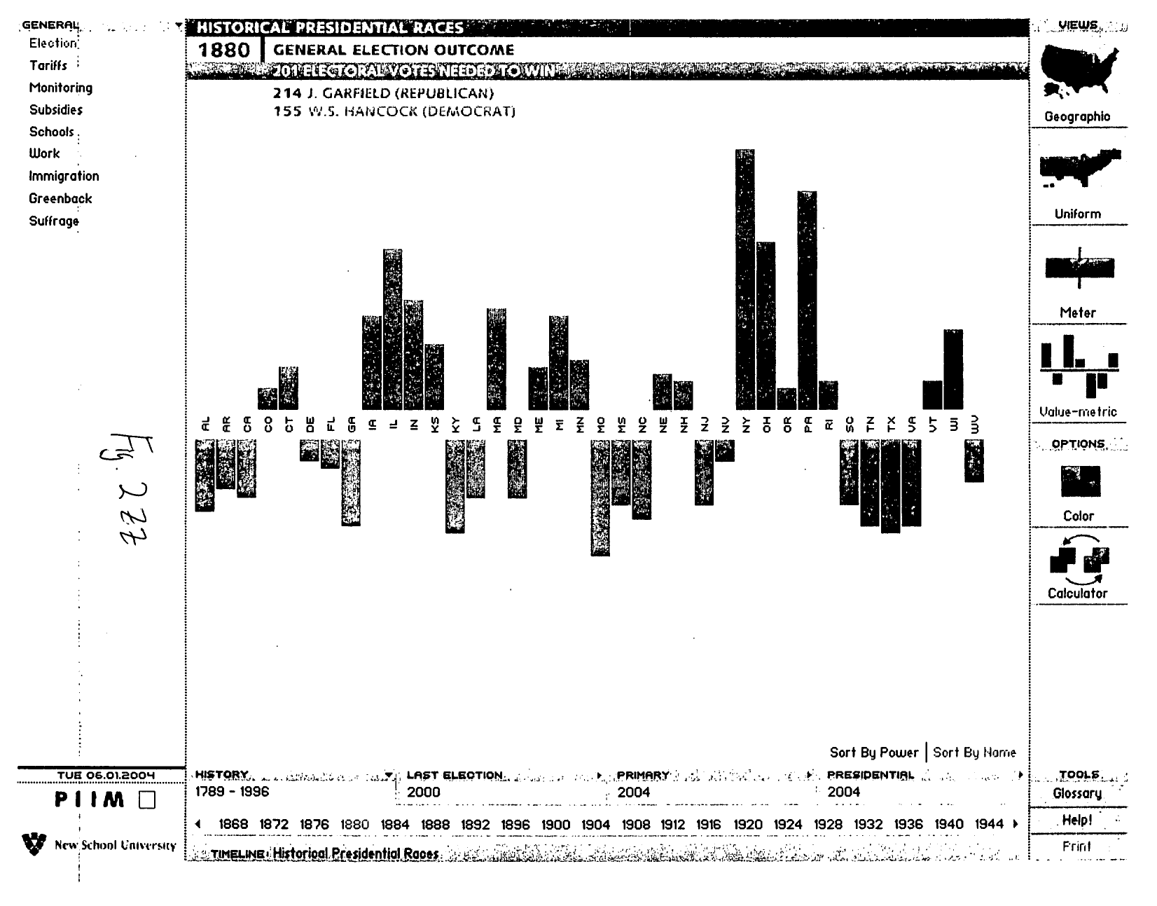

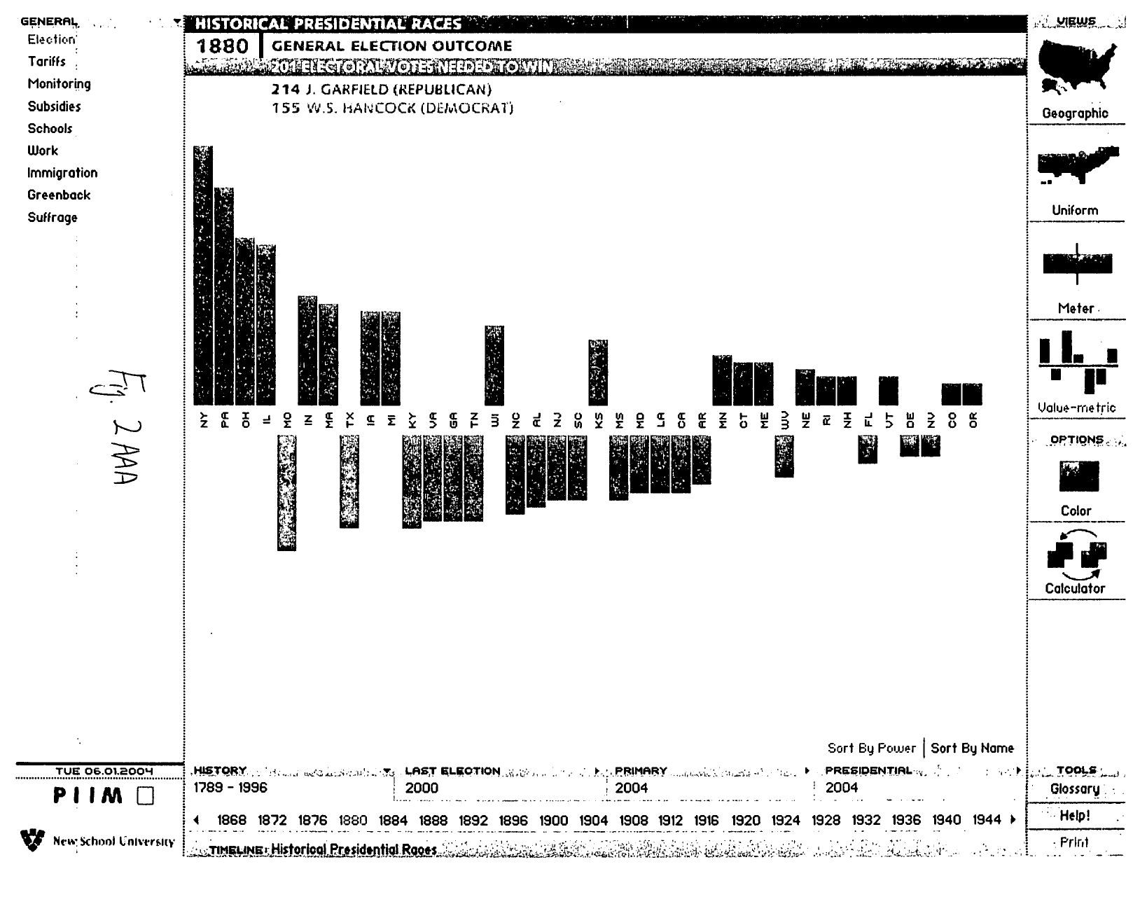

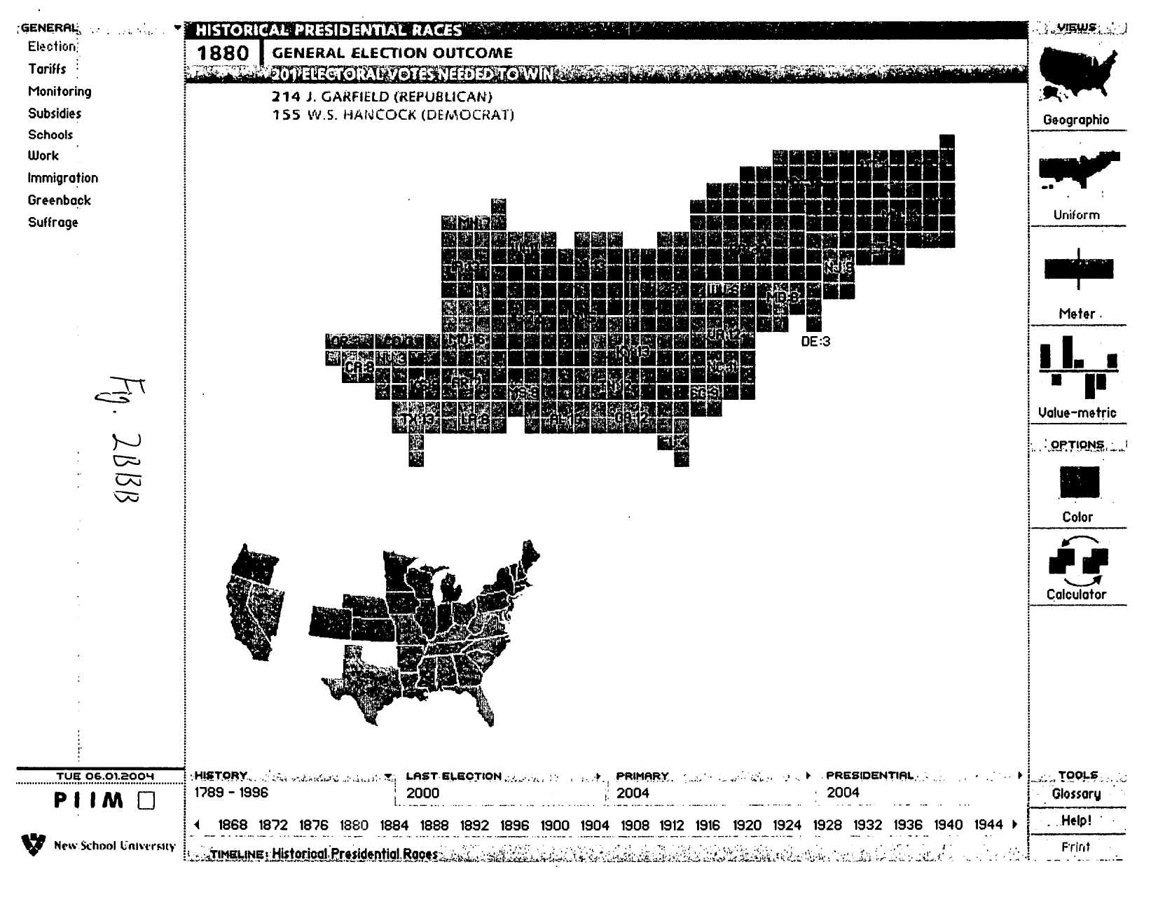

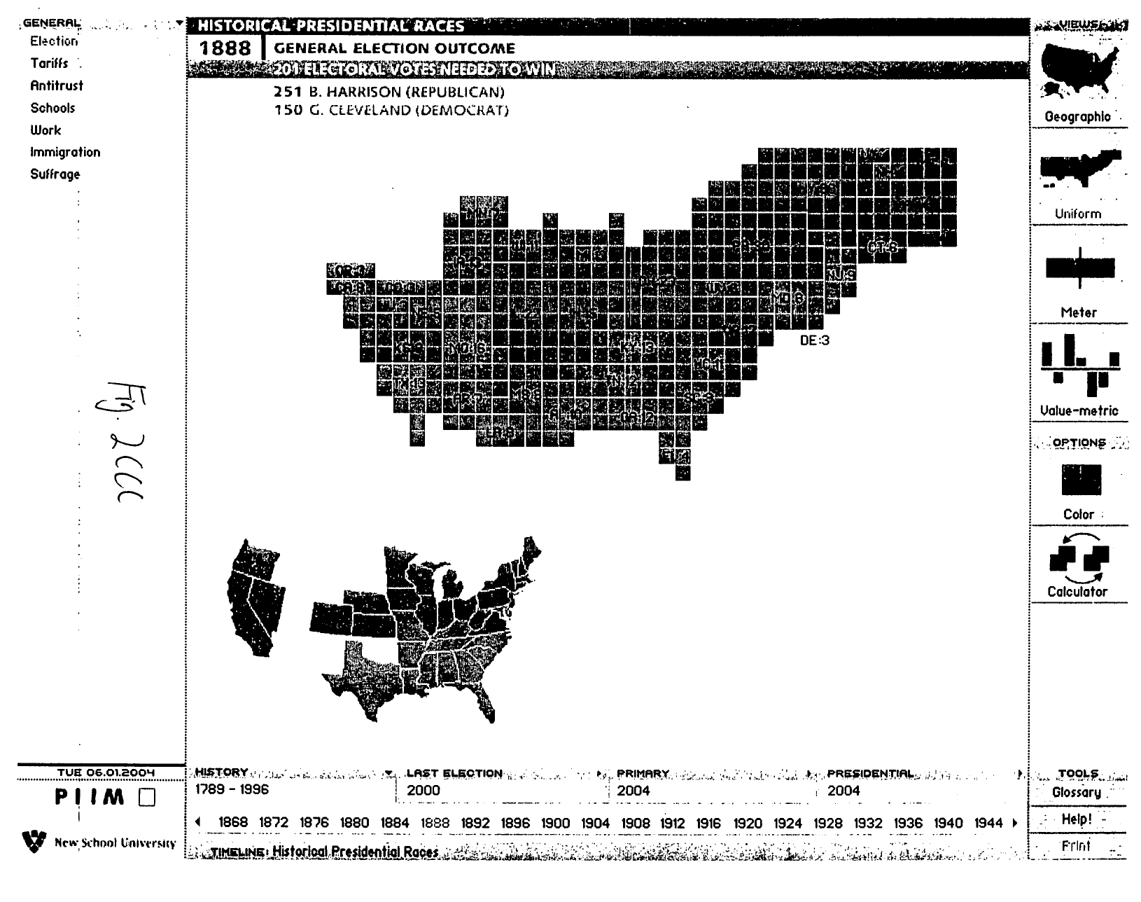

FIGS. 3A-3B are graphical visualizations in accordance with certain aspects of the invention of the presidential race of 2000, focusing on the effect of the economy.

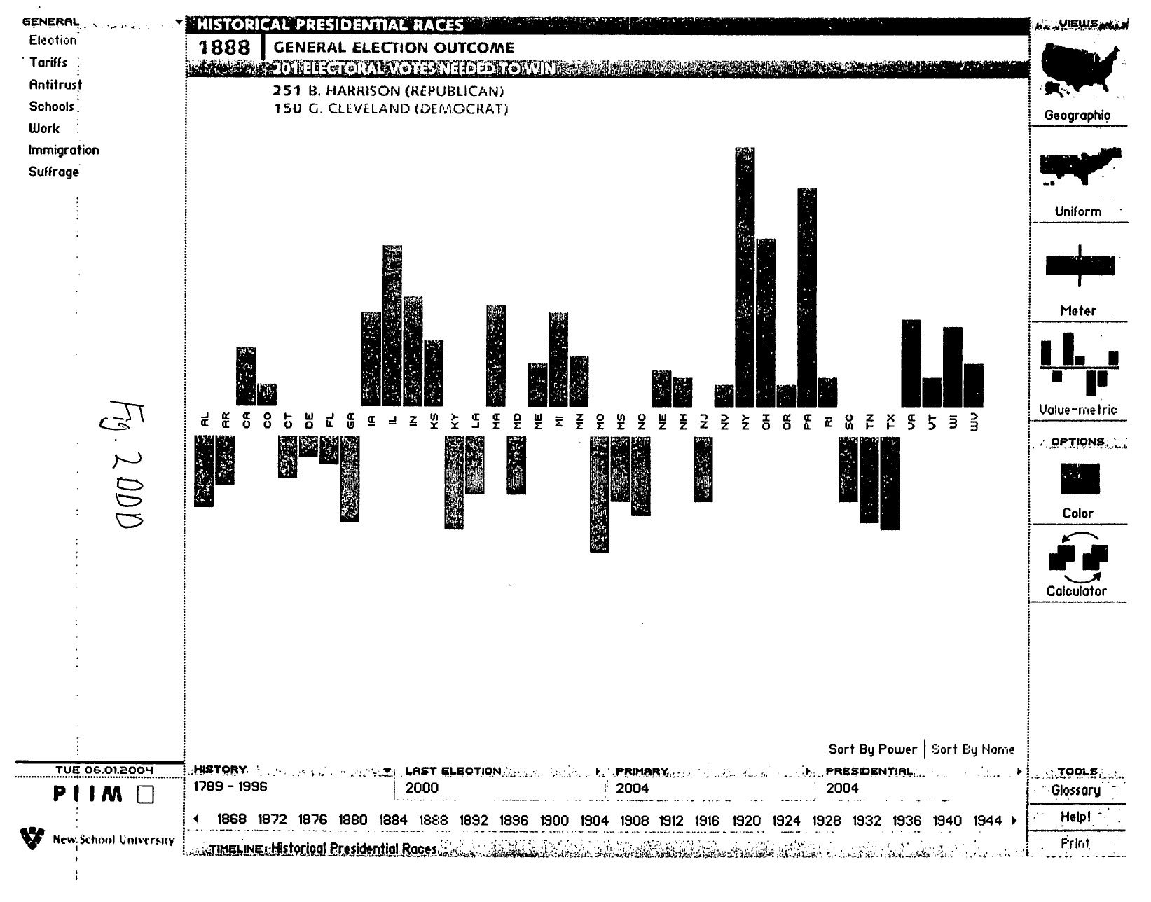

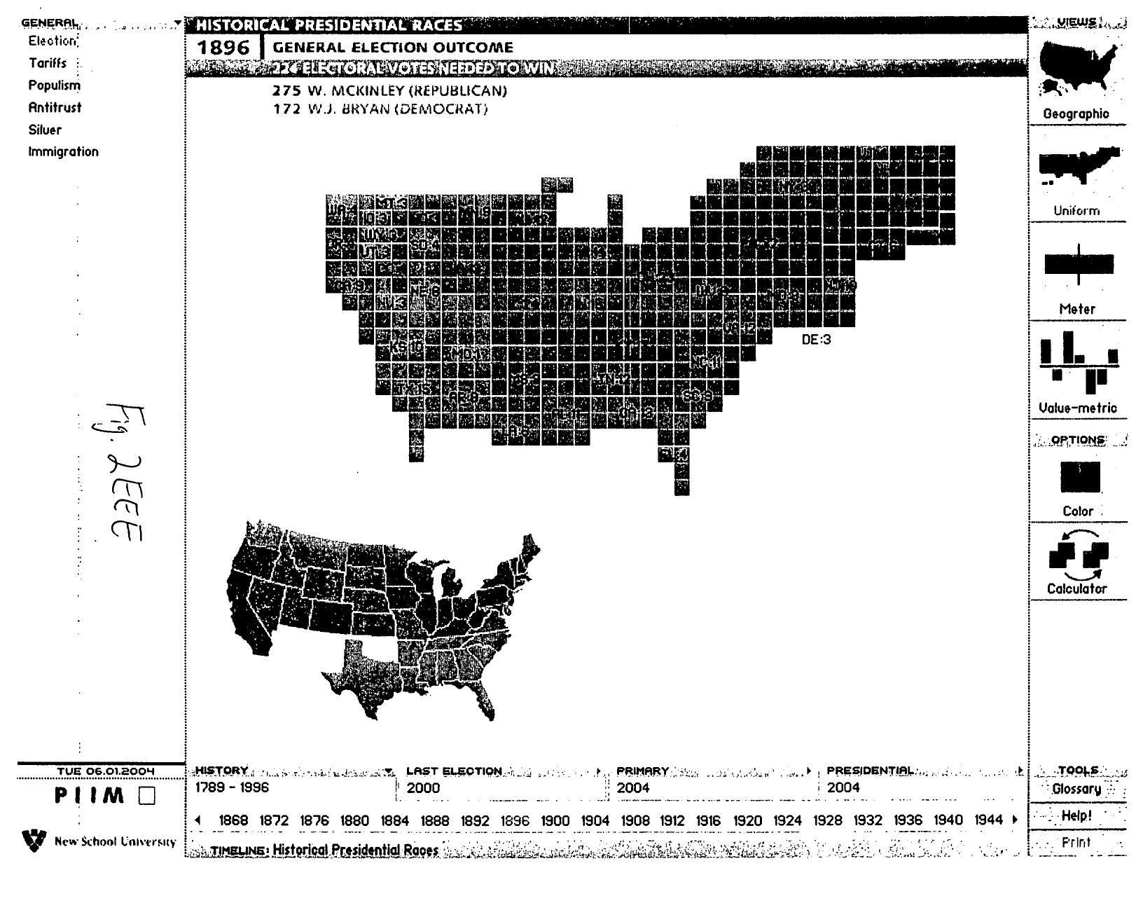

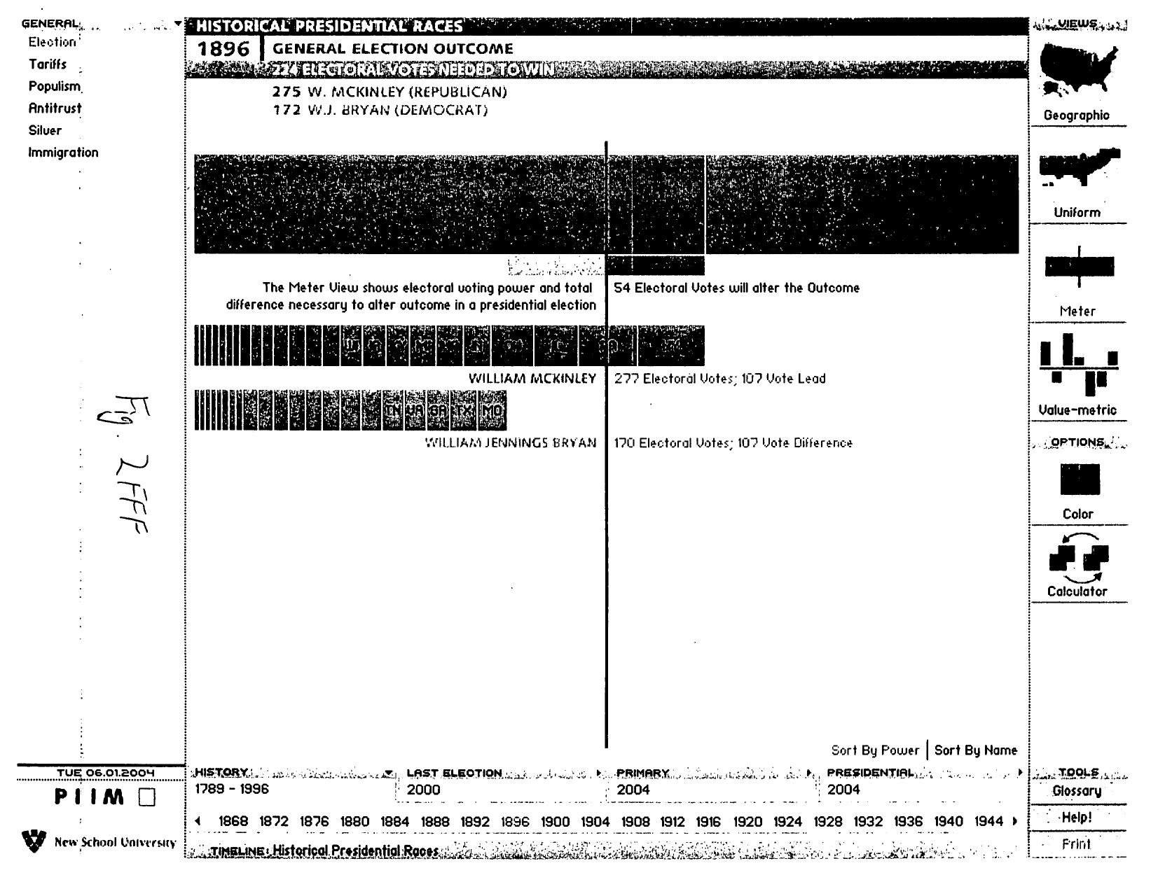

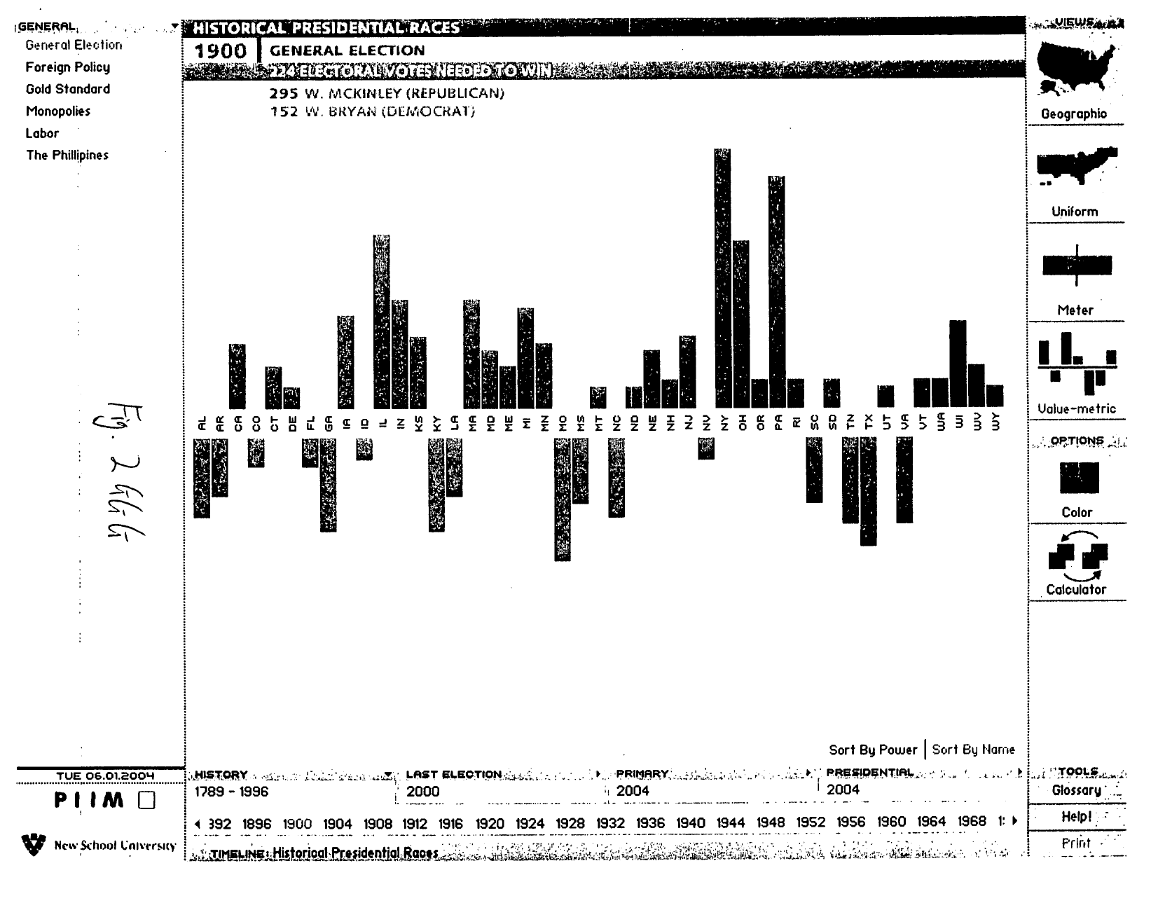

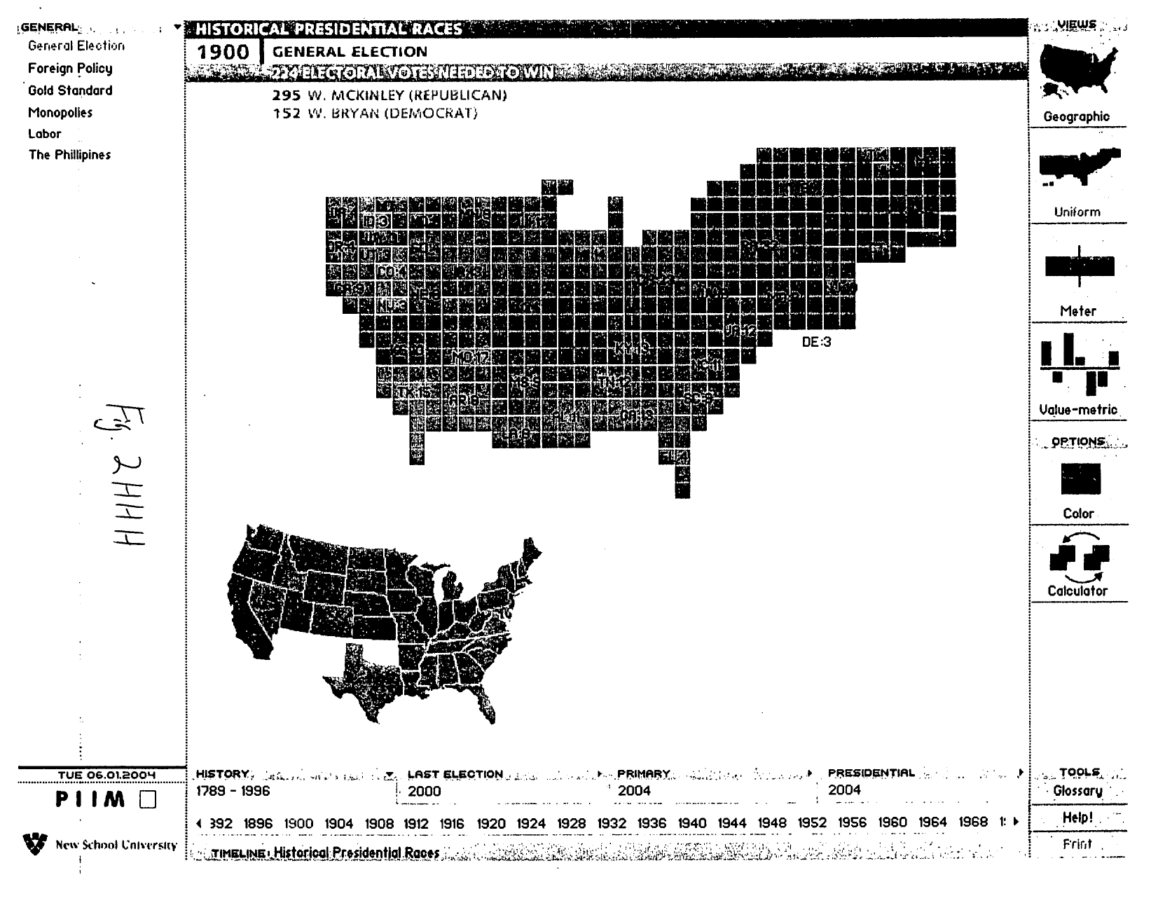

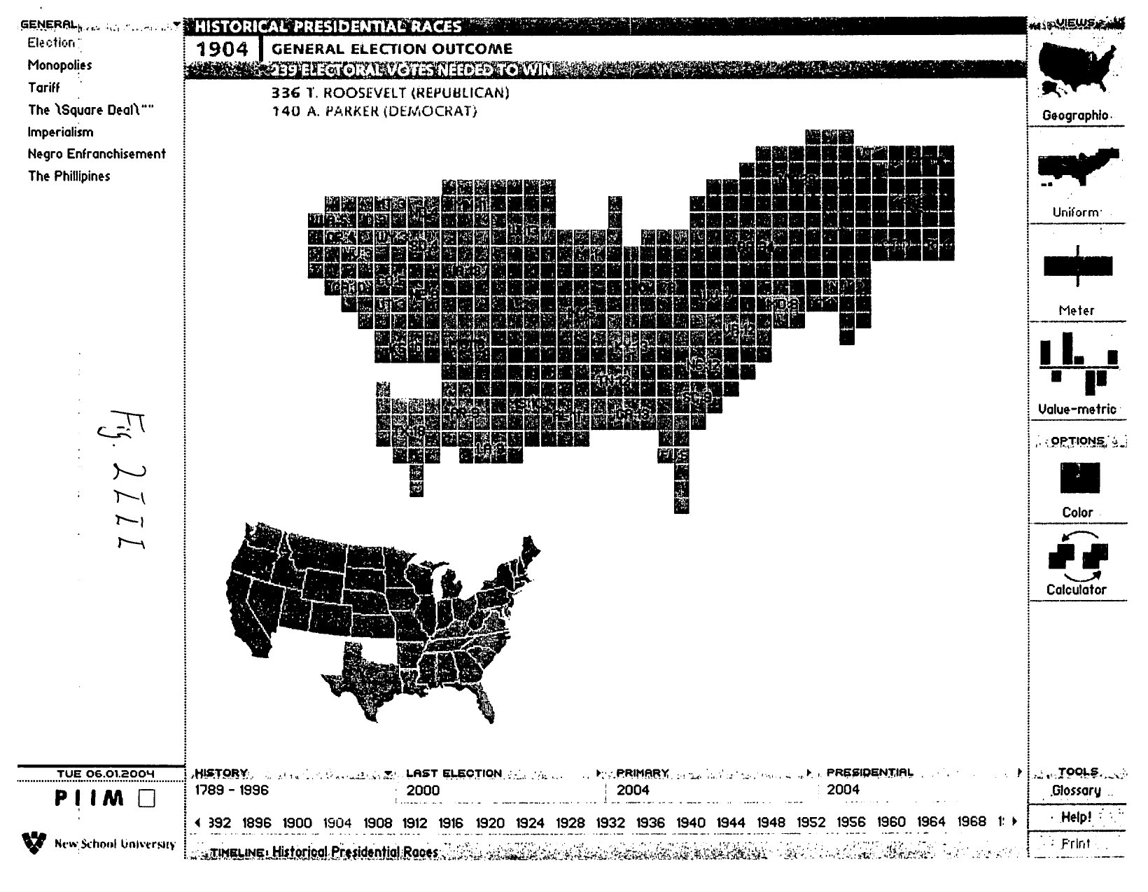

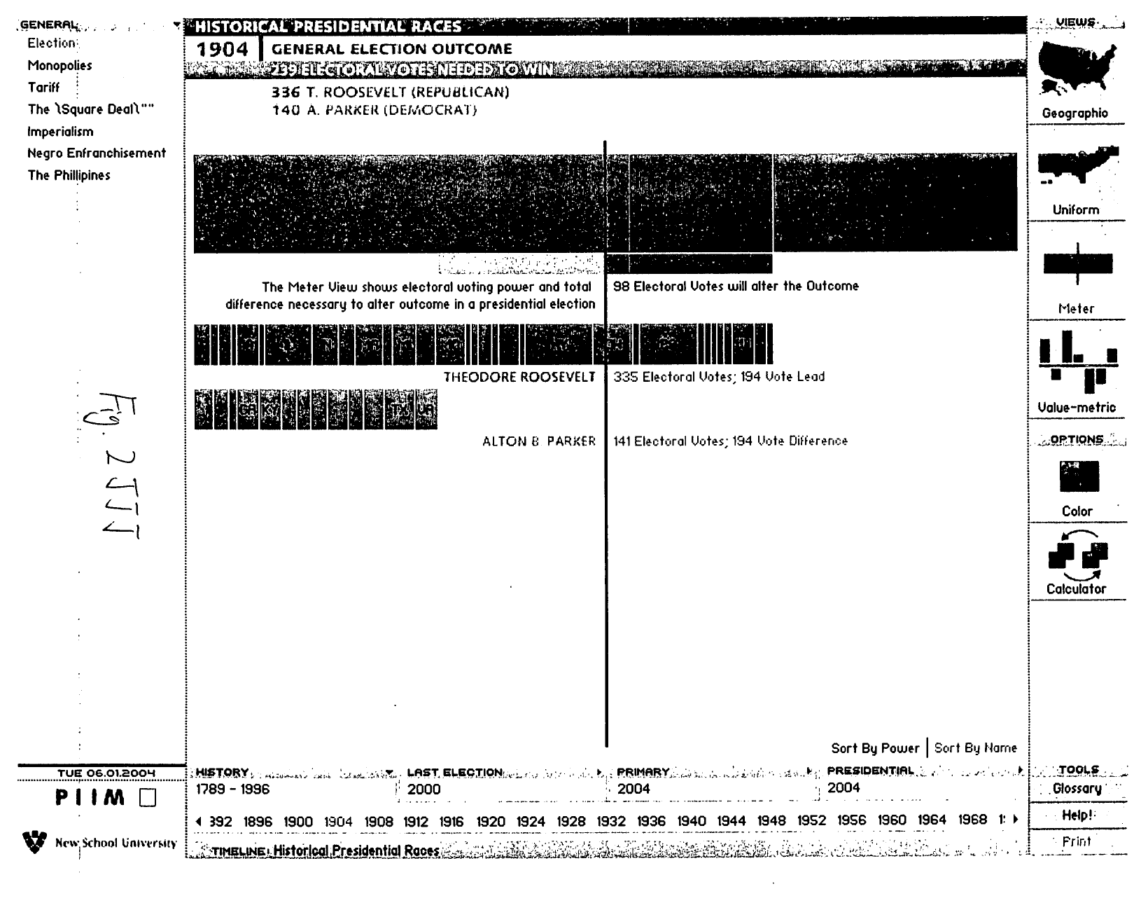

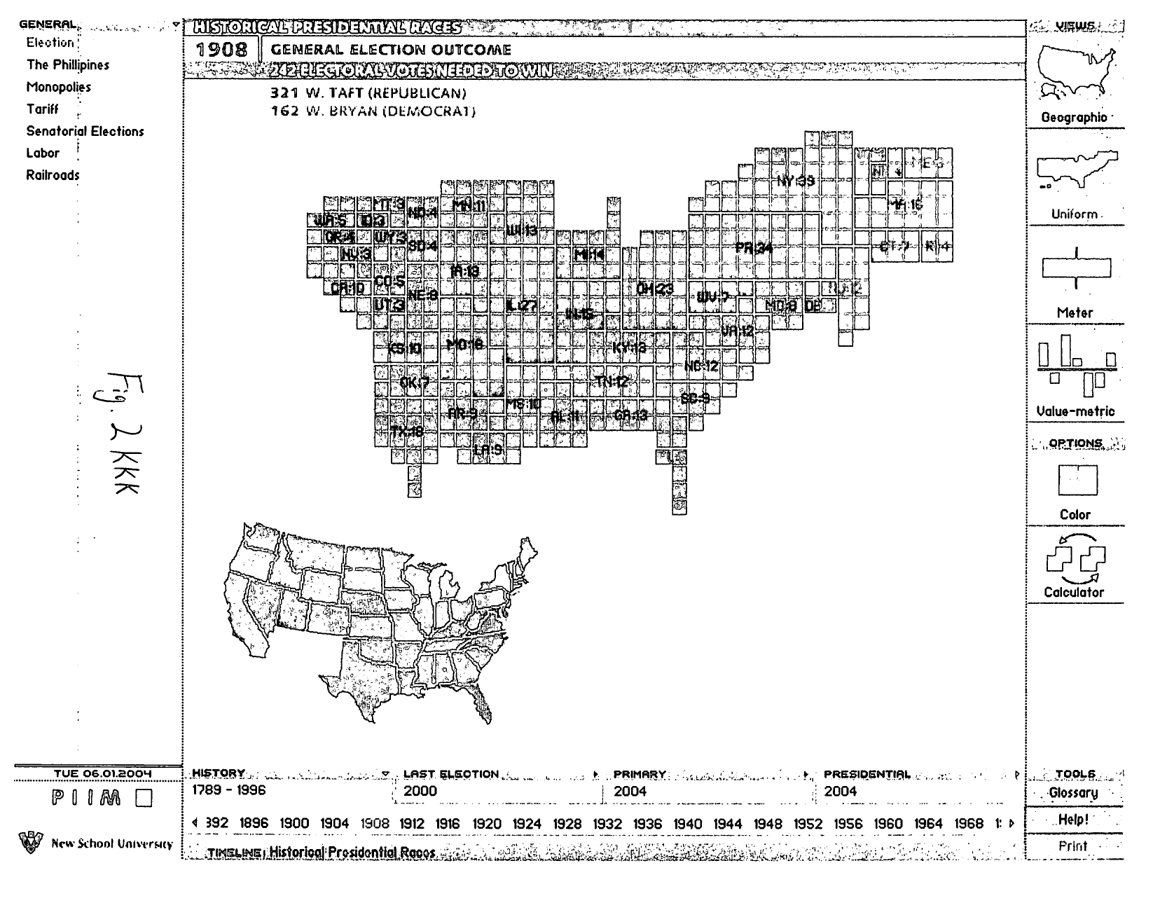

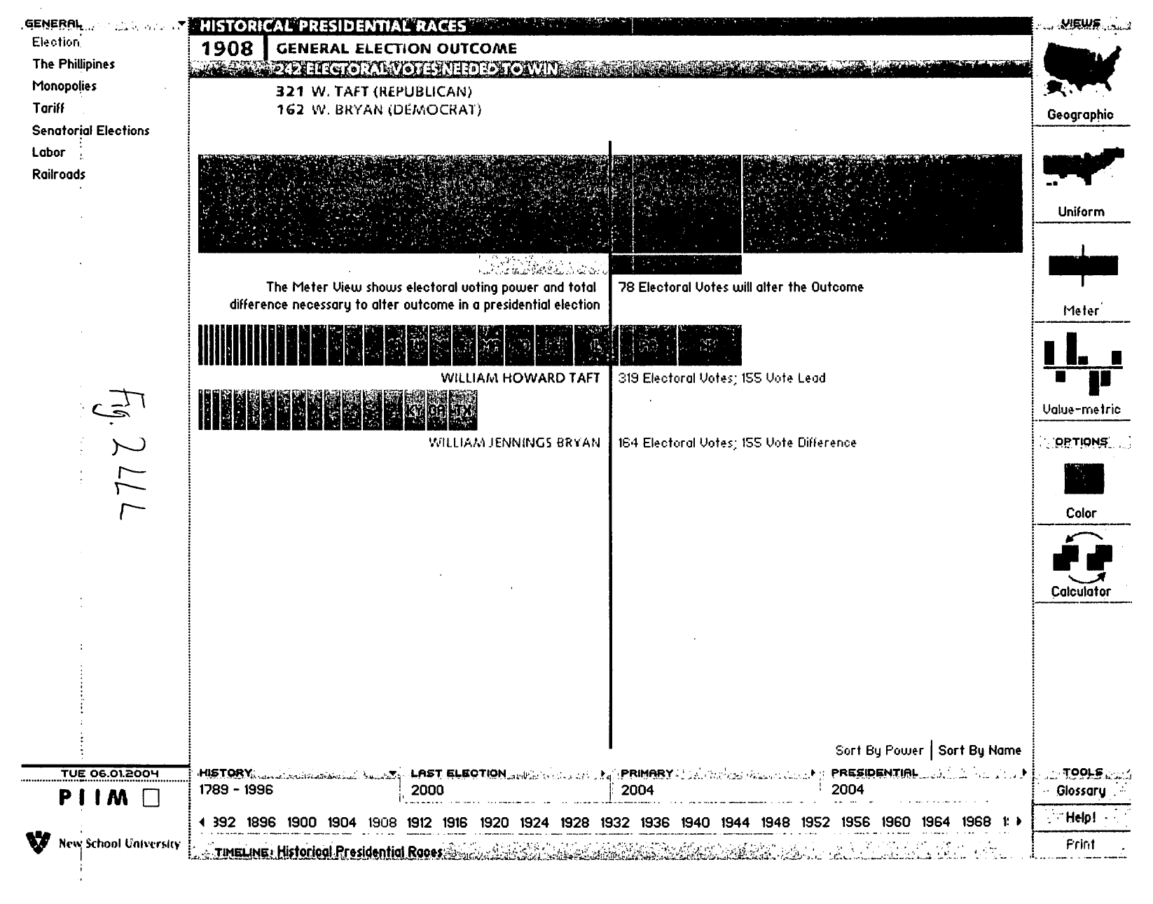

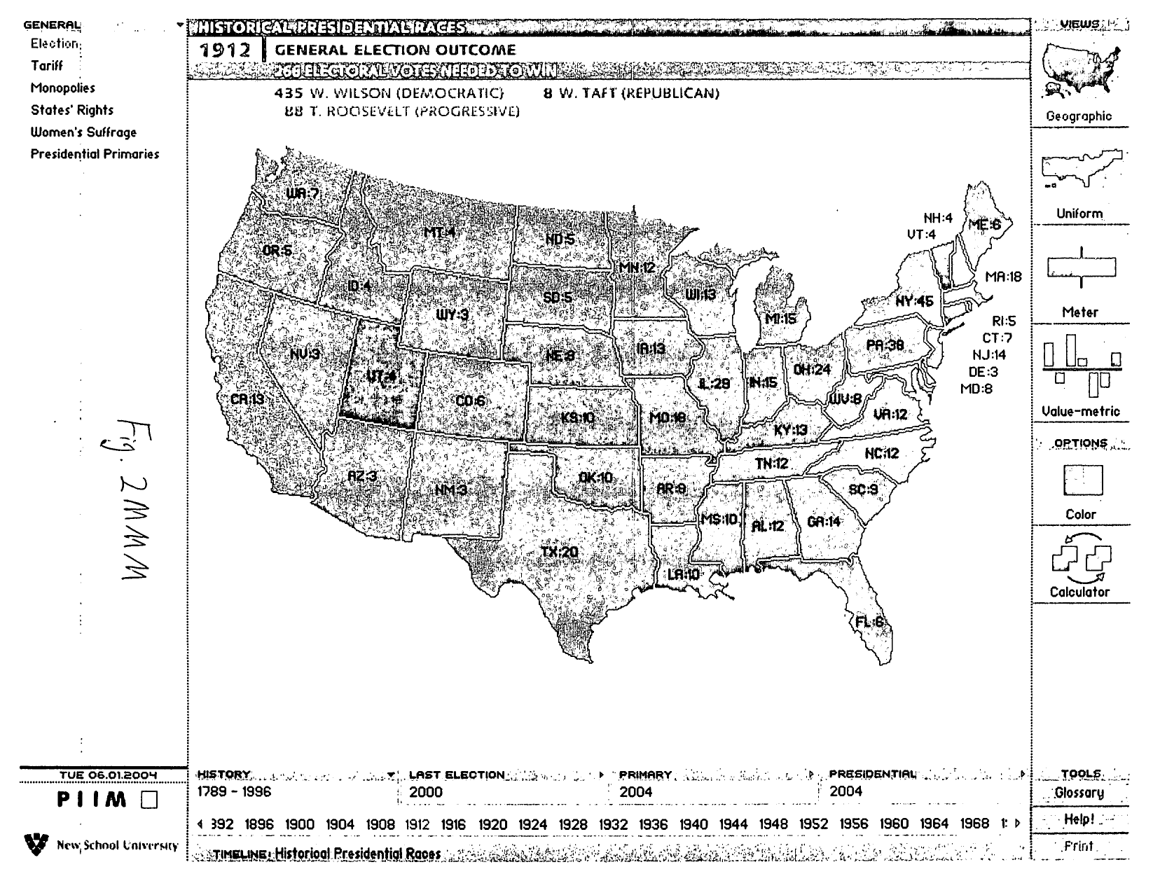

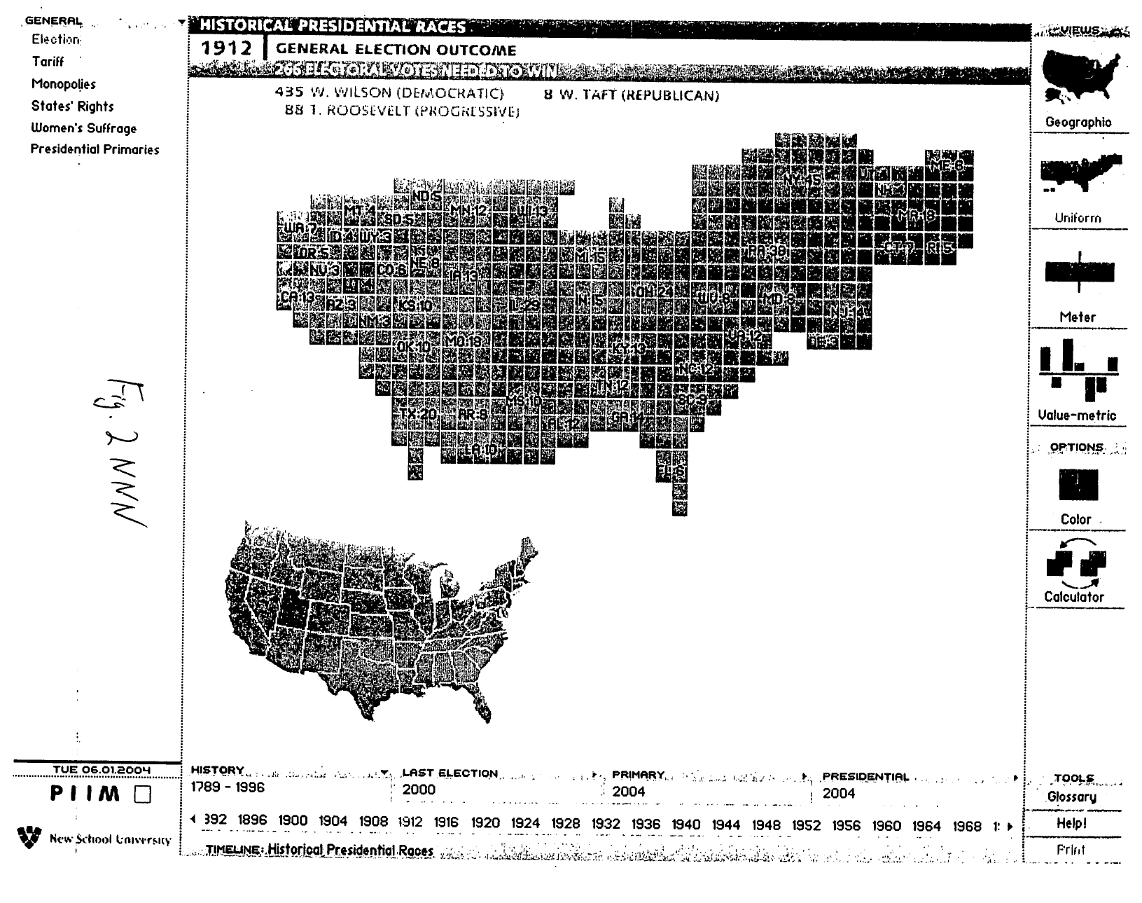

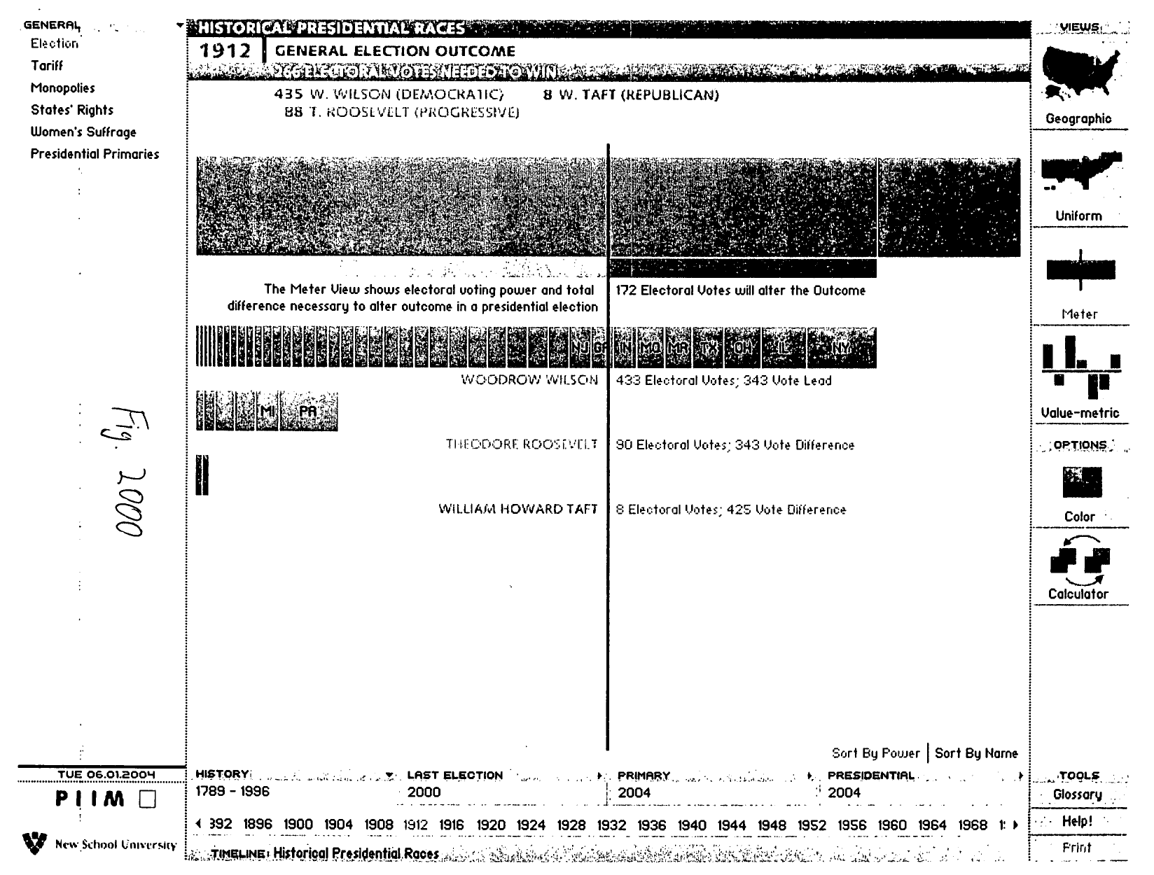

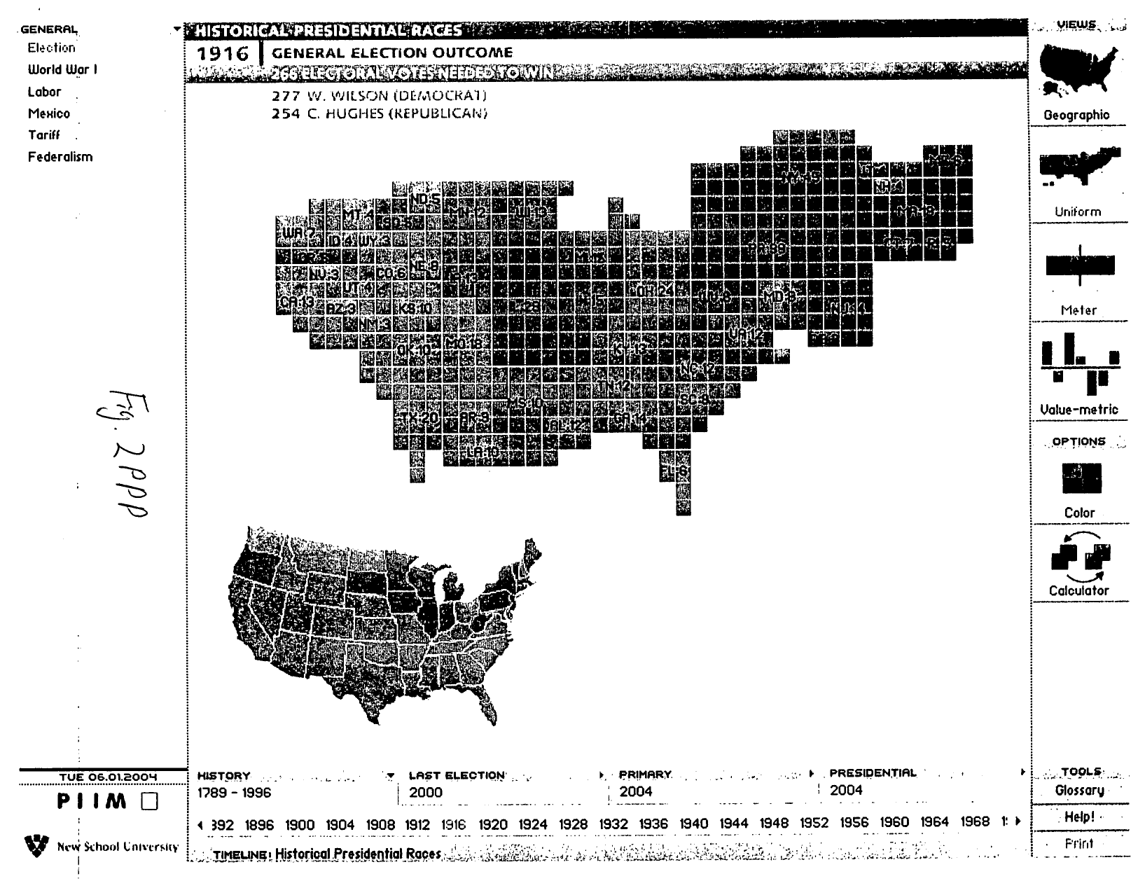

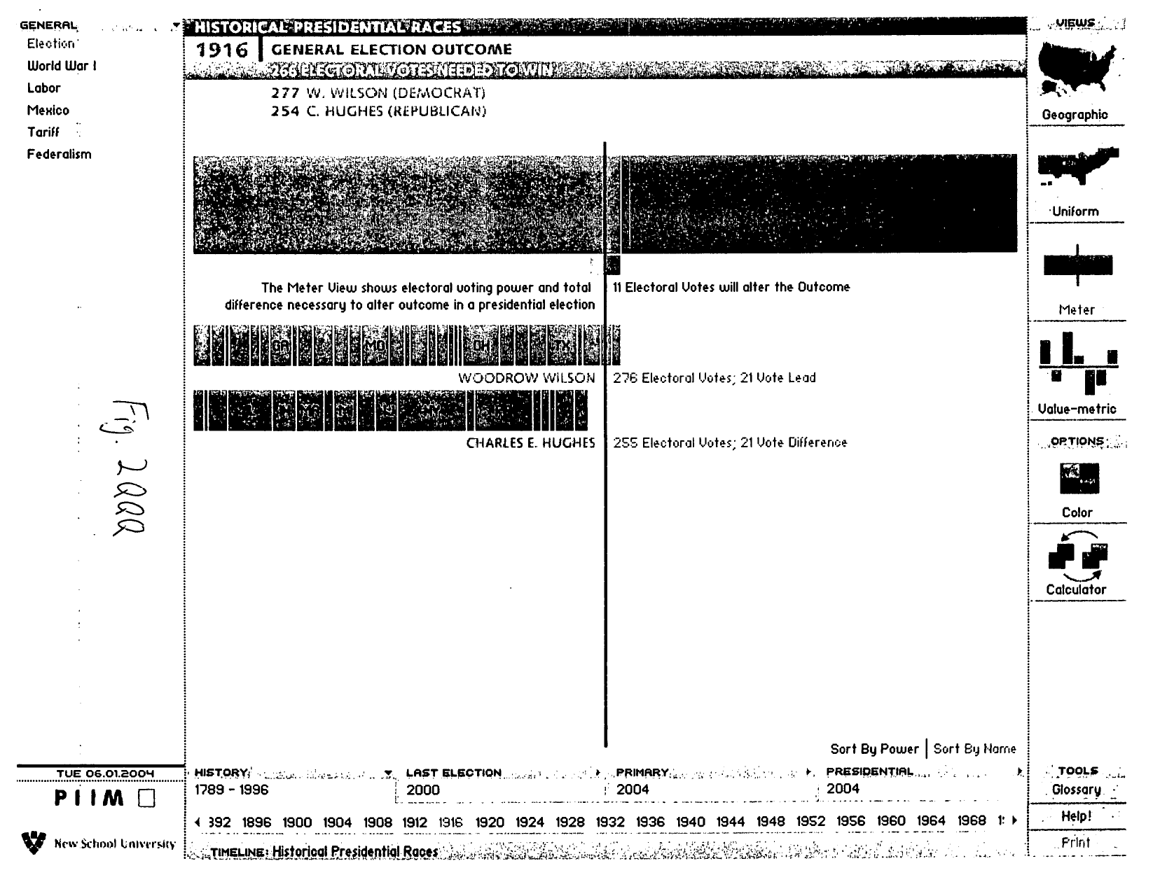

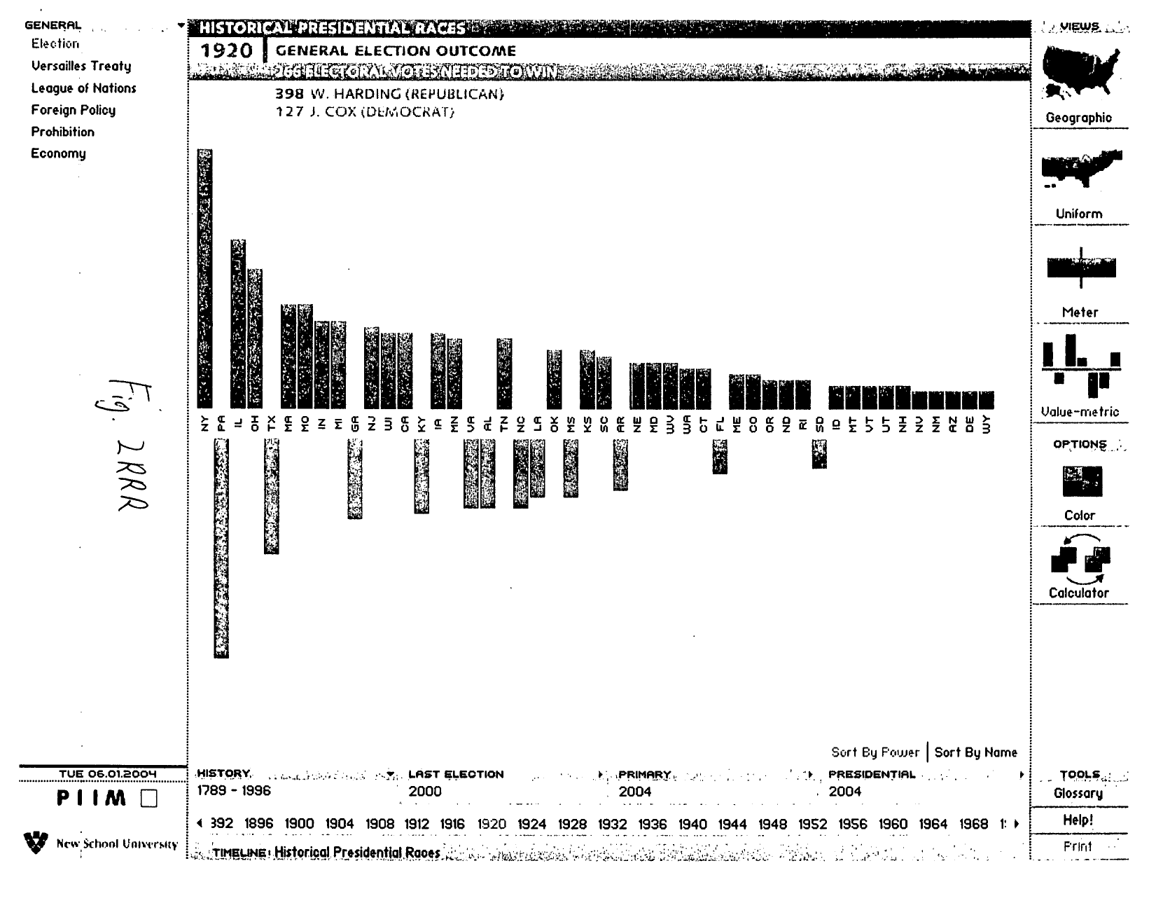

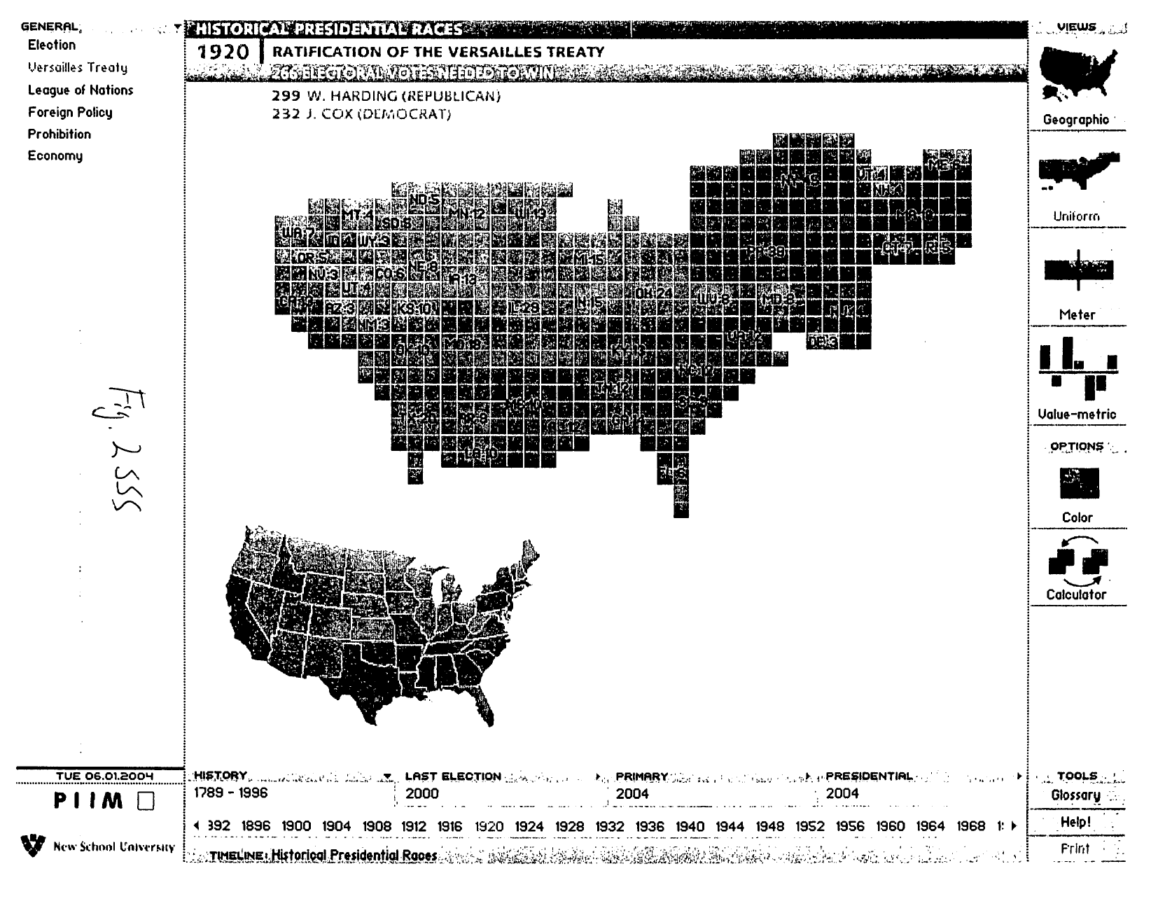

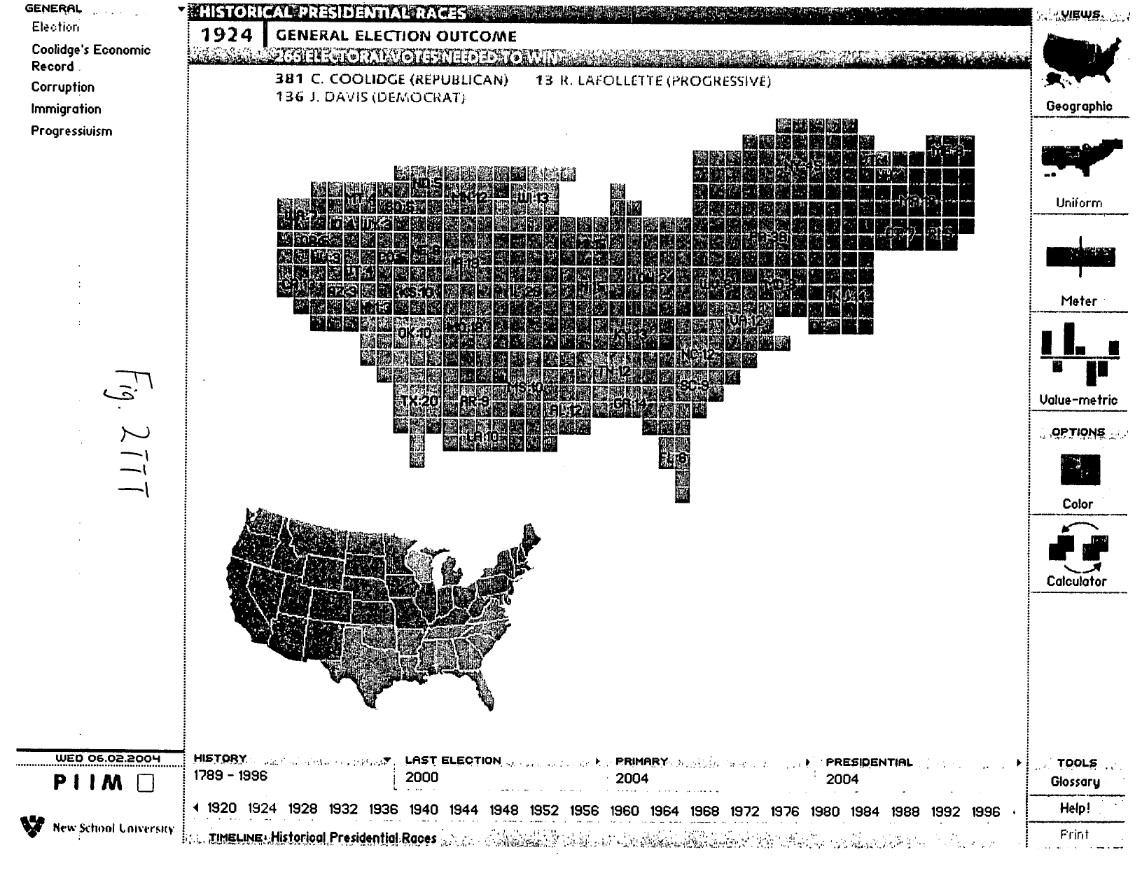

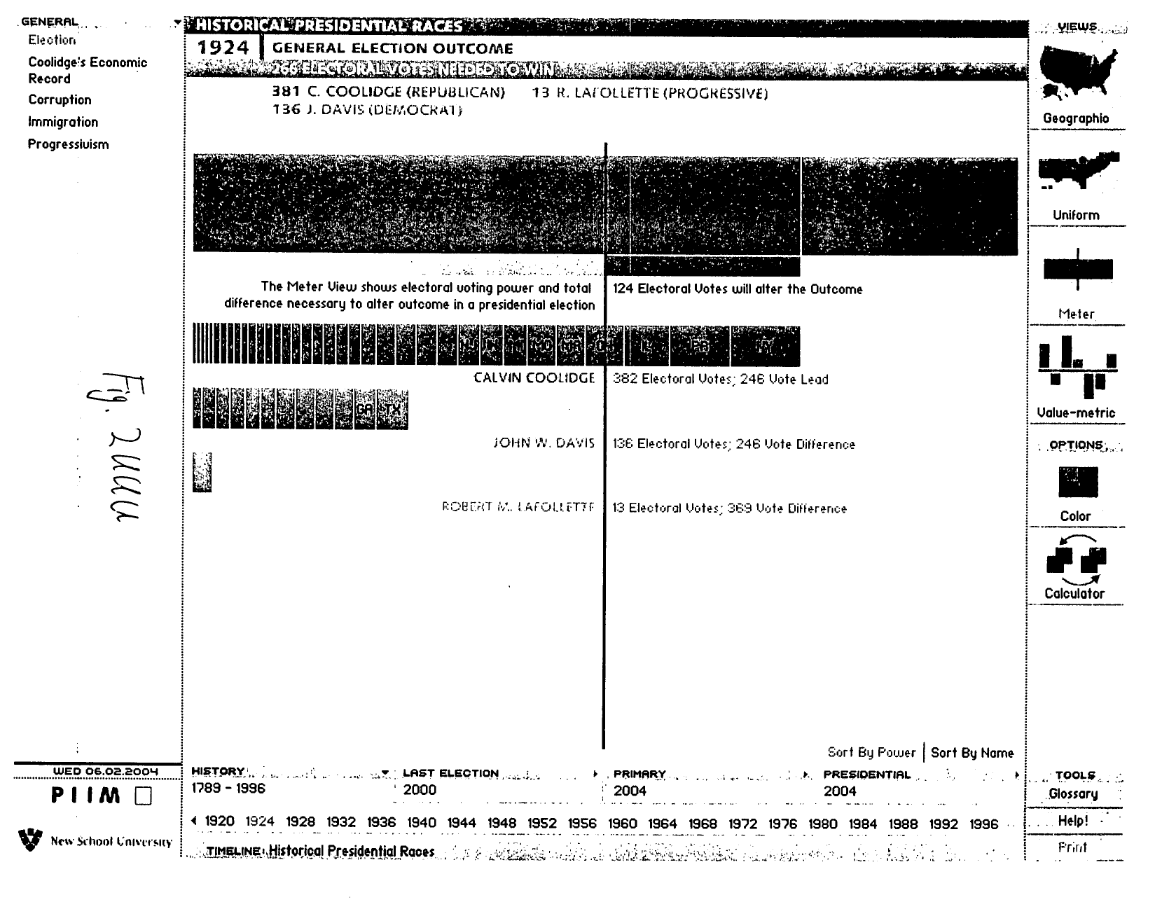

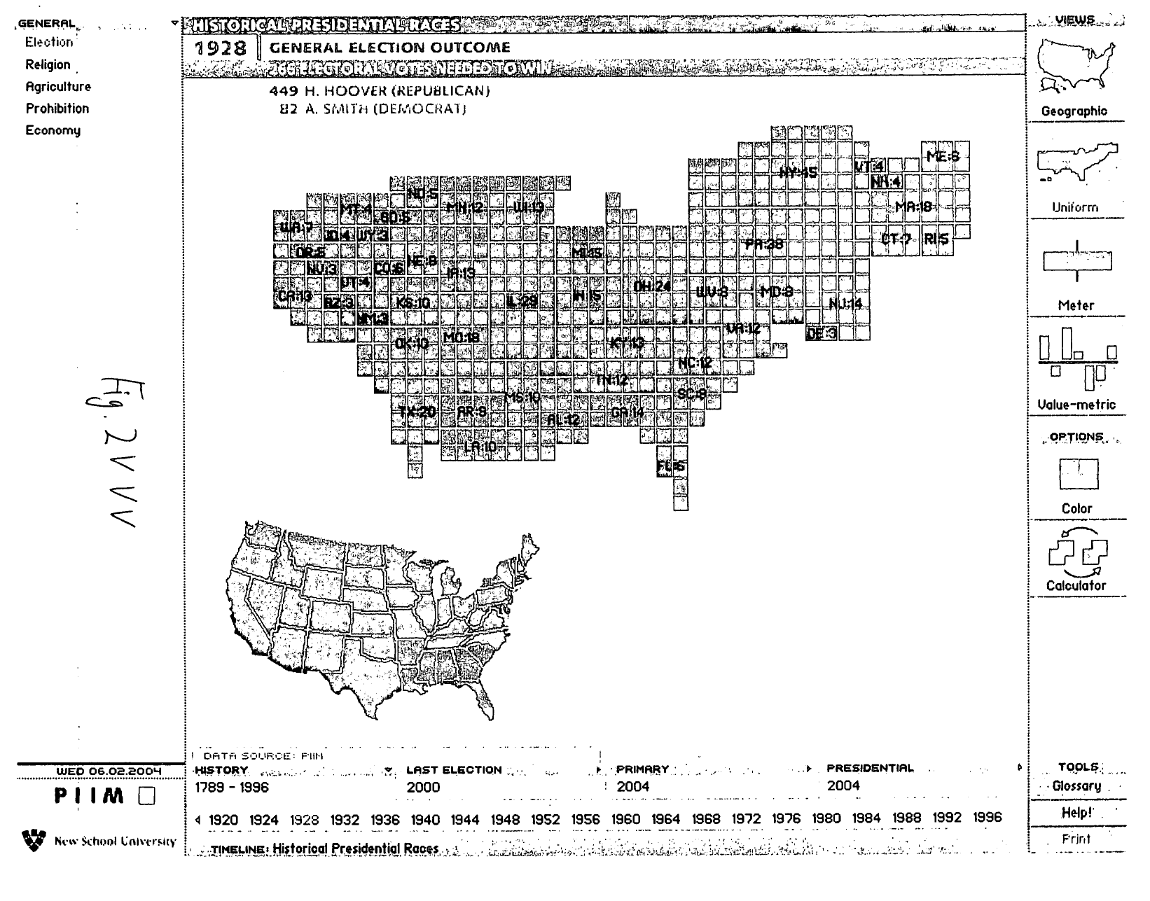

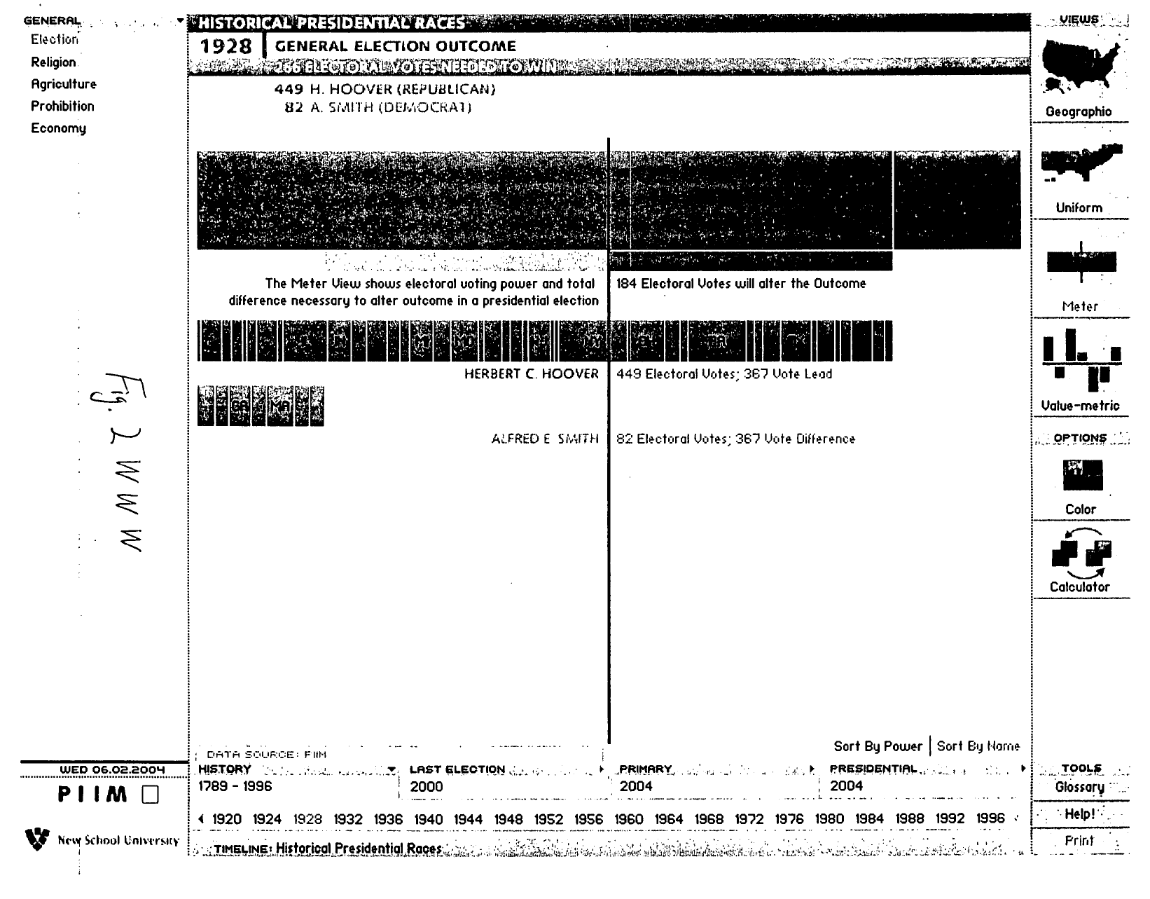

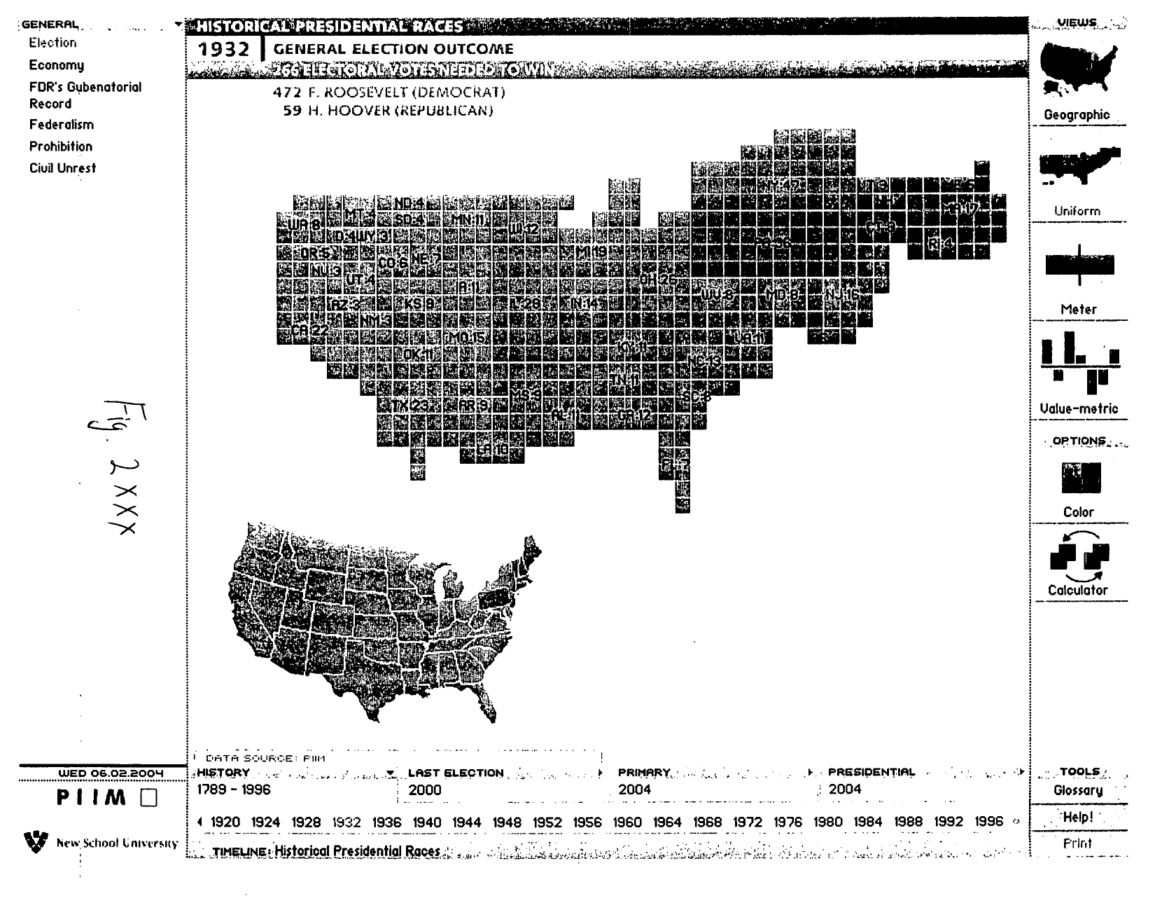

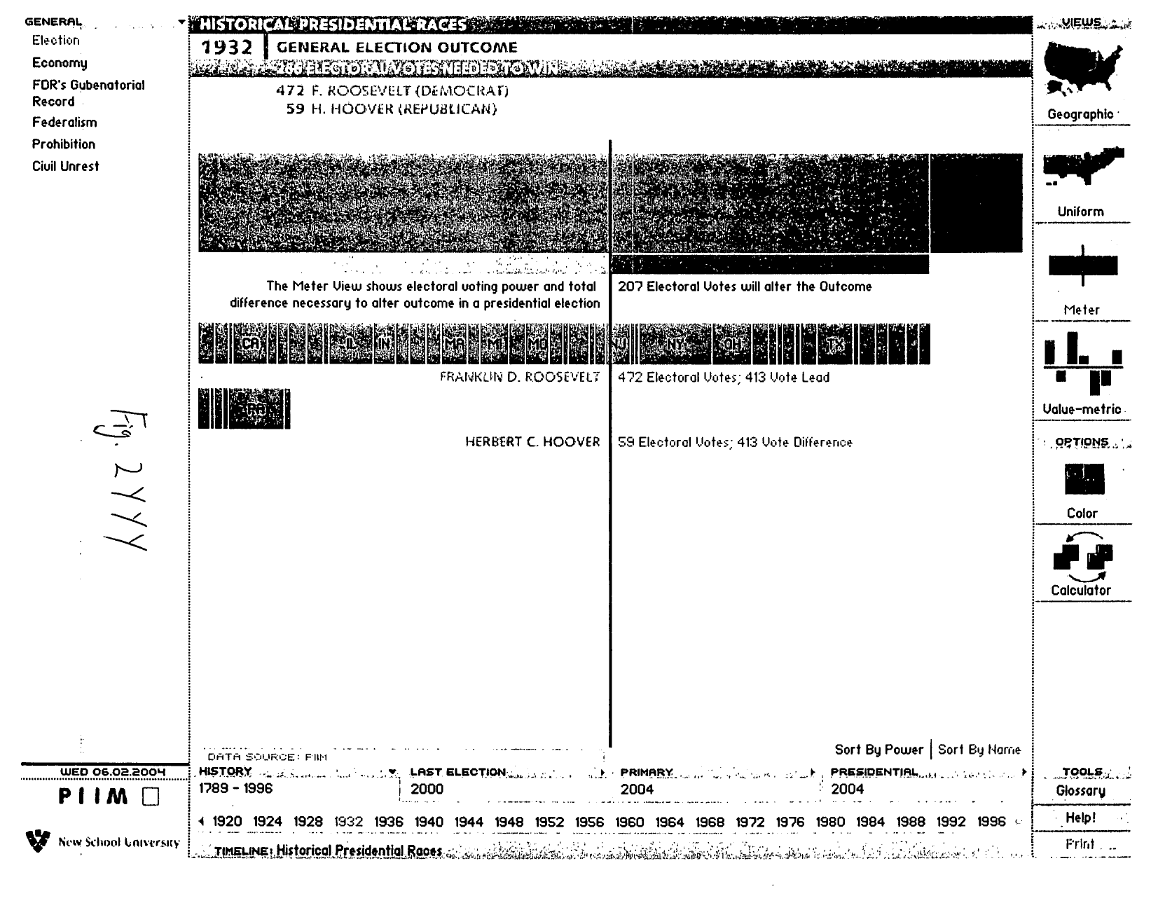

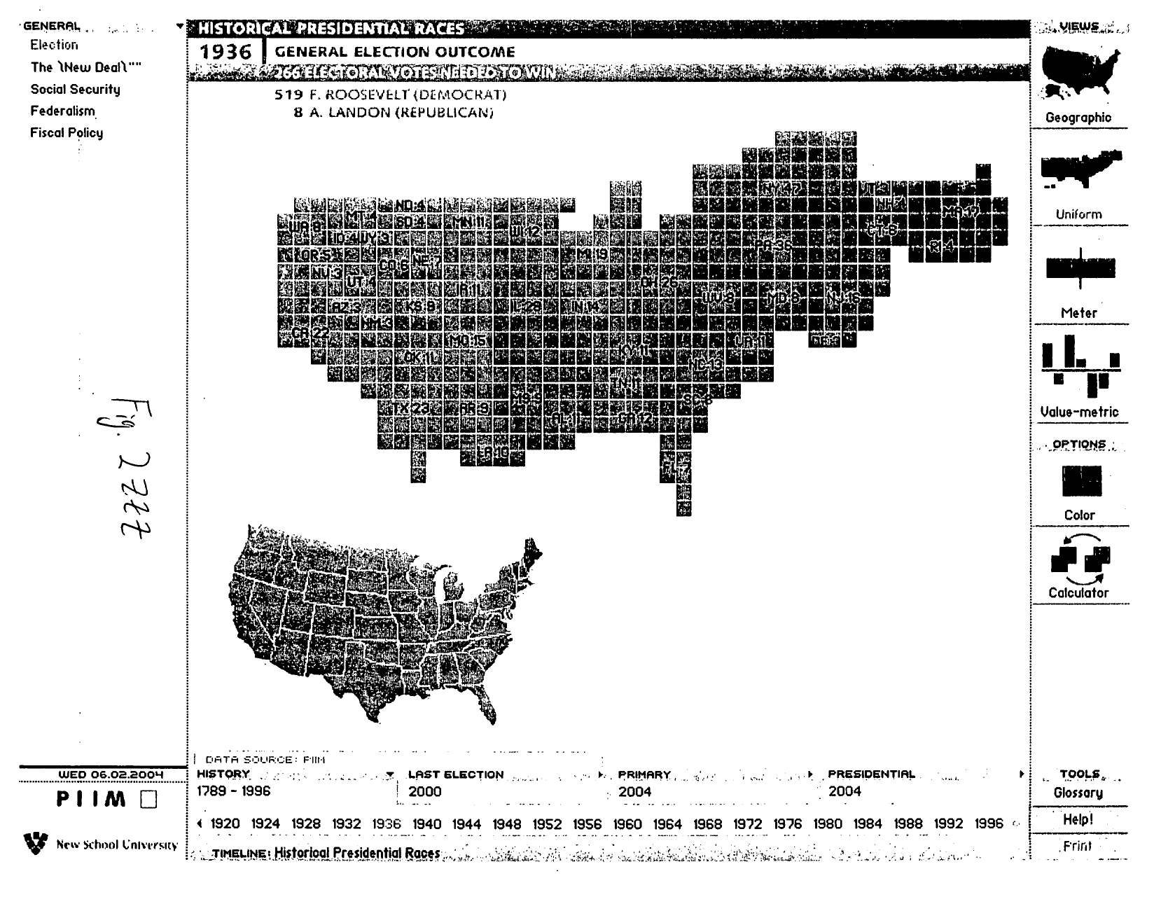

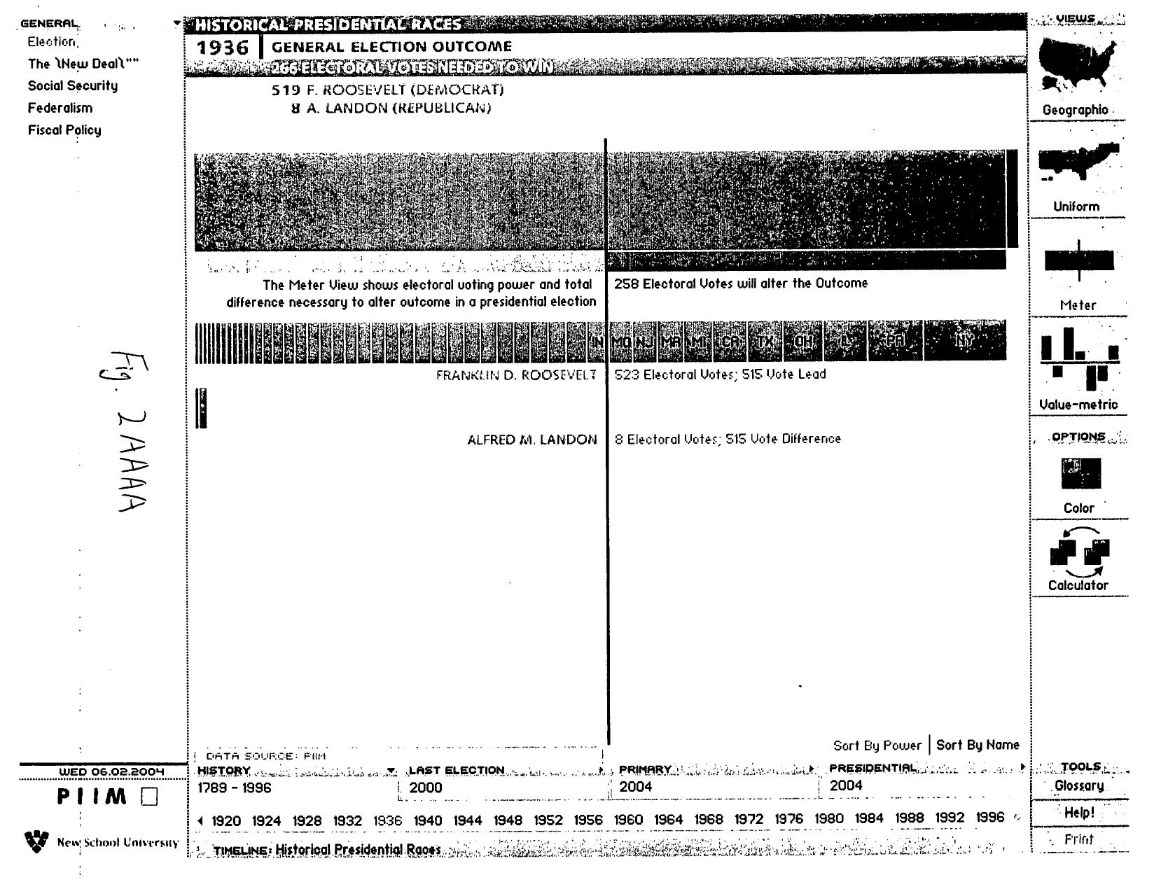

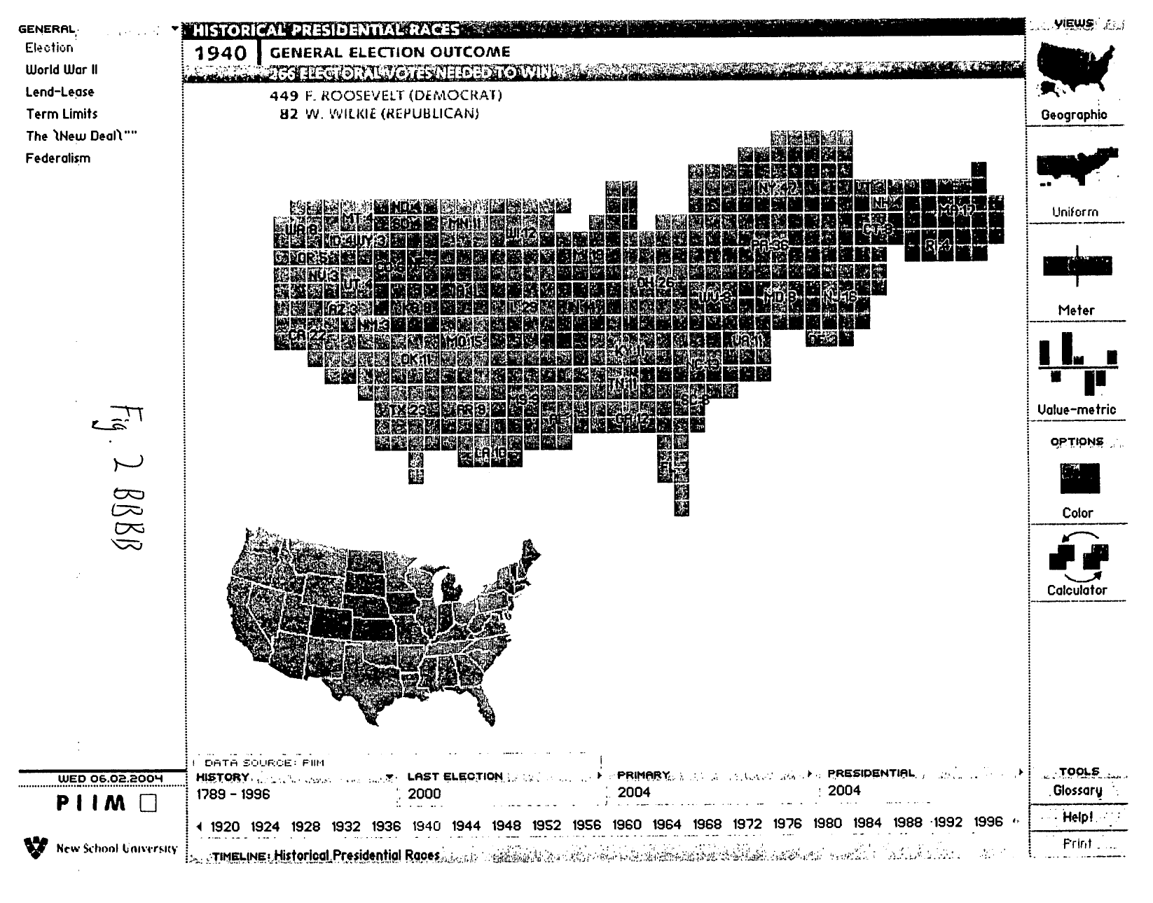

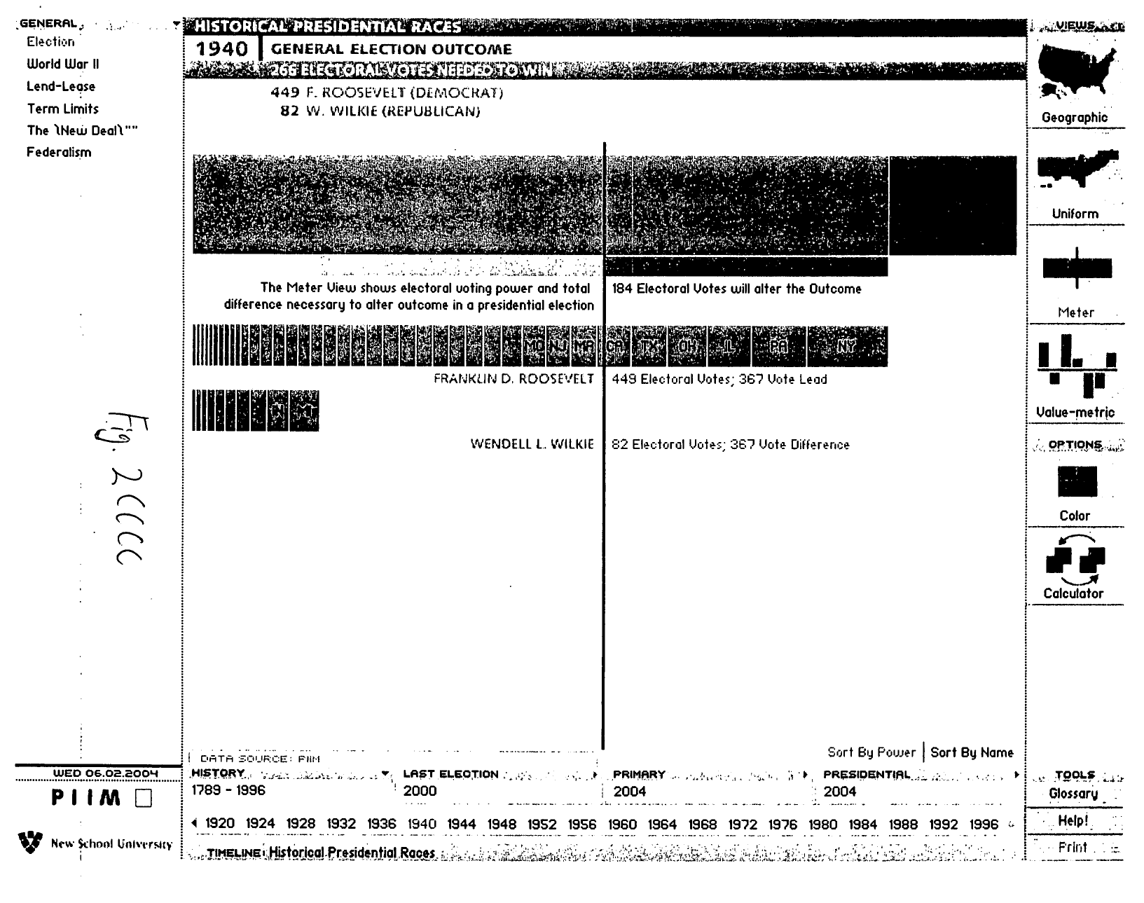

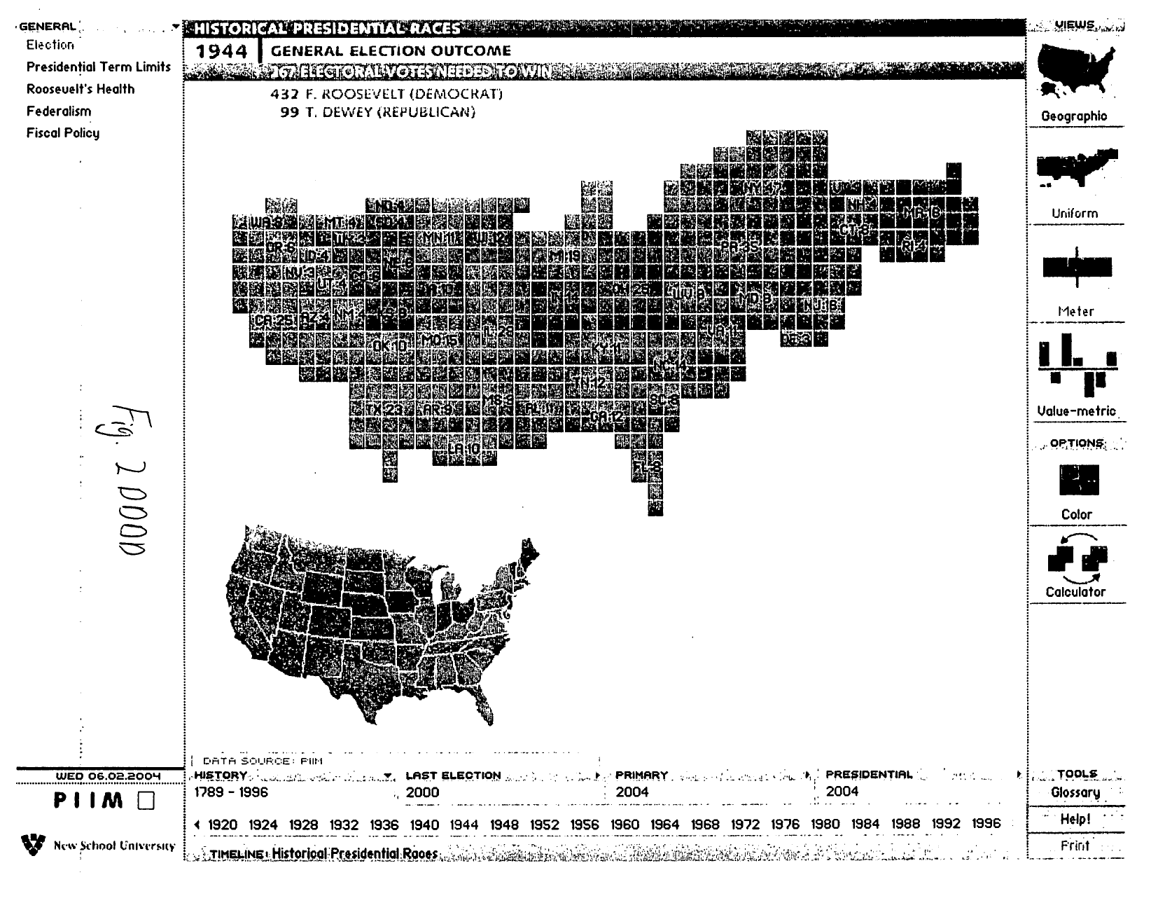

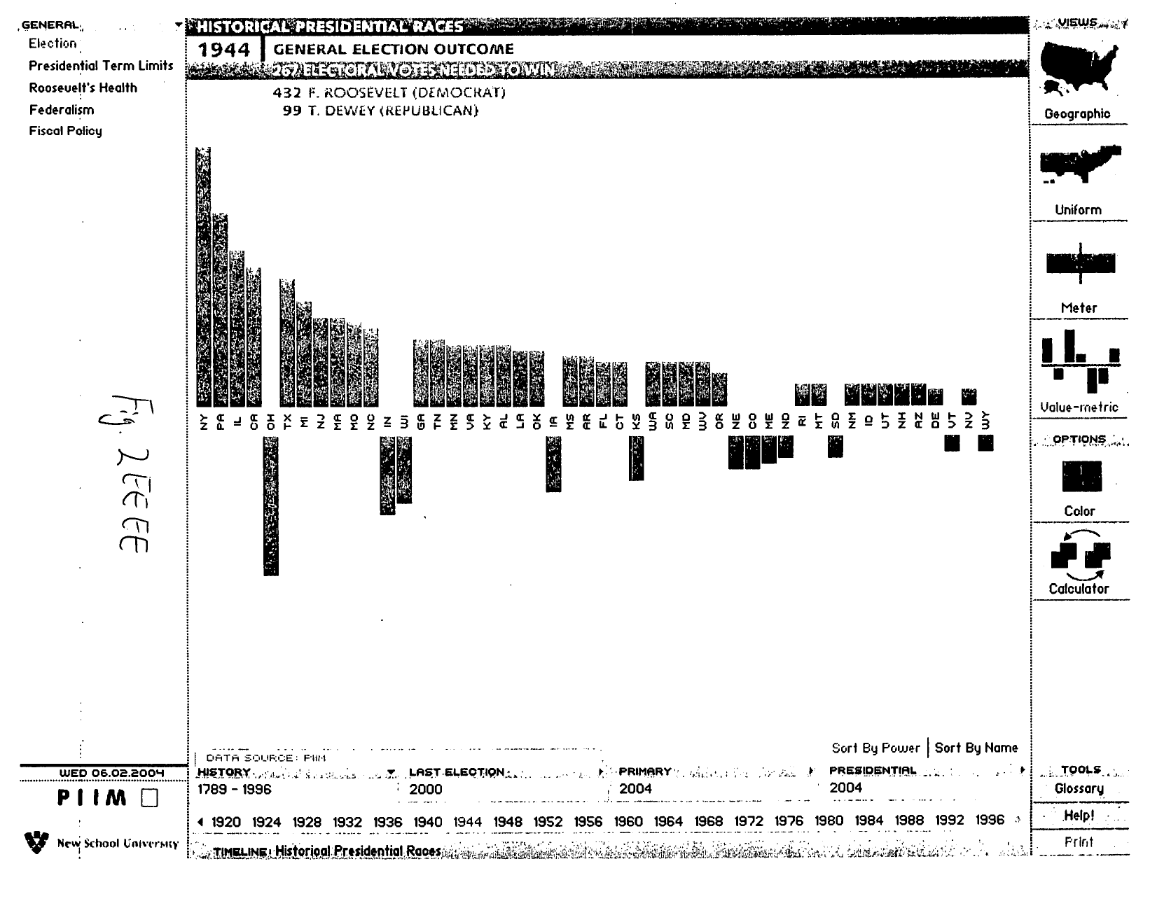

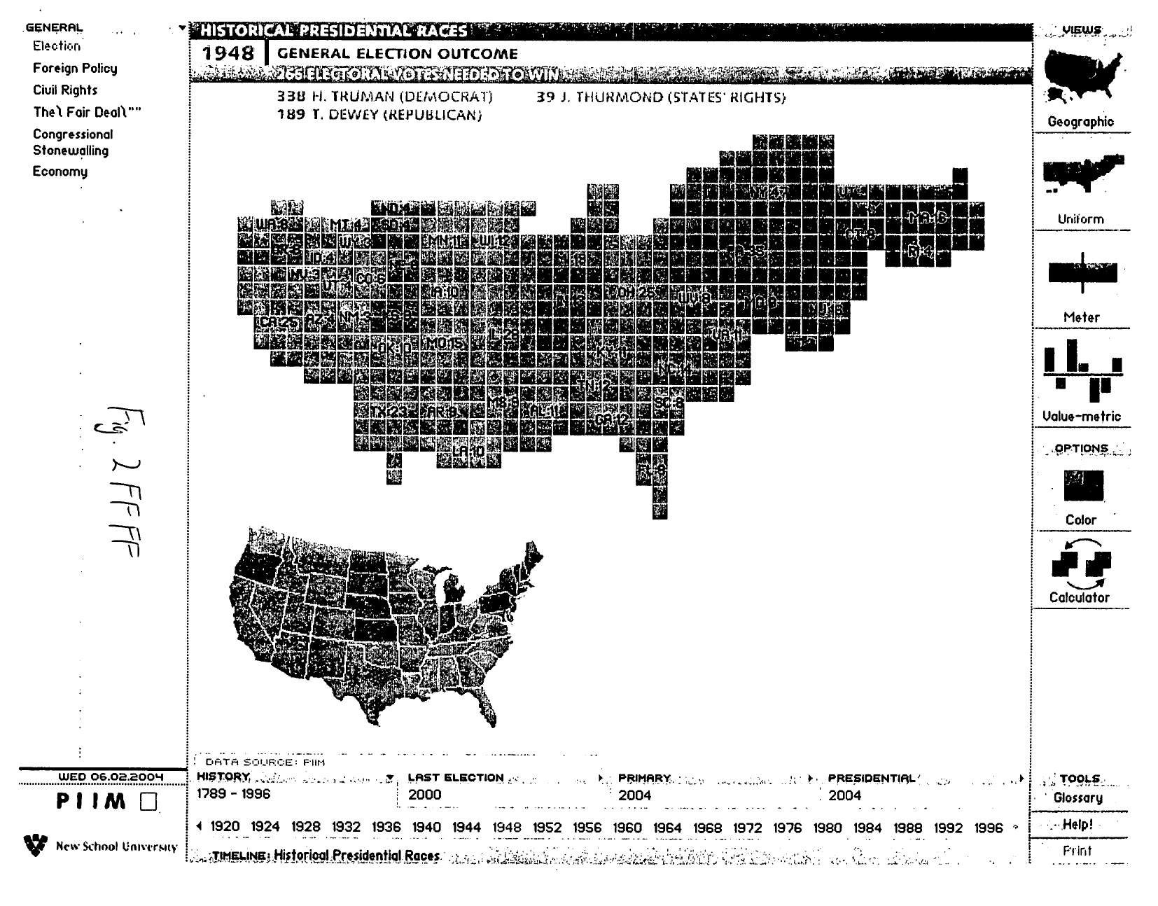

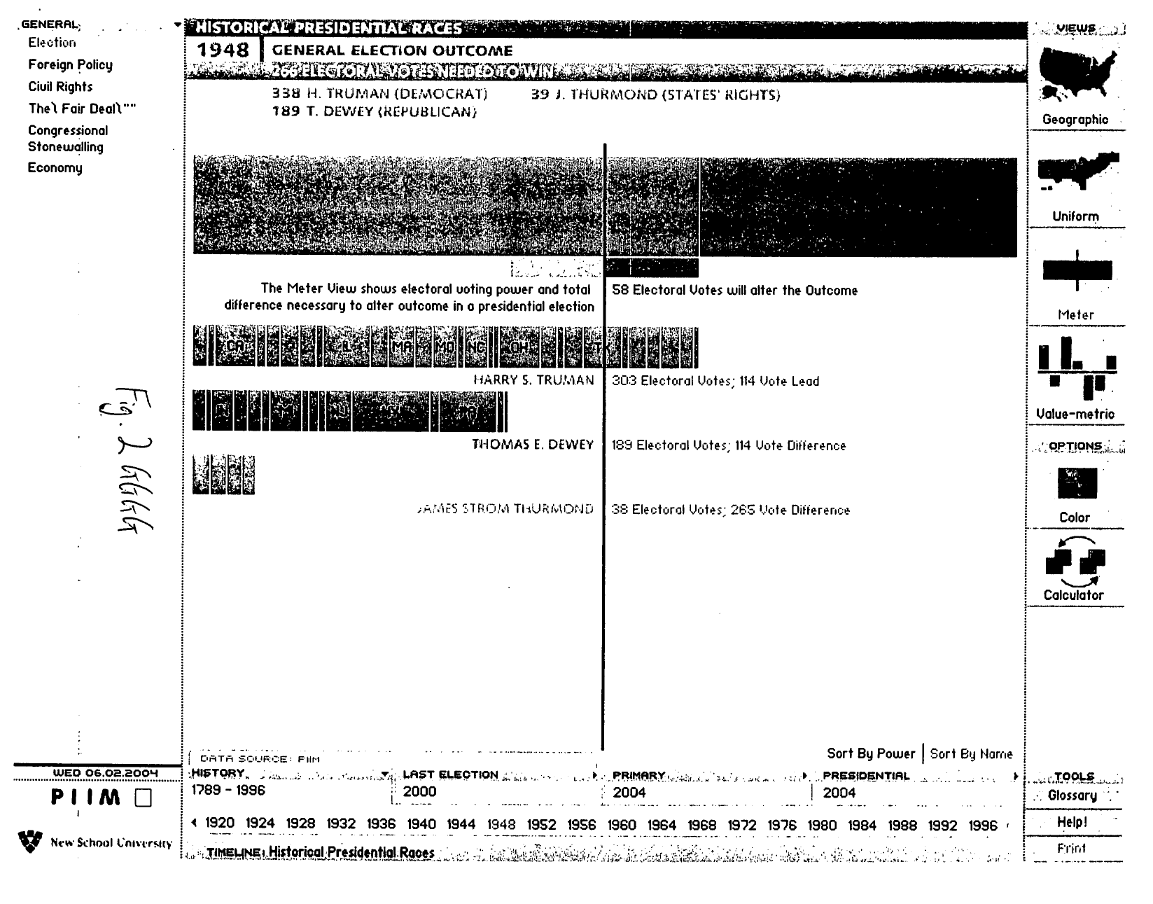

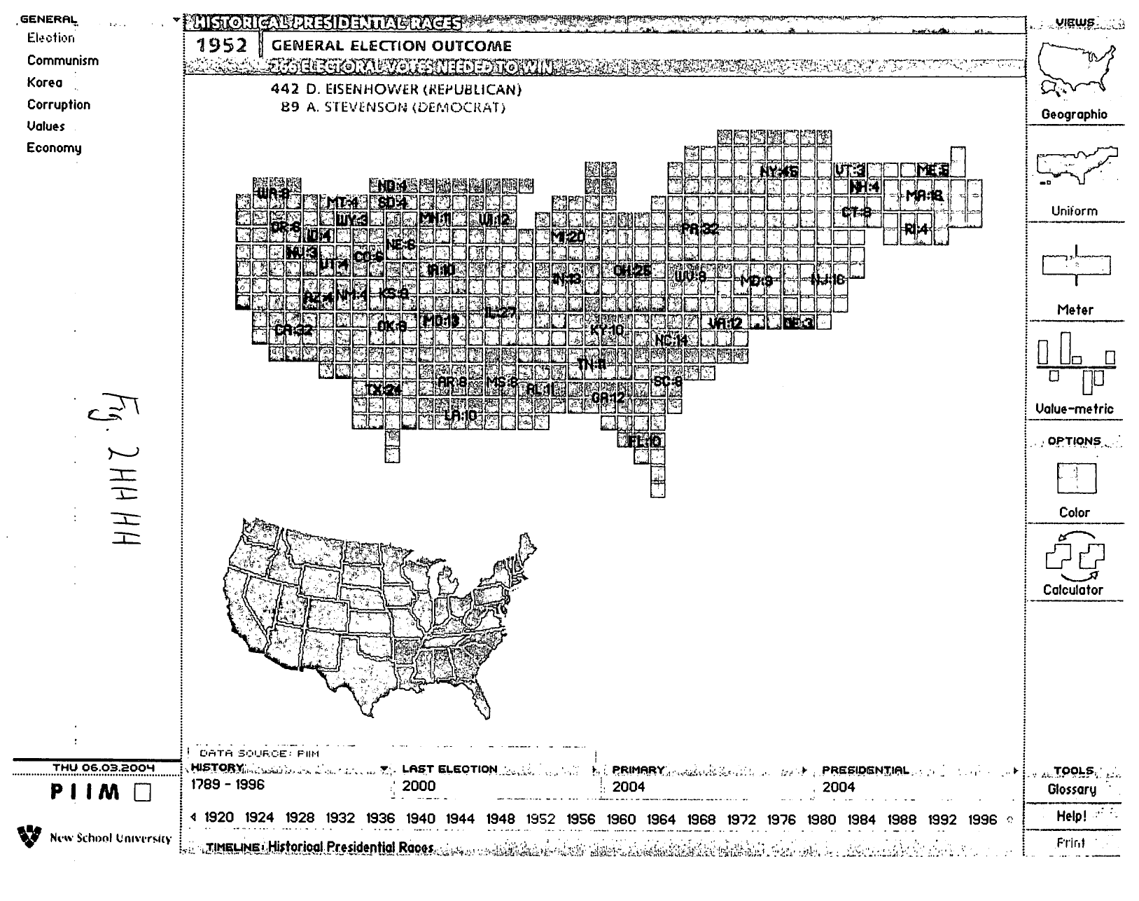

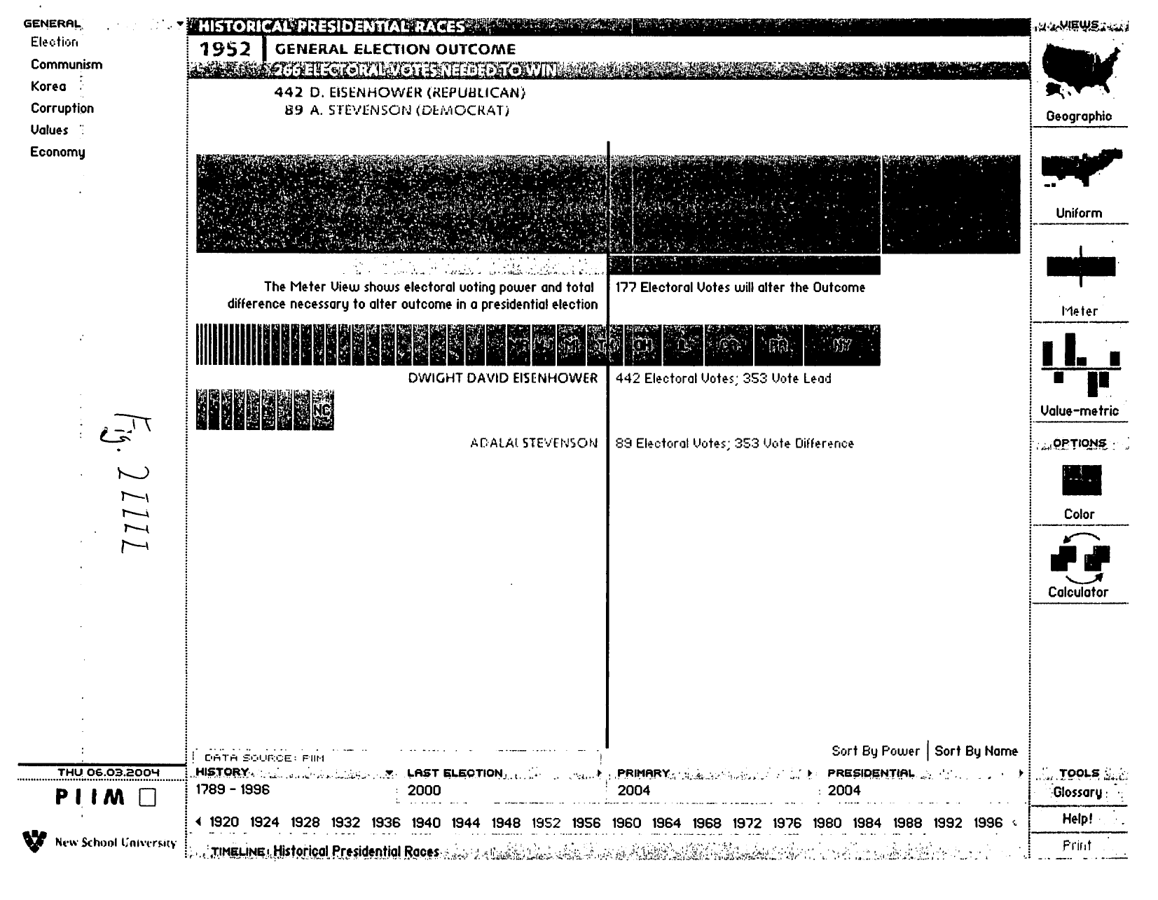

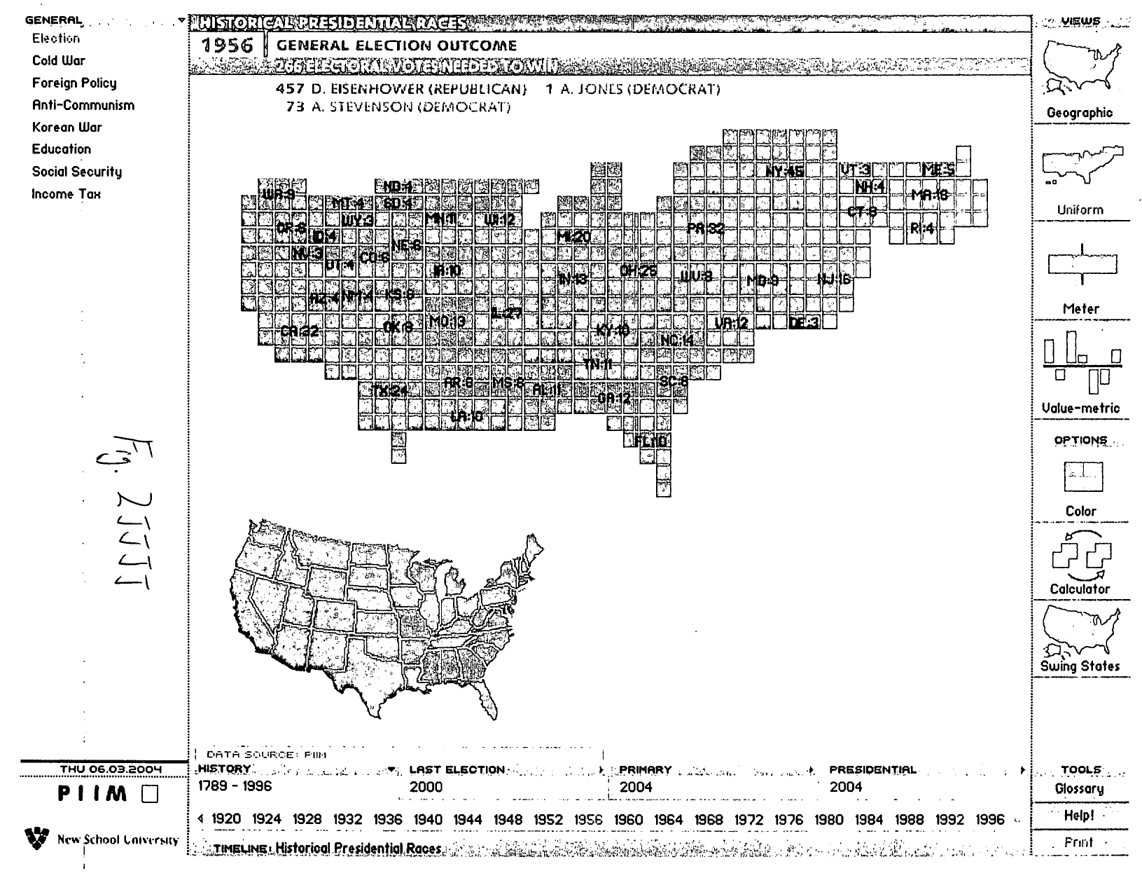

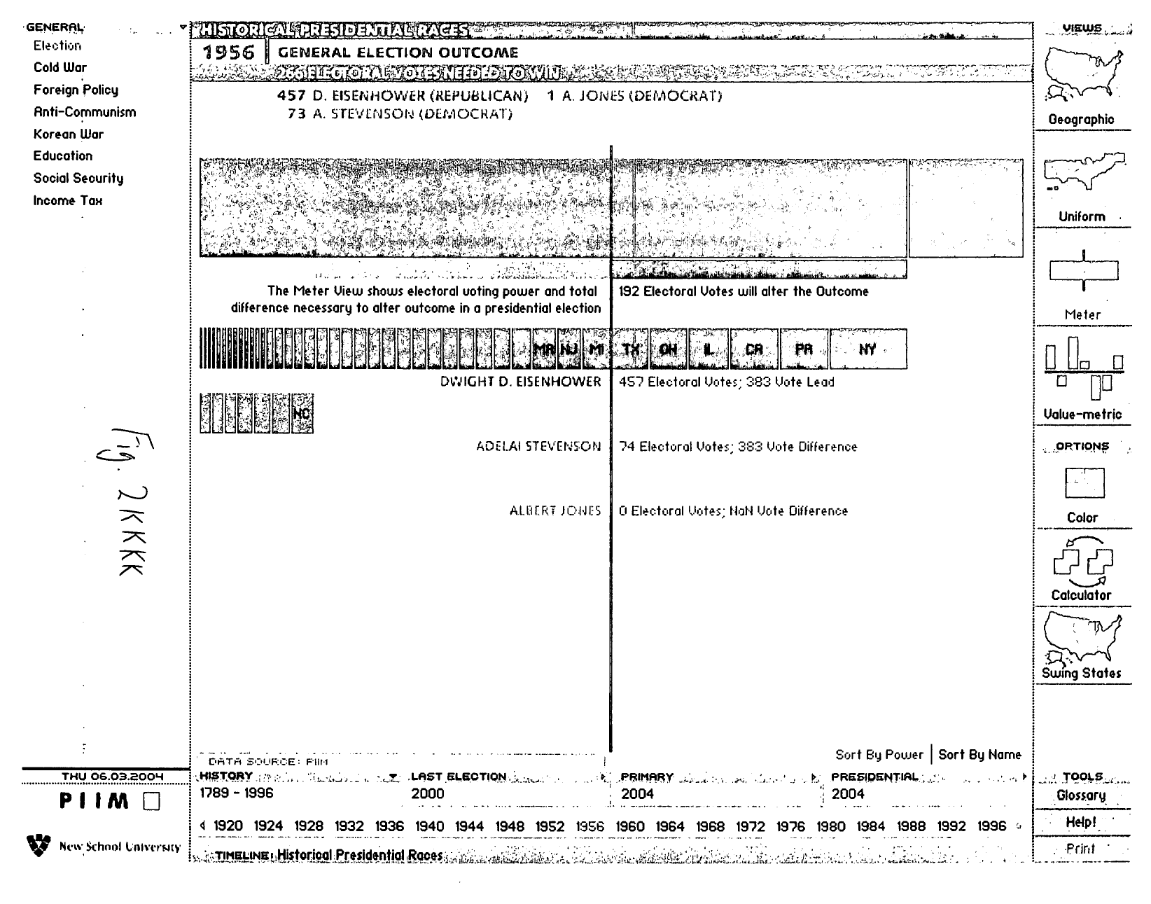

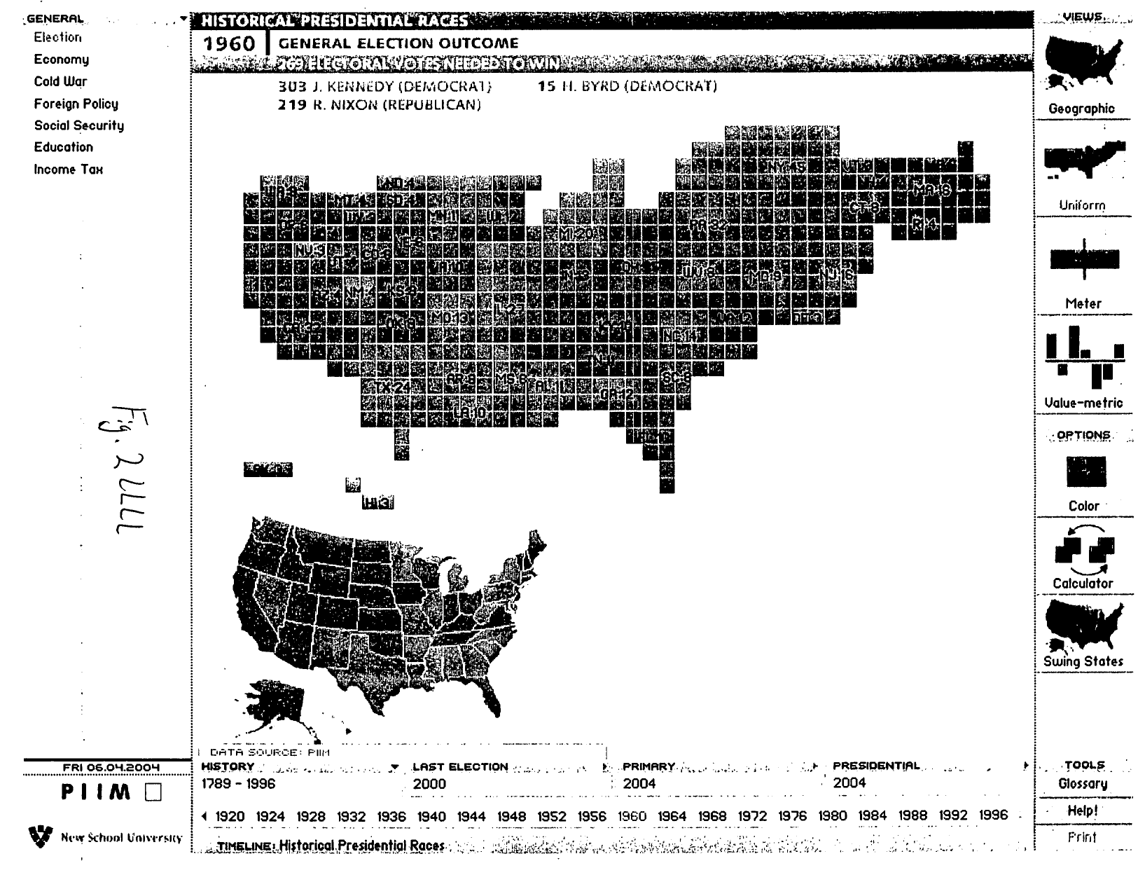

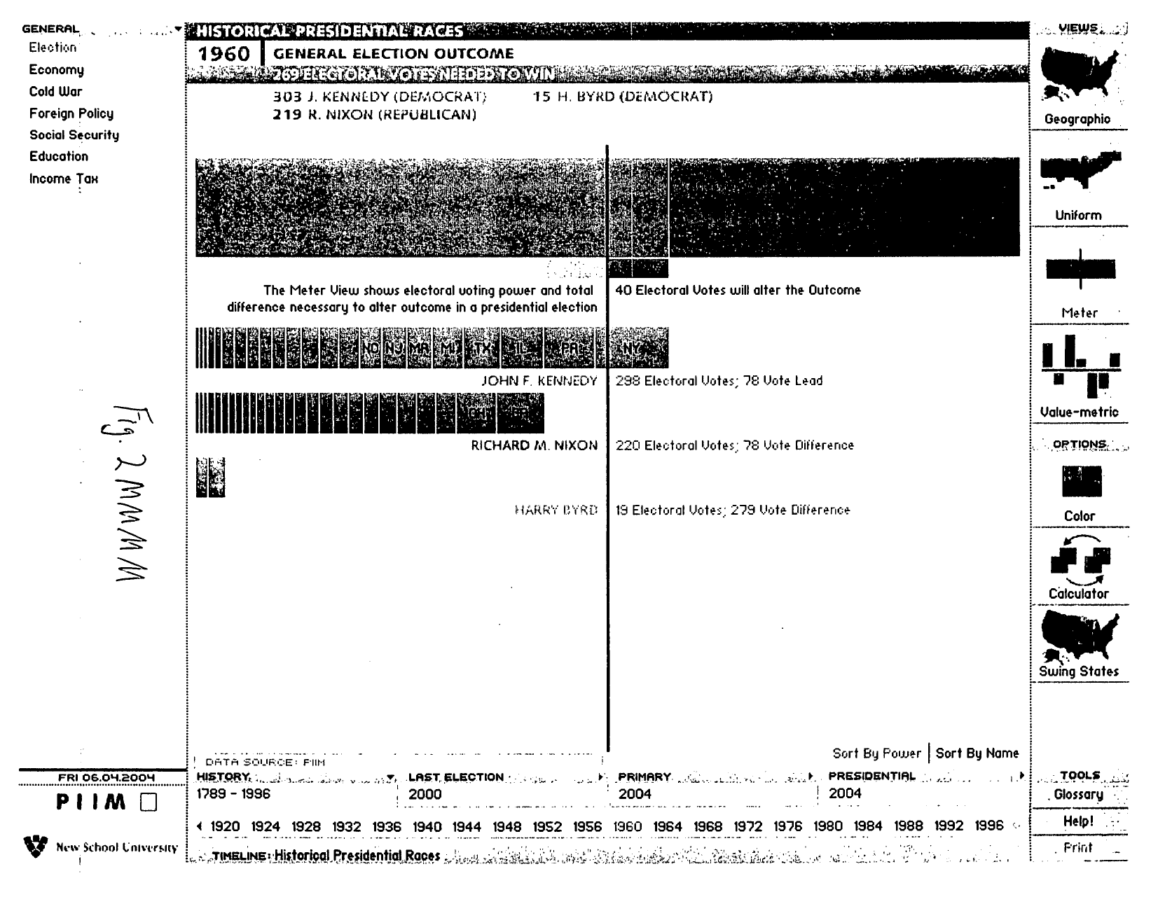

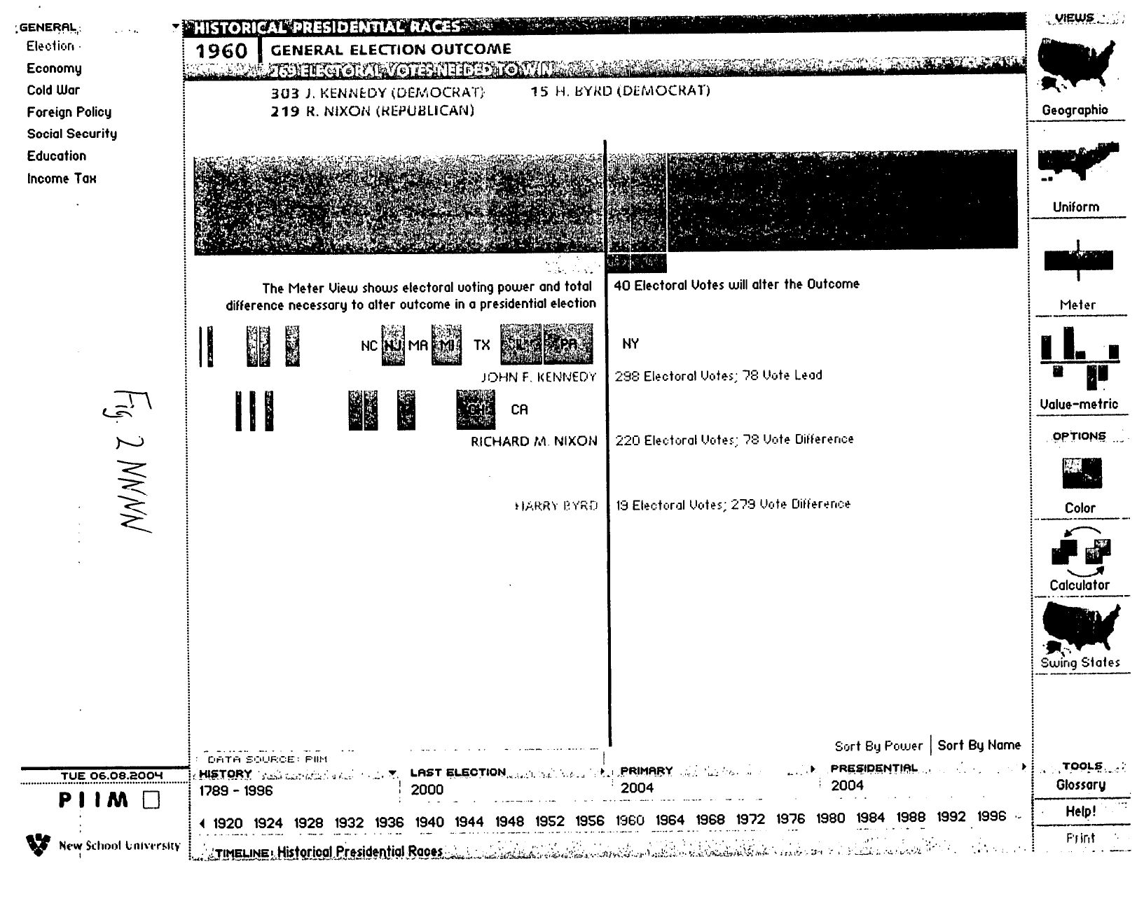

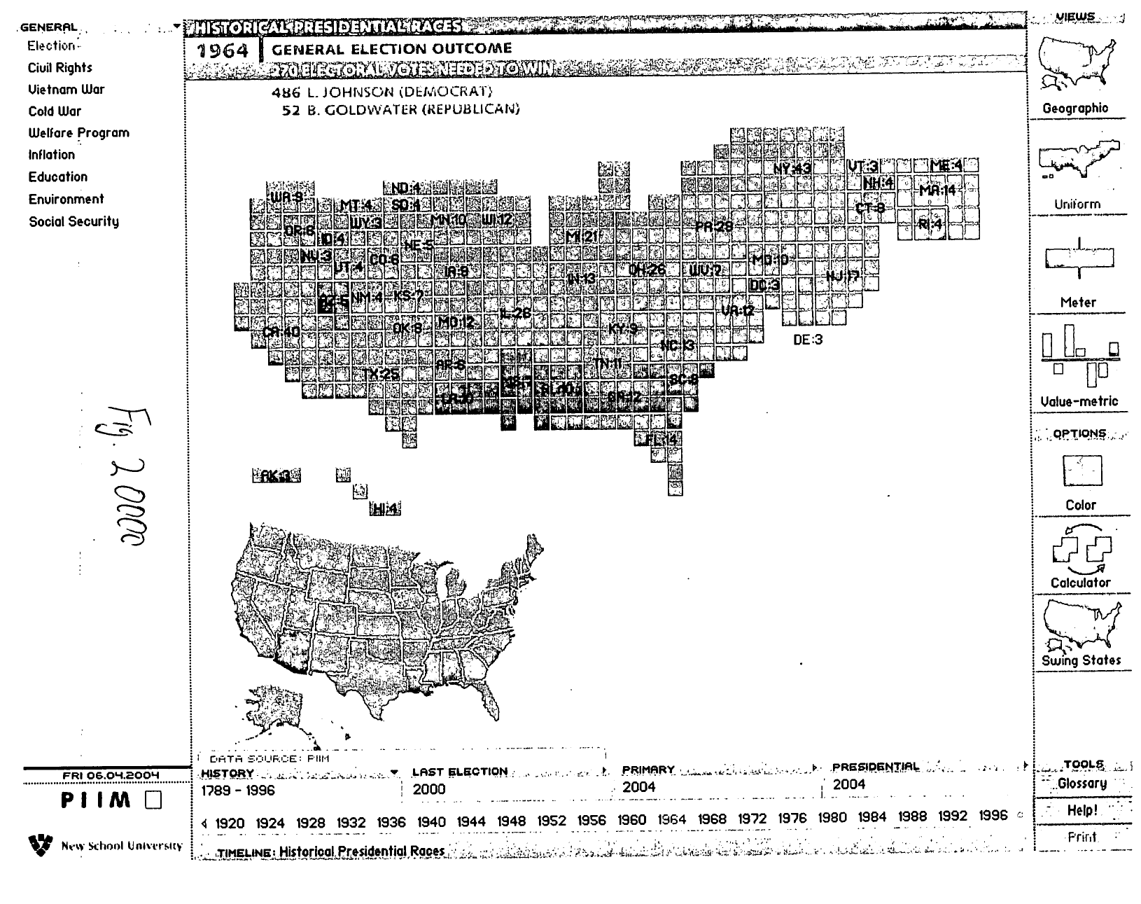

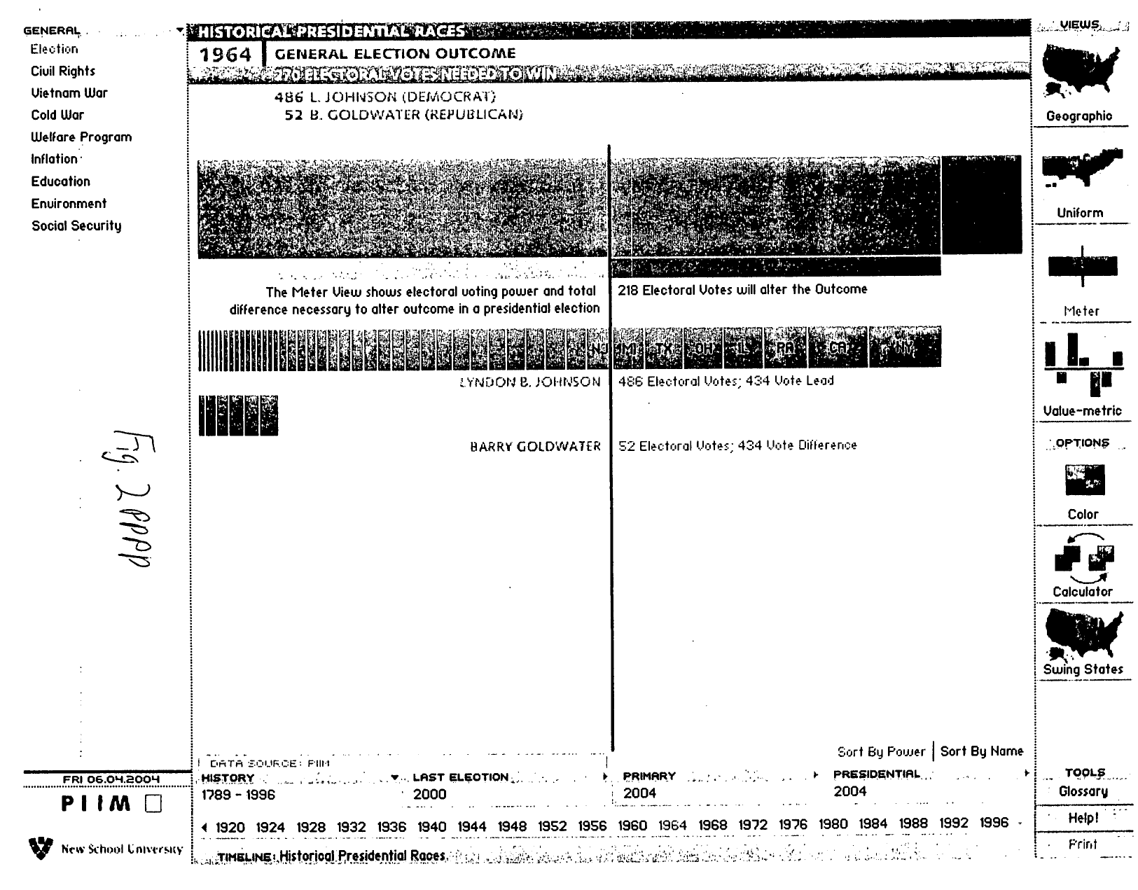

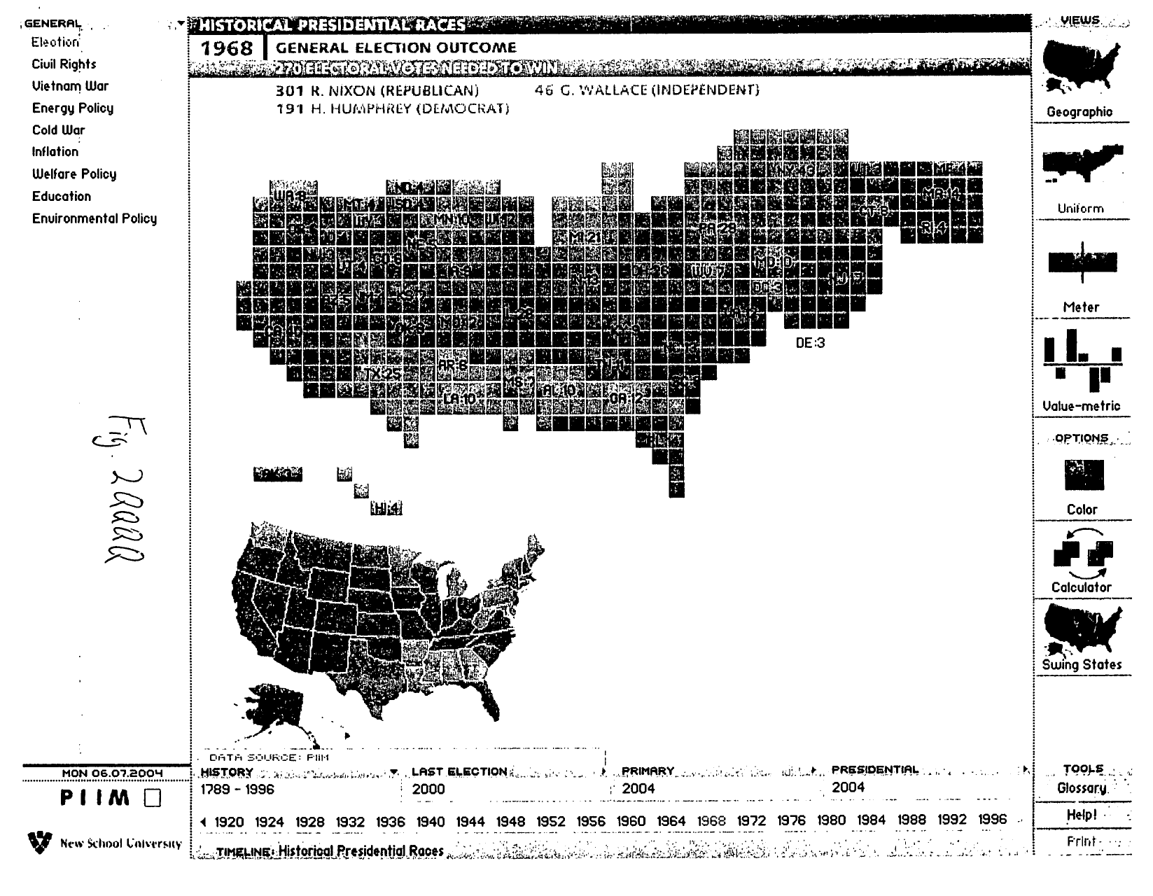

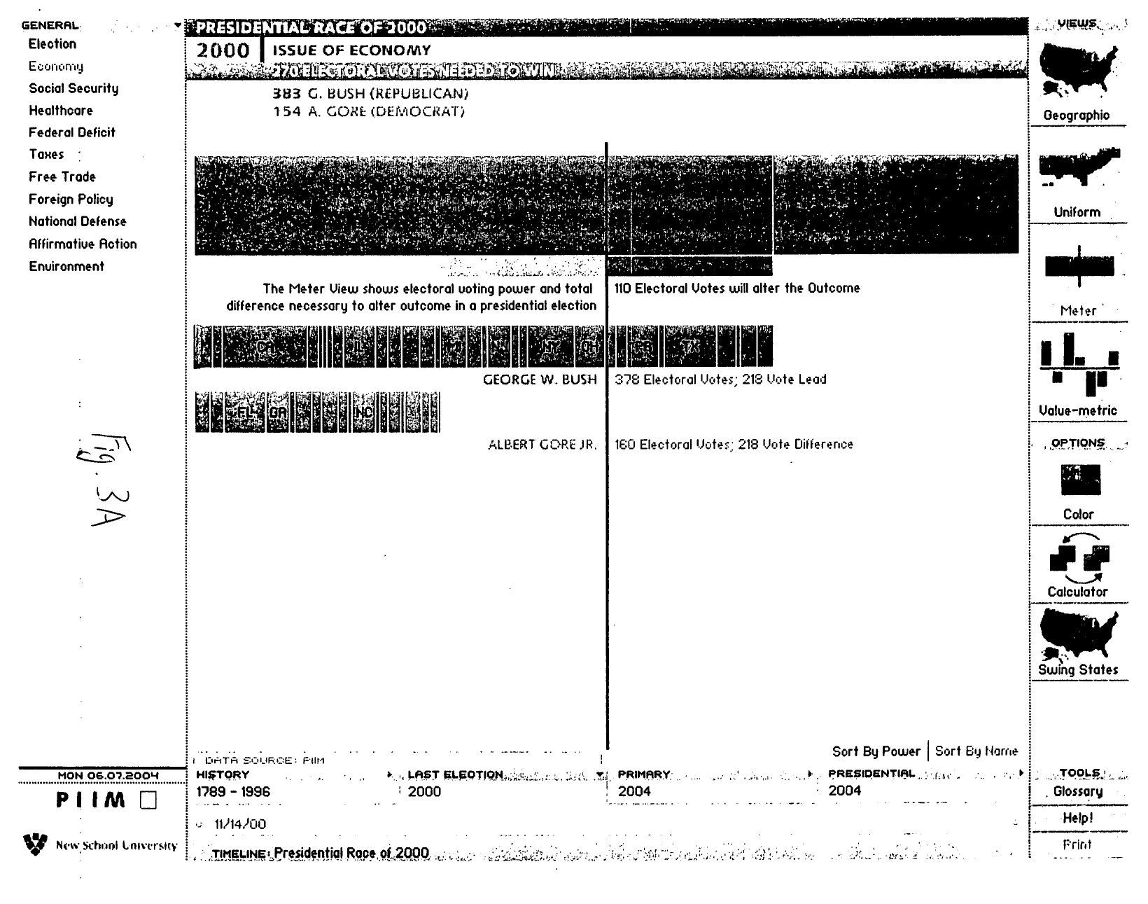

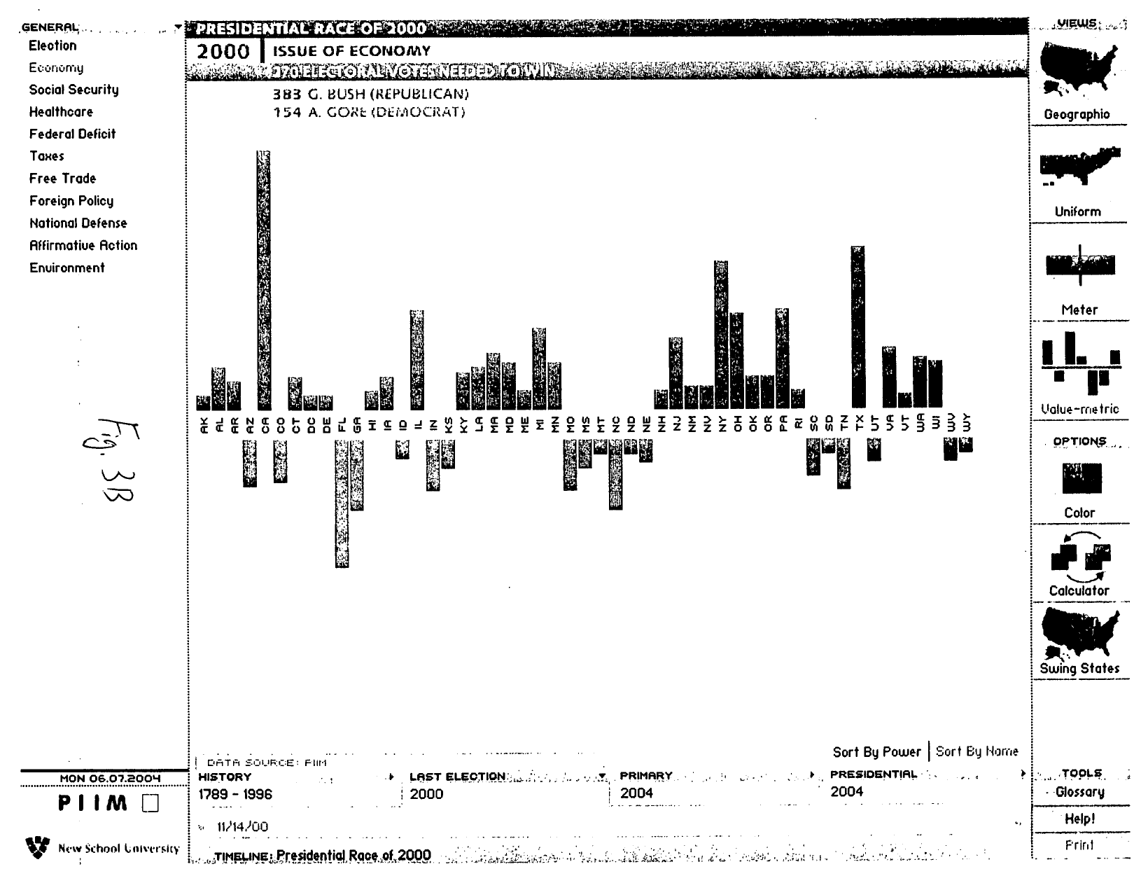

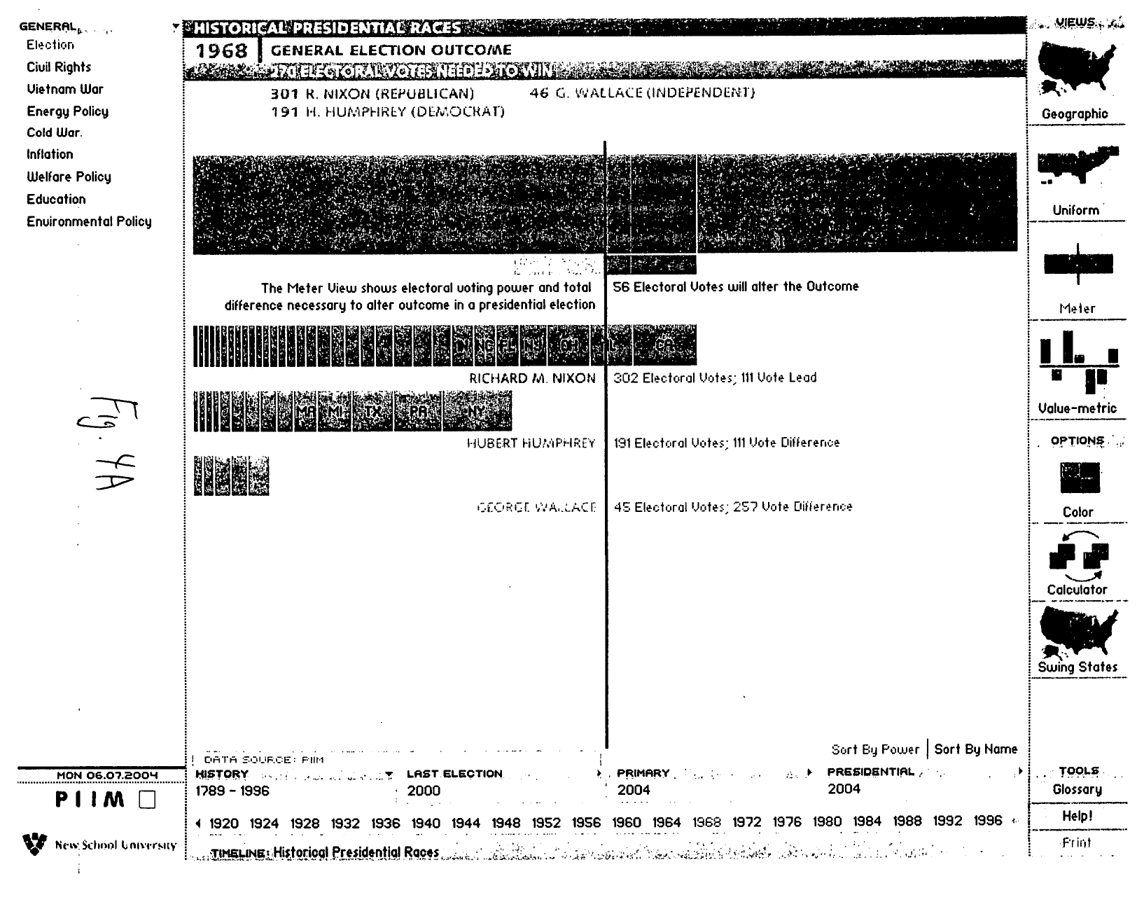

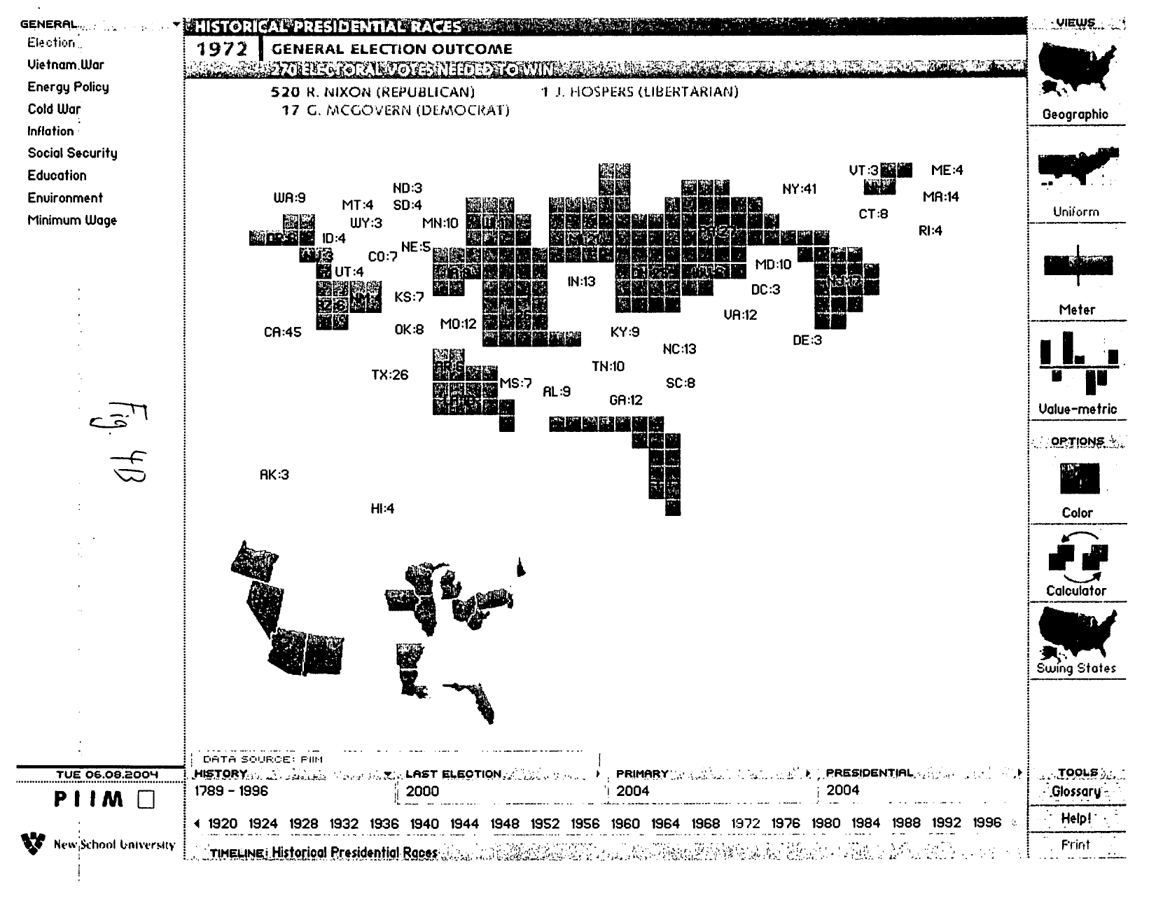

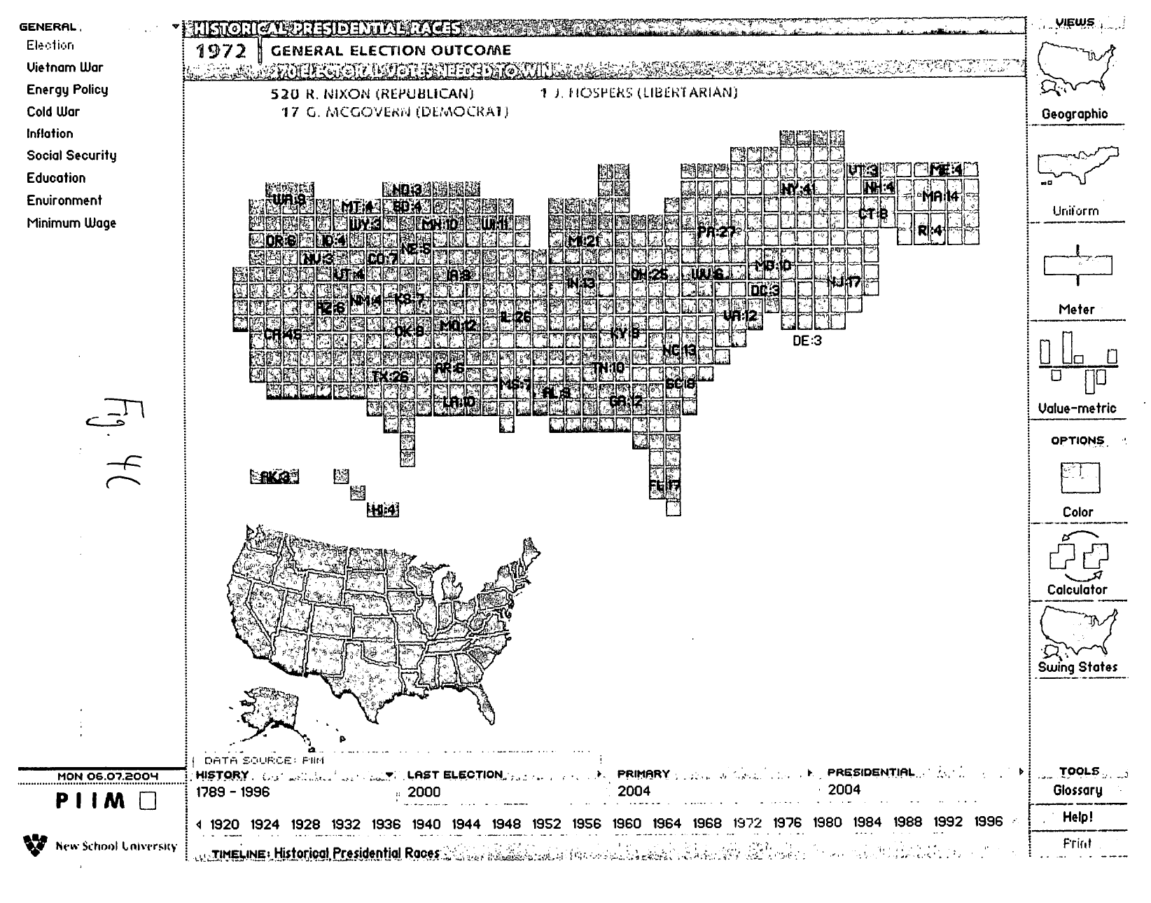

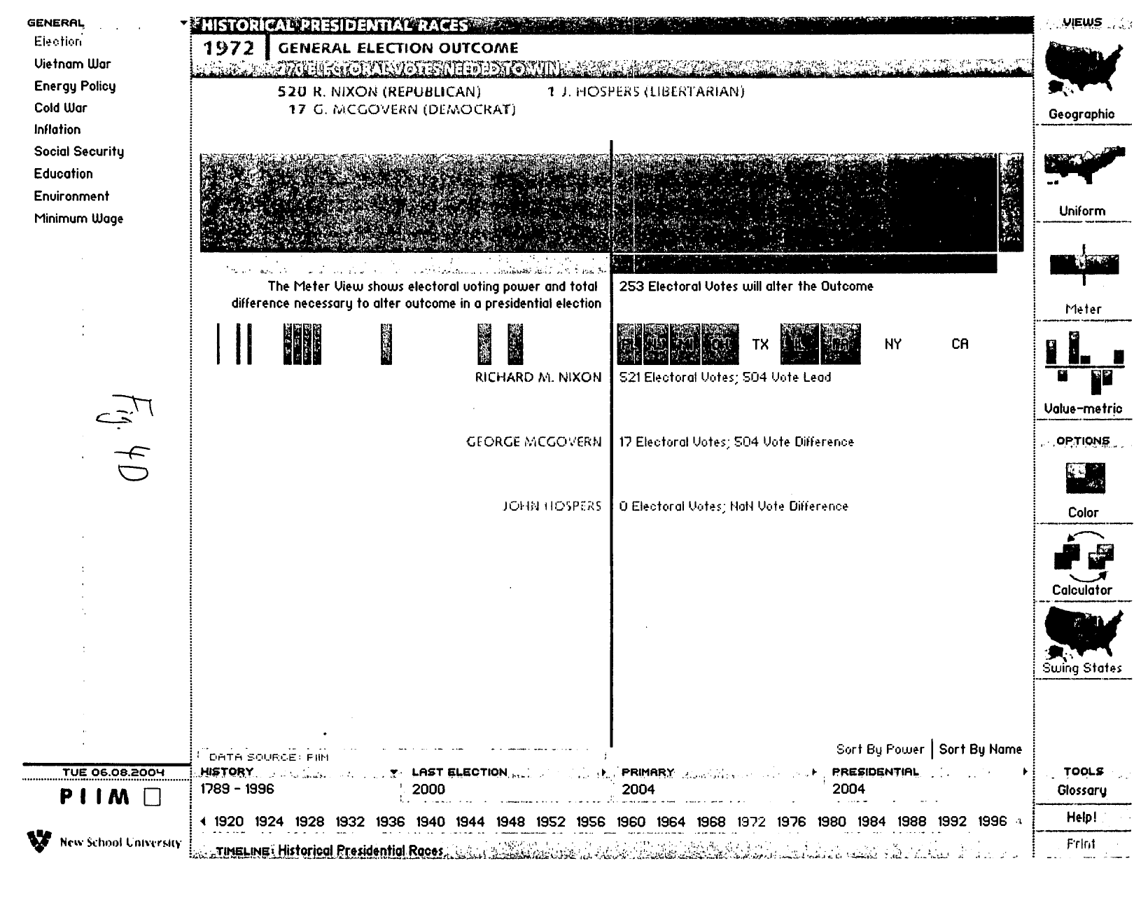

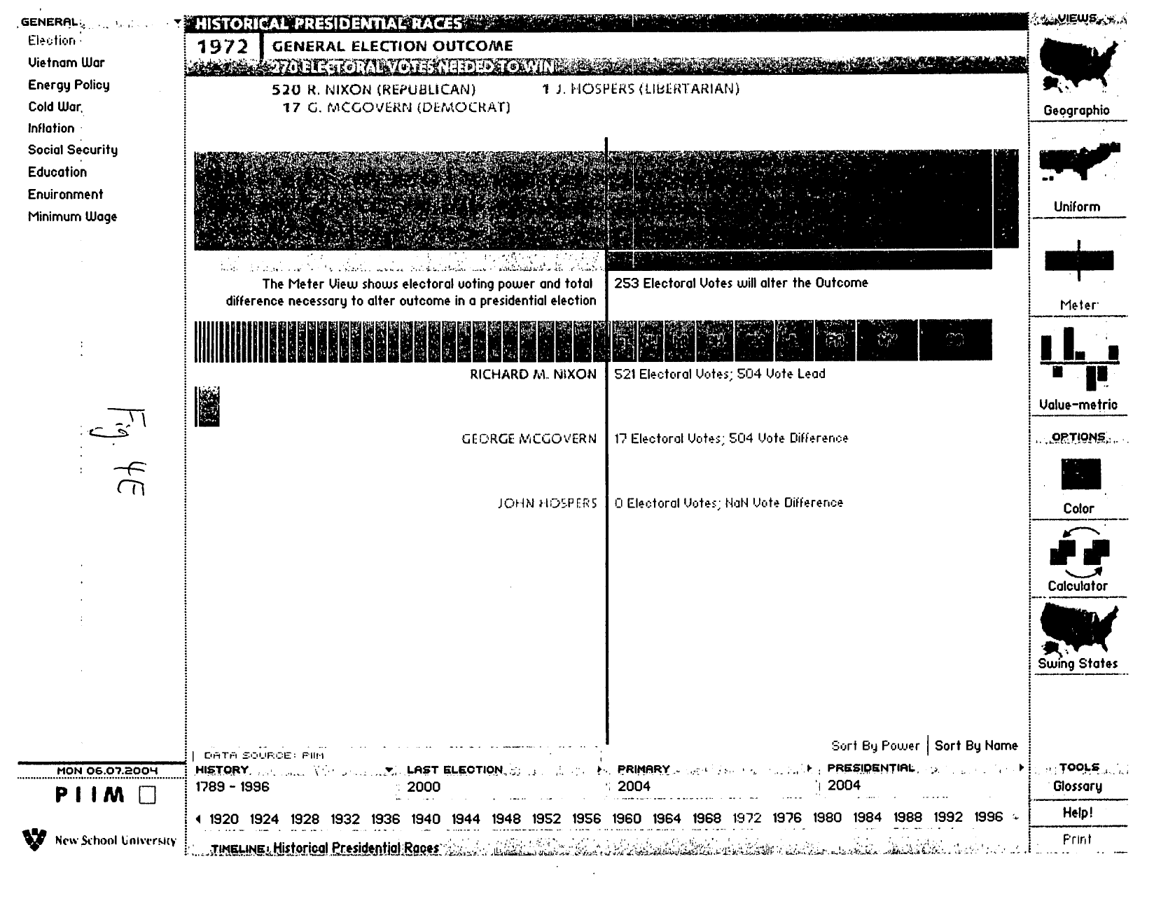

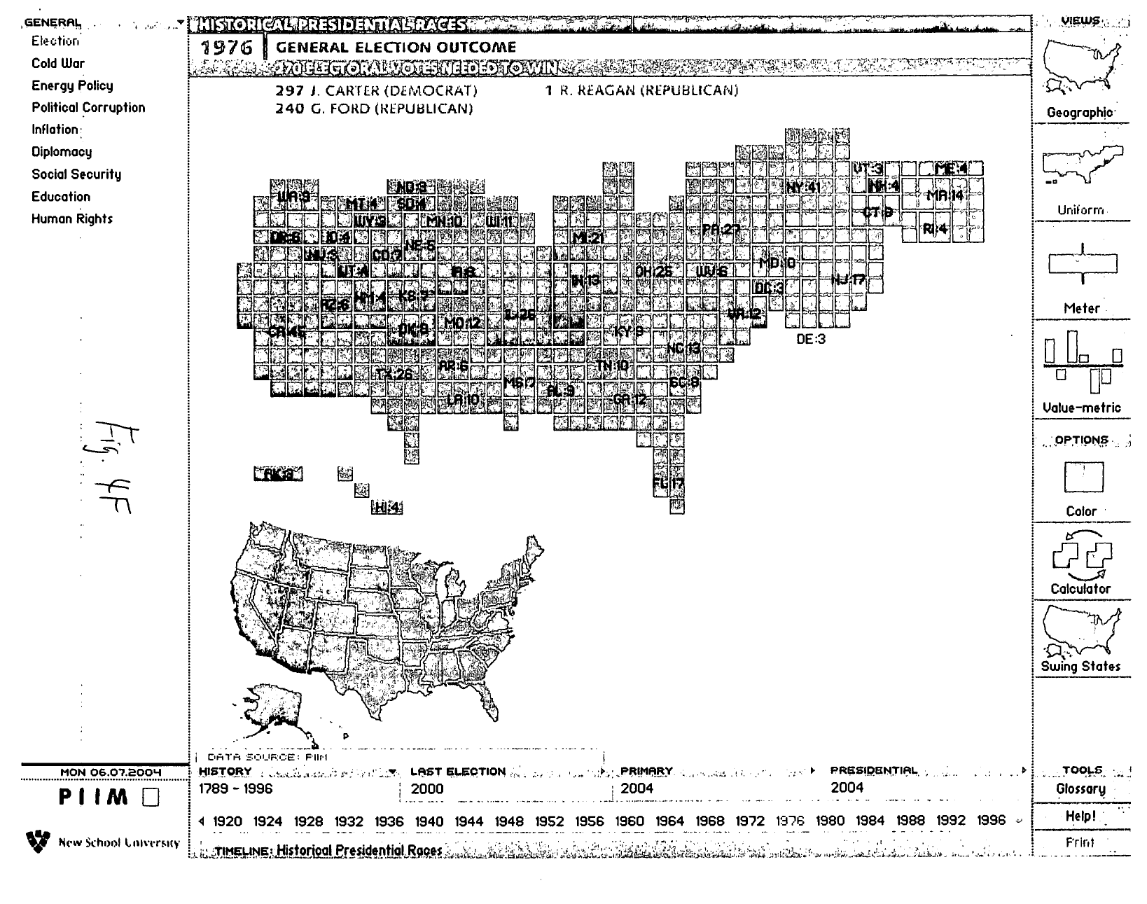

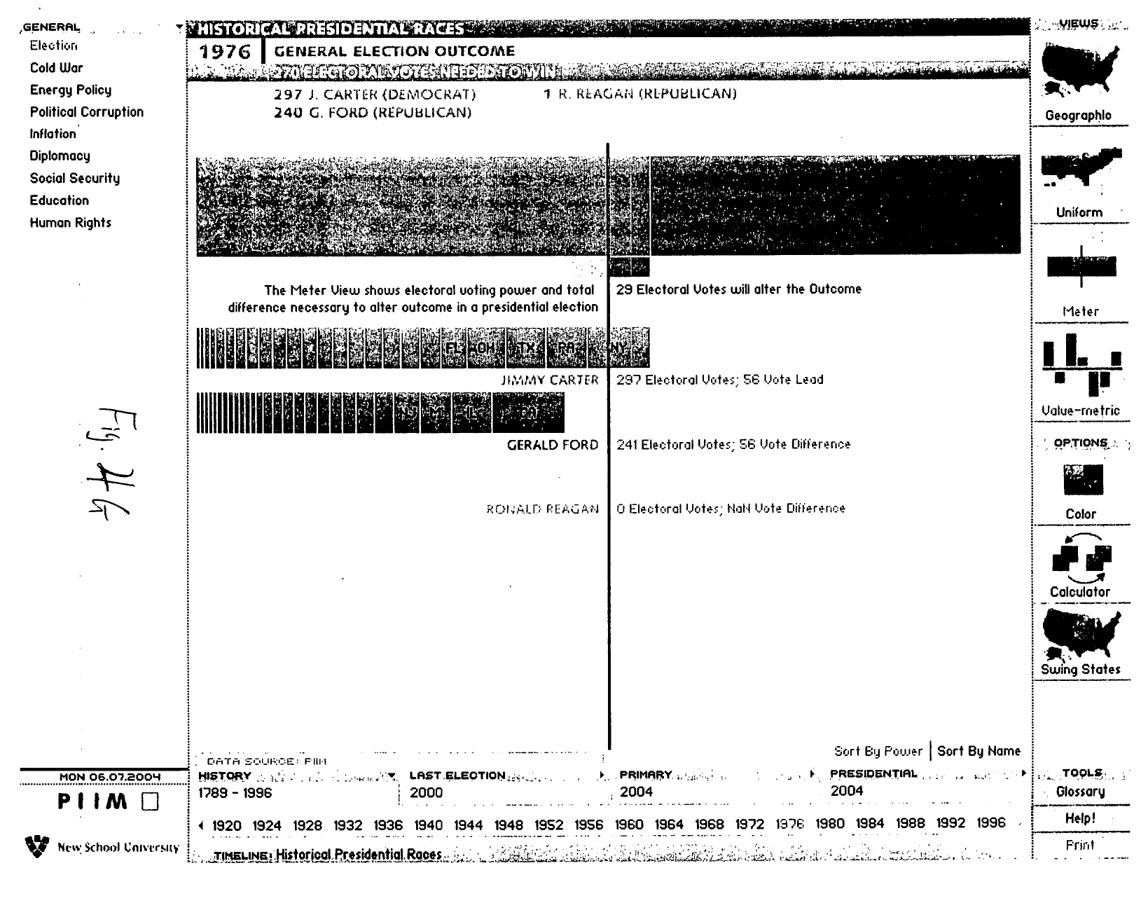

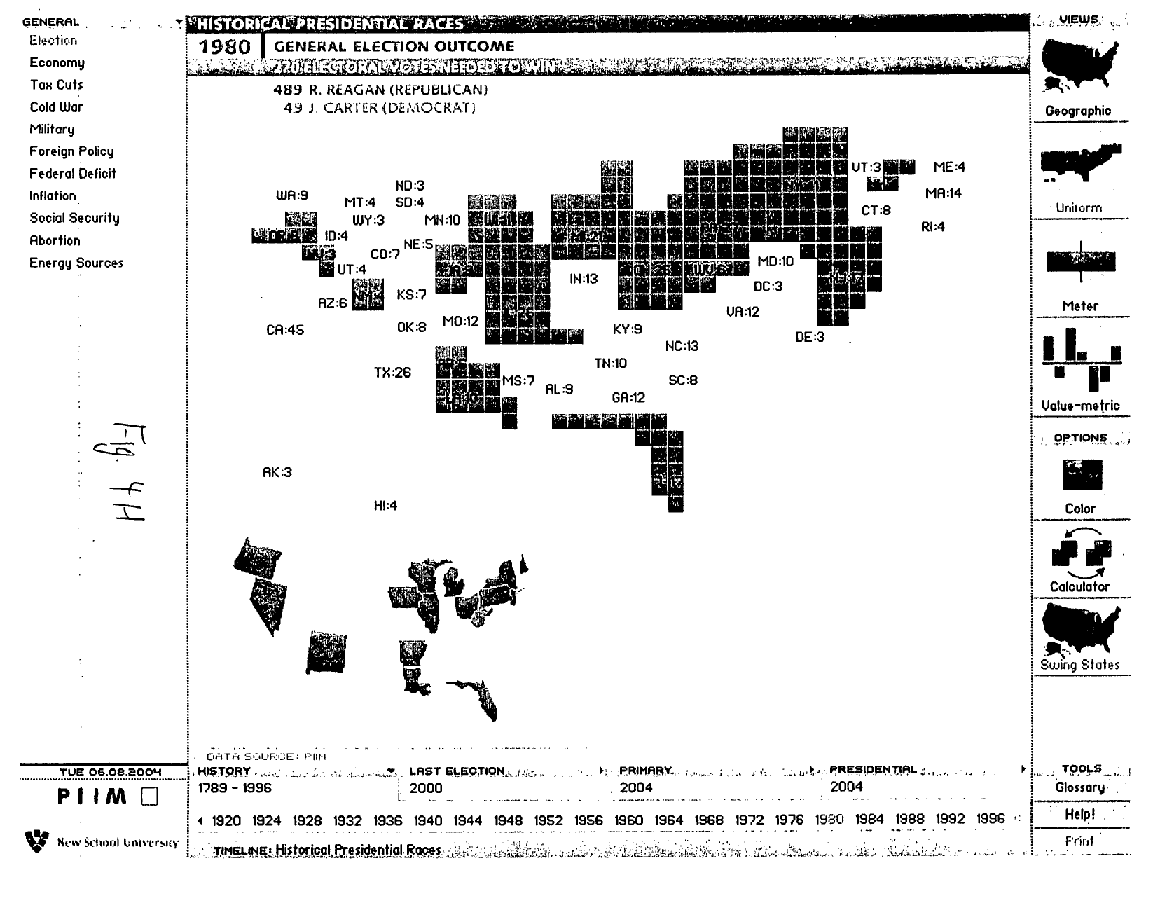

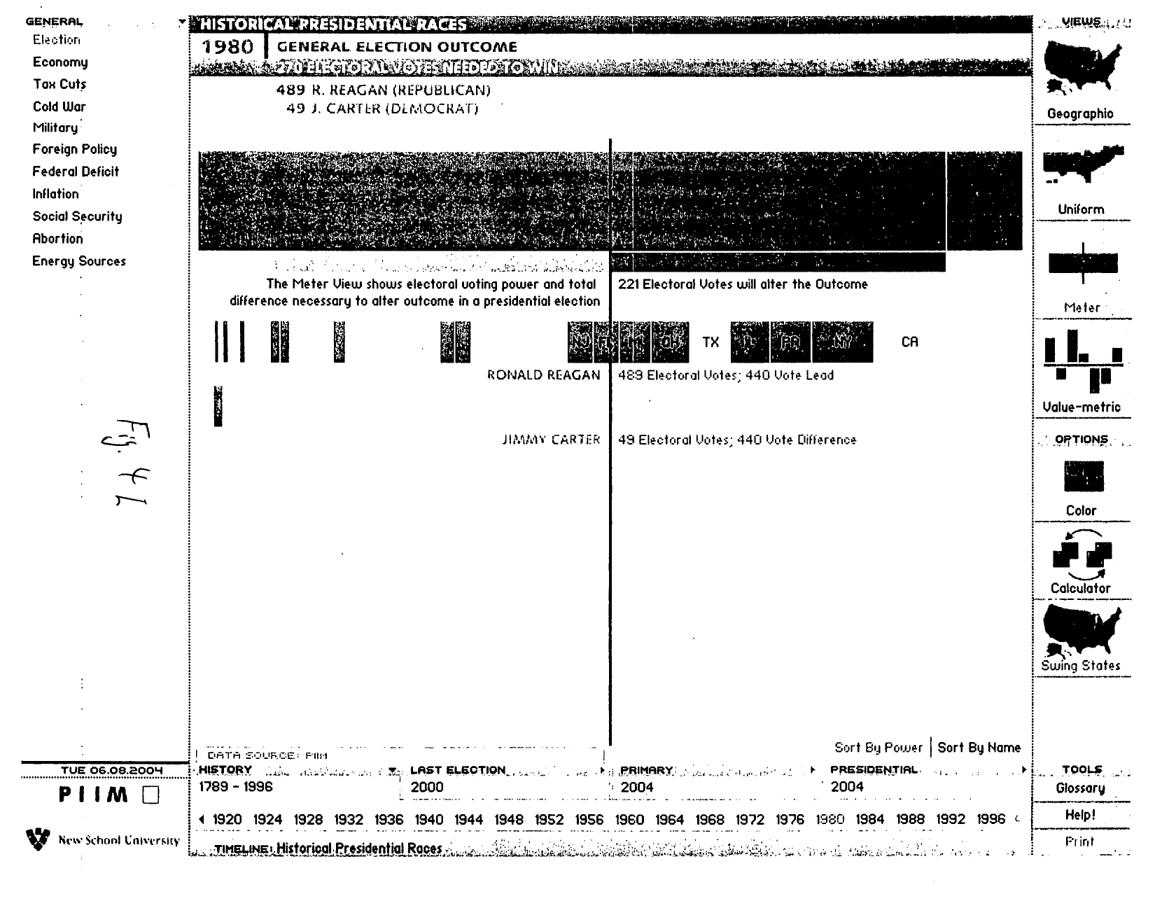

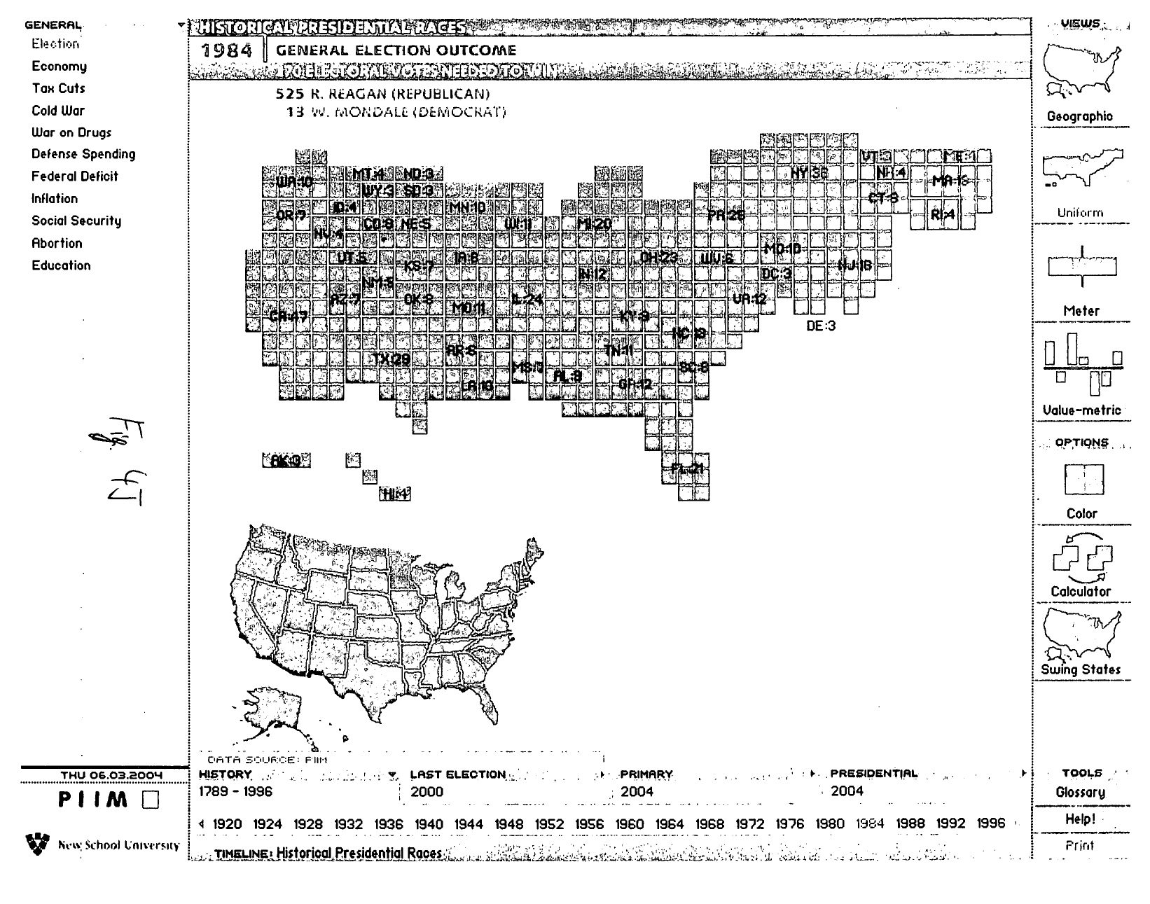

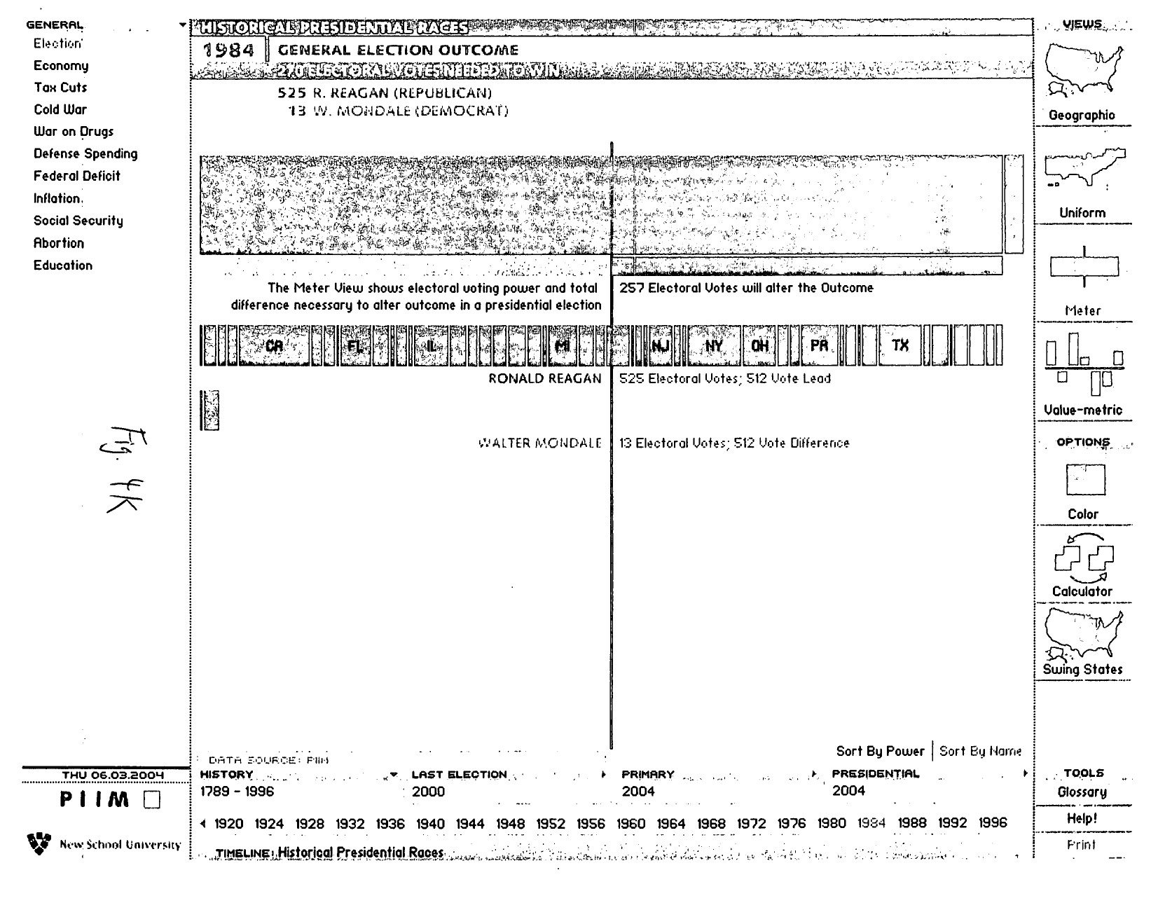

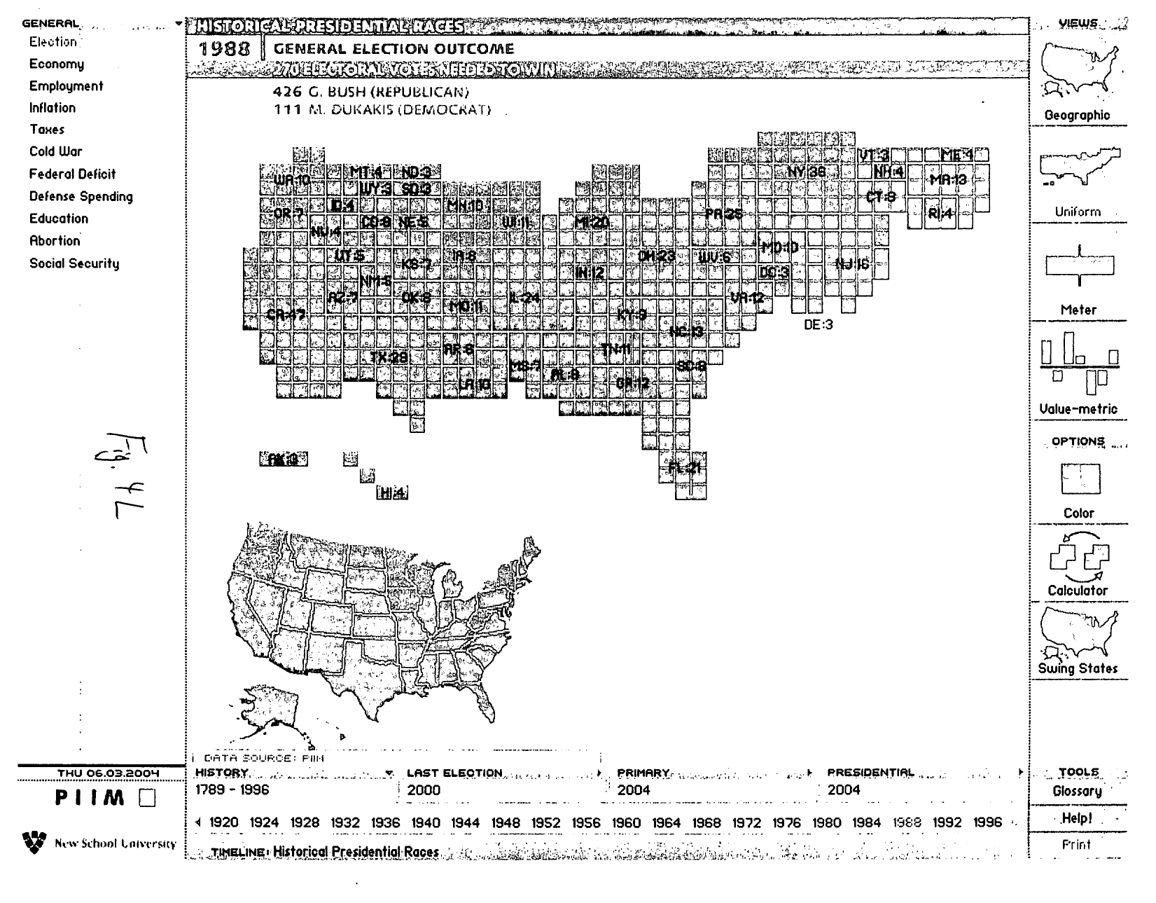

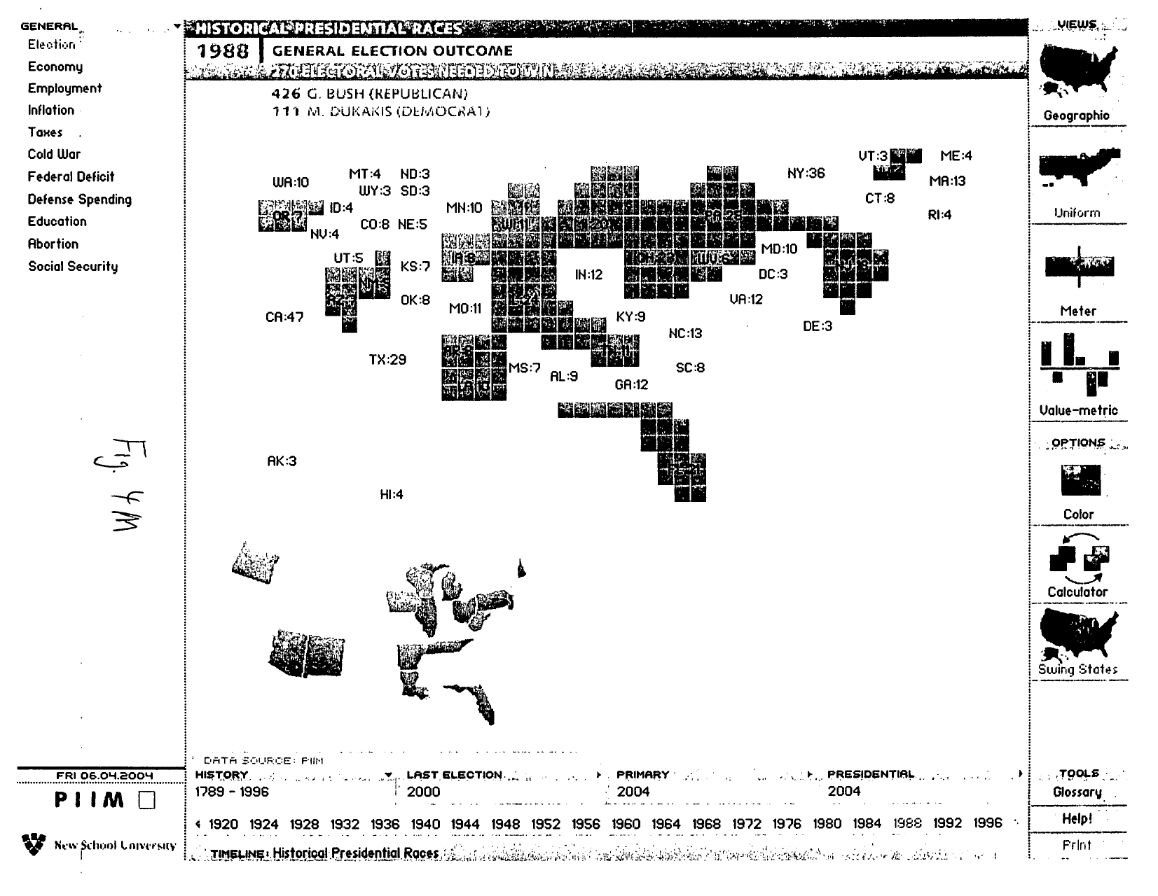

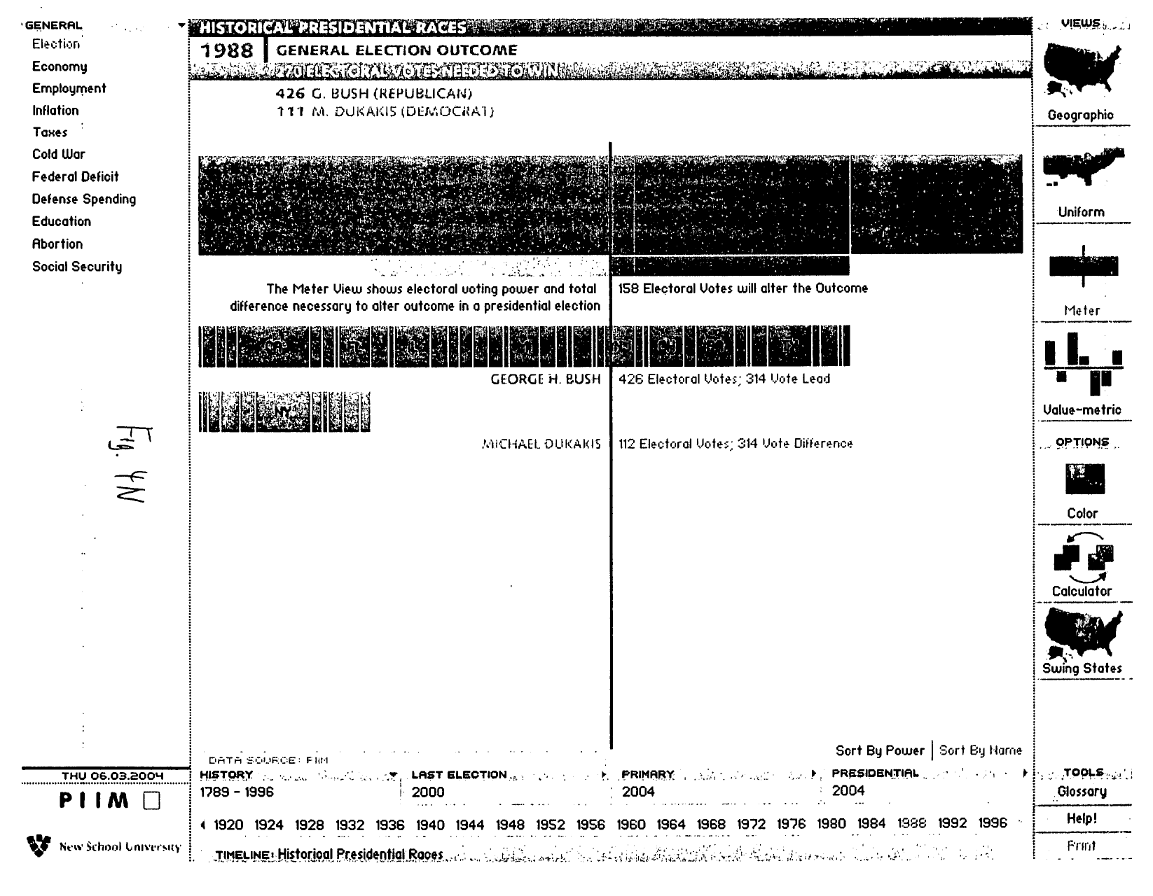

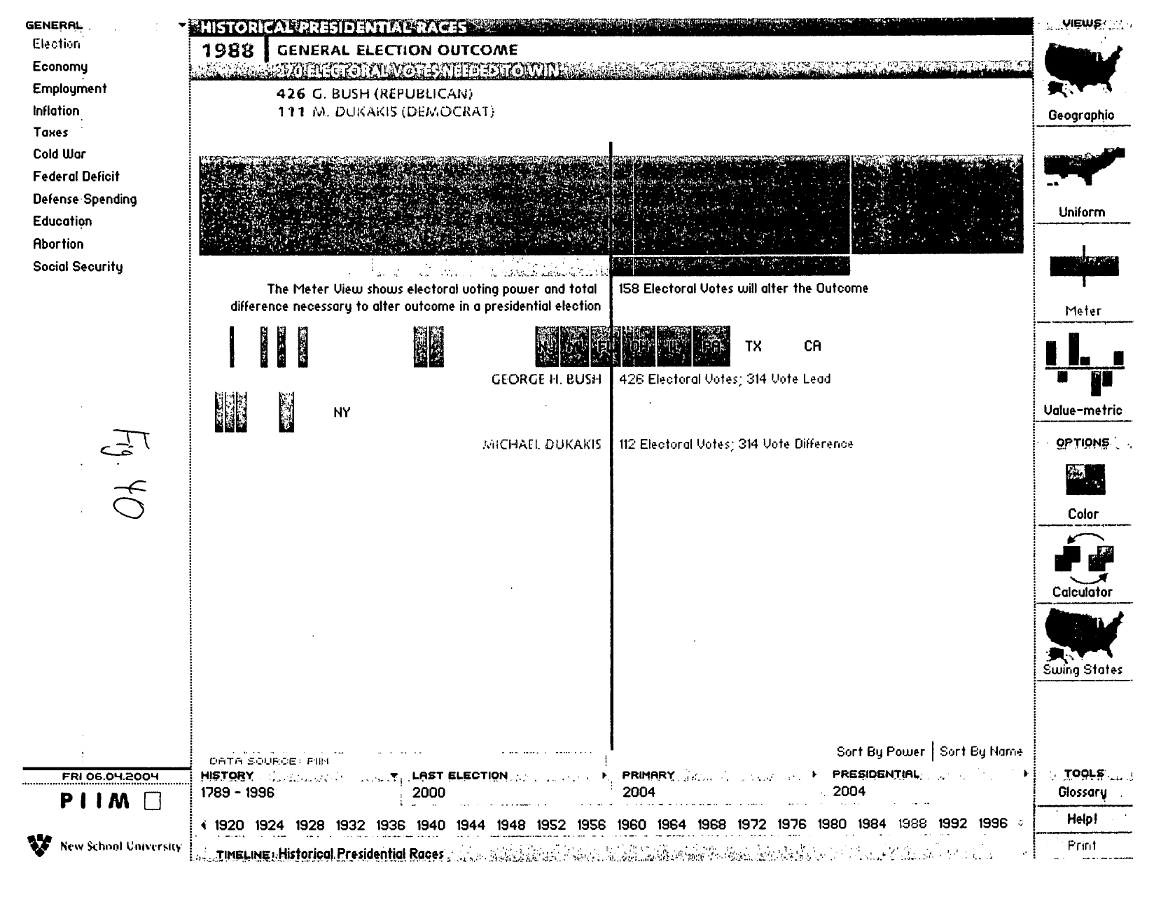

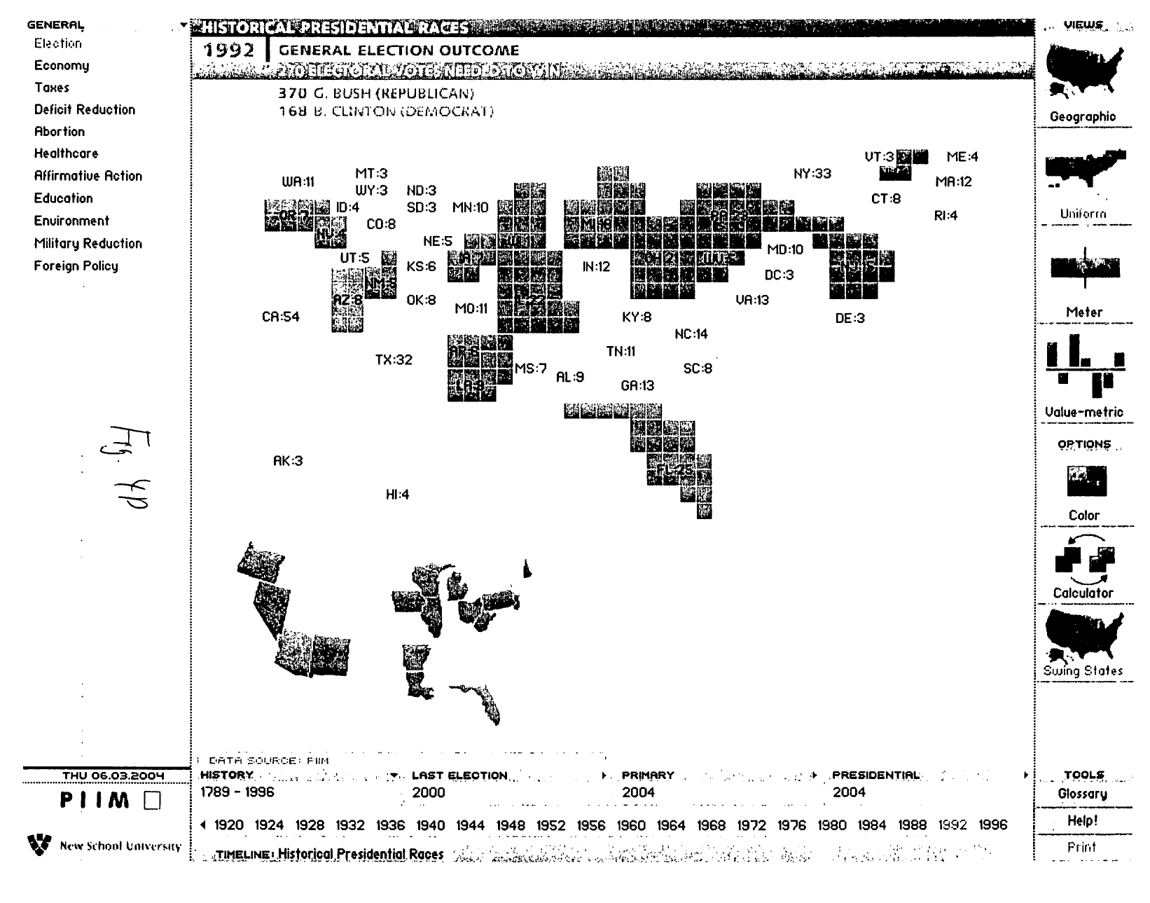

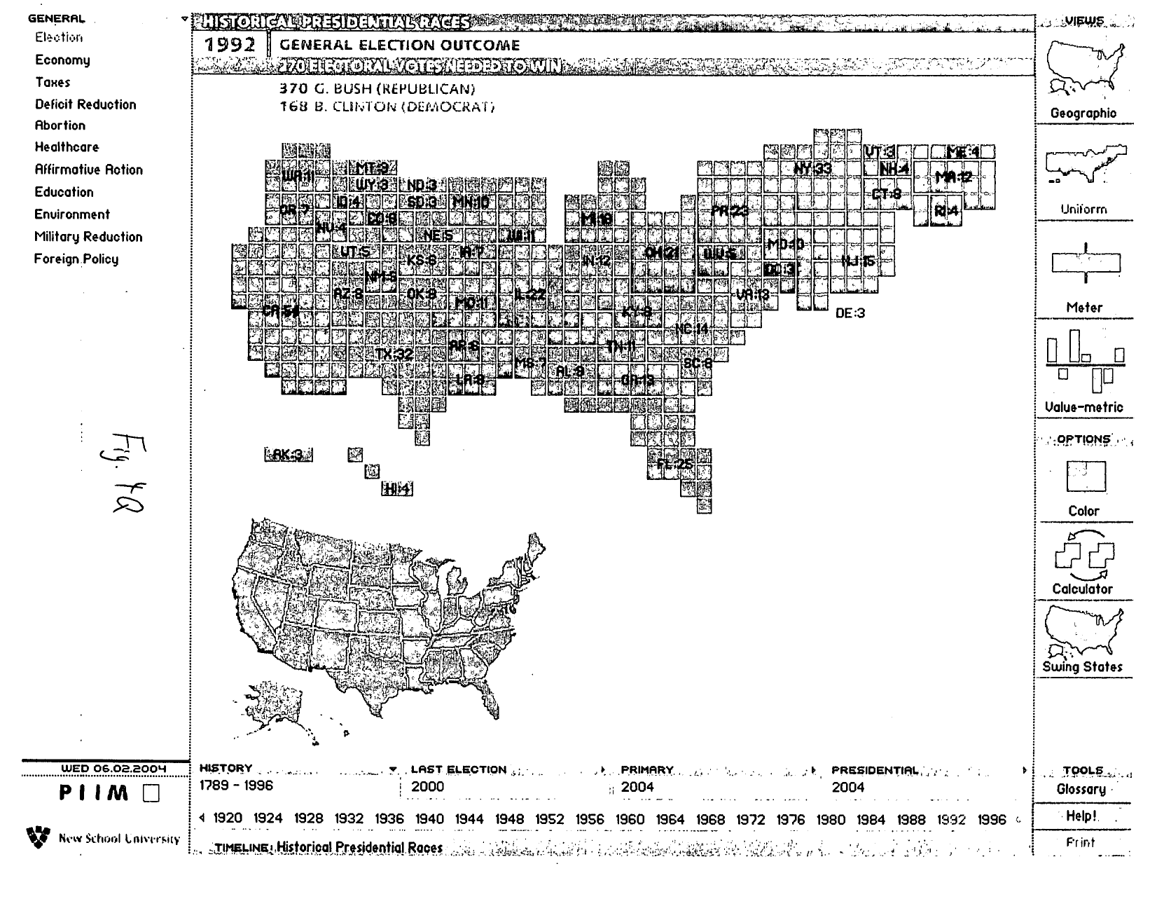

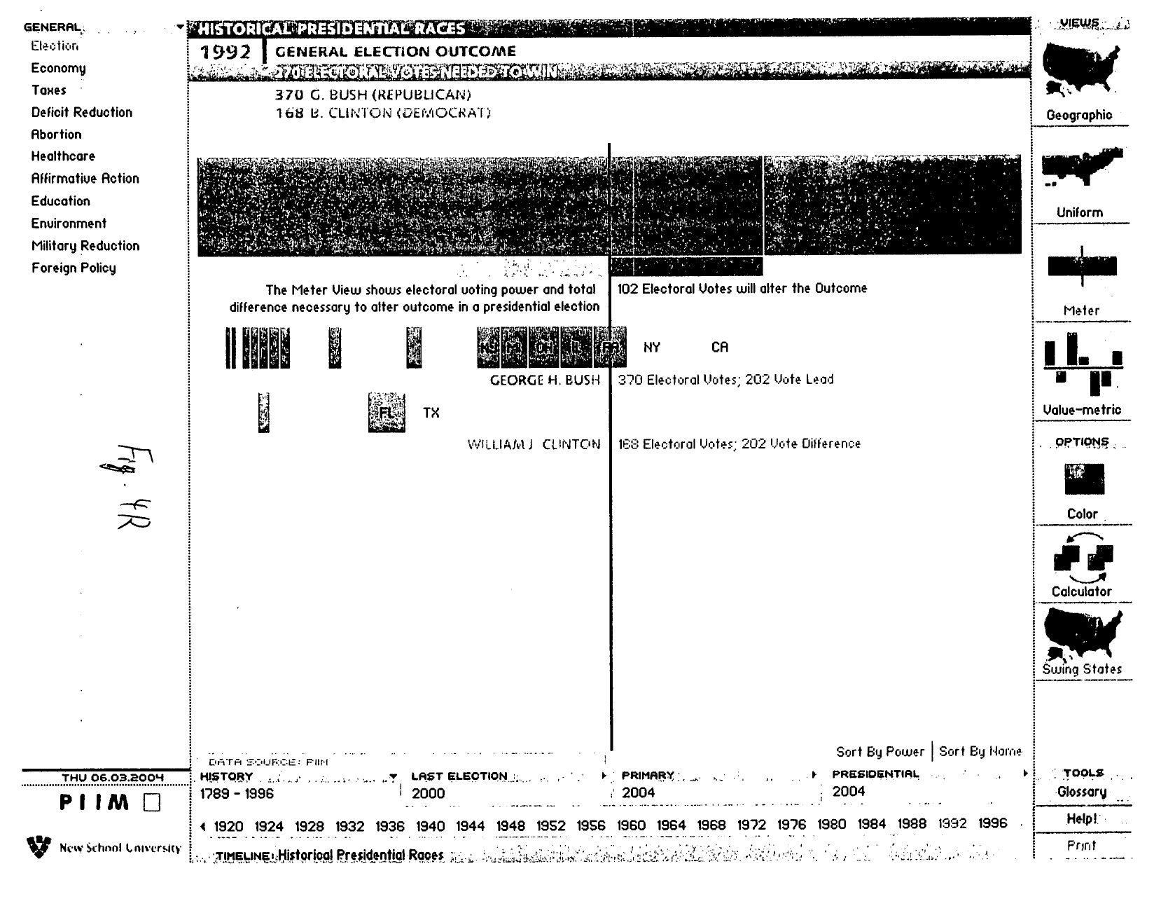

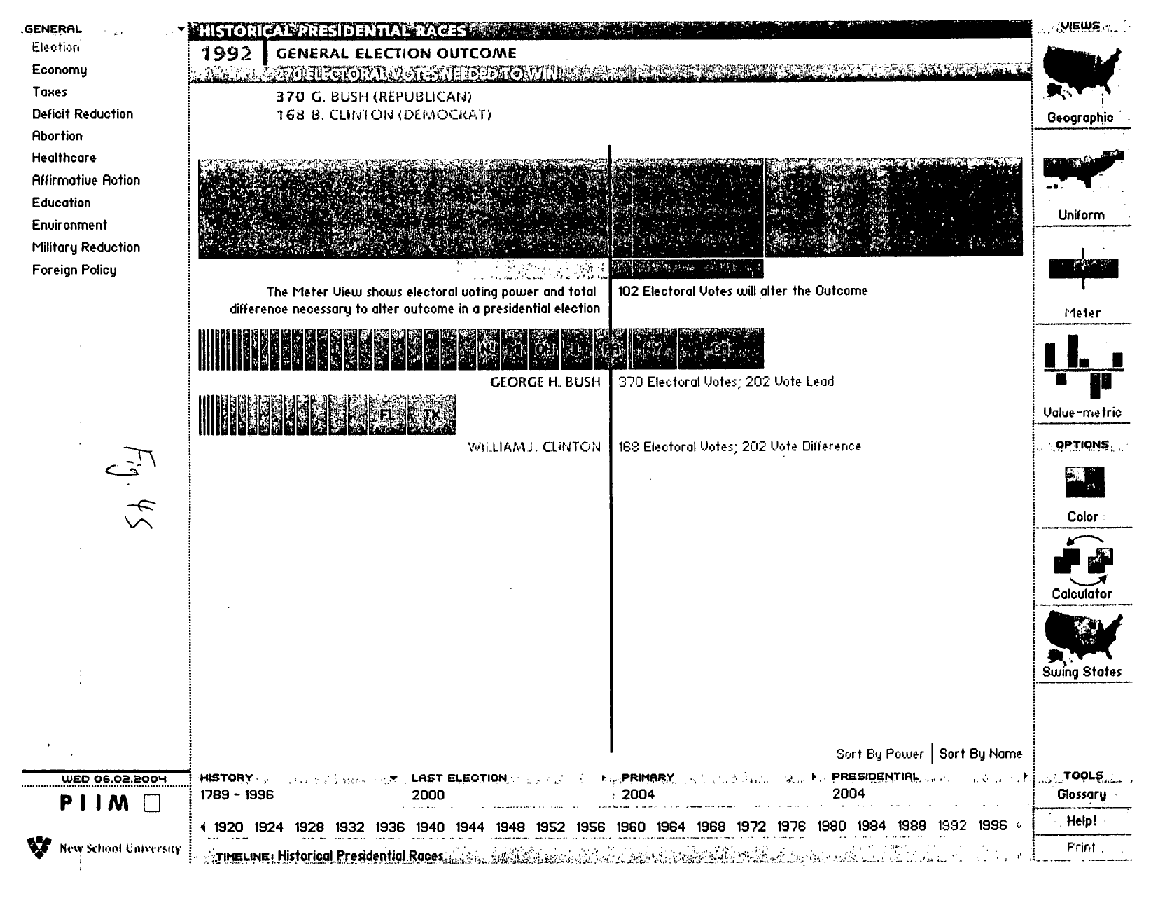

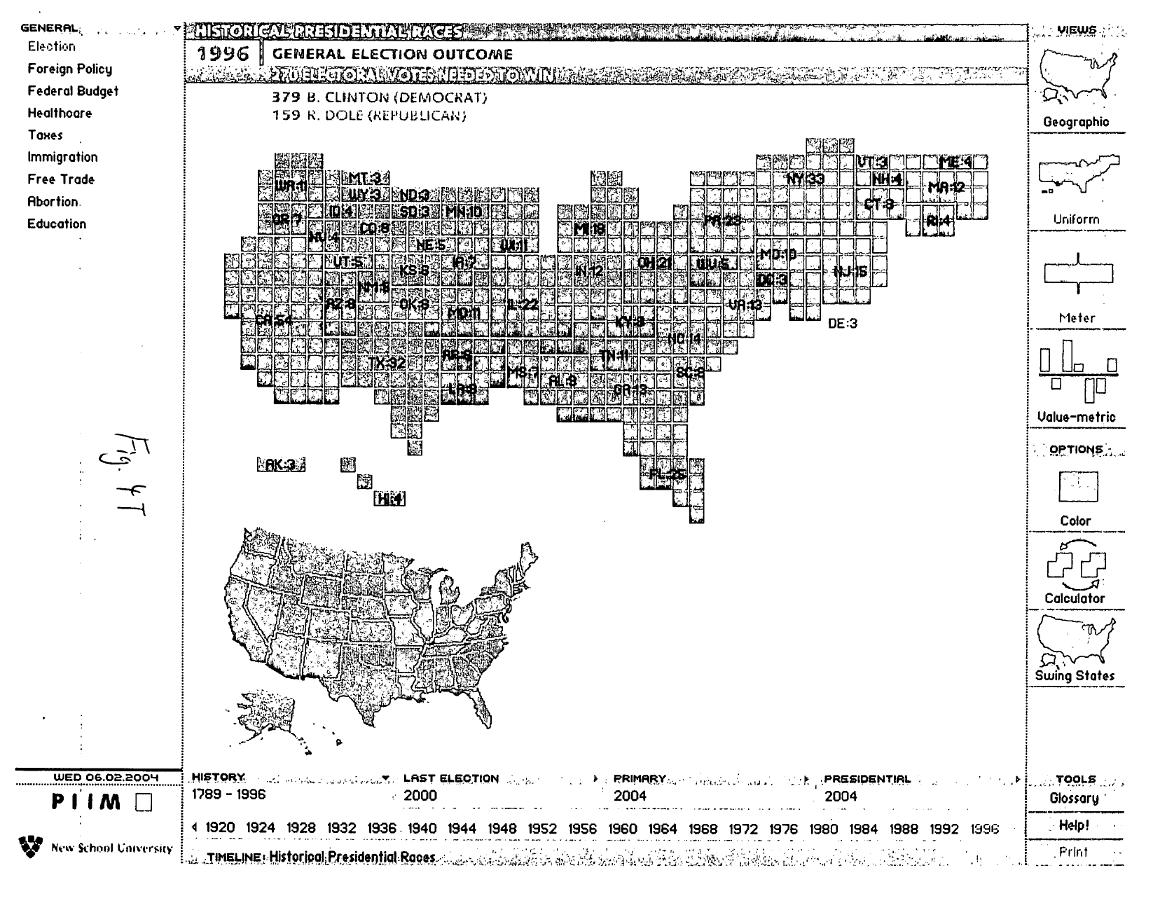

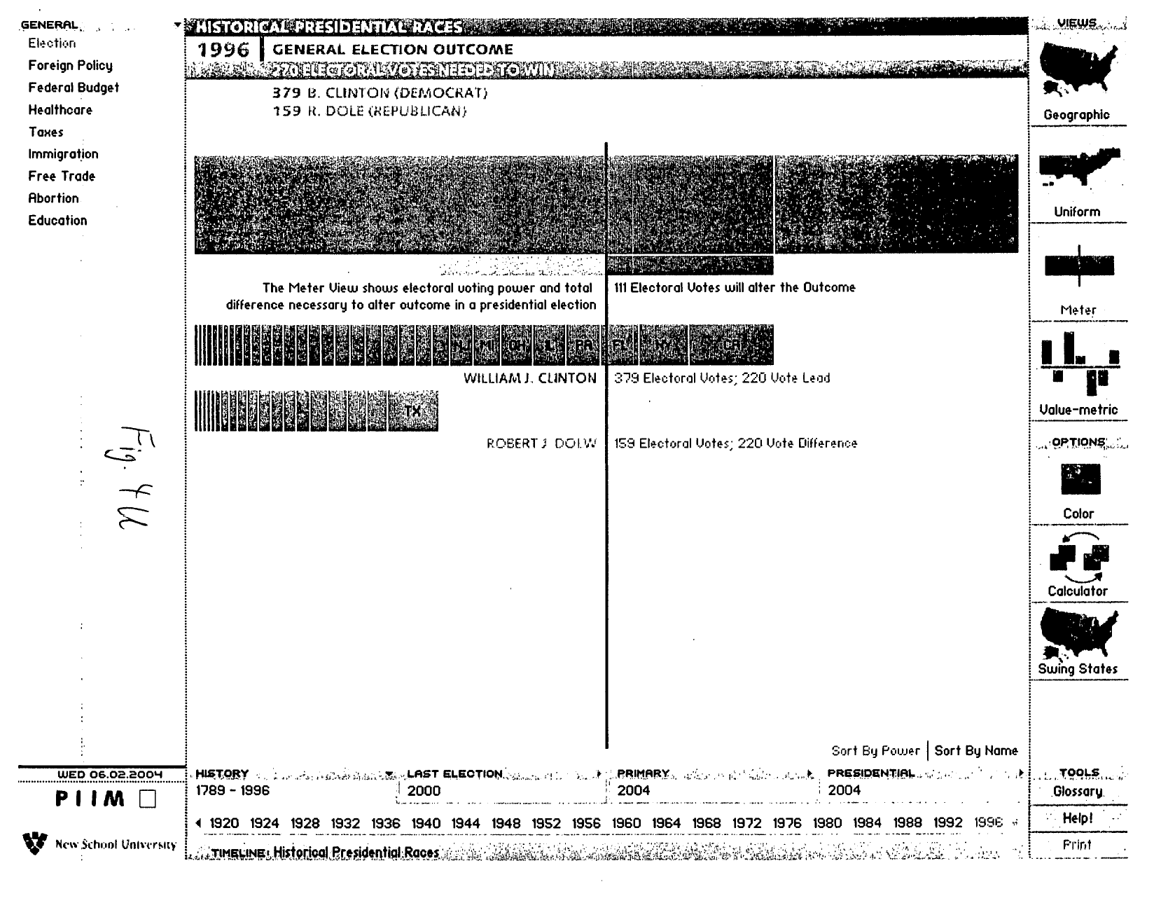

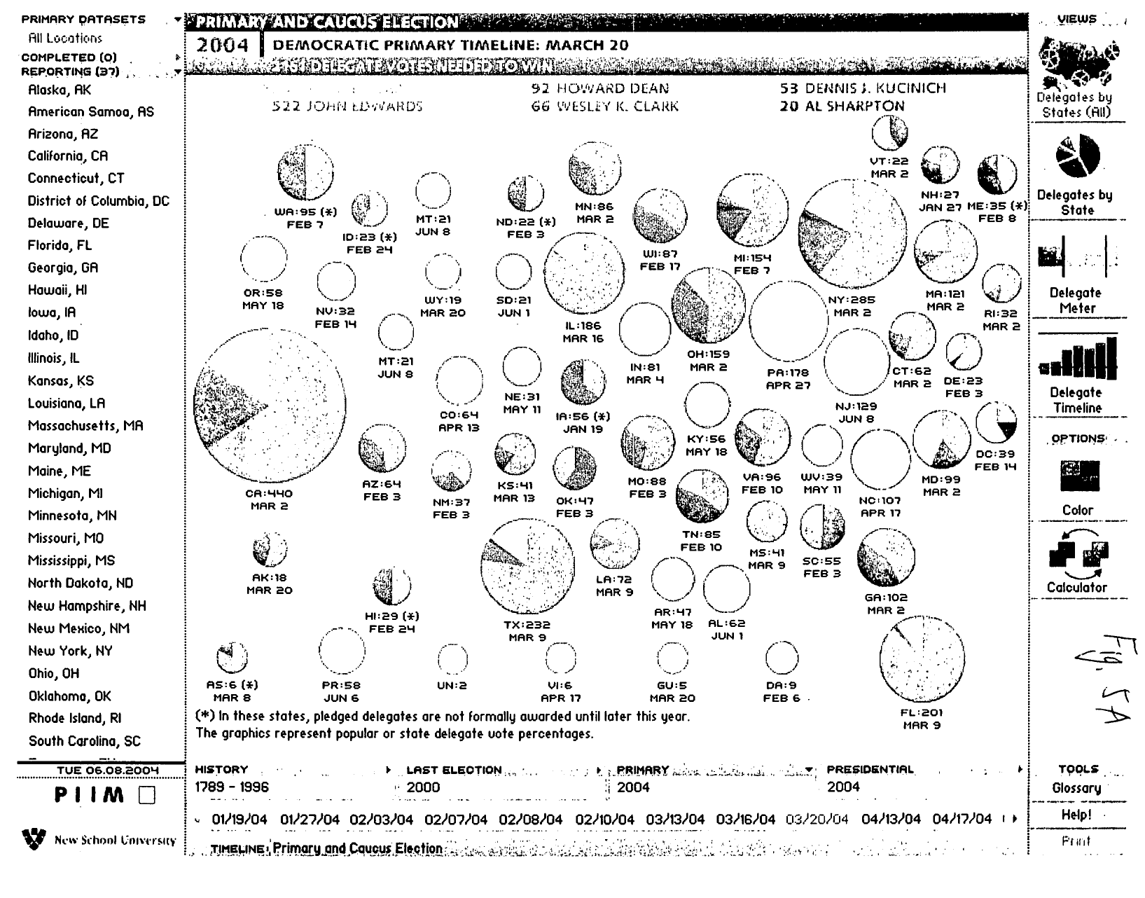

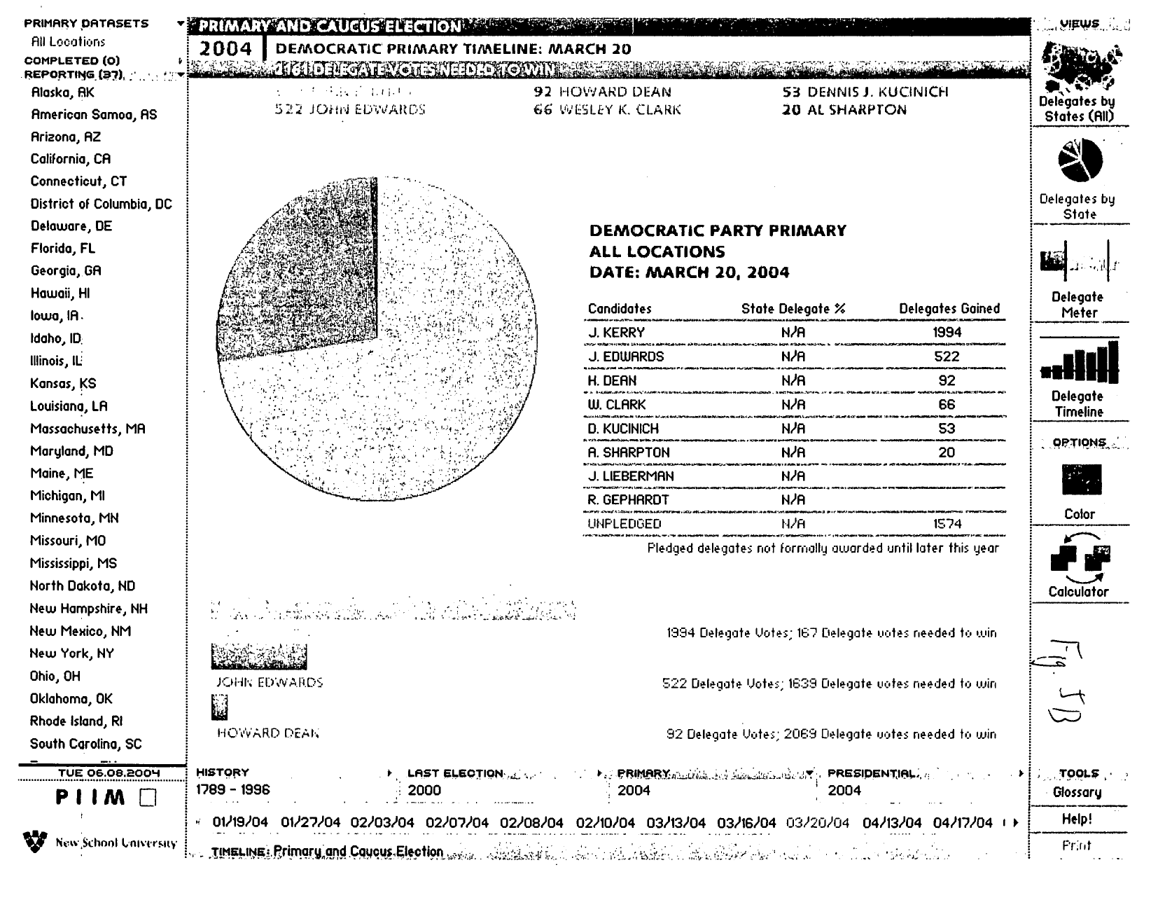

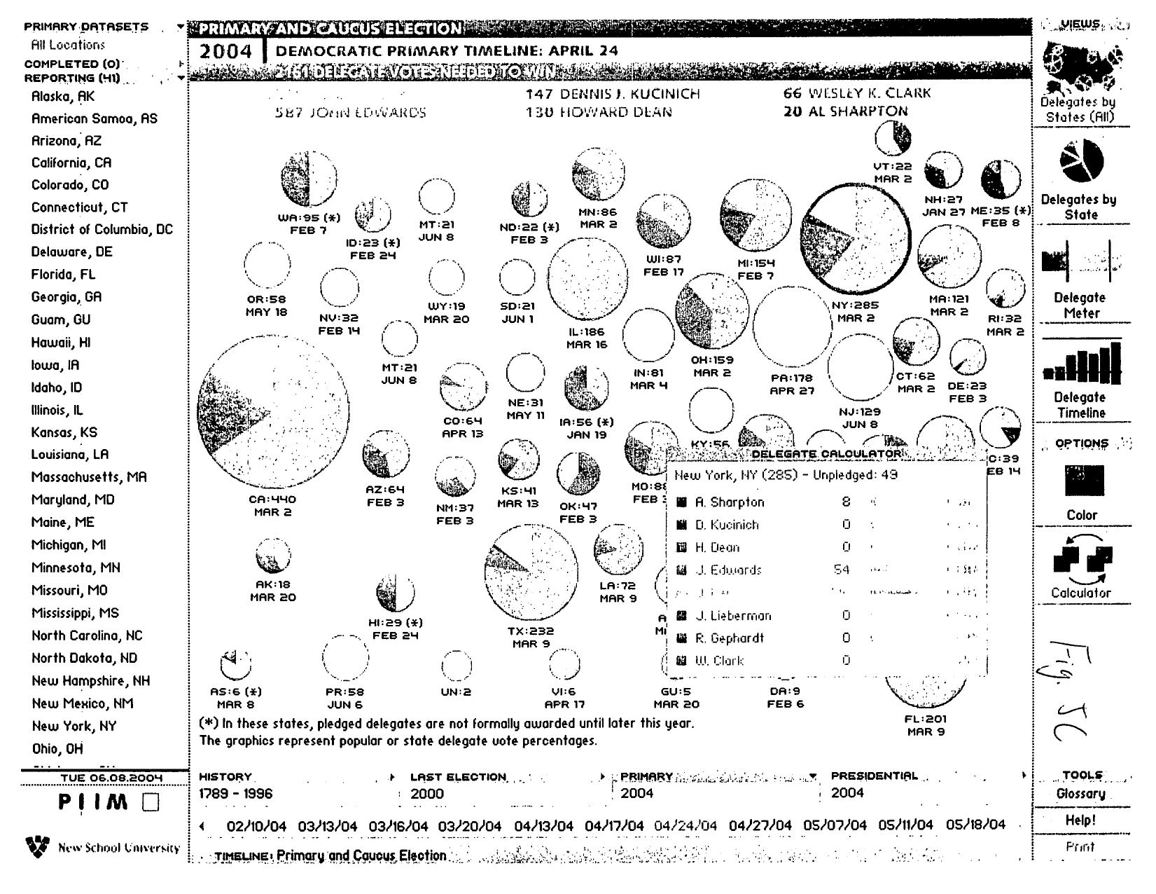

FIGS. 4A-4U are graphical visualizations in accordance with certain aspects of the invention of certain historical presidential races.

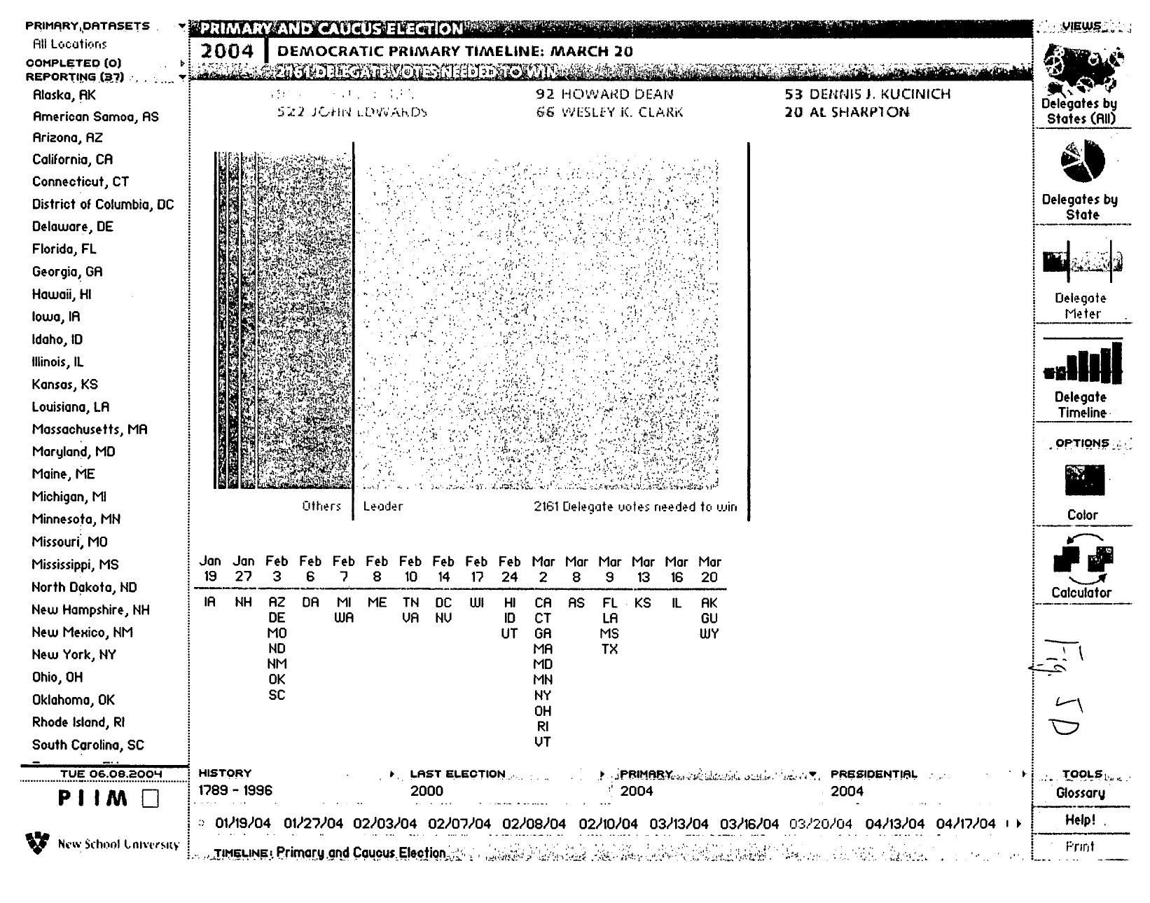

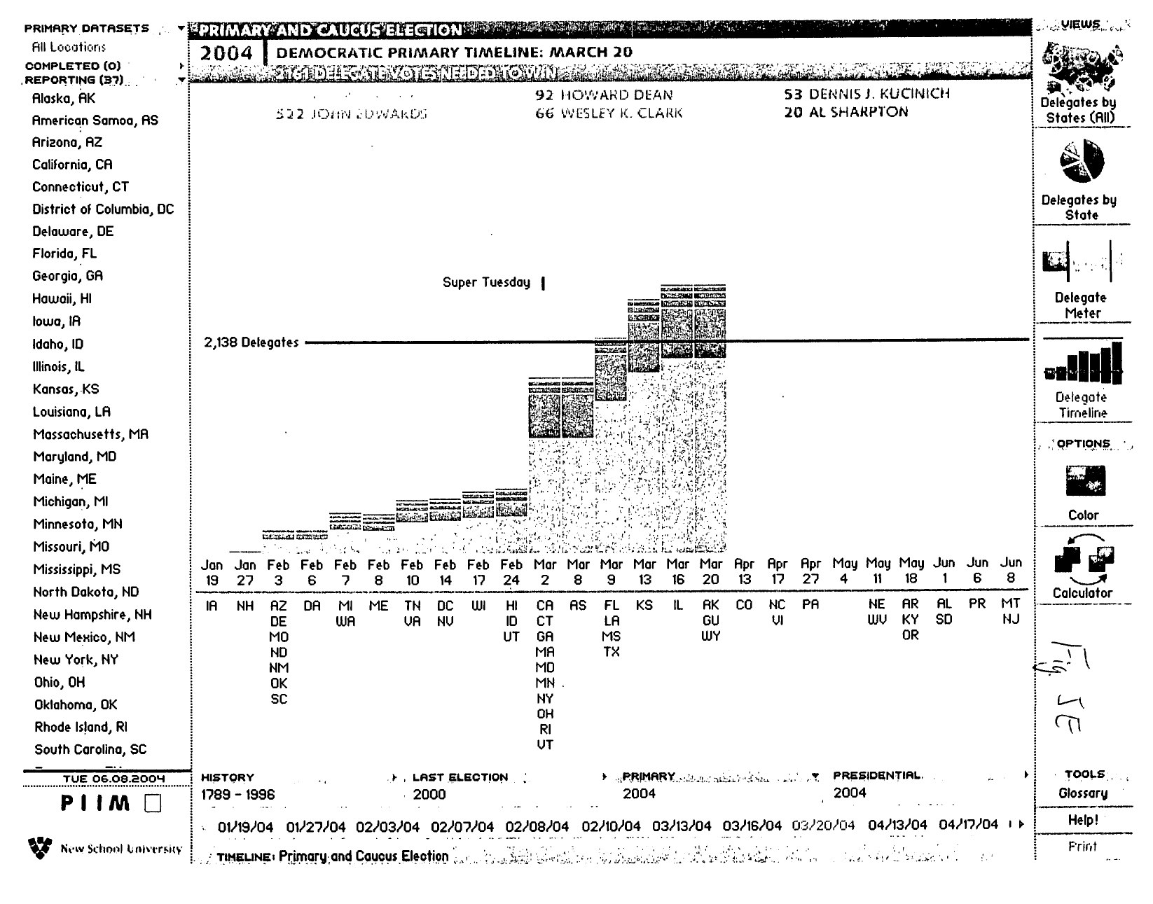

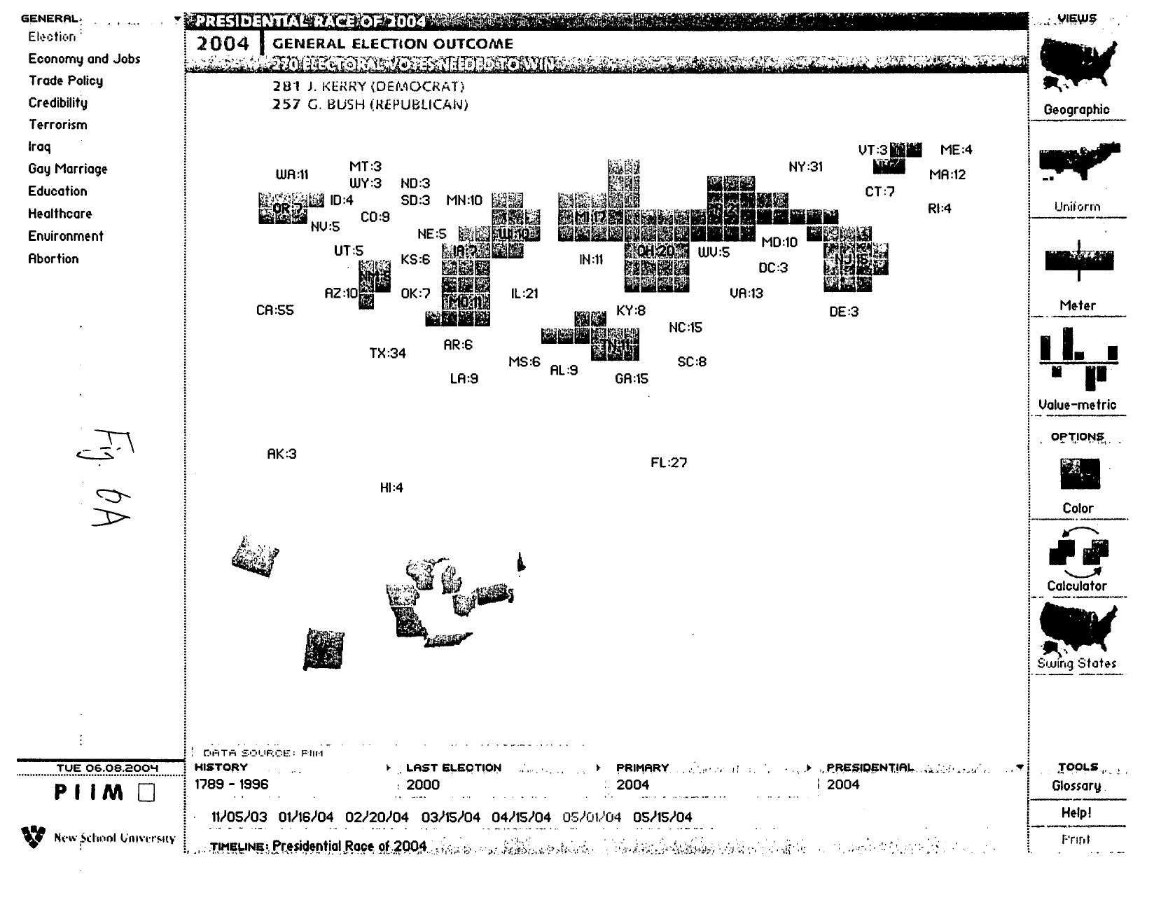

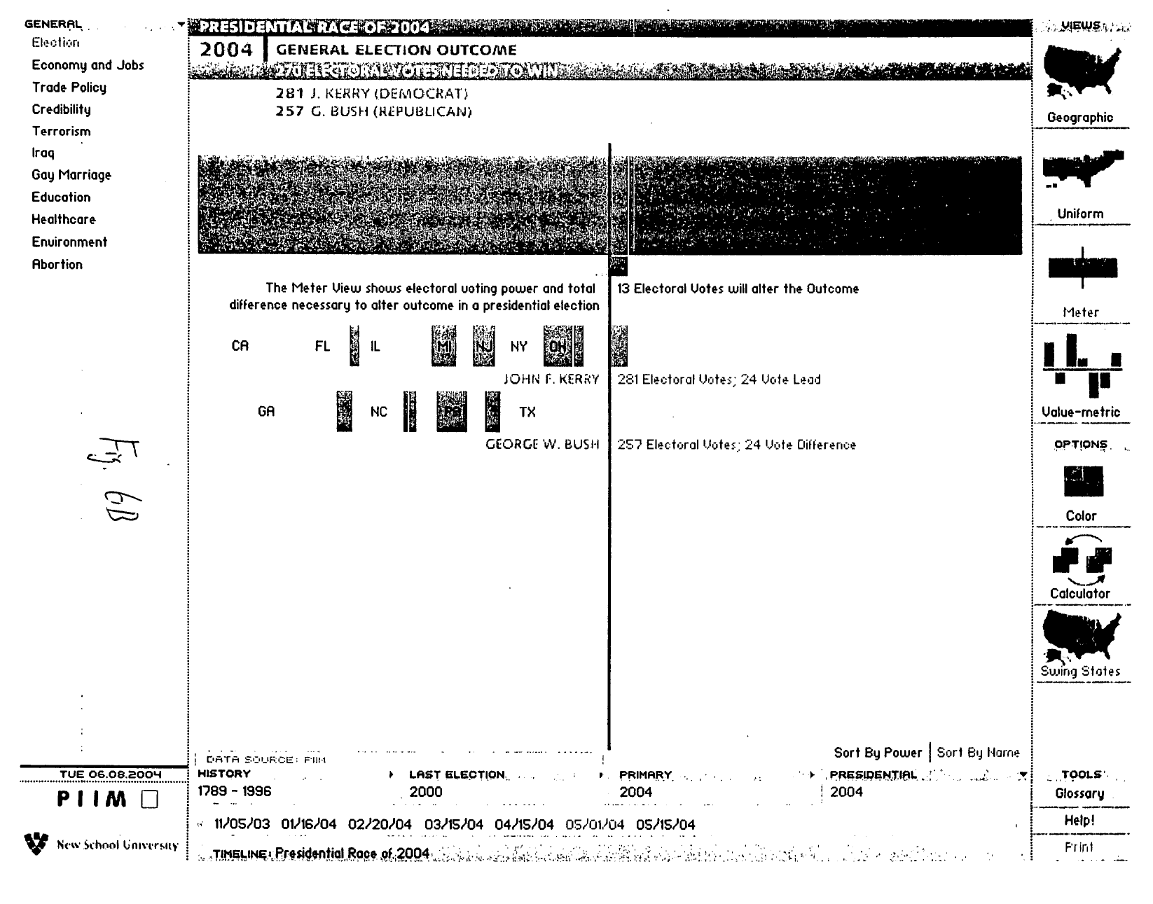

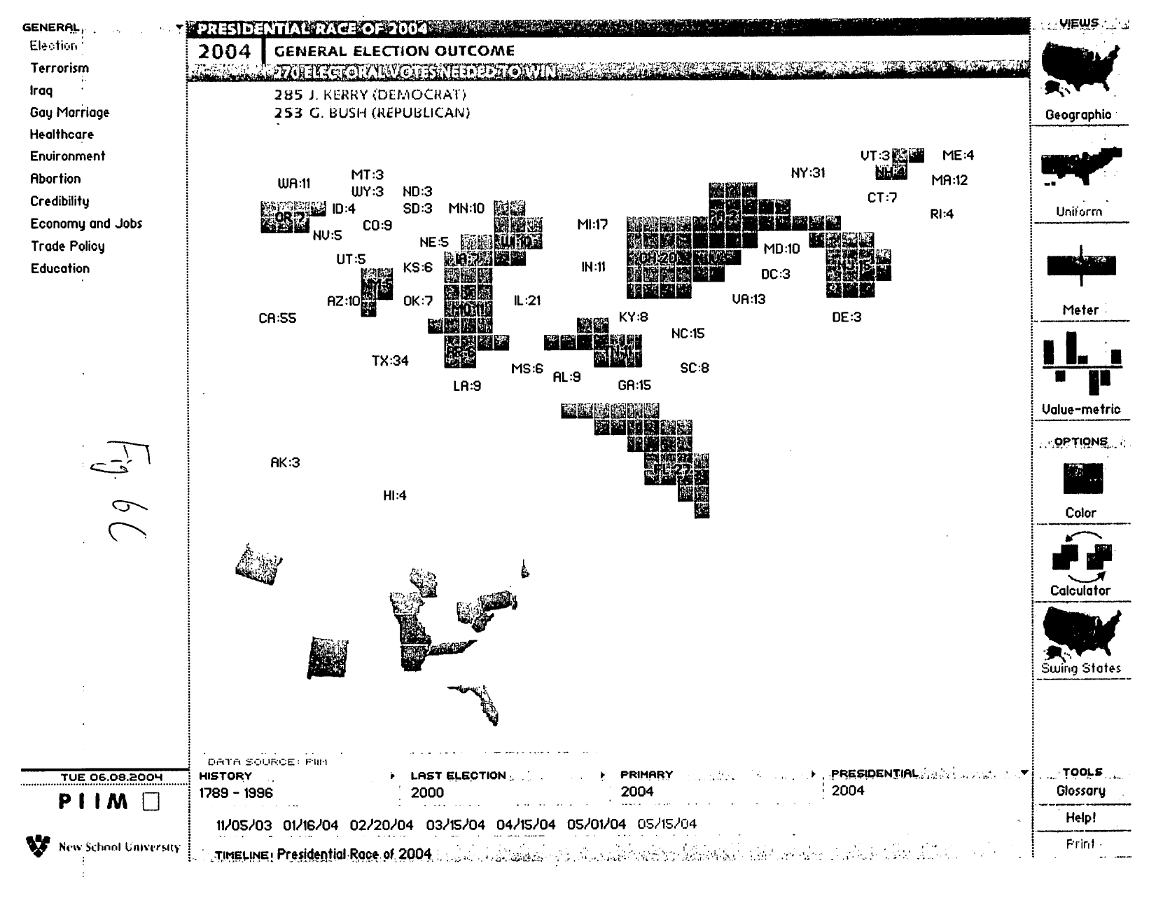

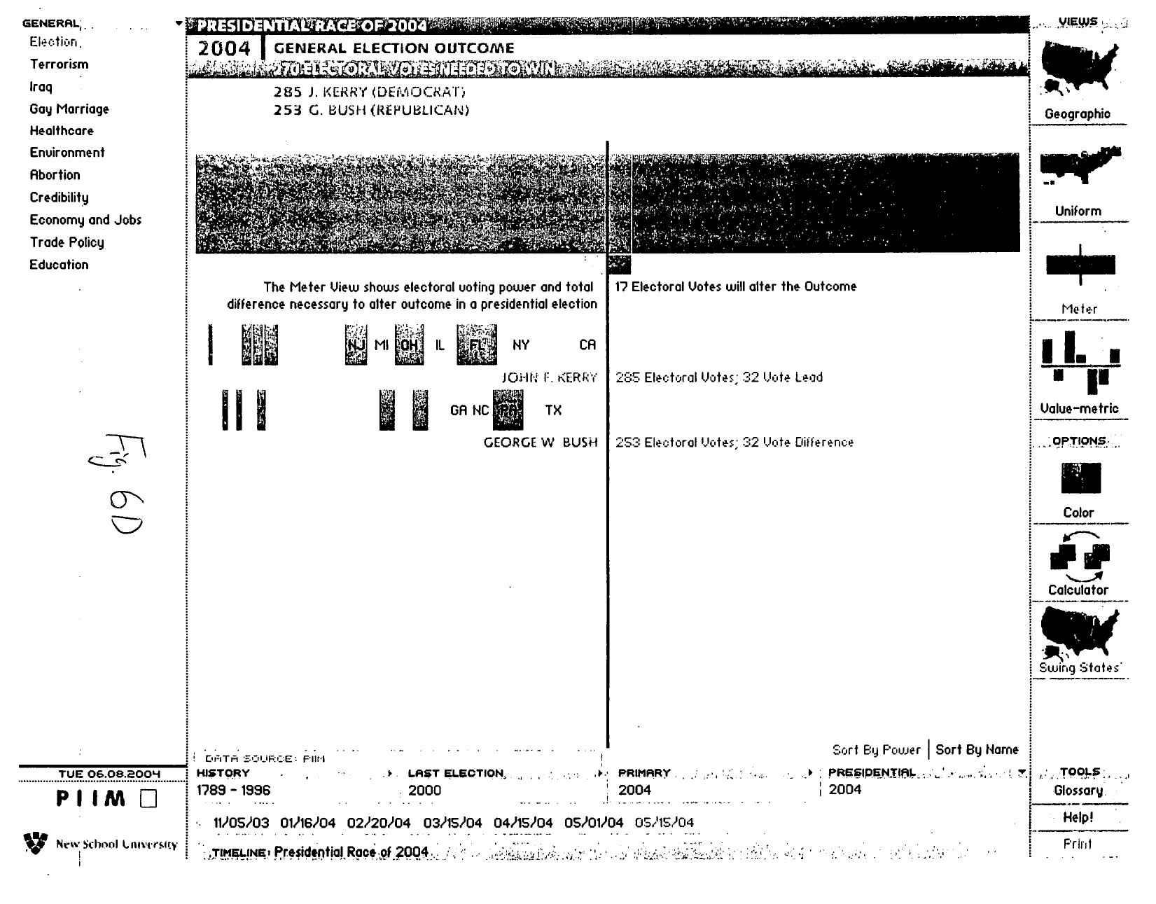

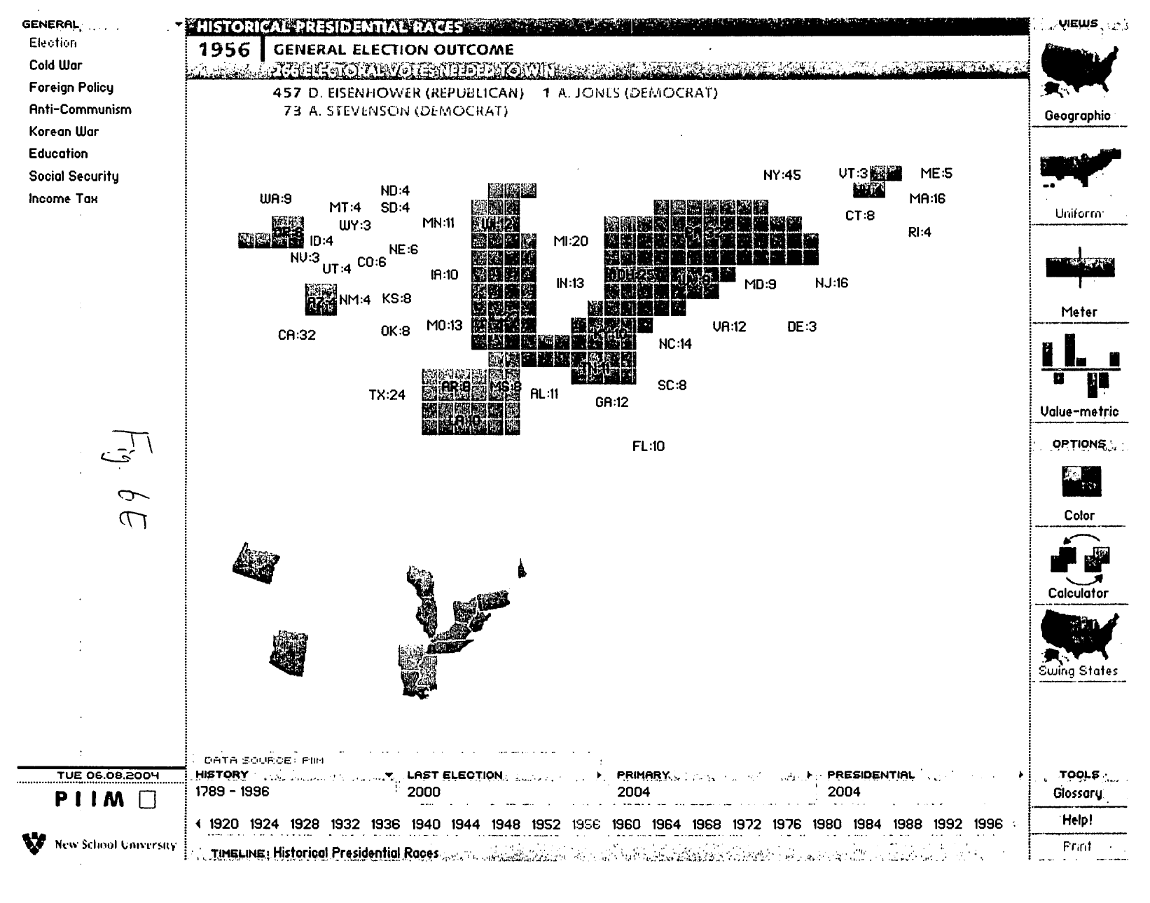

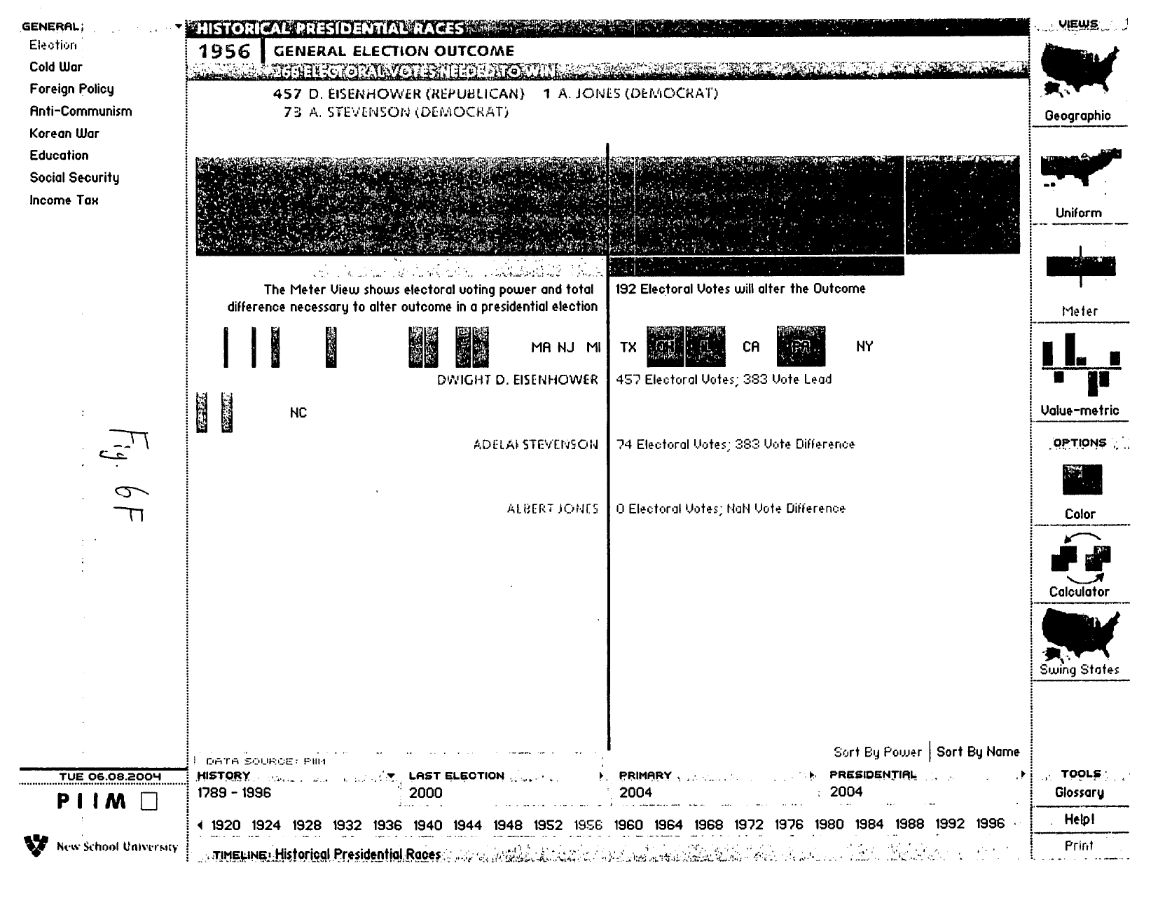

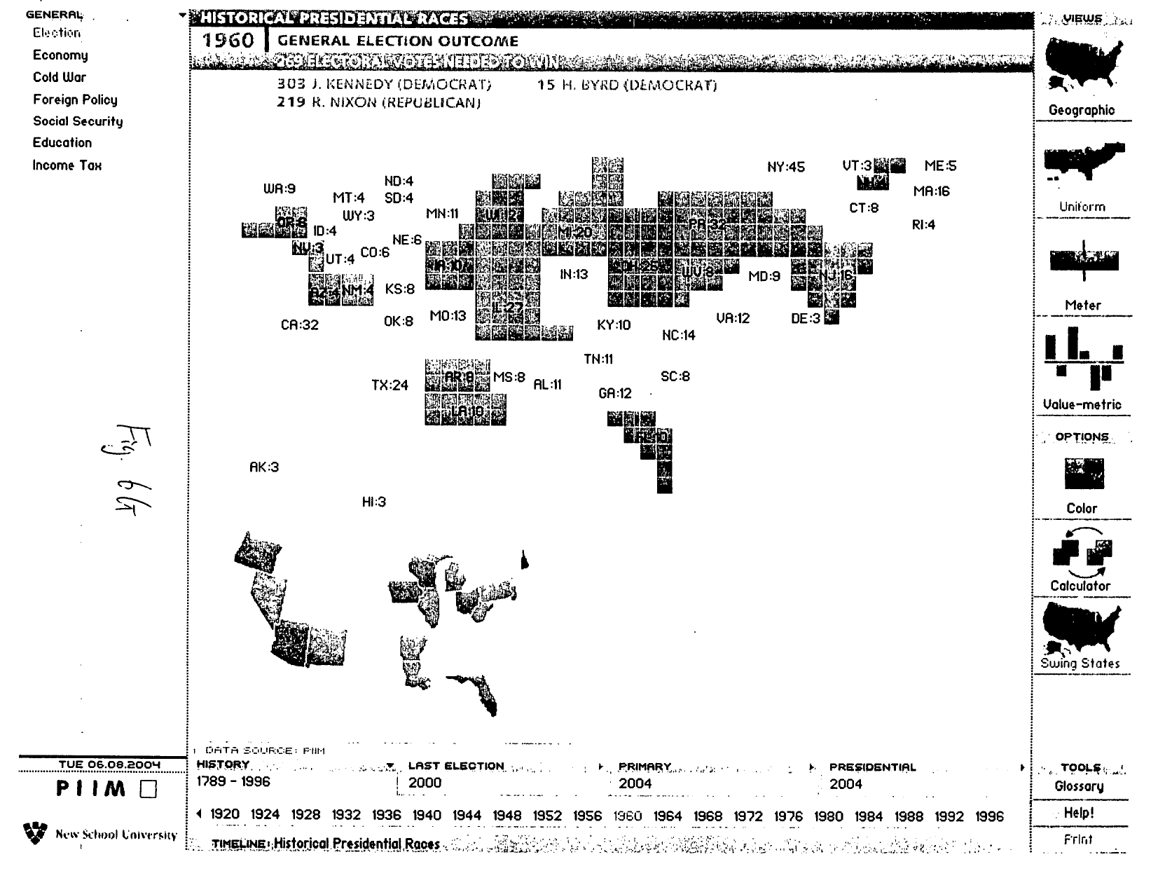

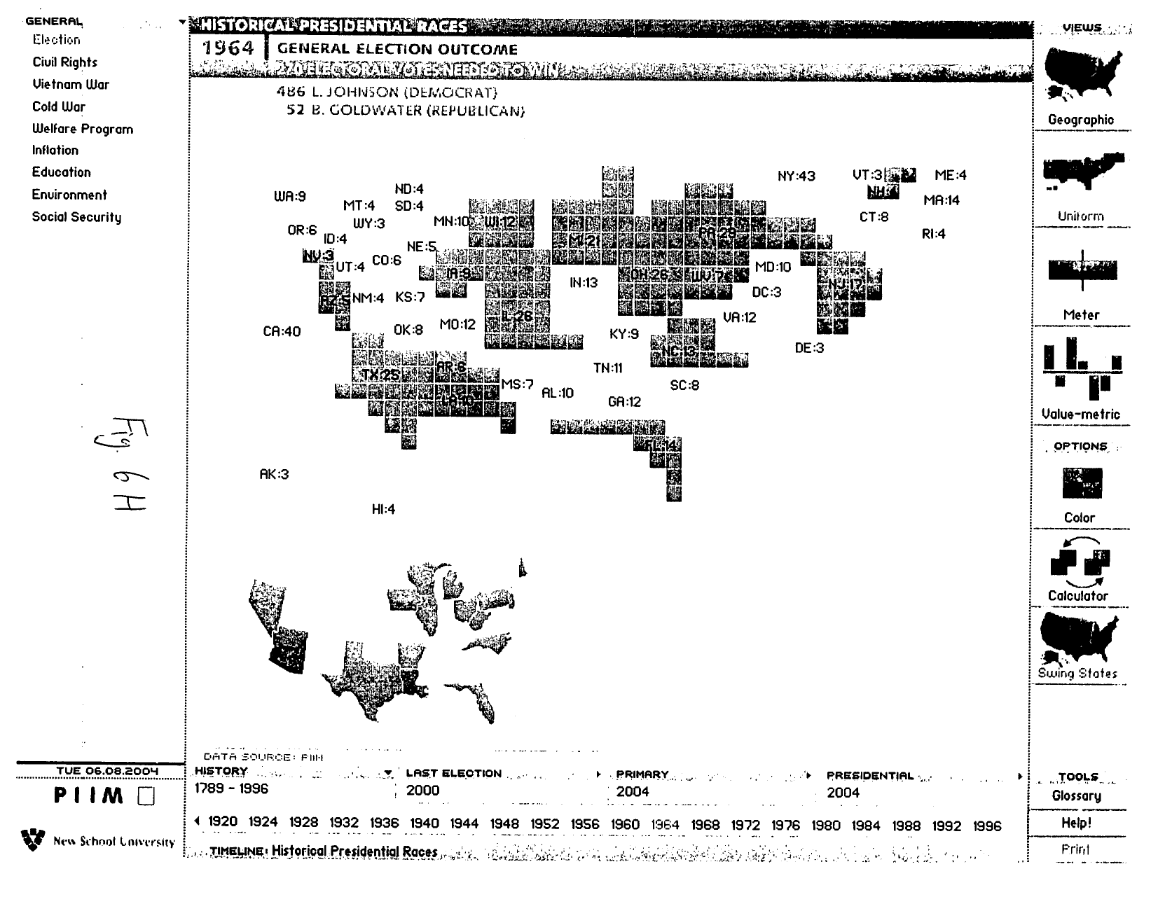

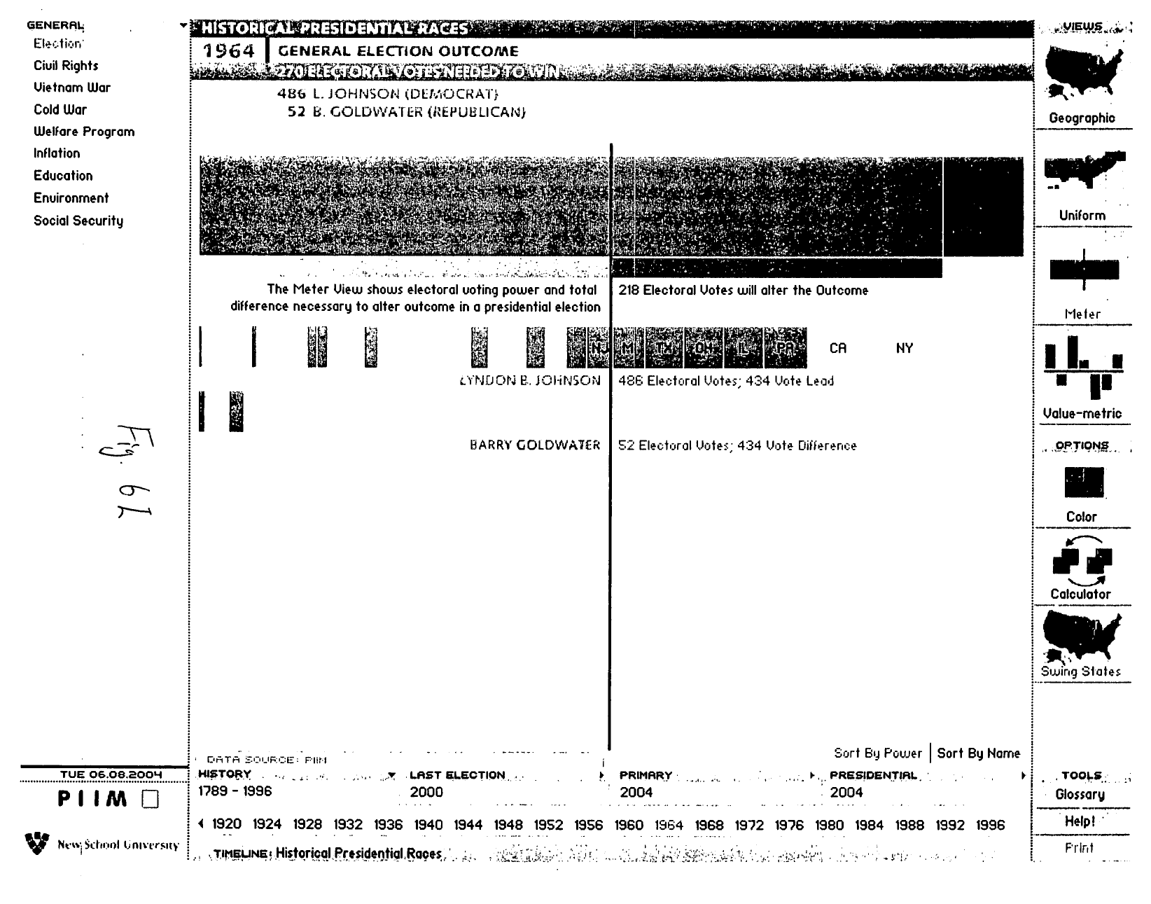

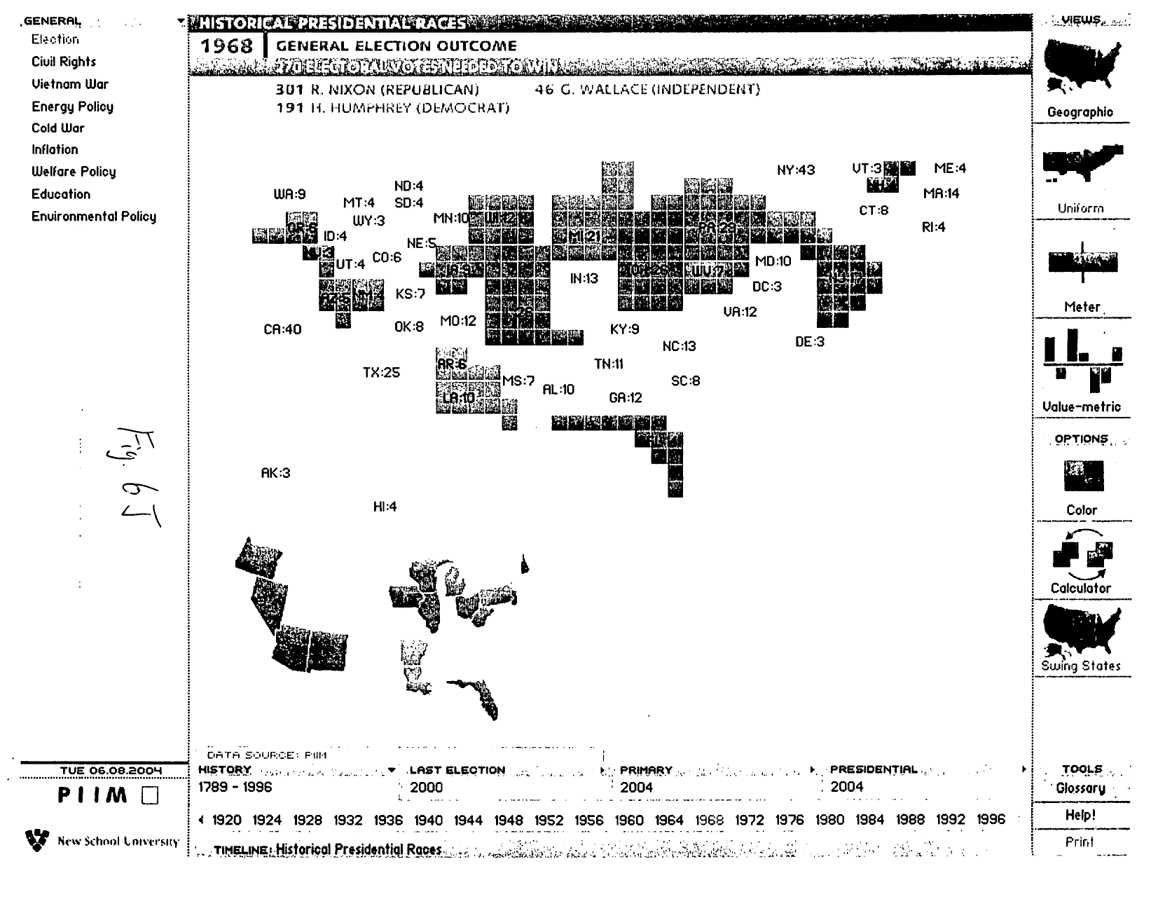

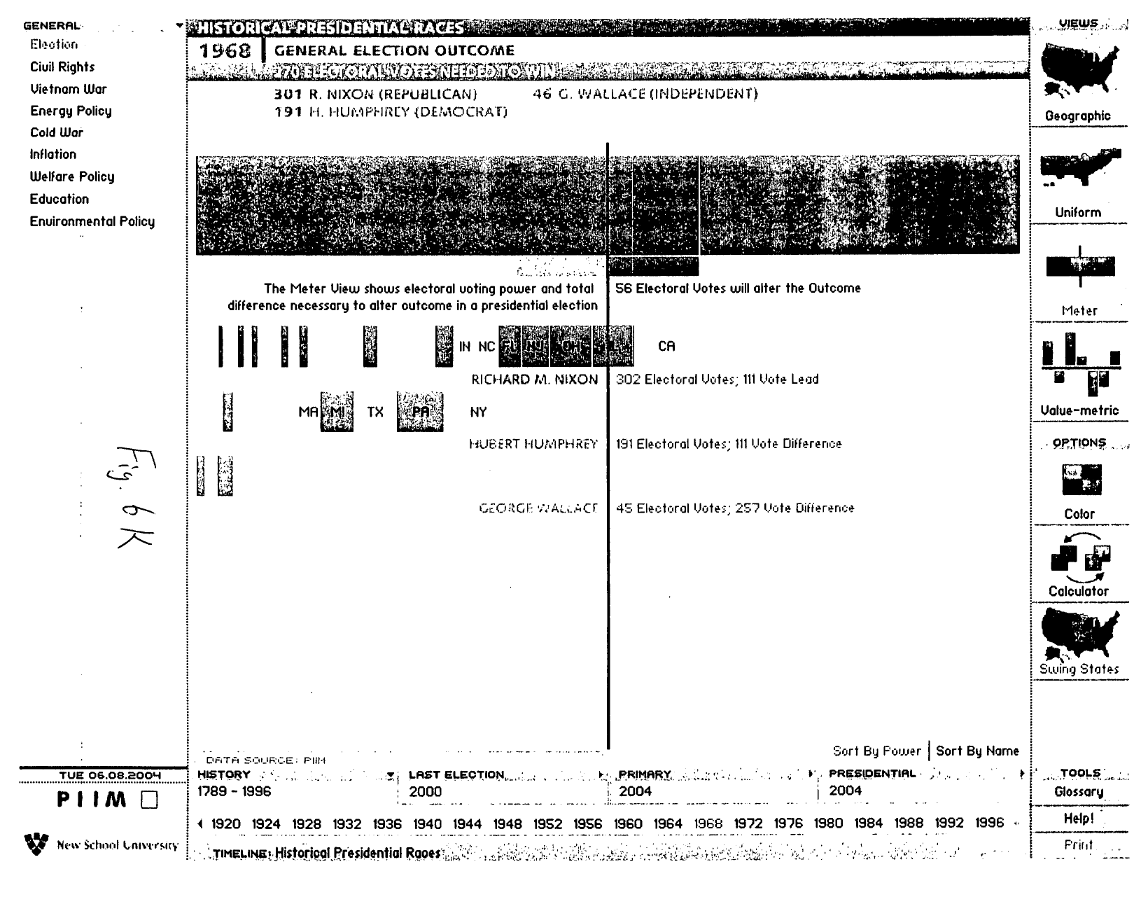

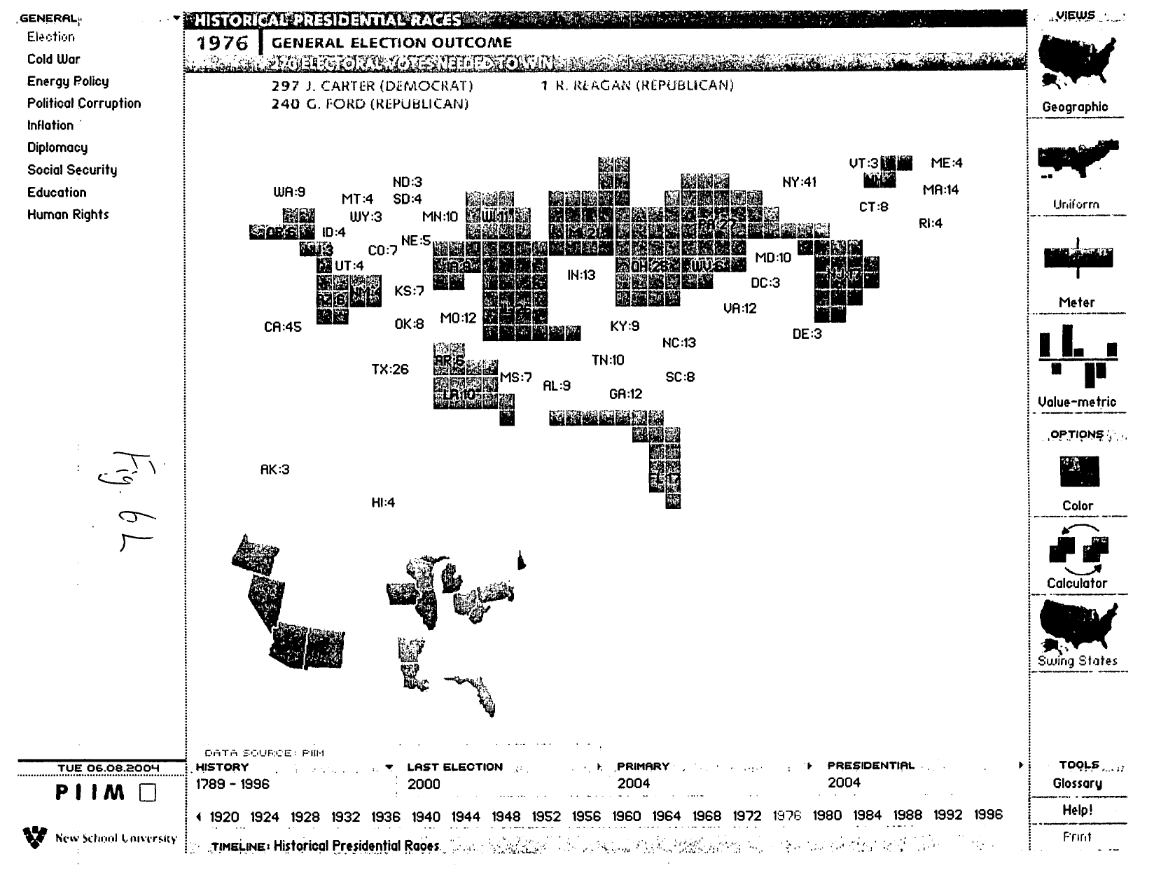

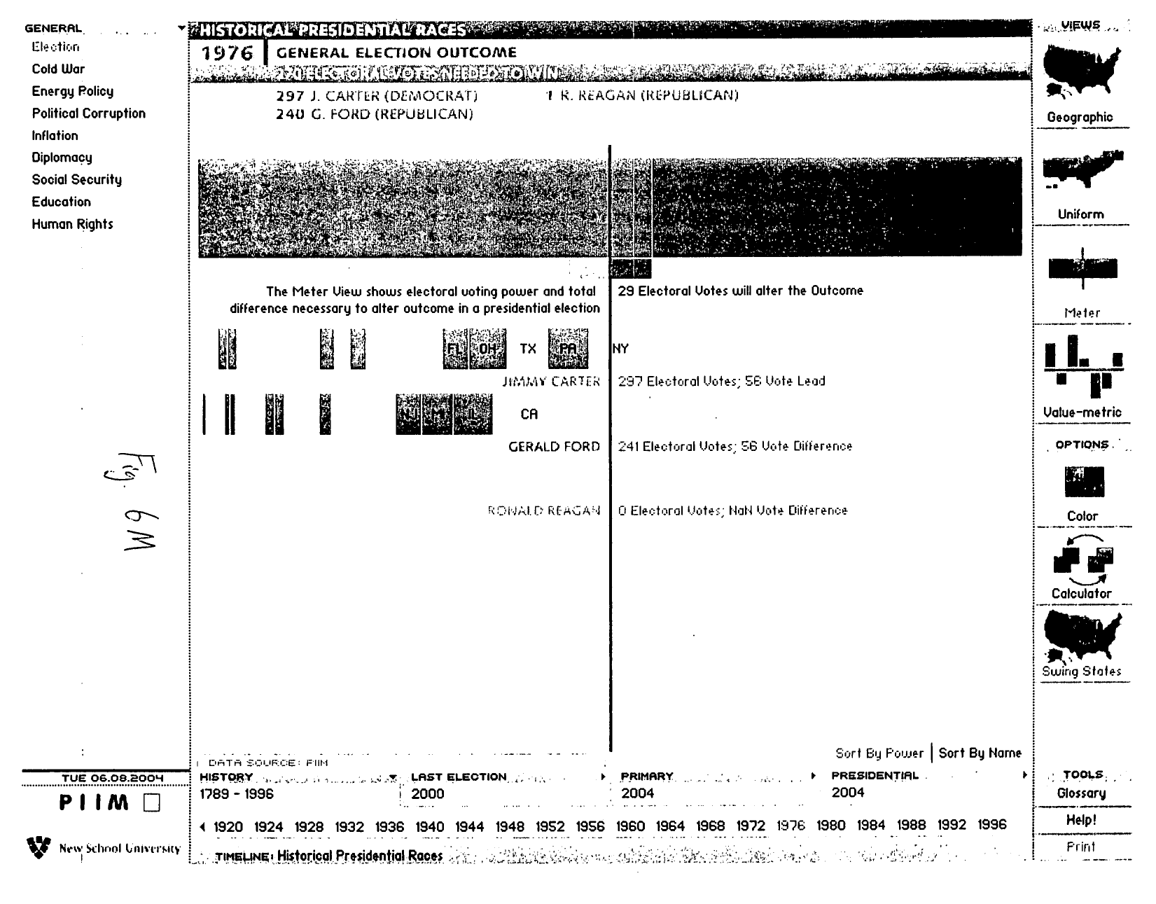

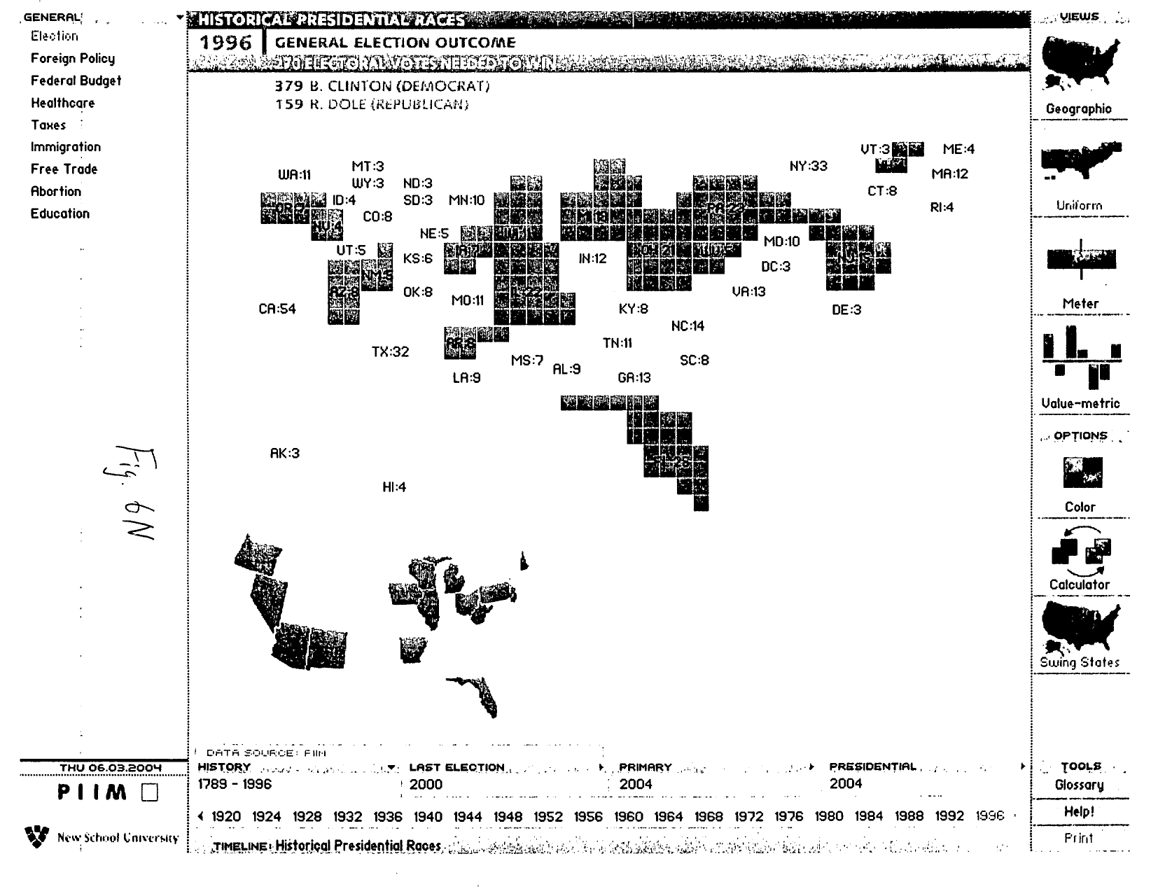

FIGS. 5A-5E are graphical visualizations in accordance with certain aspects of the invention of the primary and caucus elections of 2004. These representations reflect a somewhat different approach, wherein states vary not by electoral vote, but by number of delegates. Instead of a weight-distorted map, the primary presentation is by circular pie charts arranged in a roughly geographic state-by-state layout.

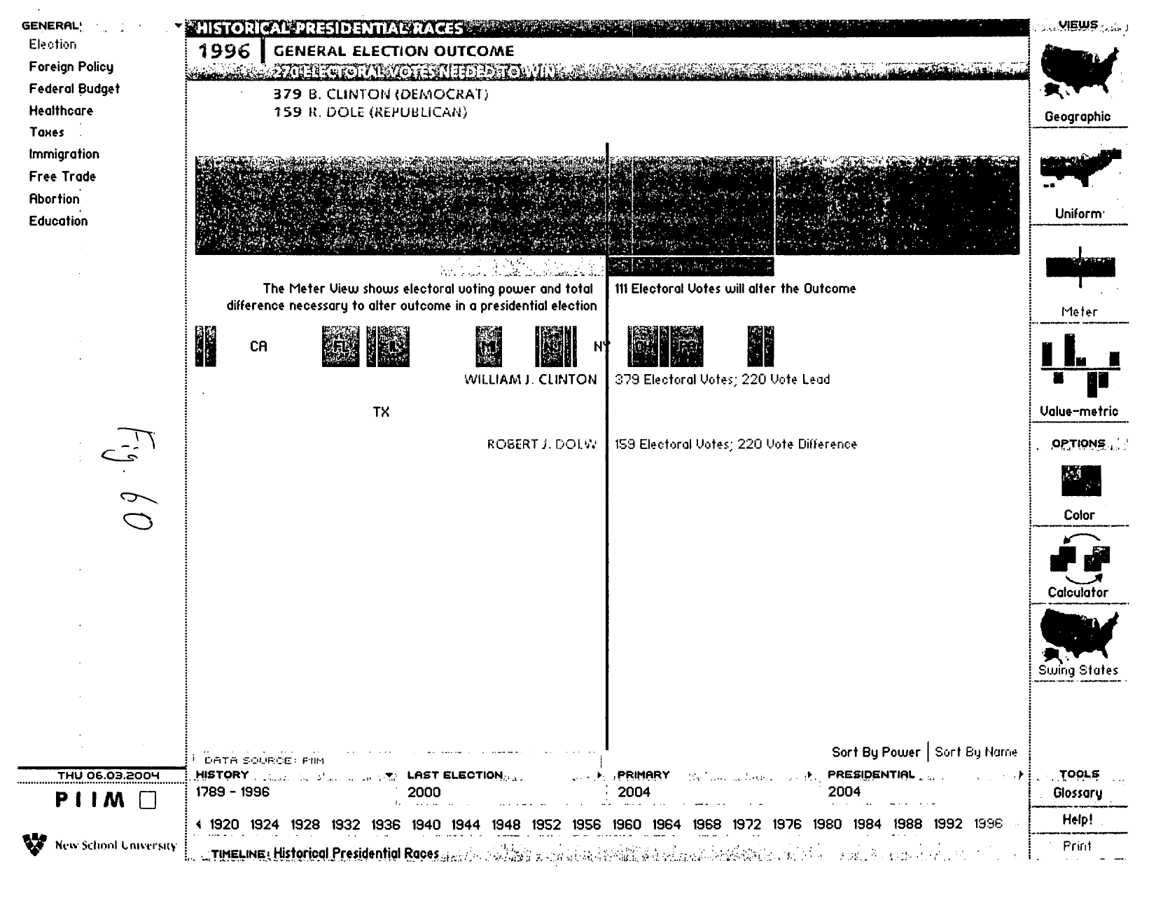

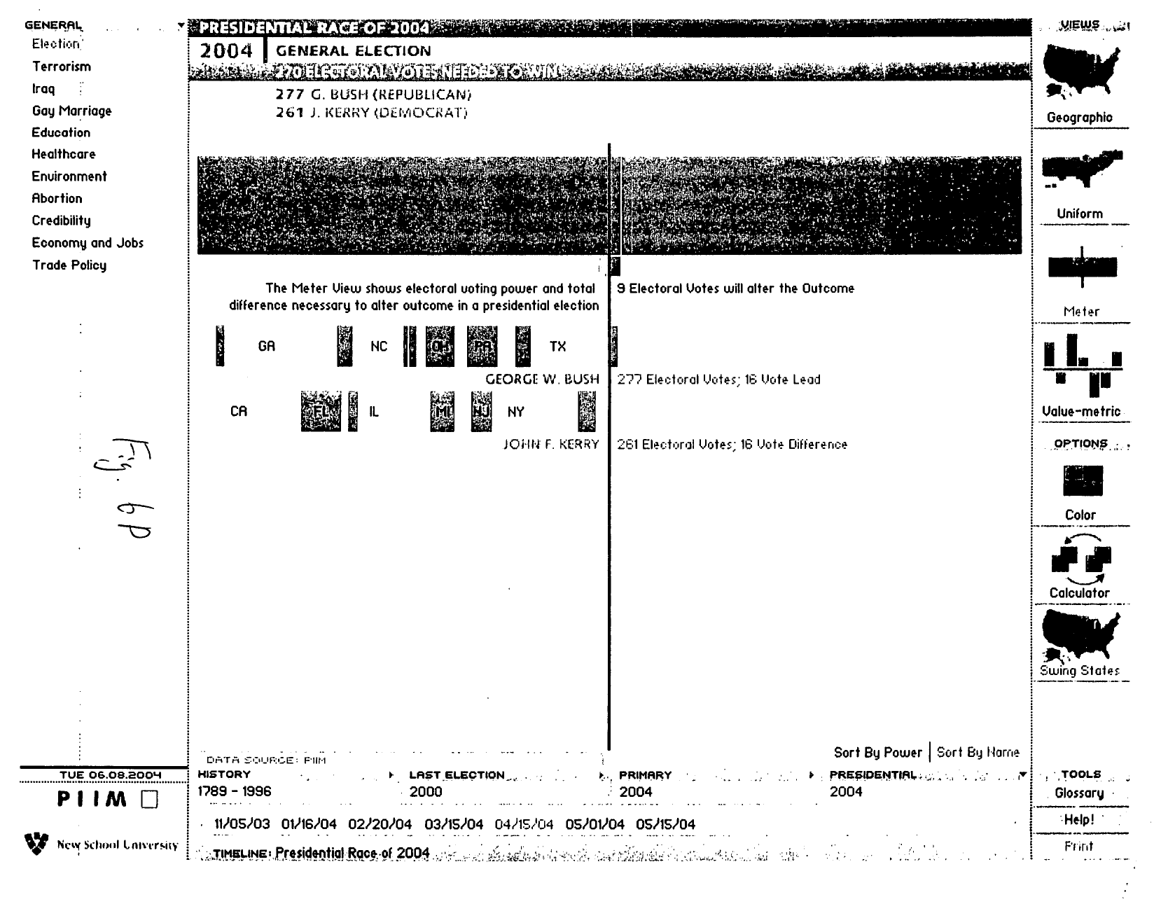

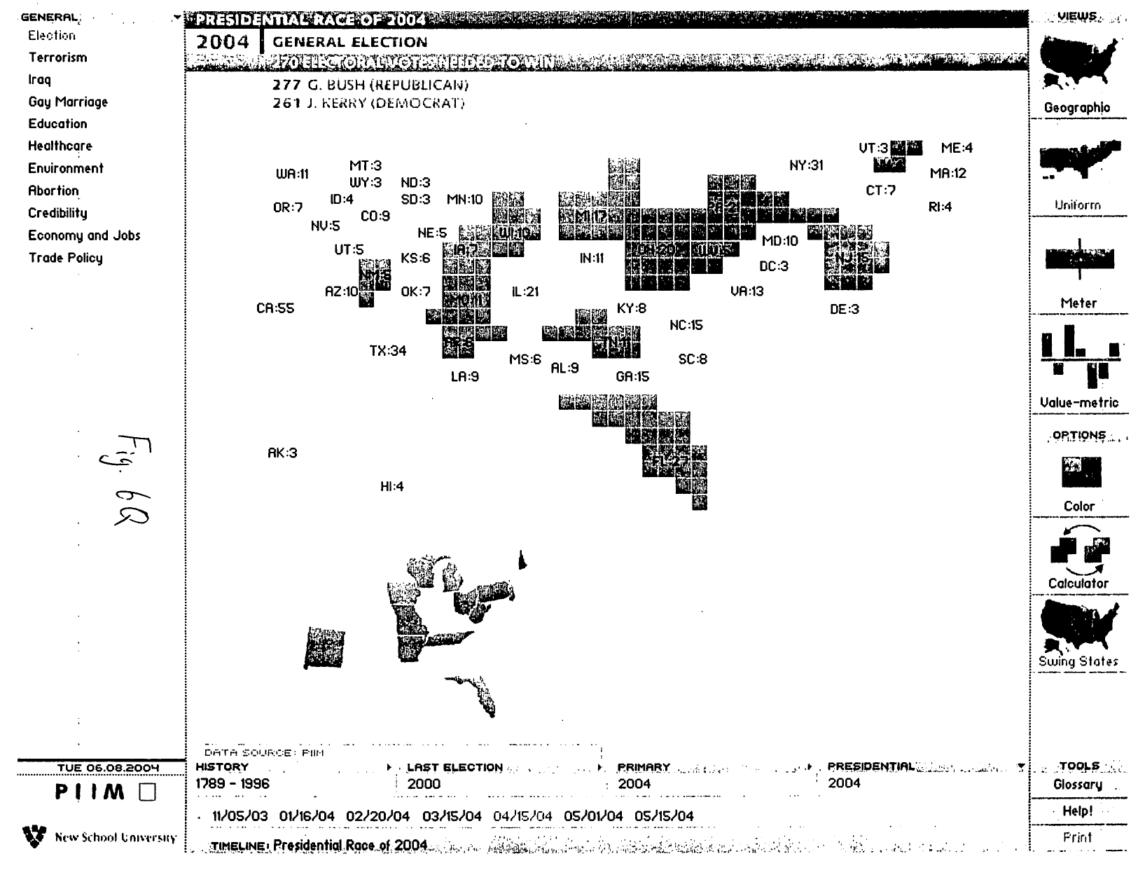

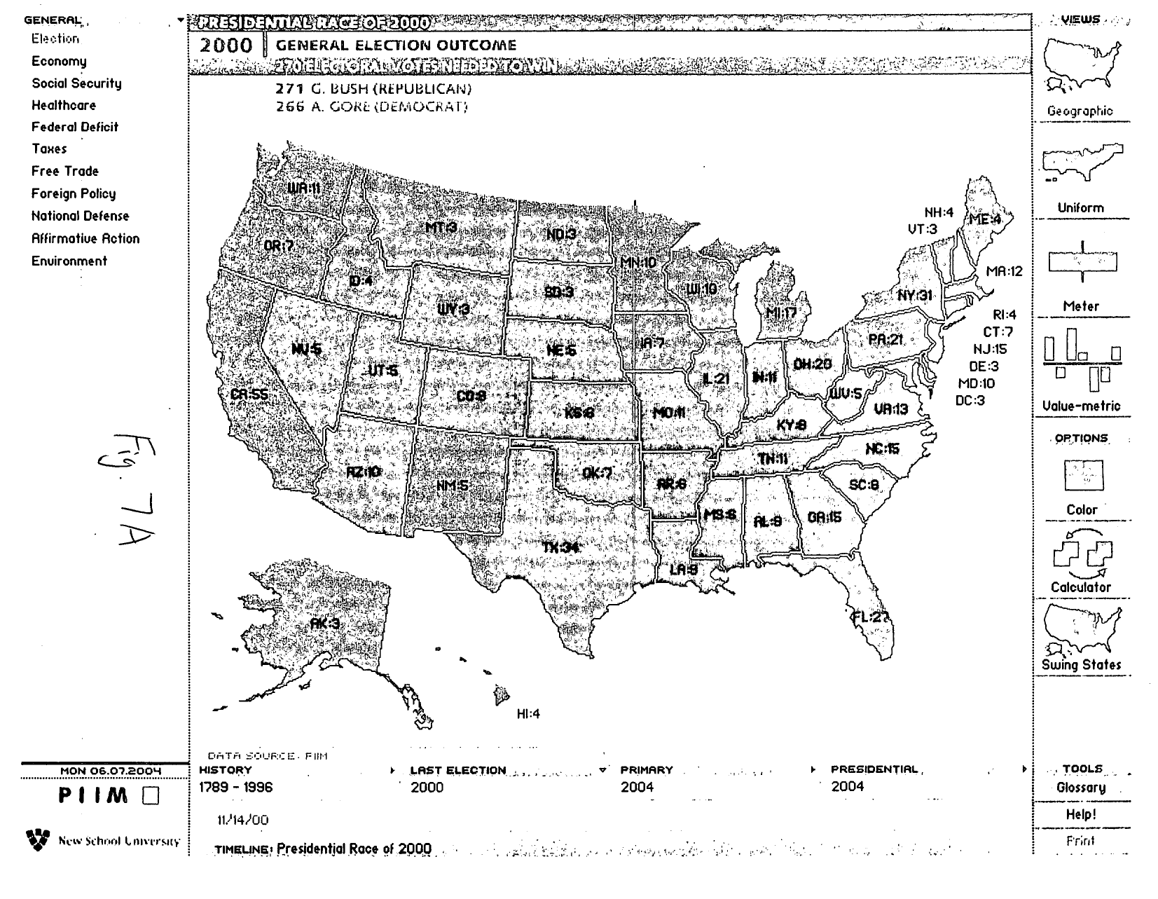

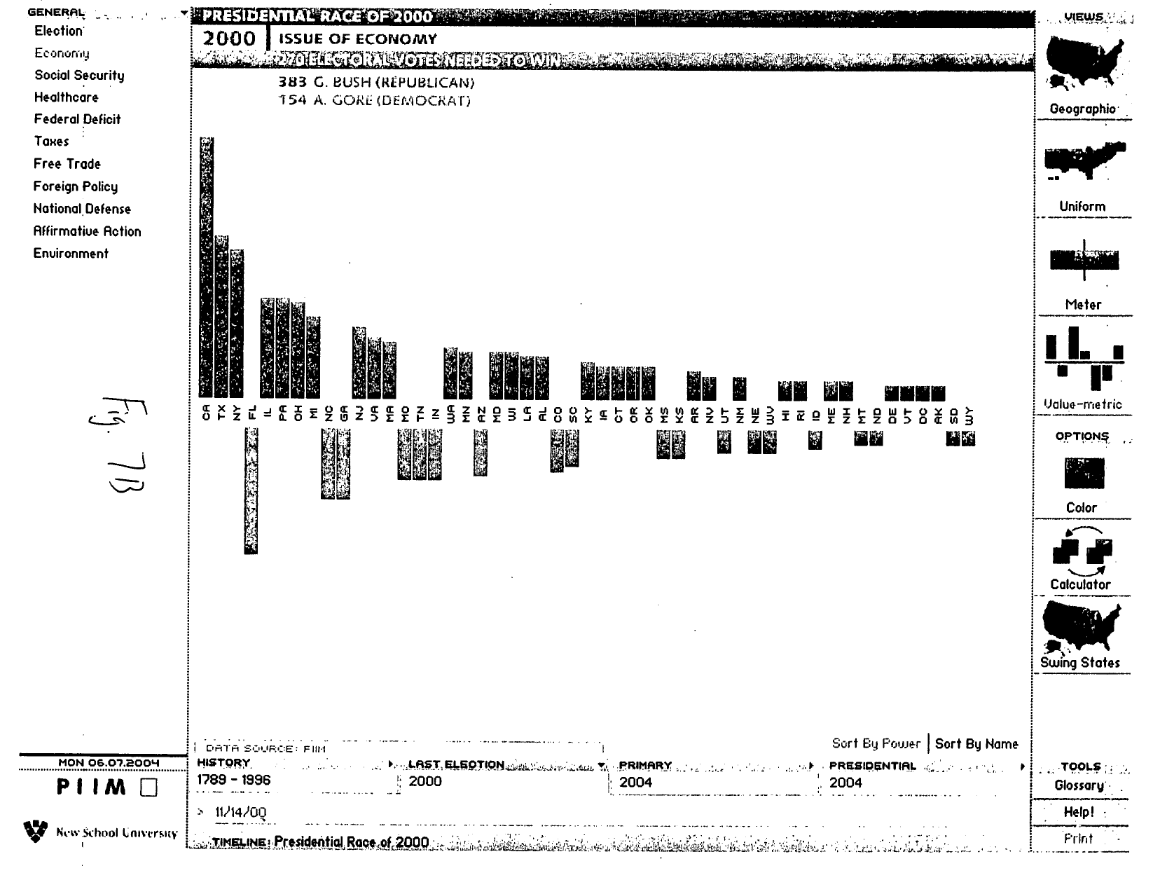

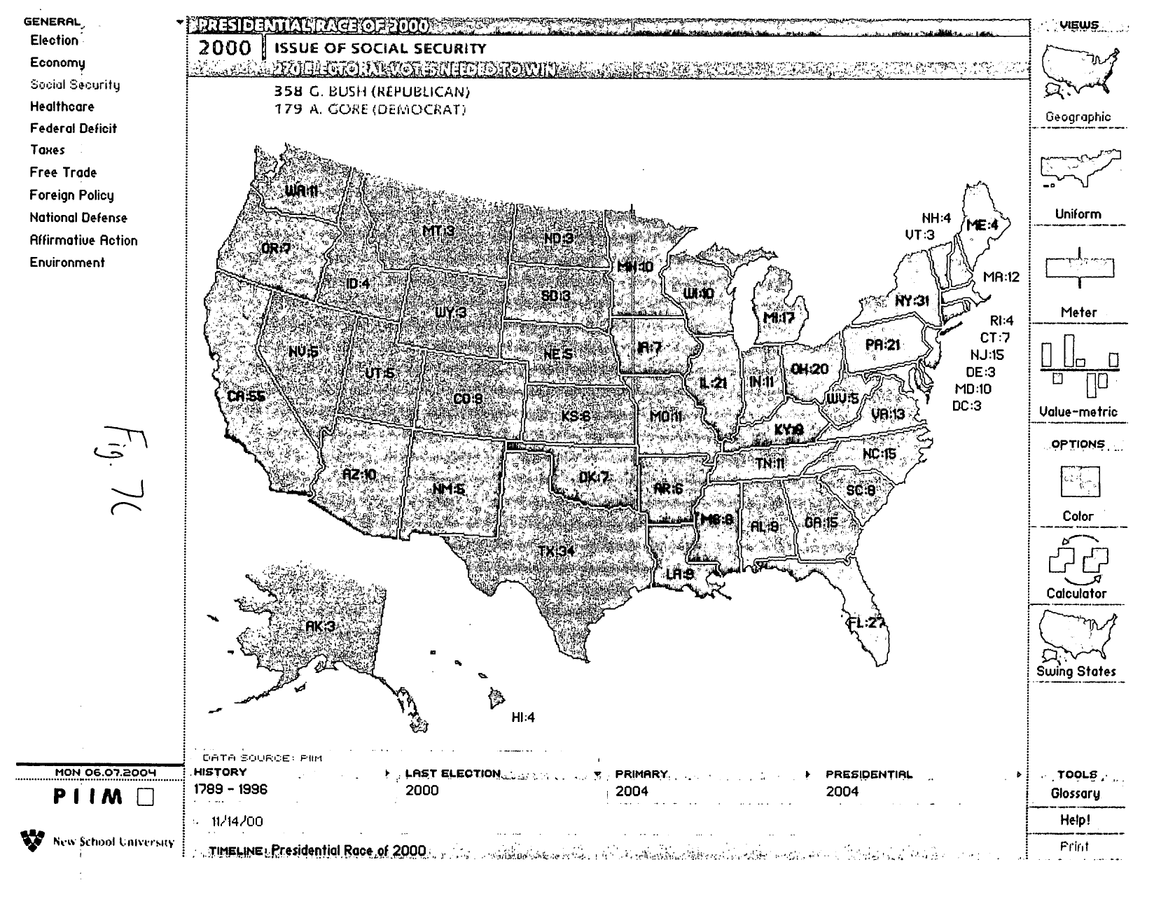

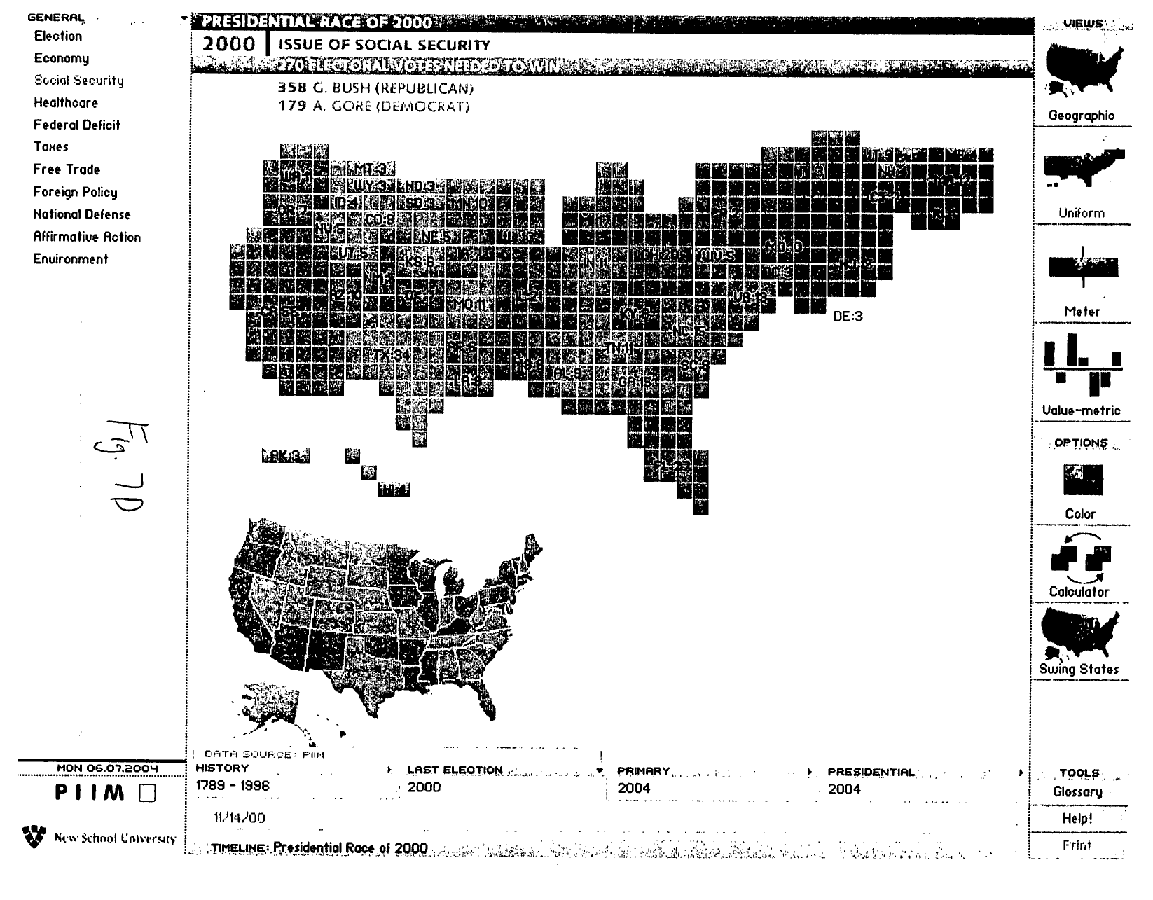

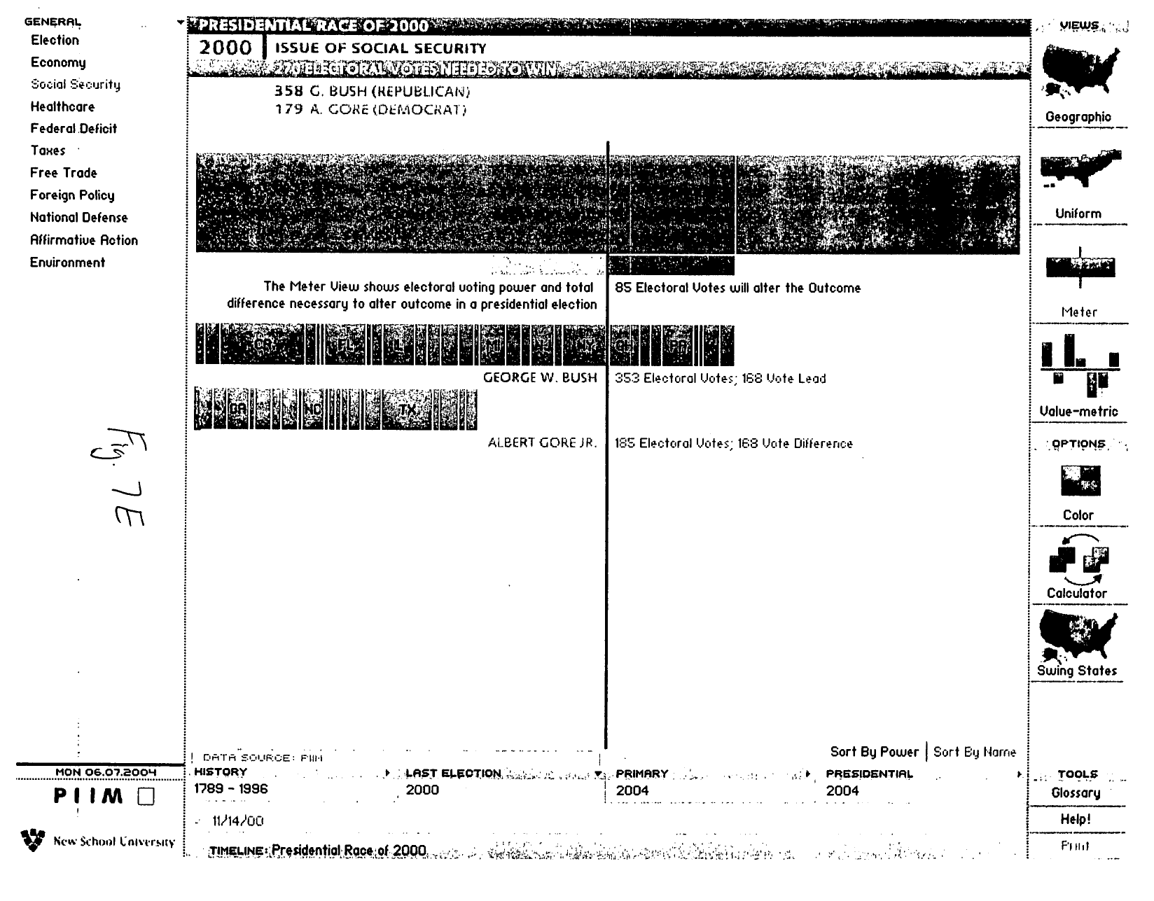

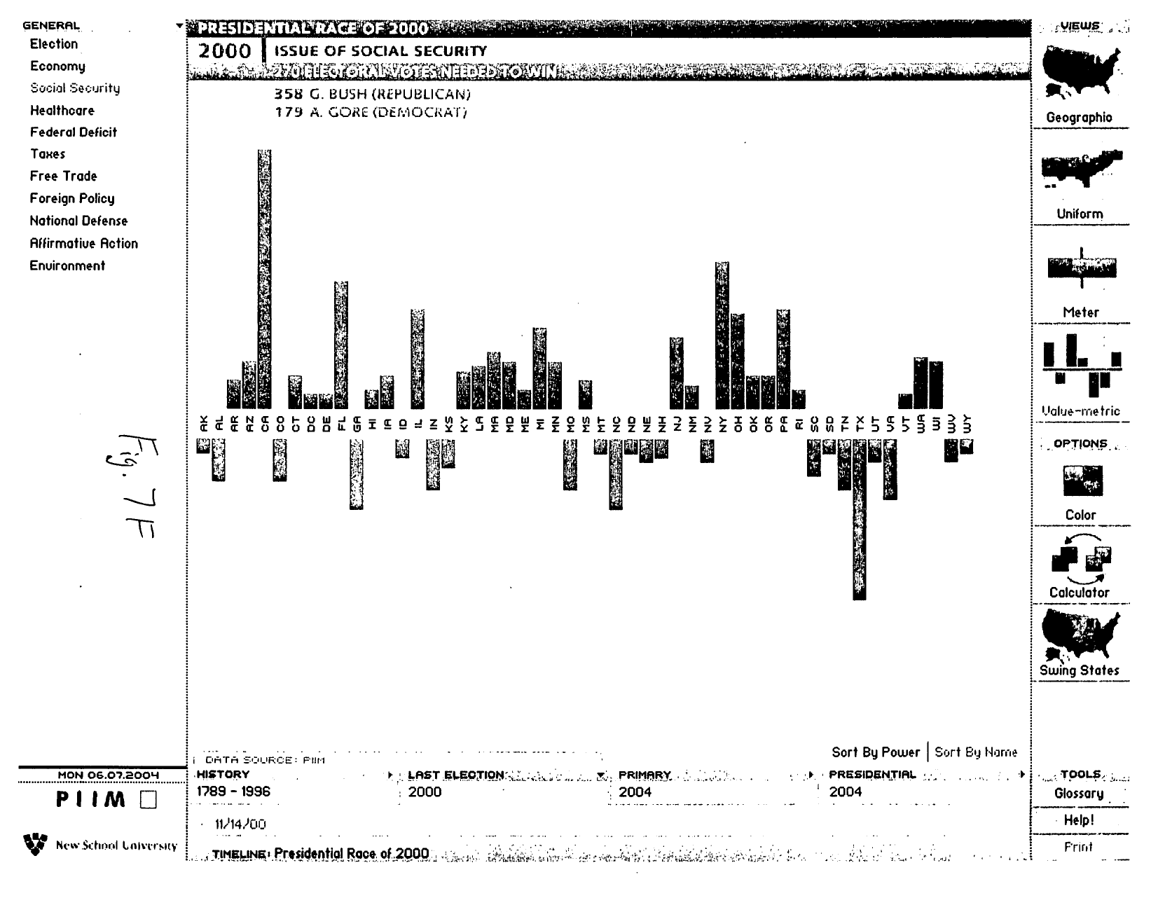

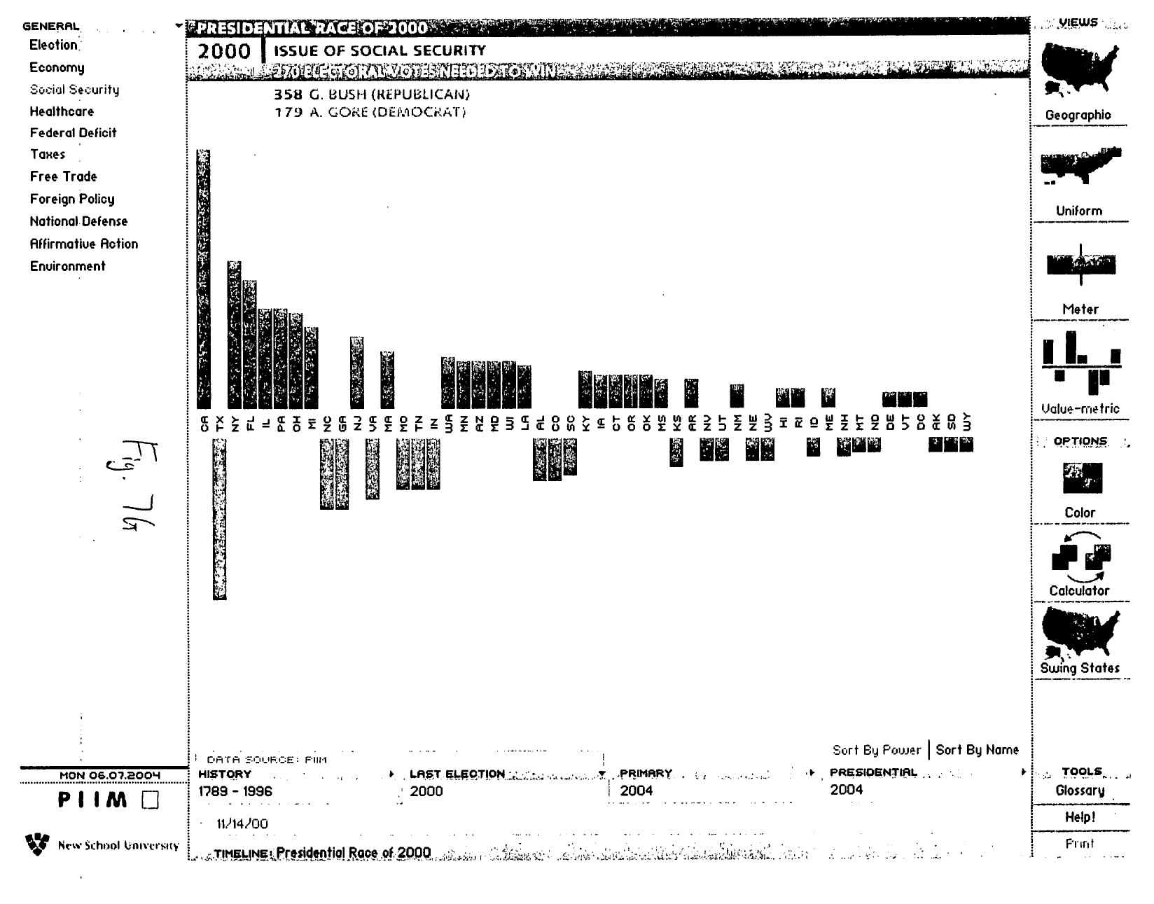

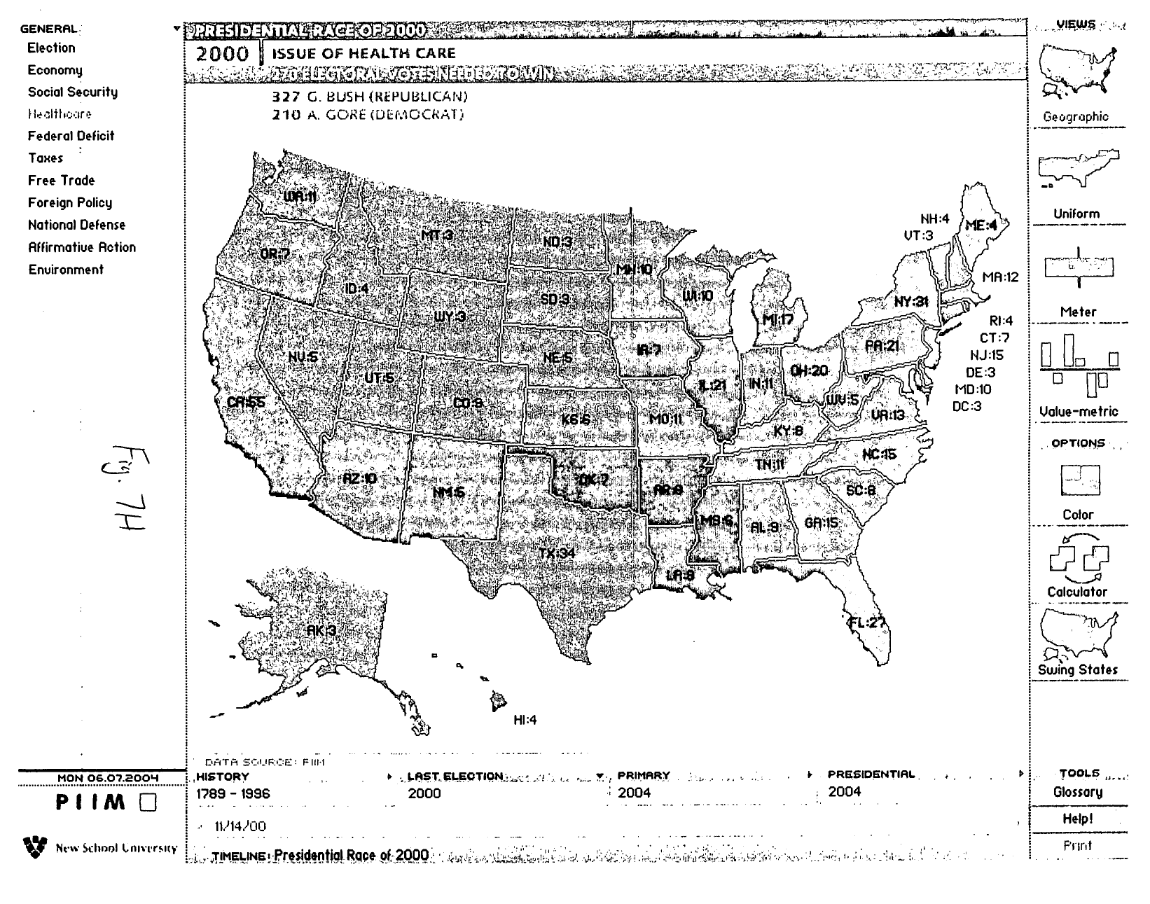

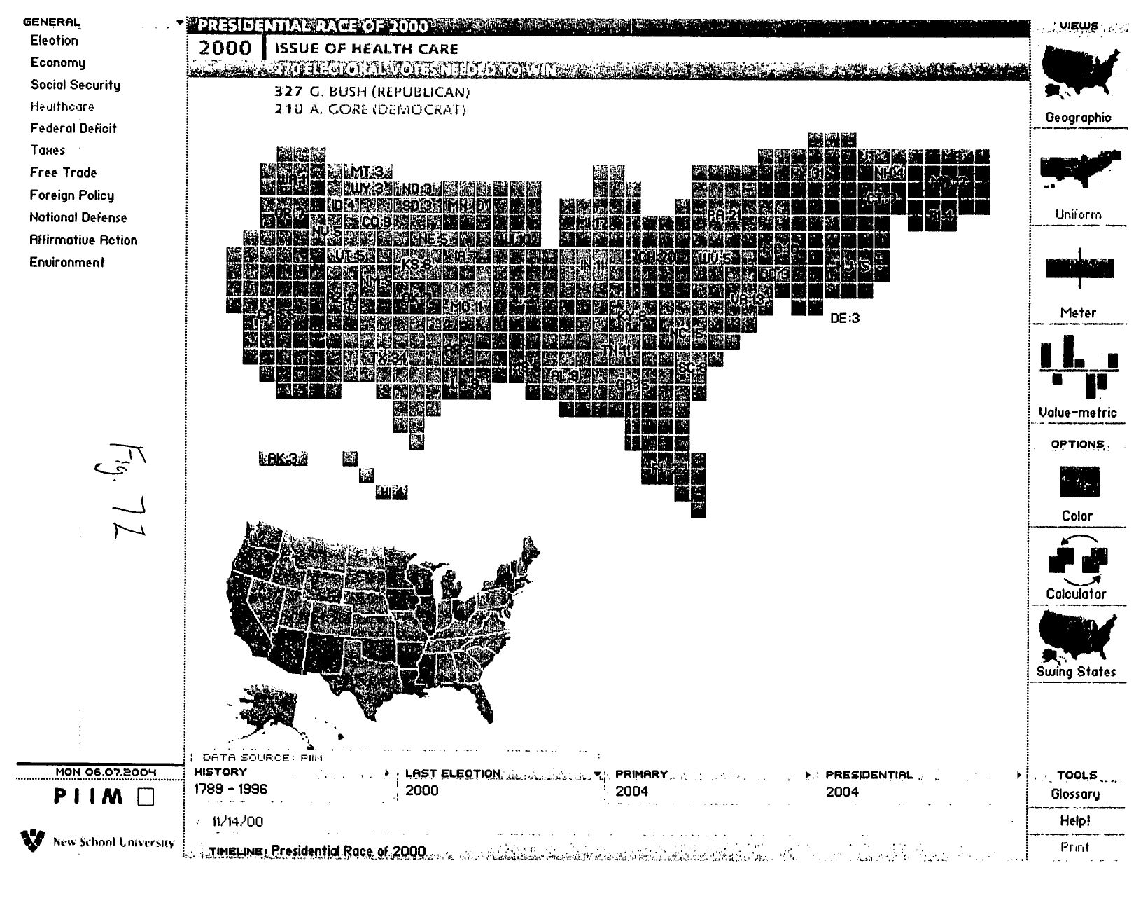

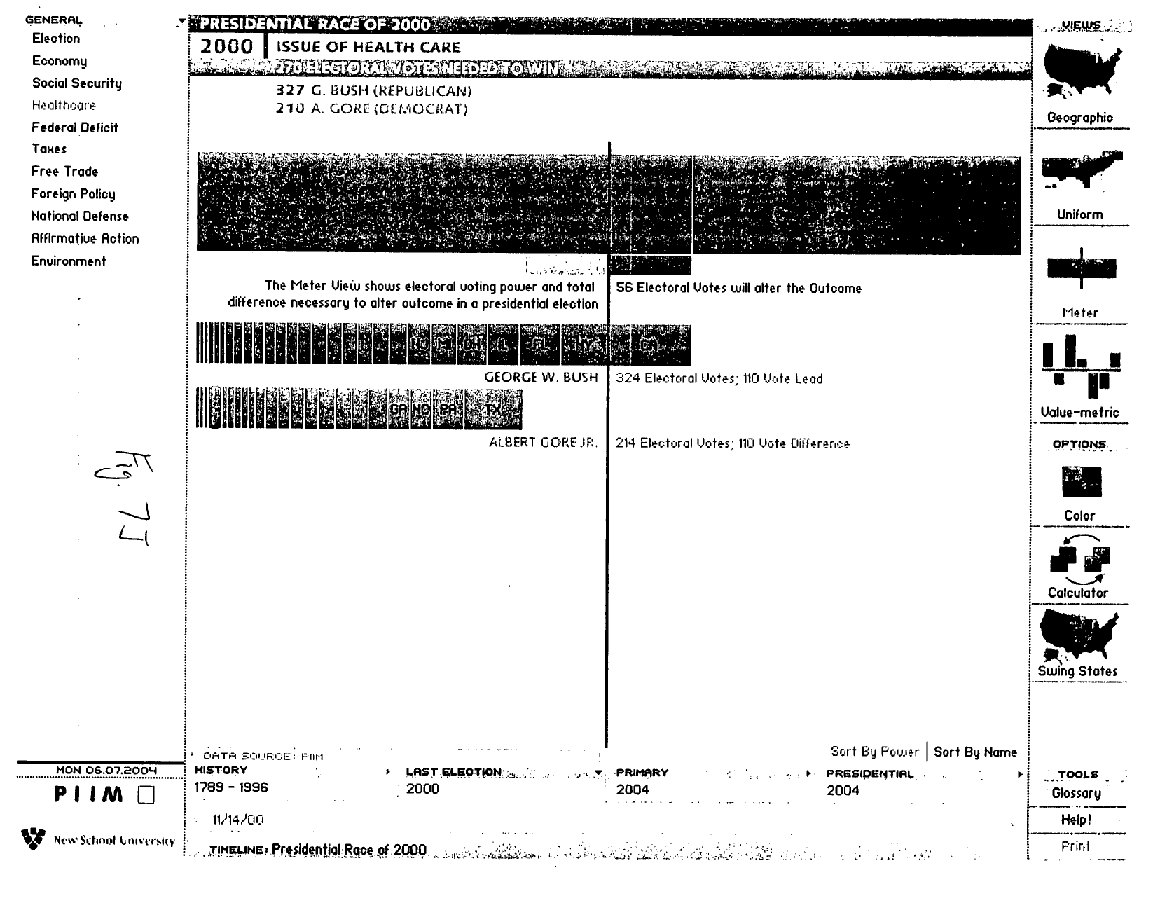

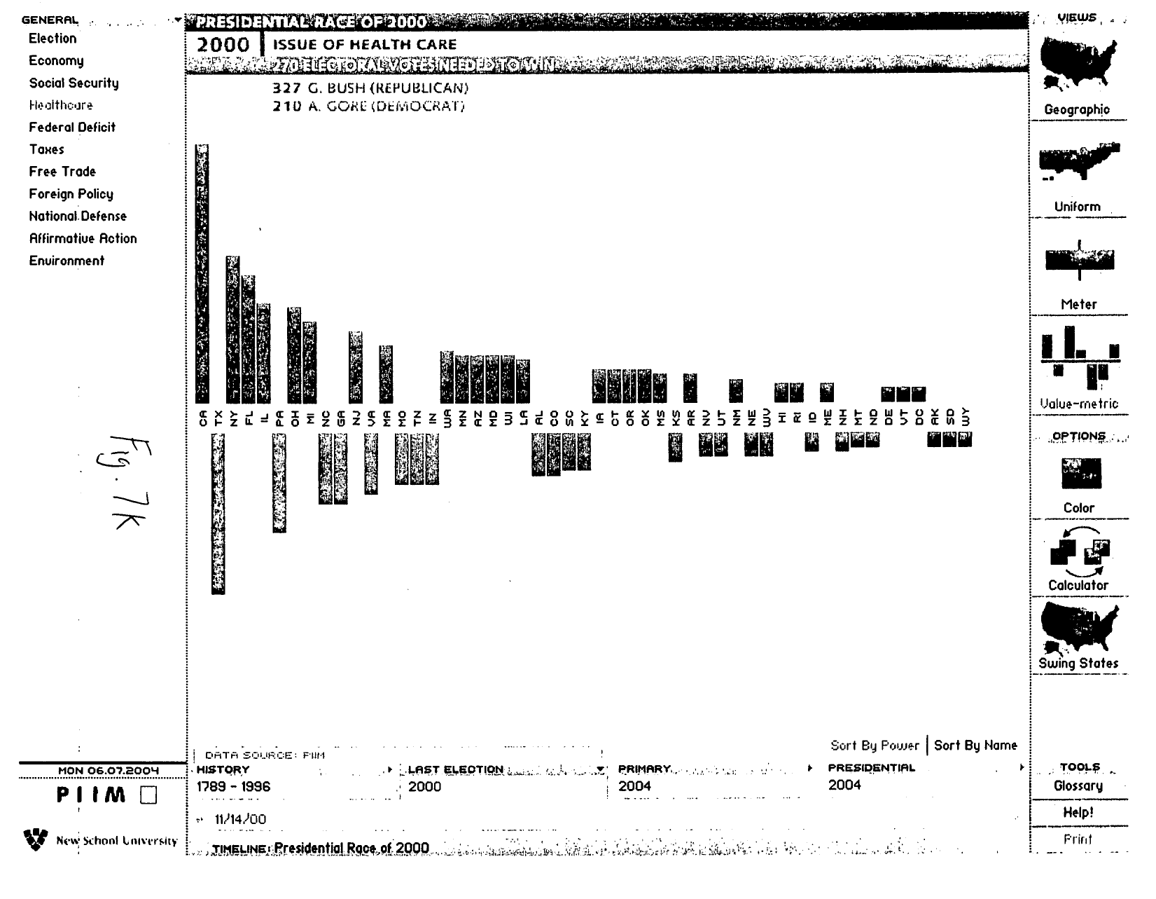

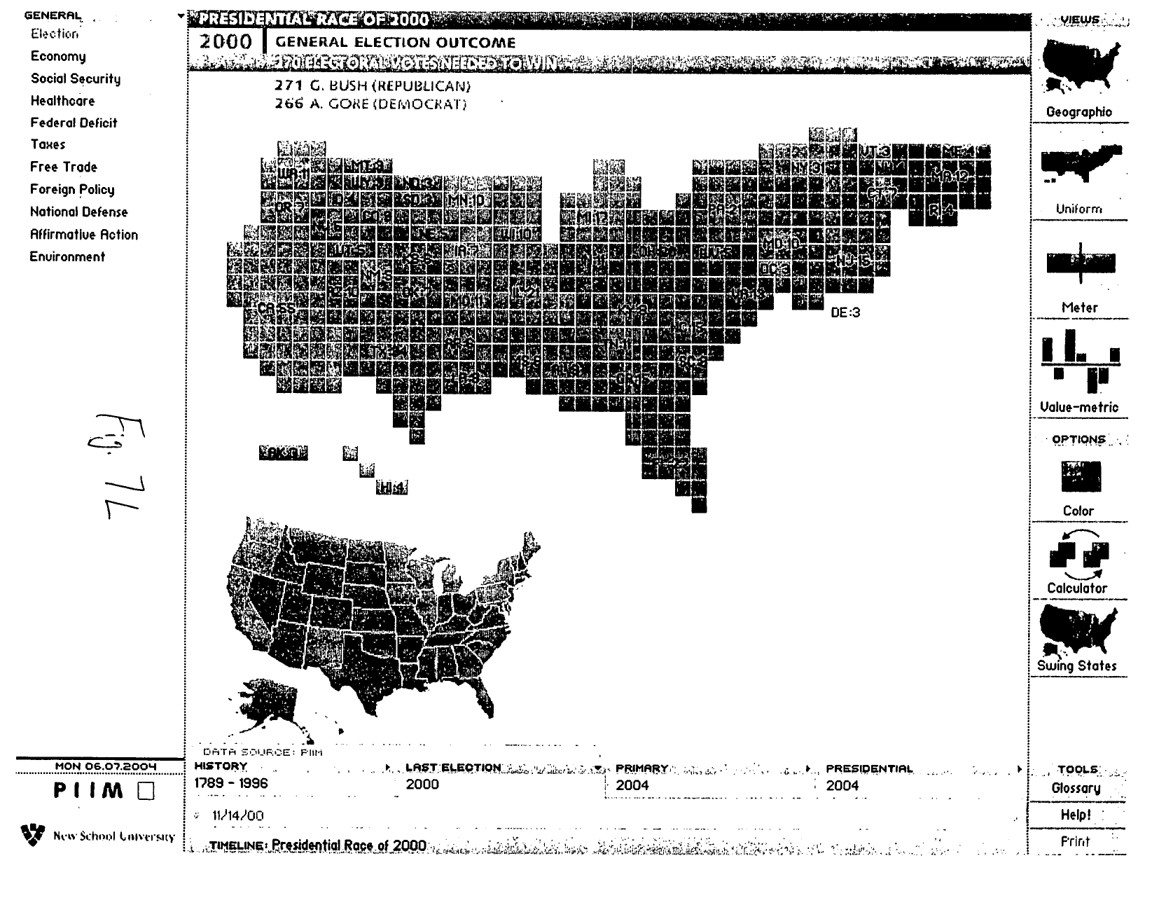

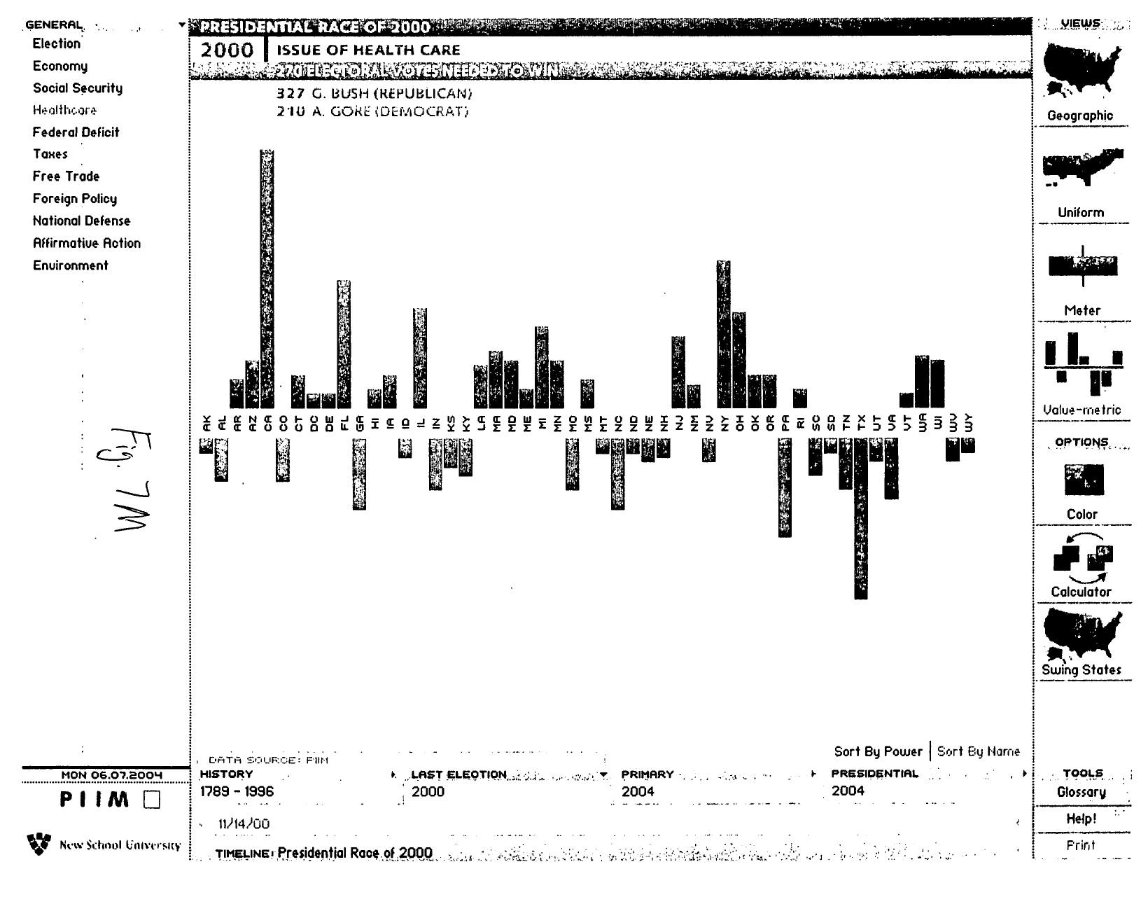

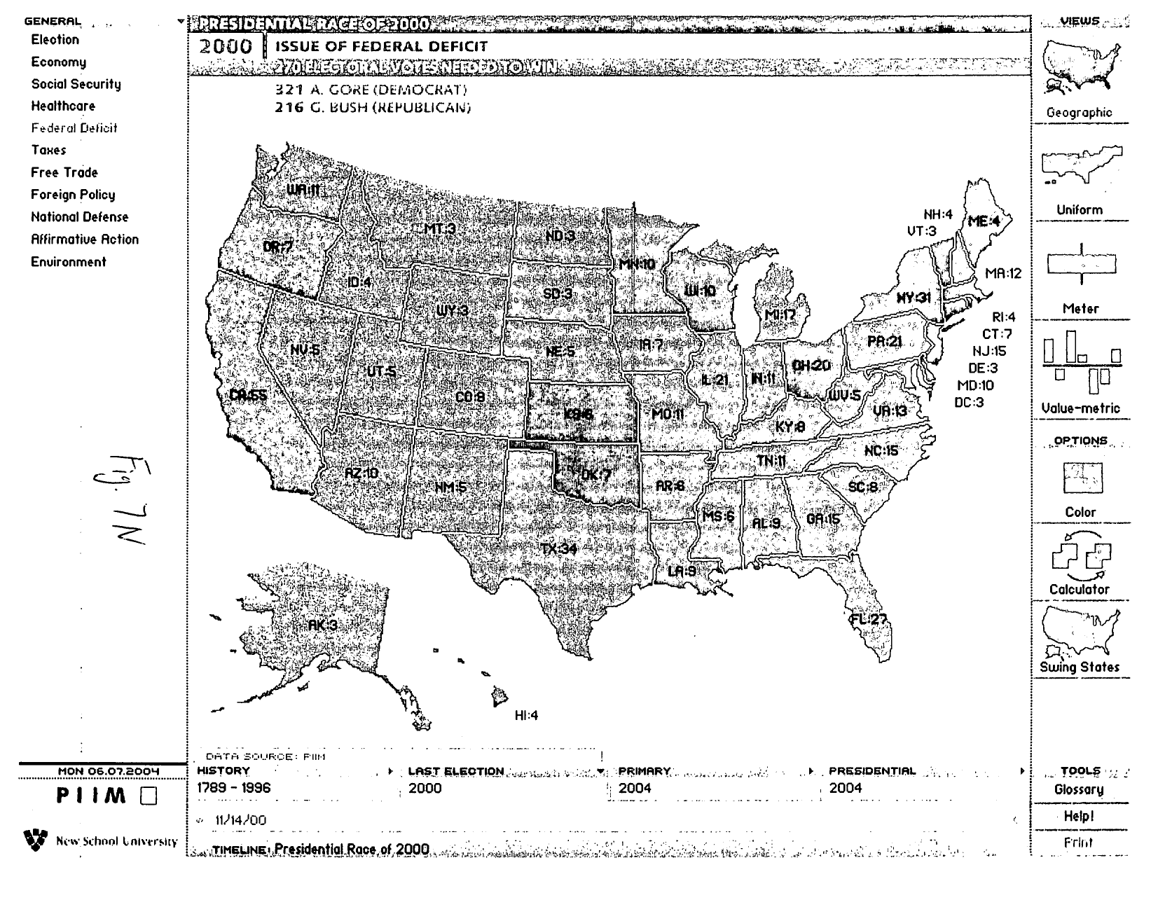

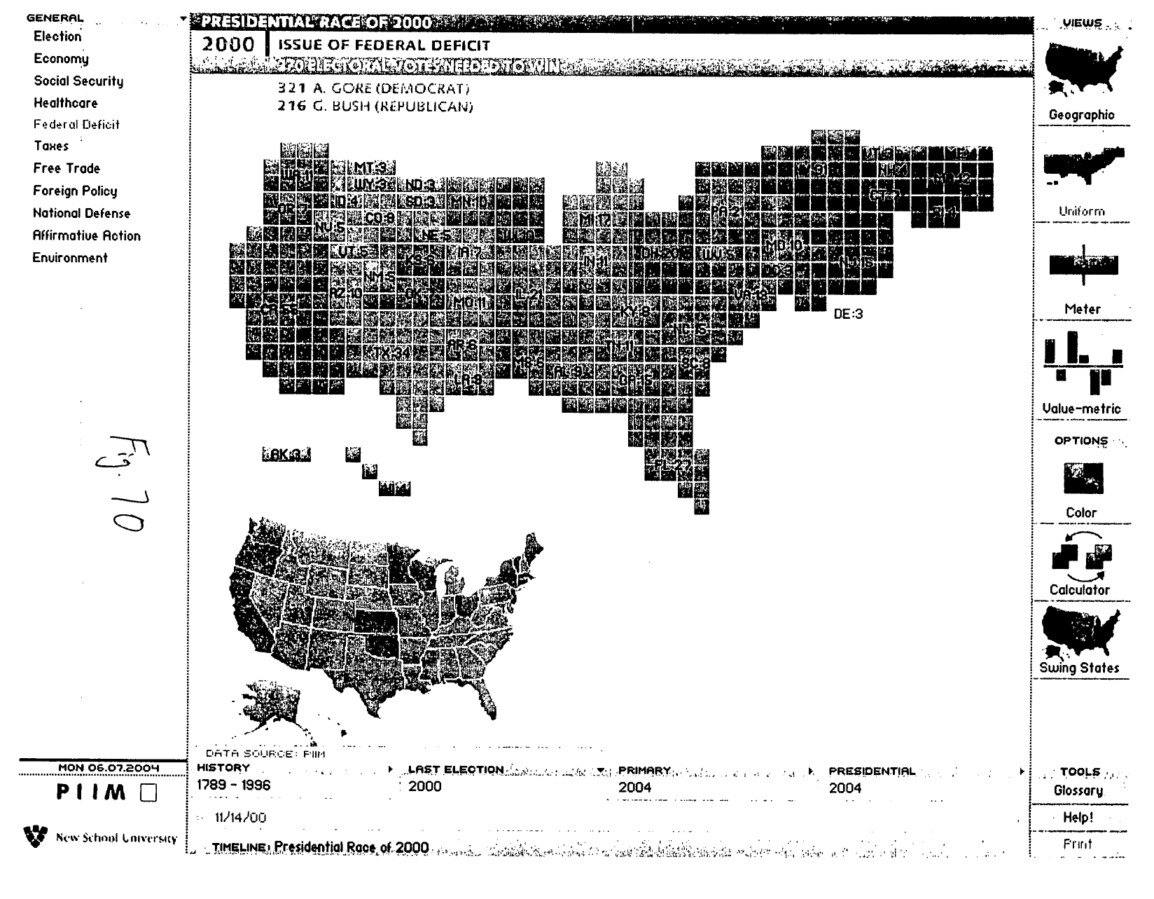

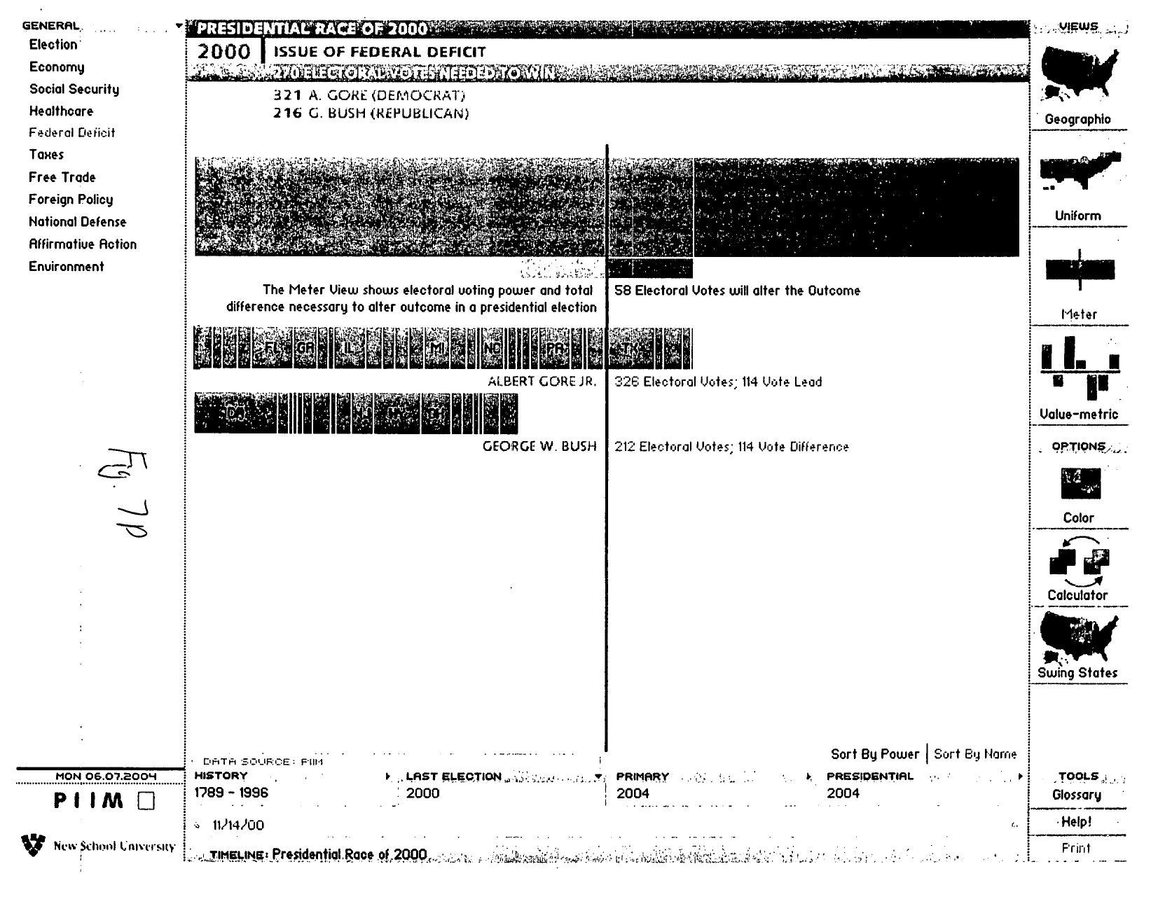

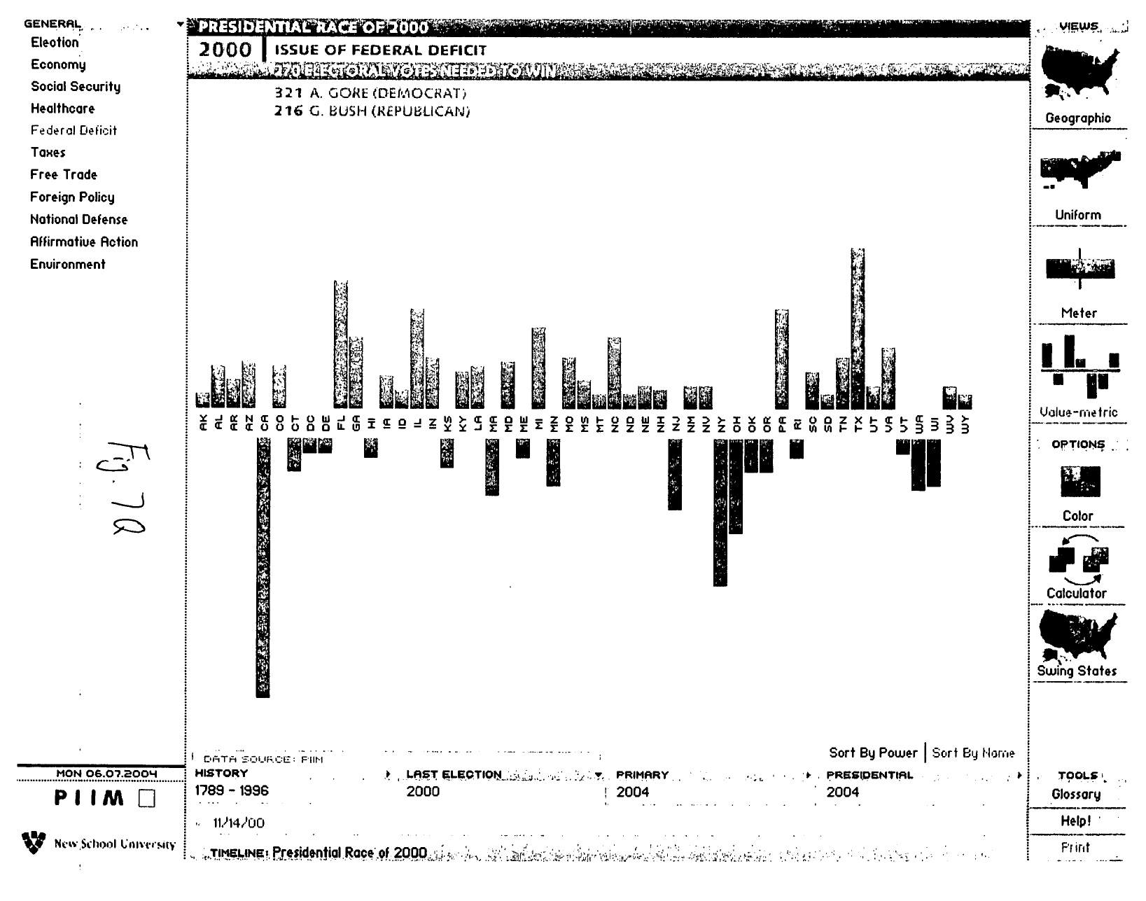

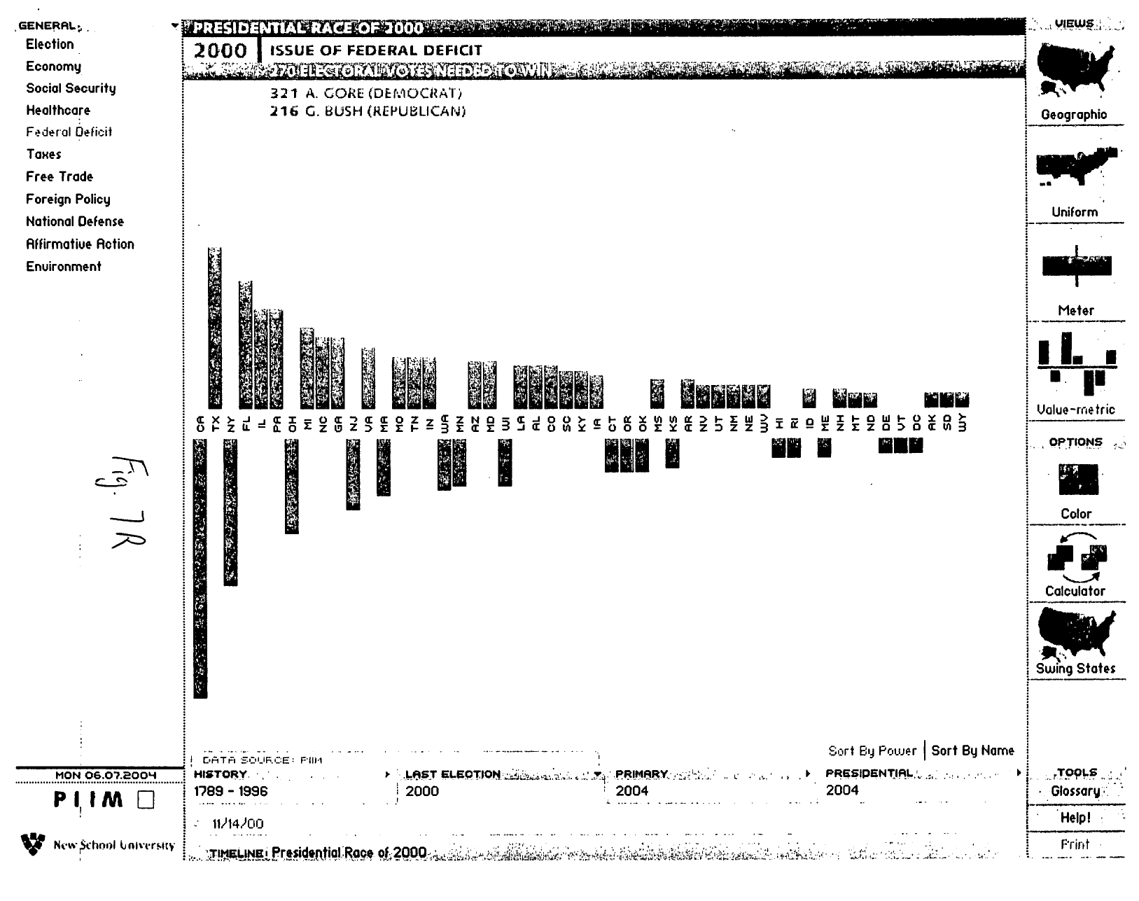

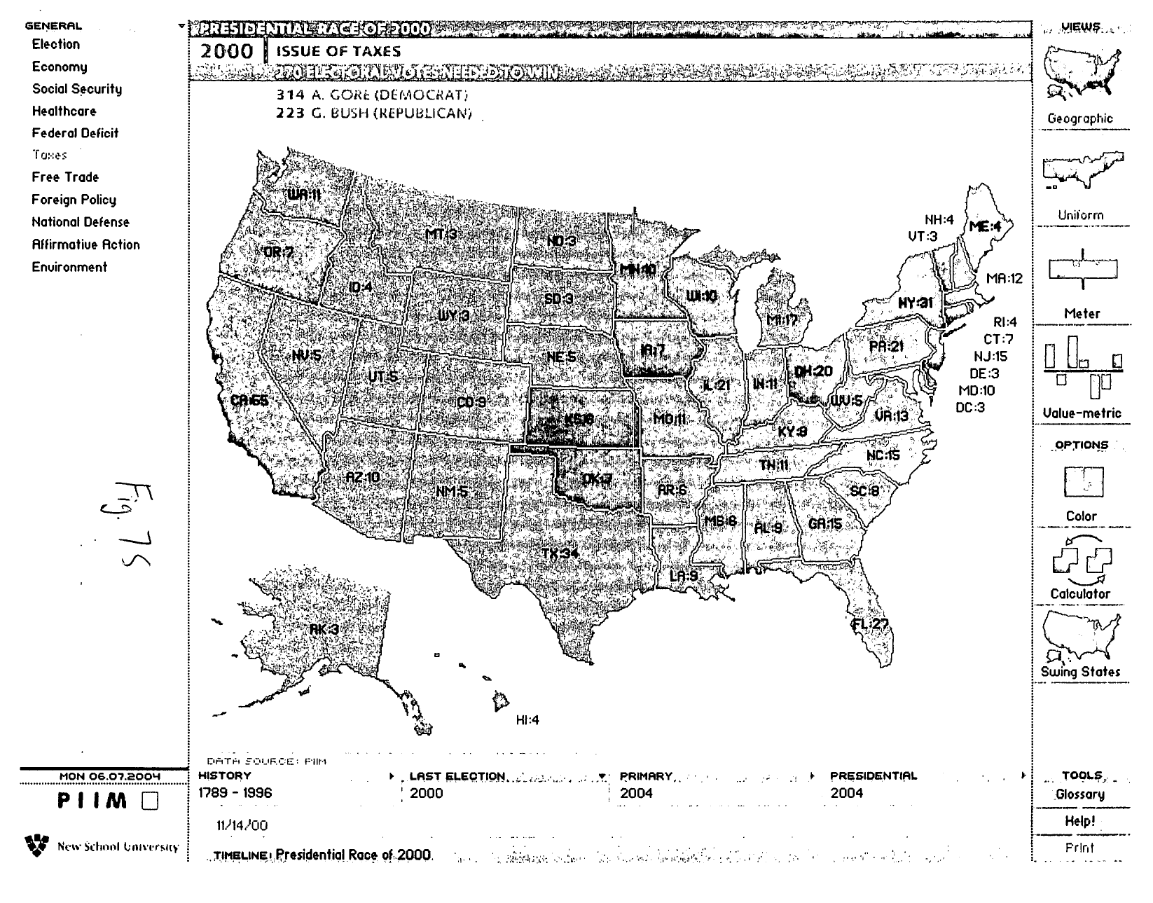

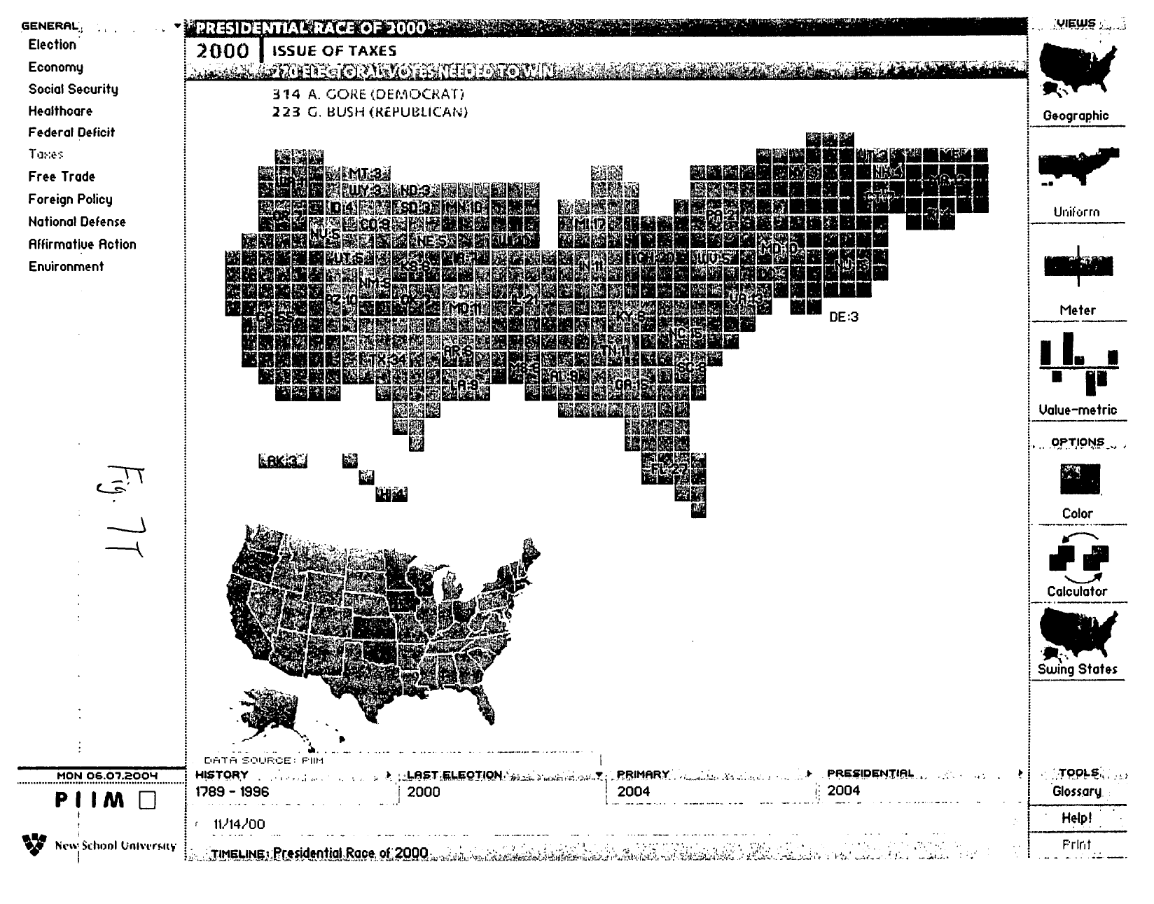

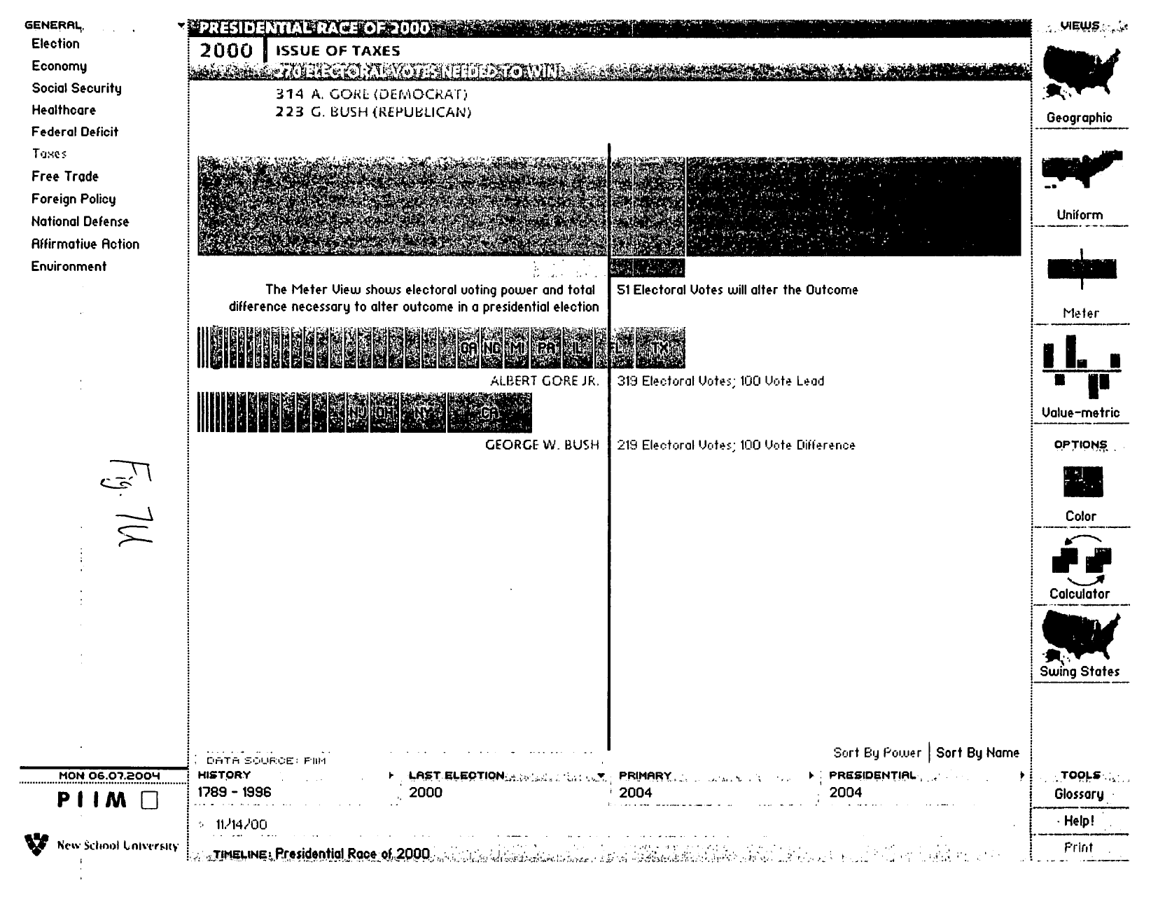

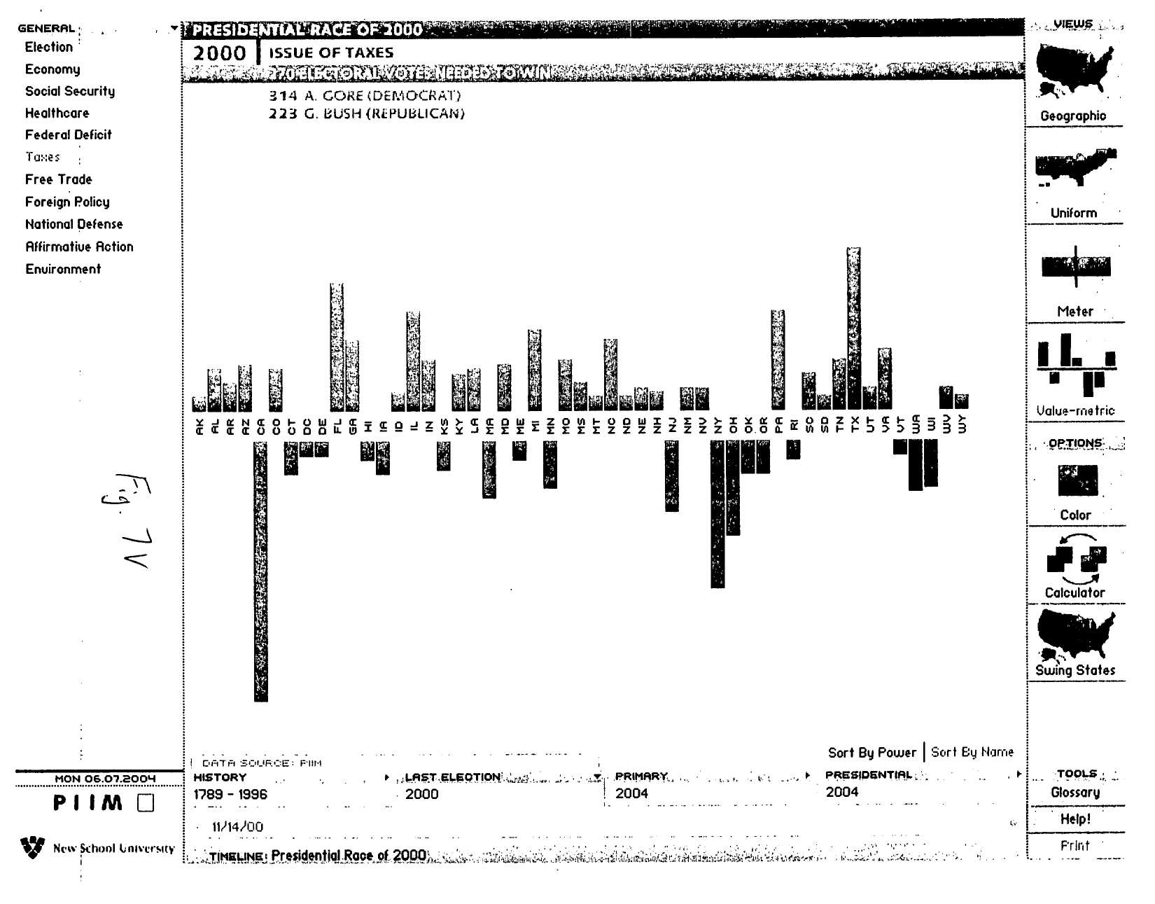

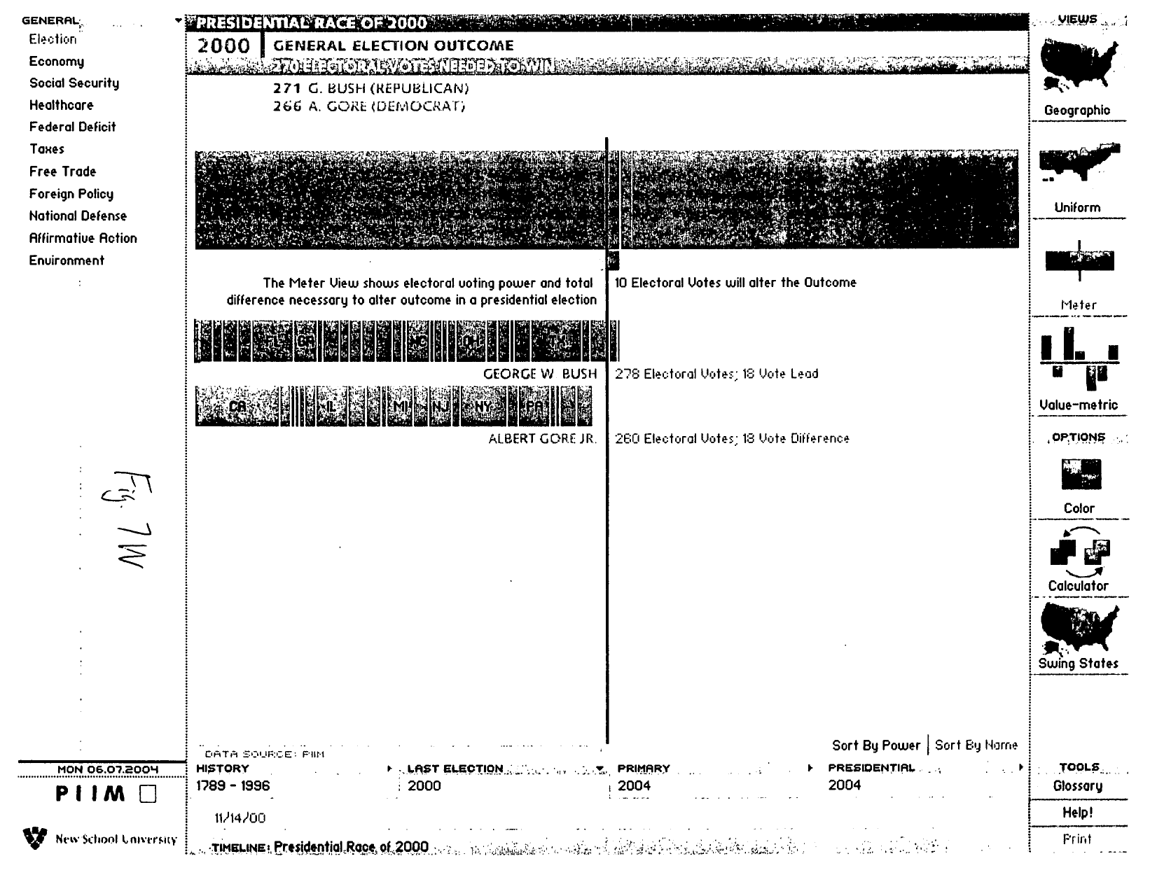

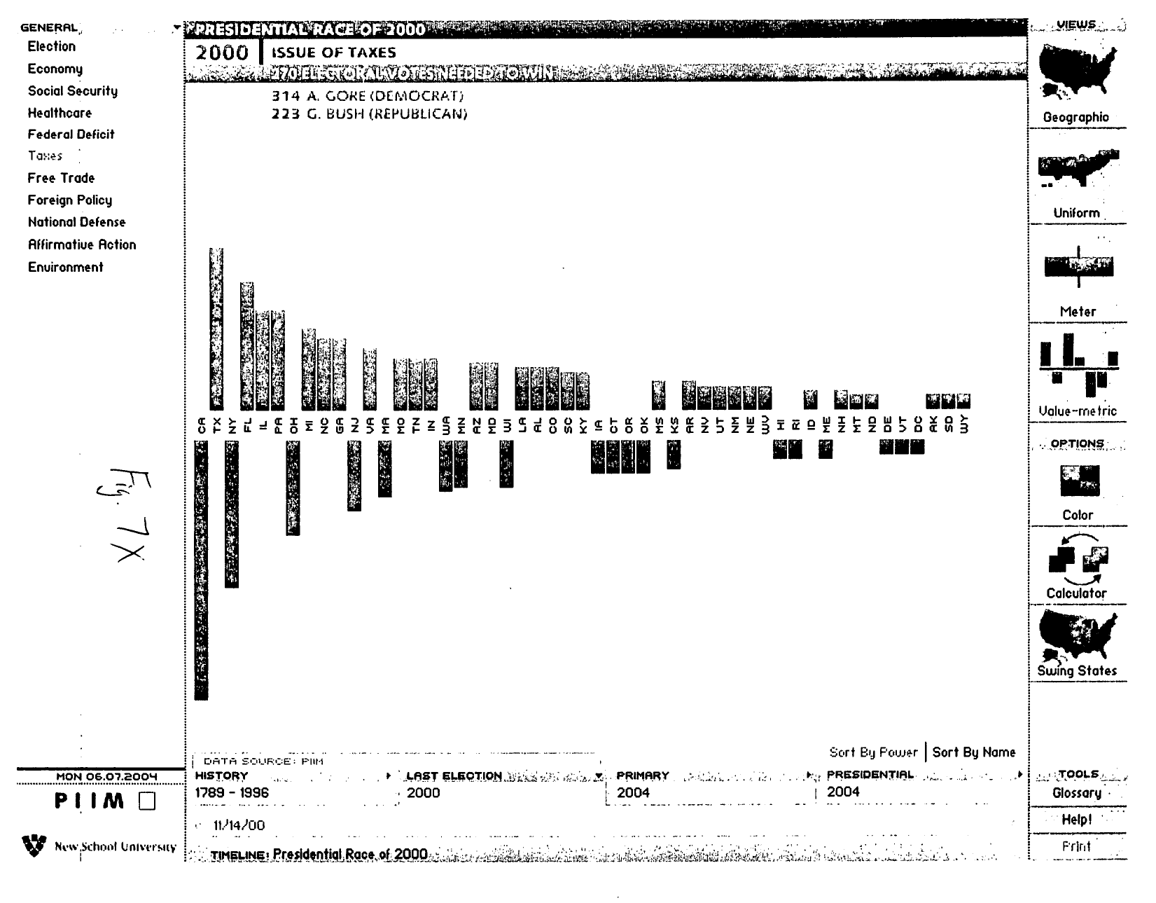

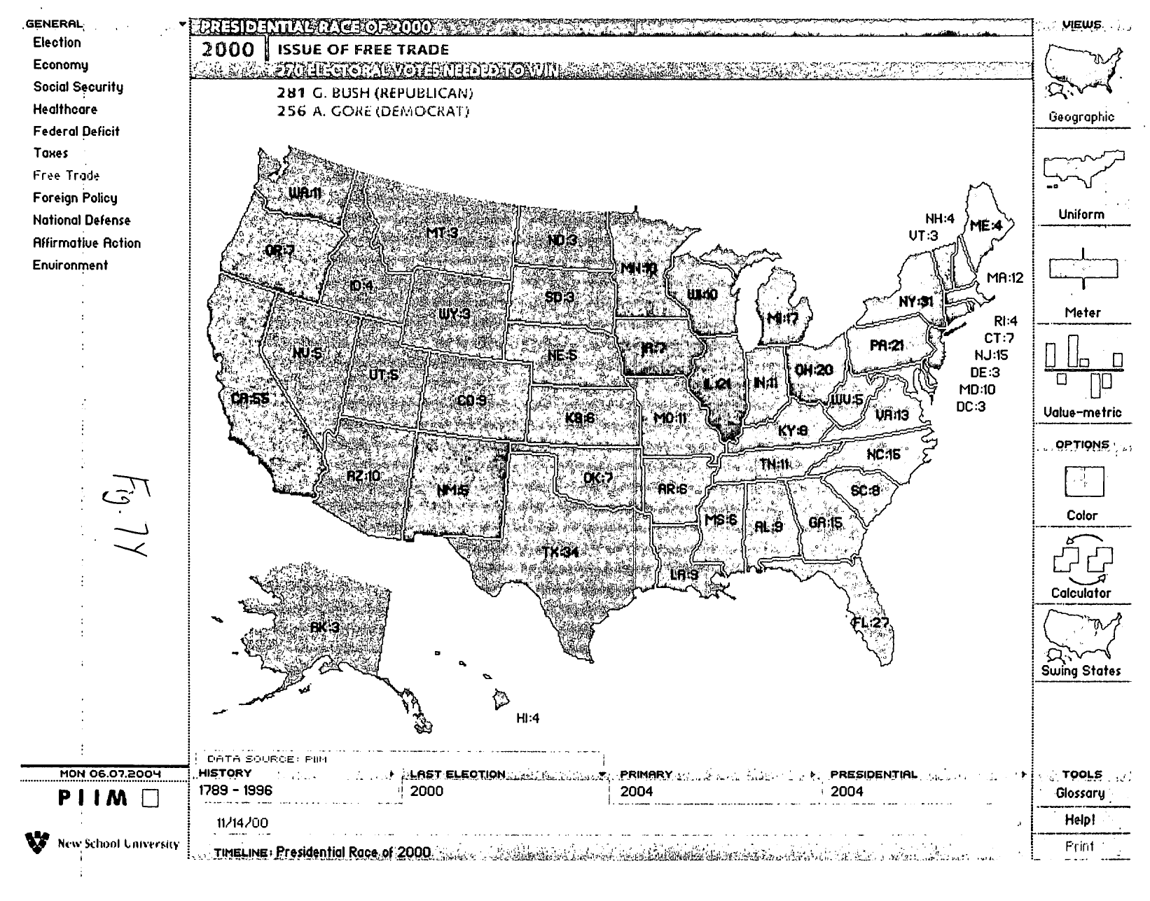

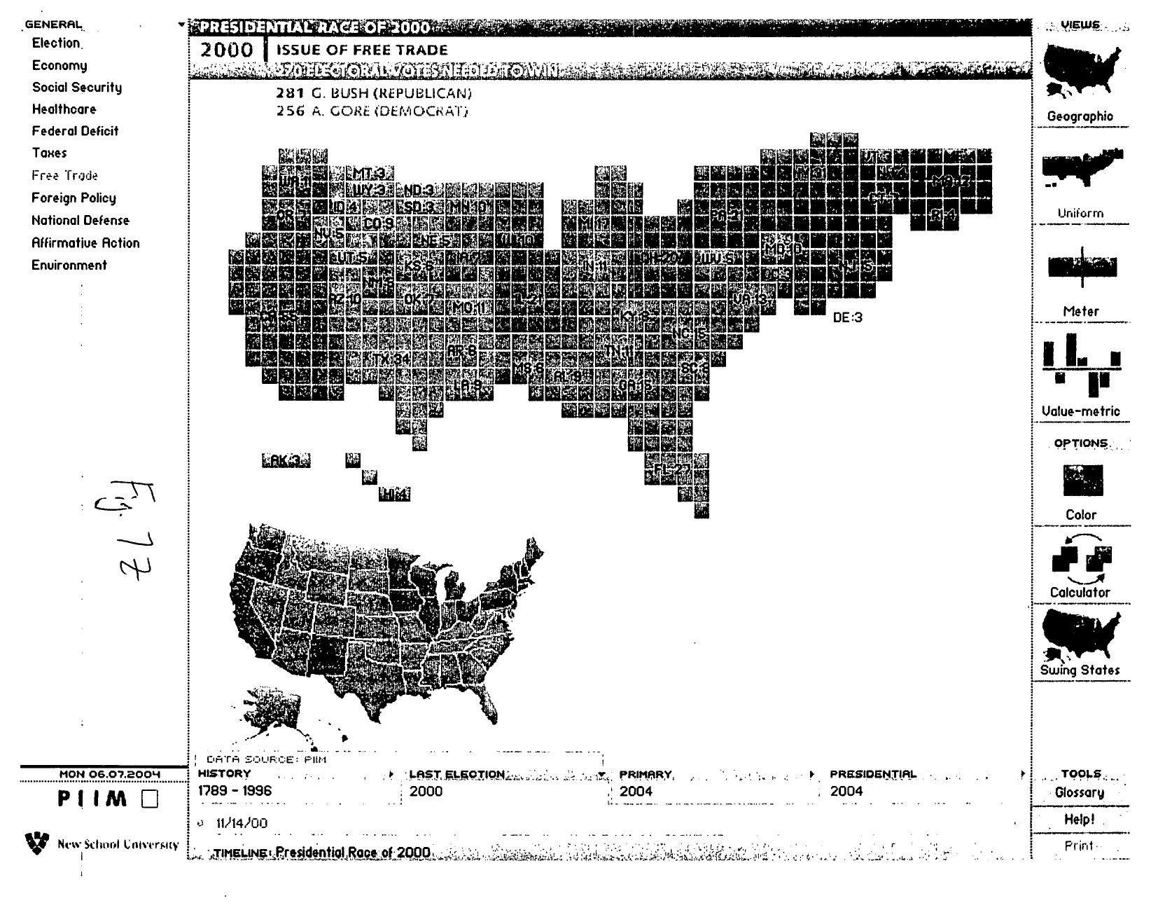

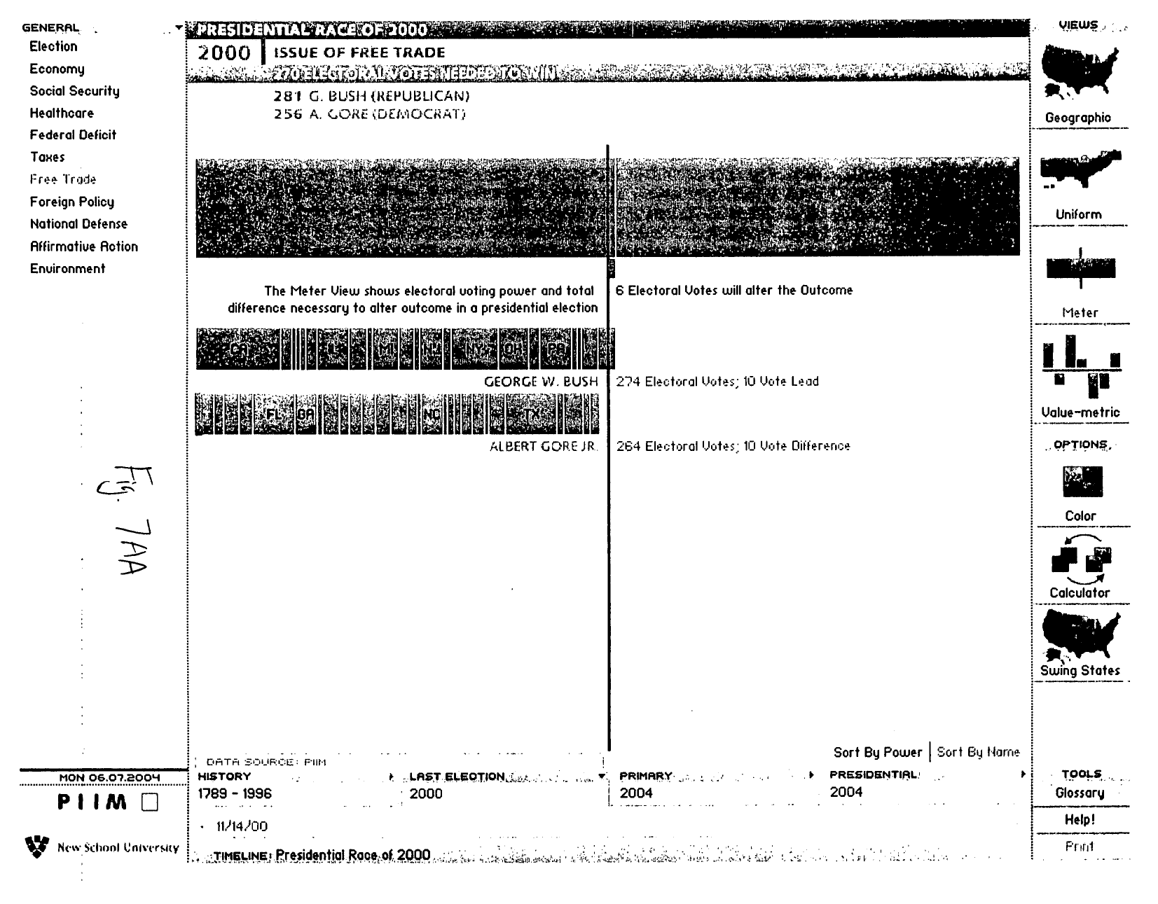

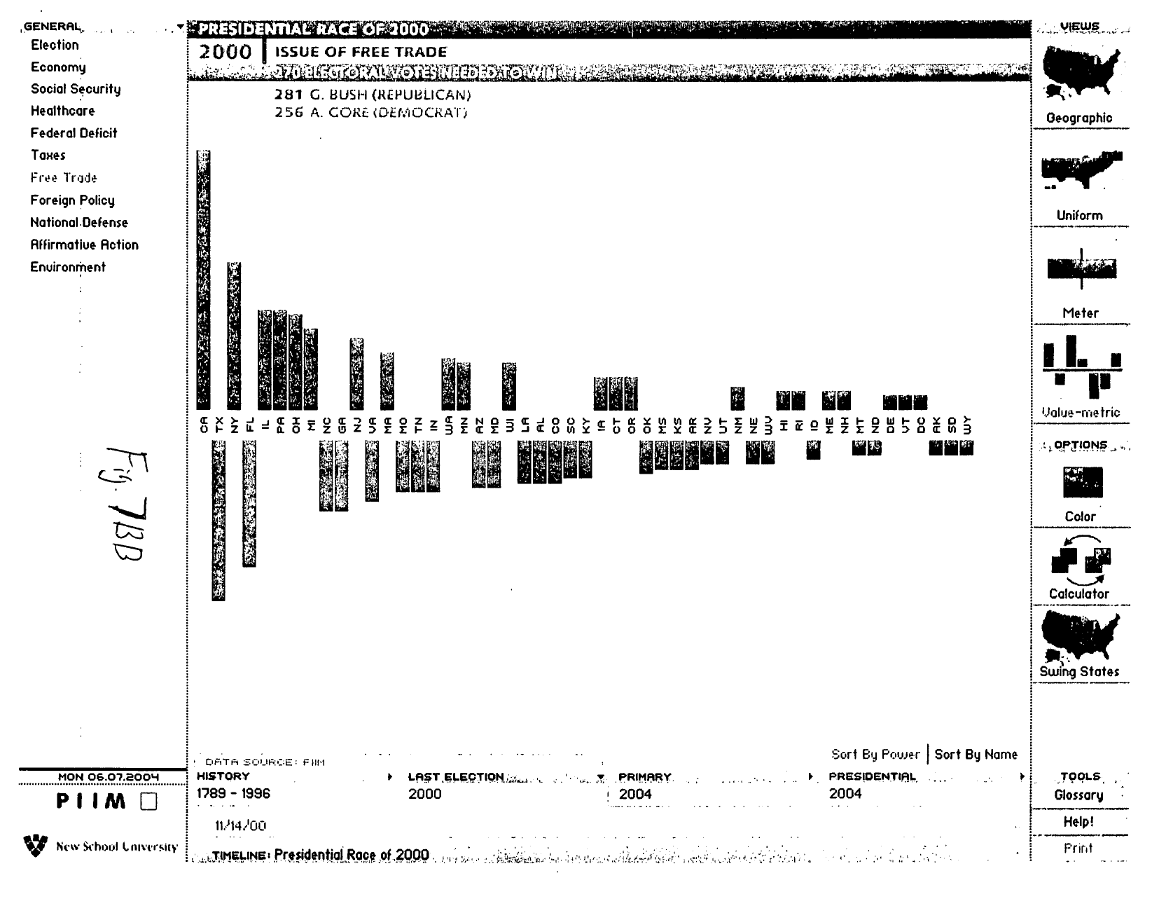

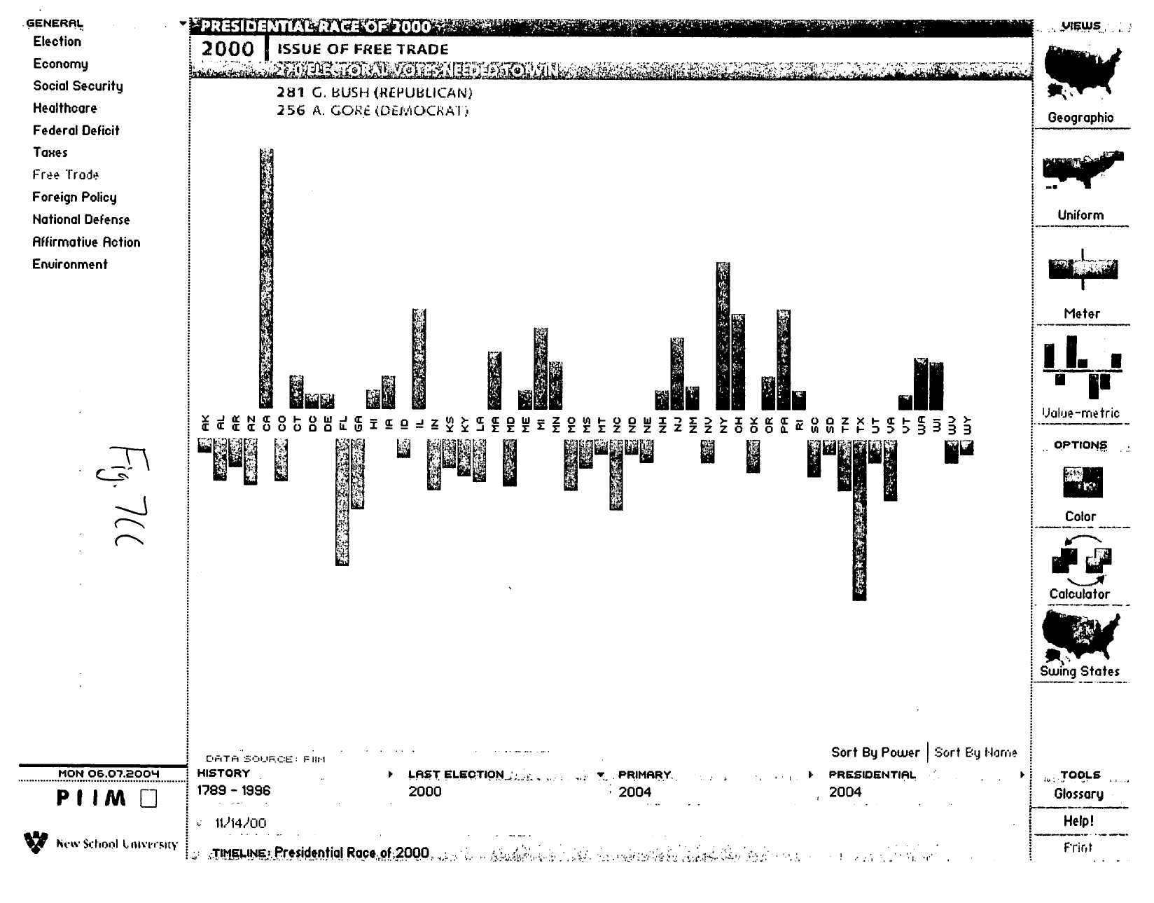

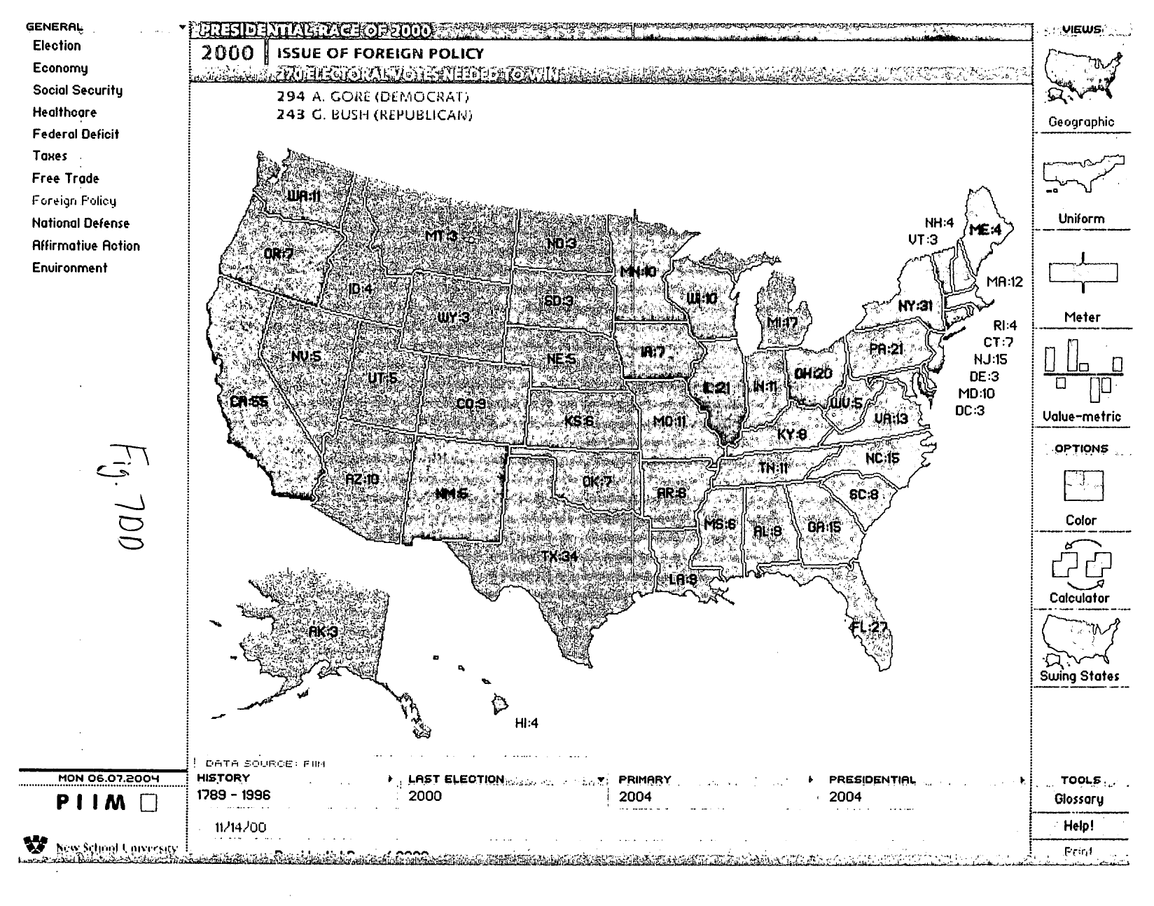

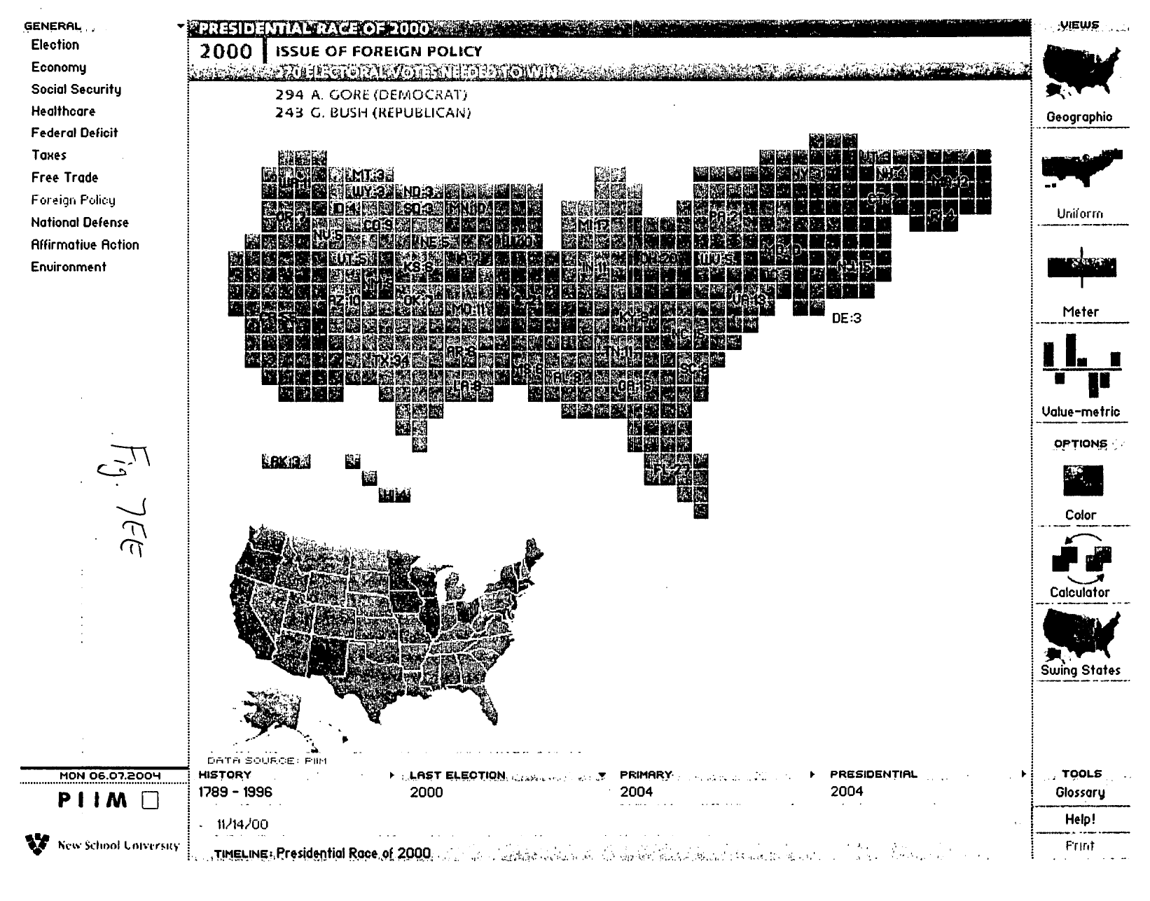

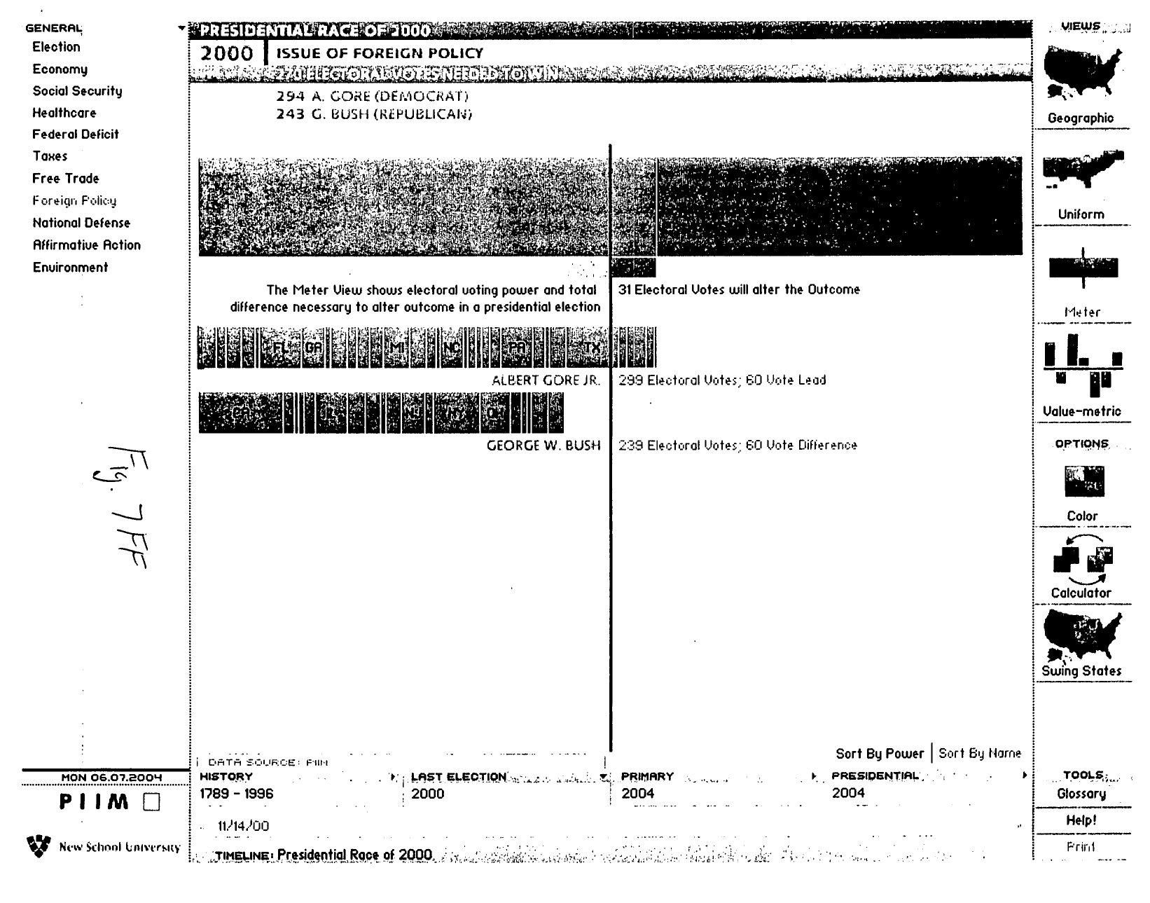

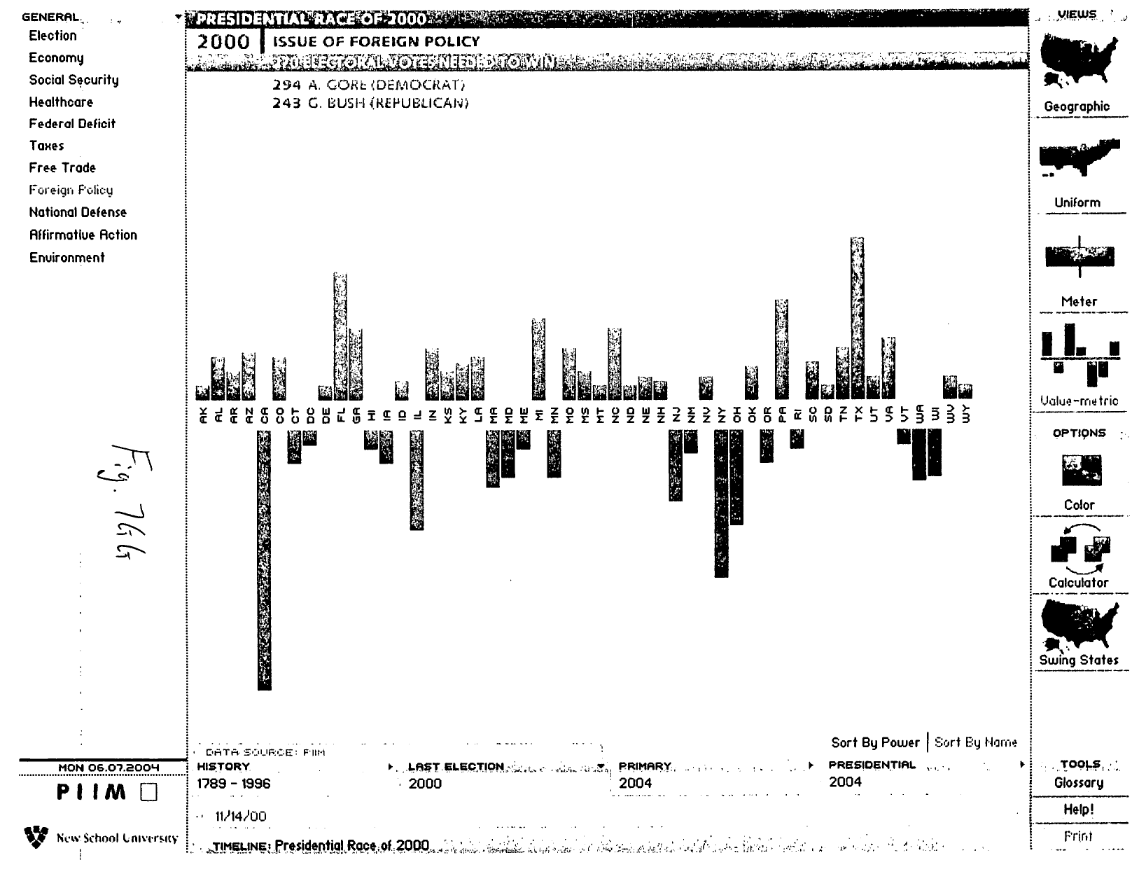

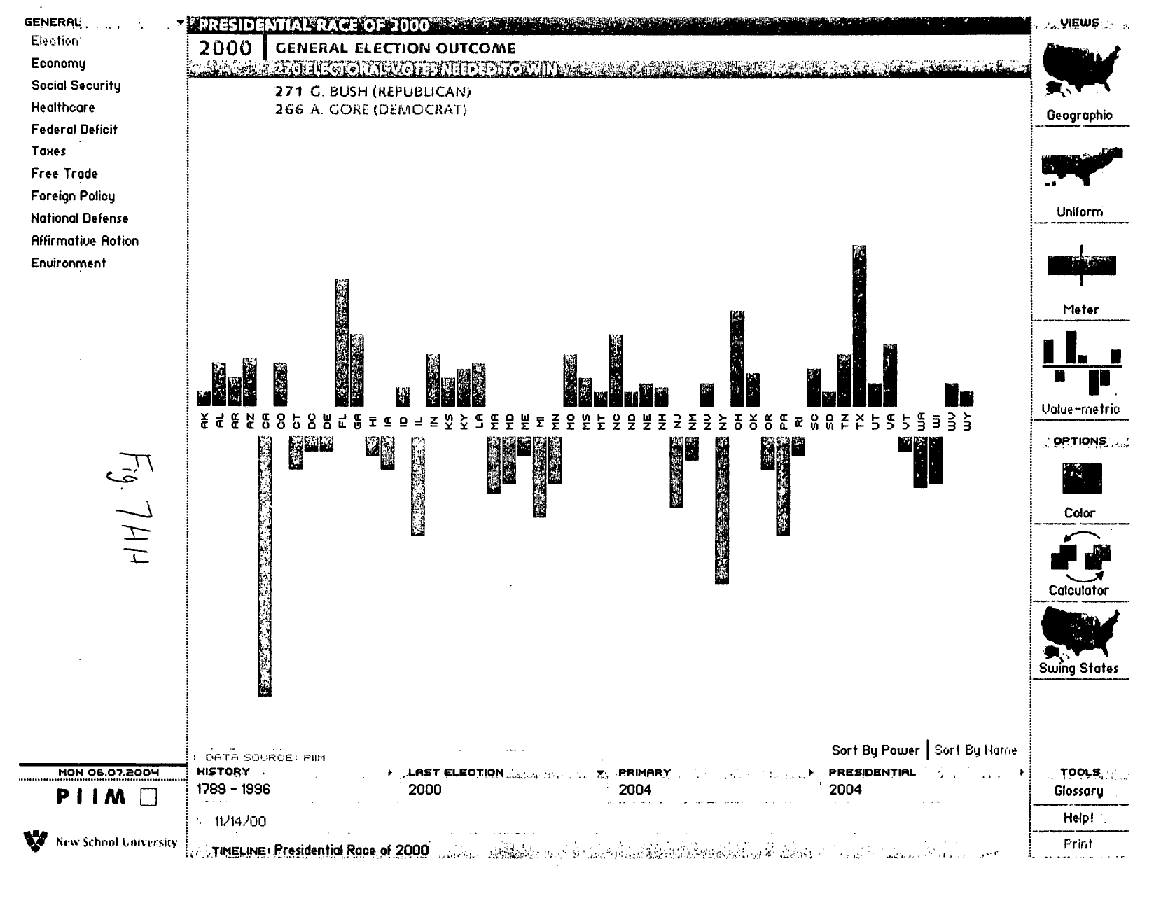

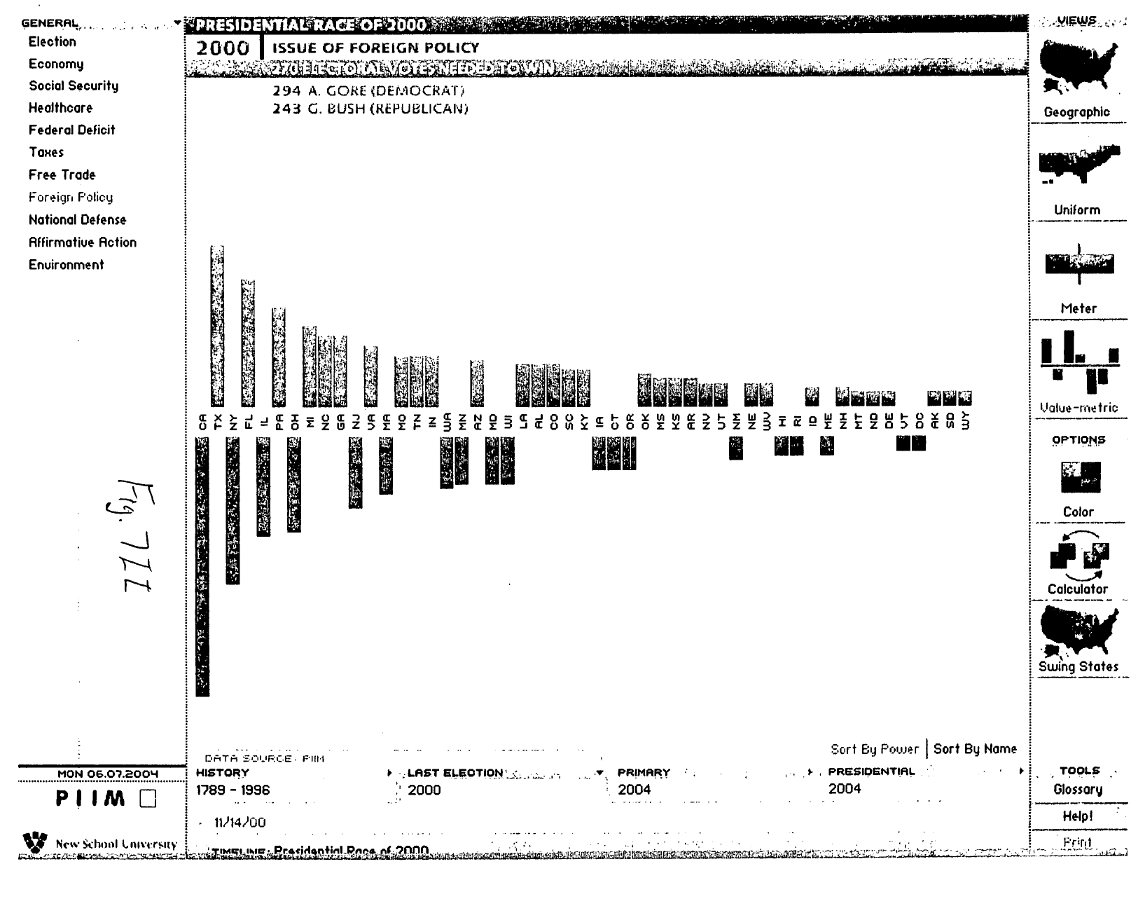

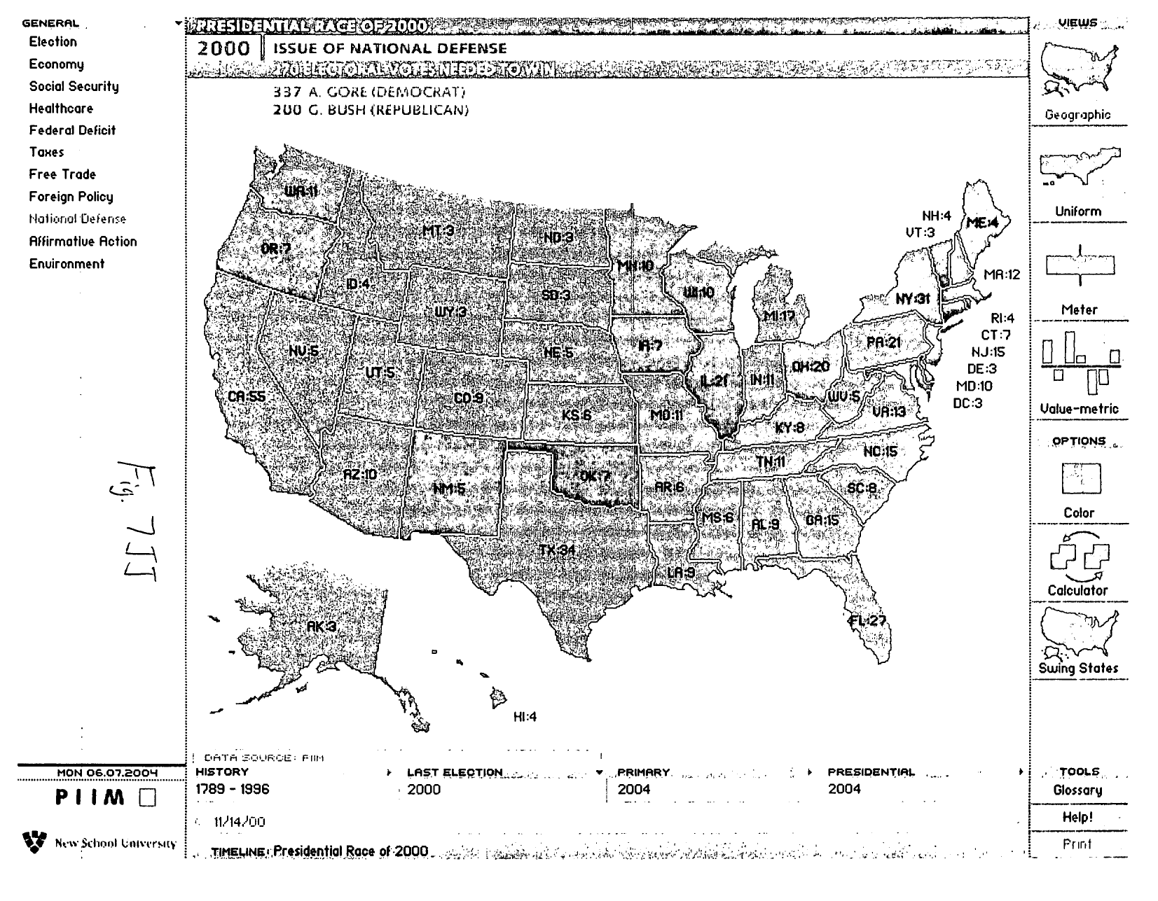

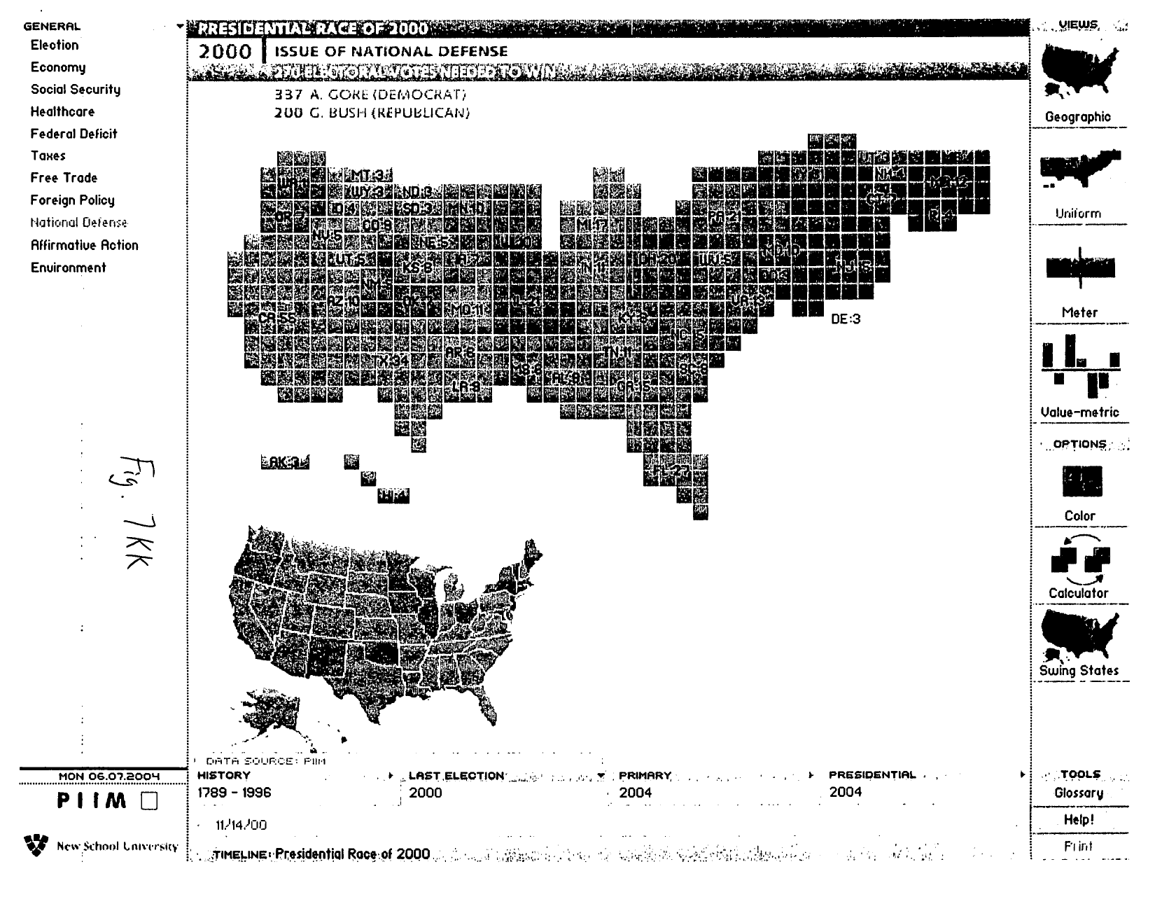

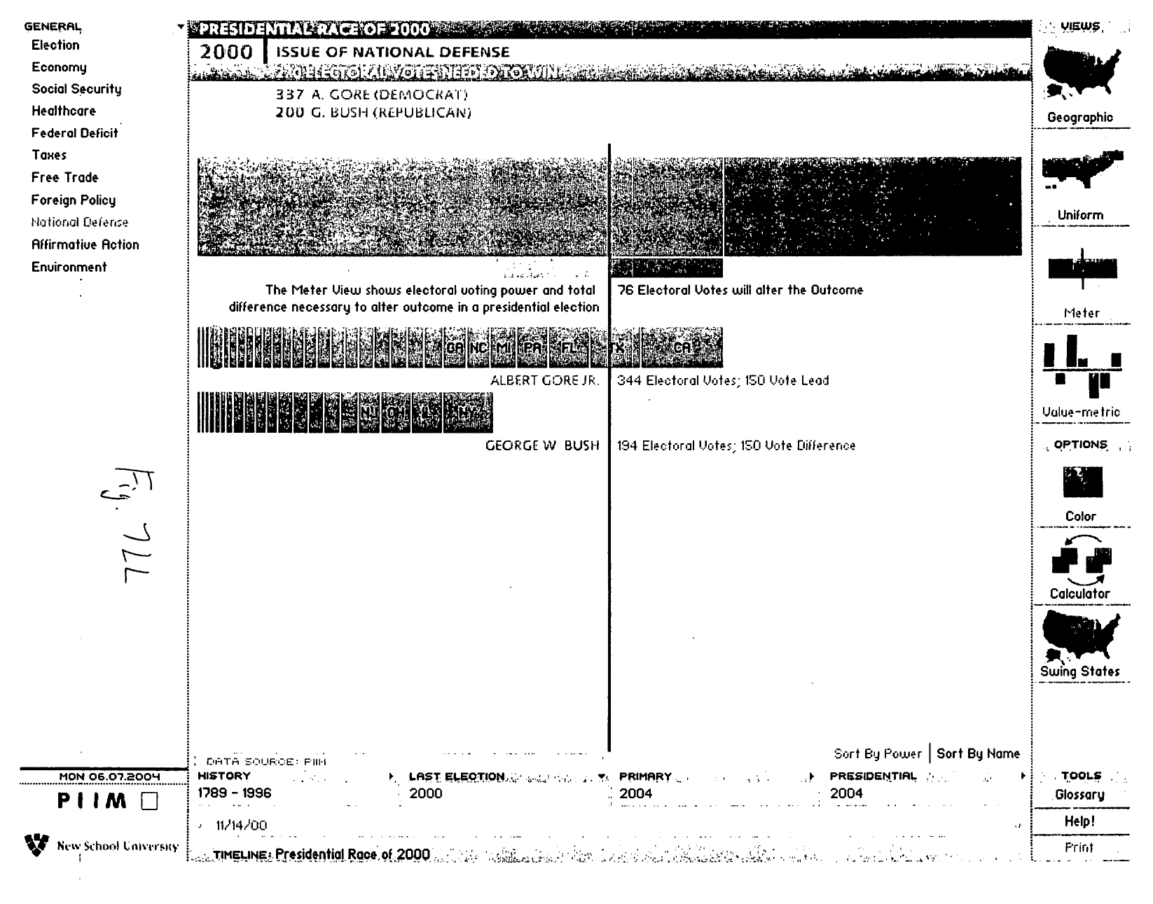

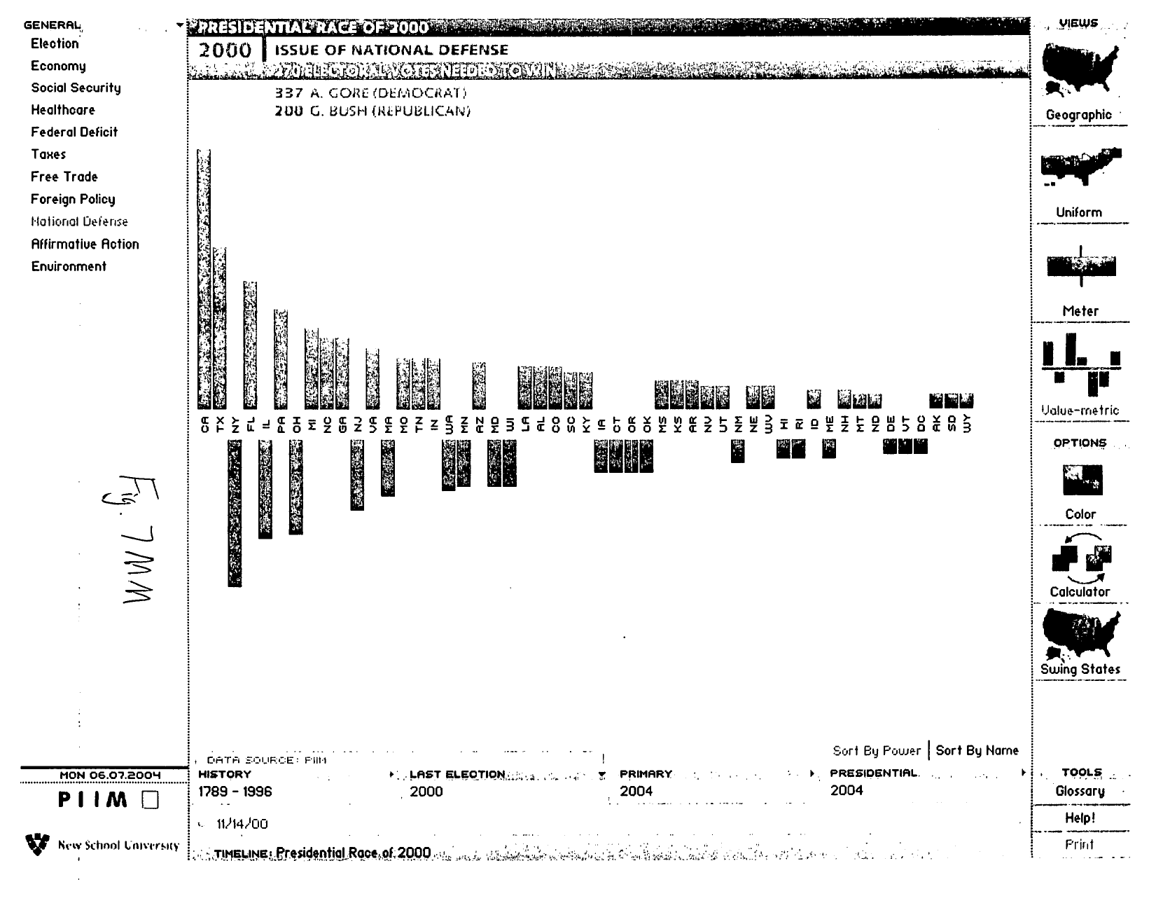

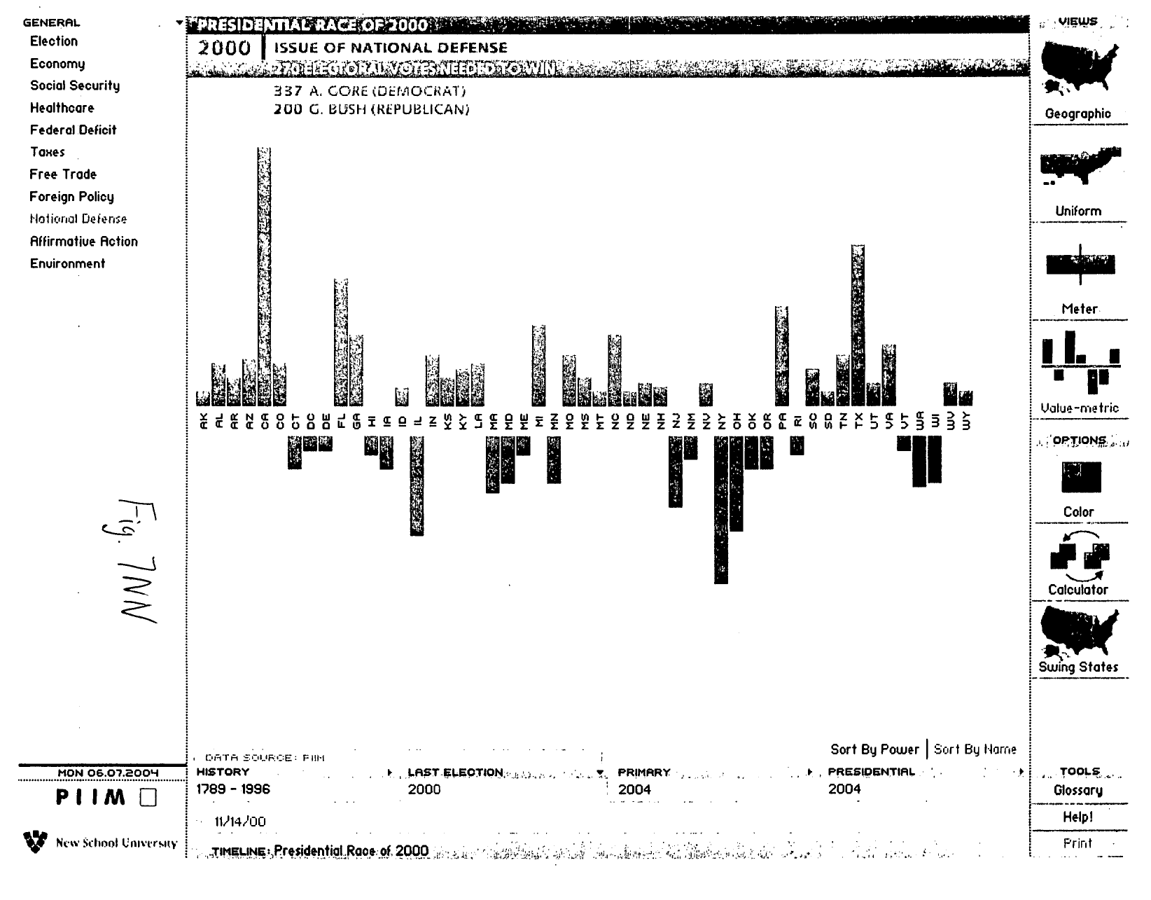

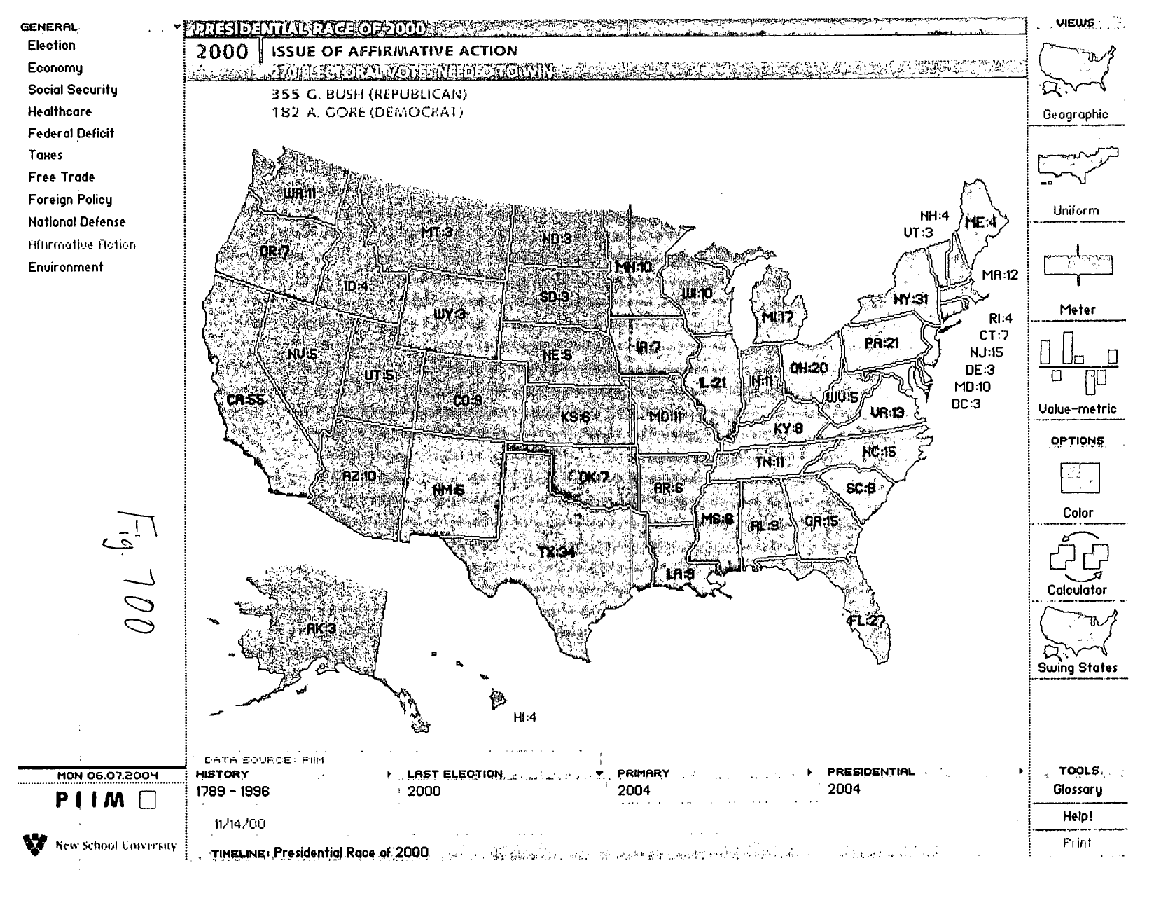

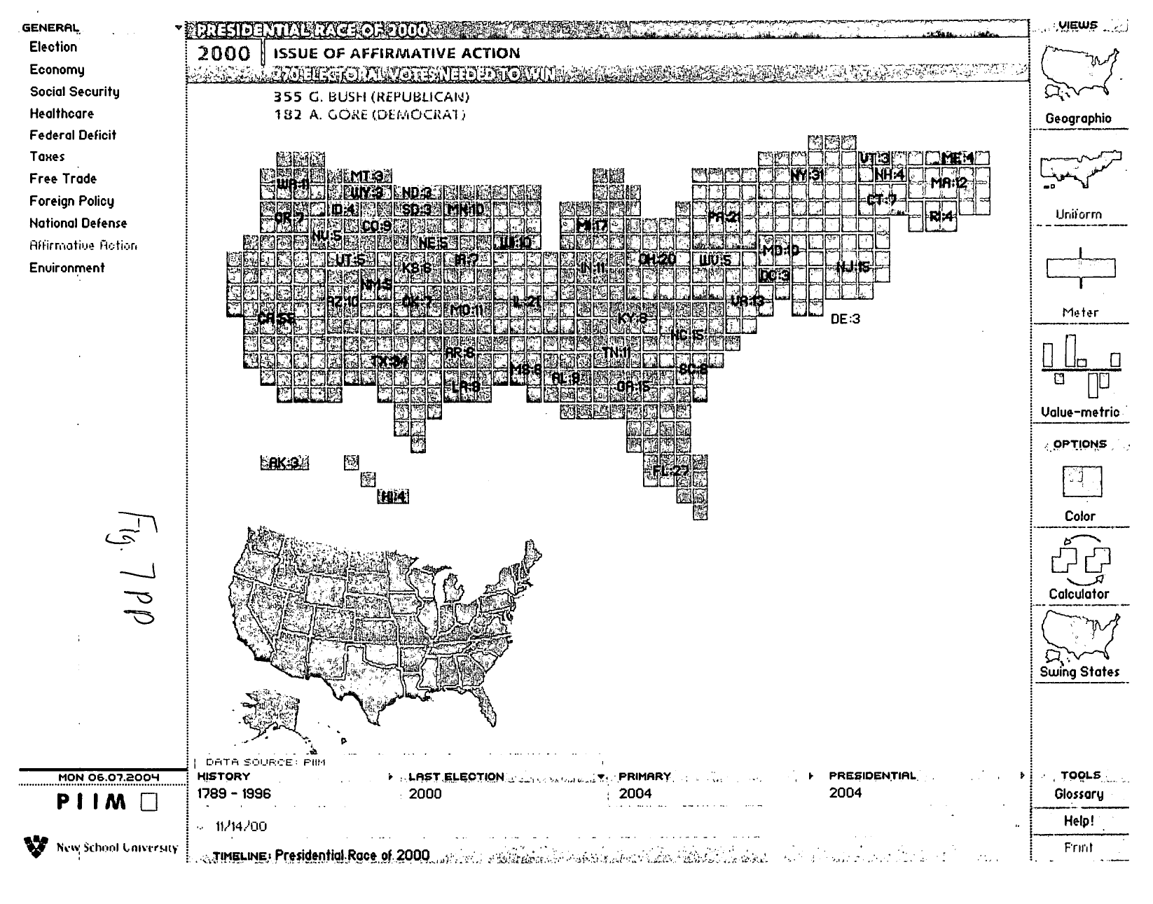

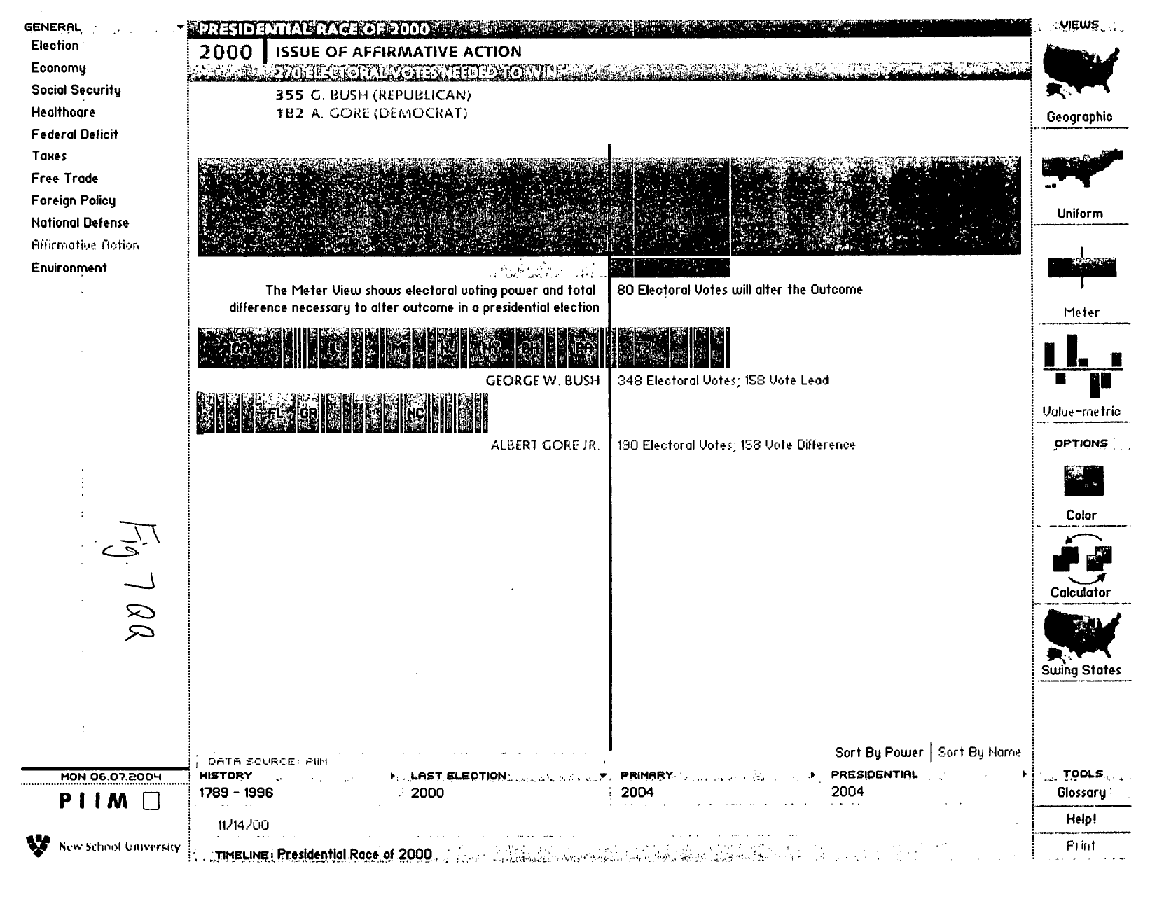

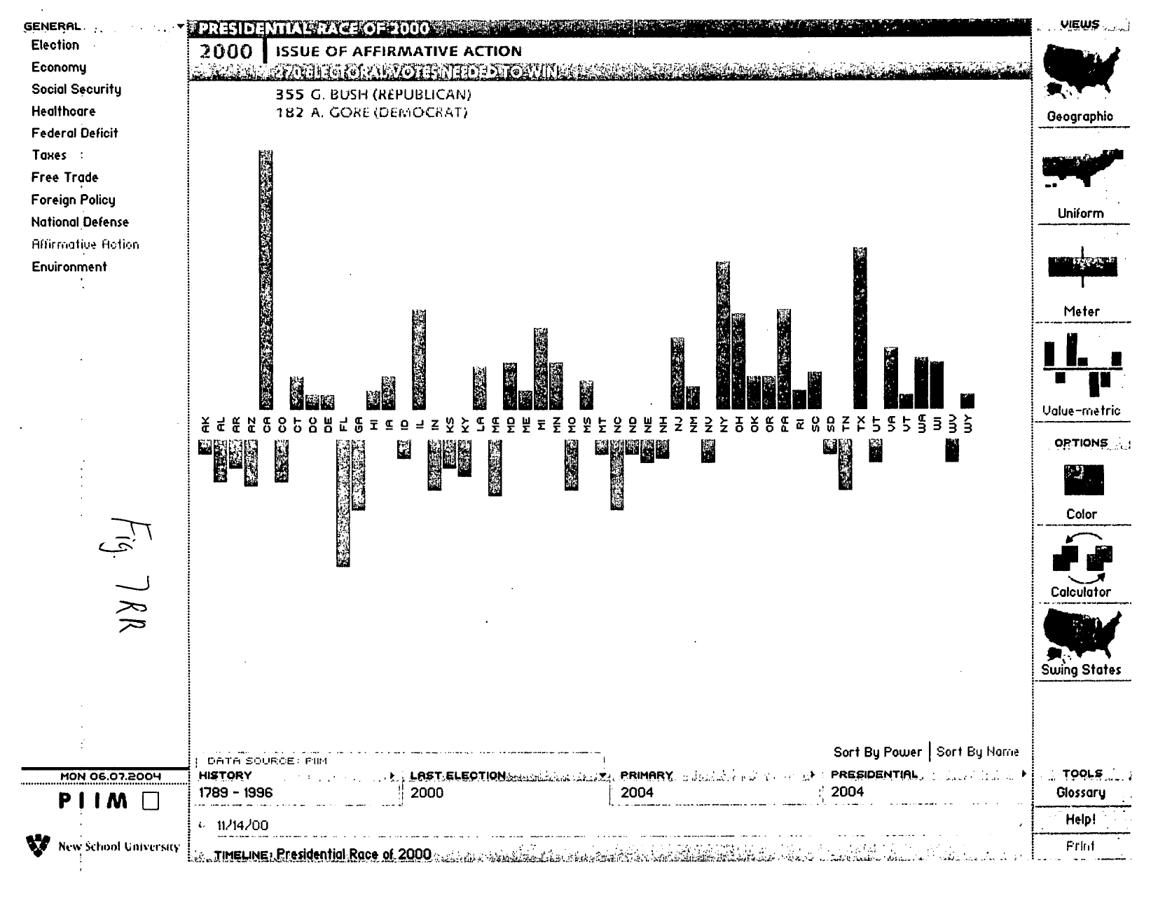

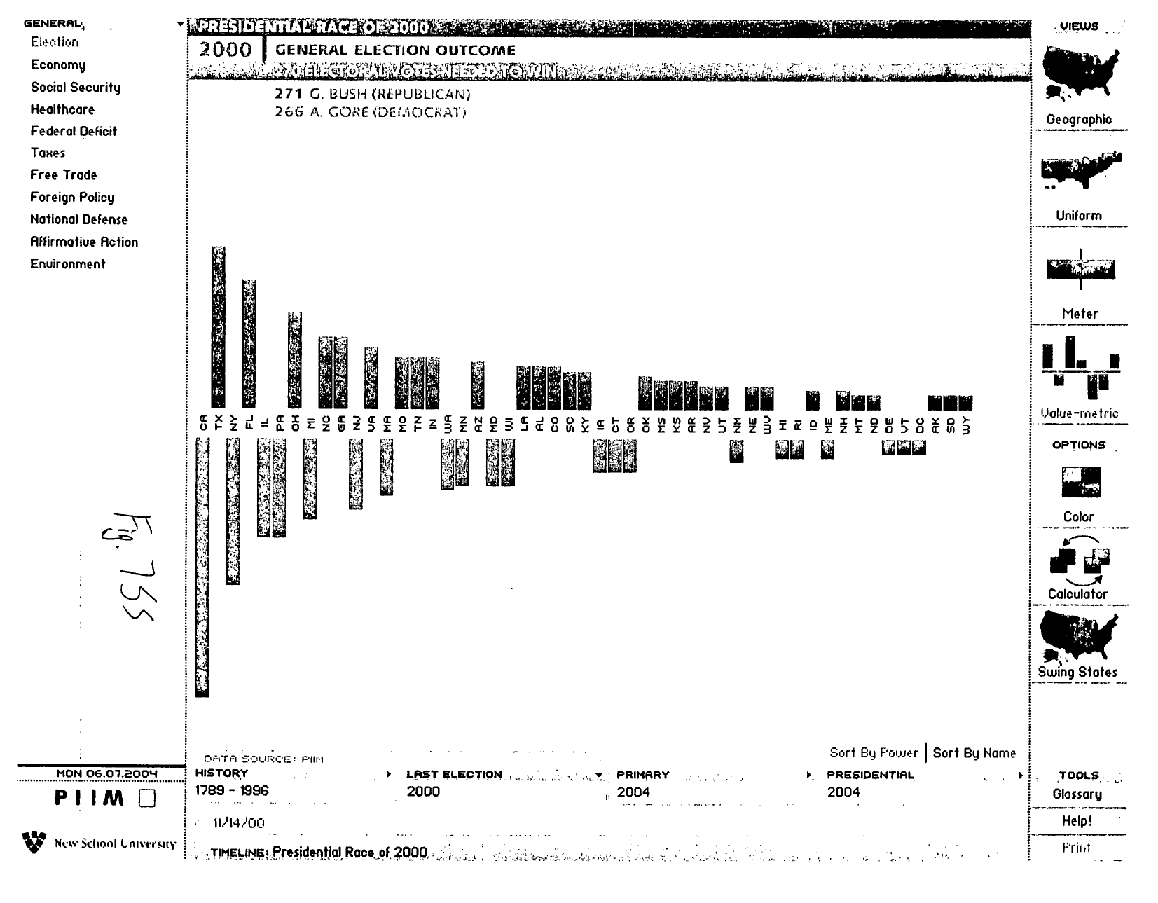

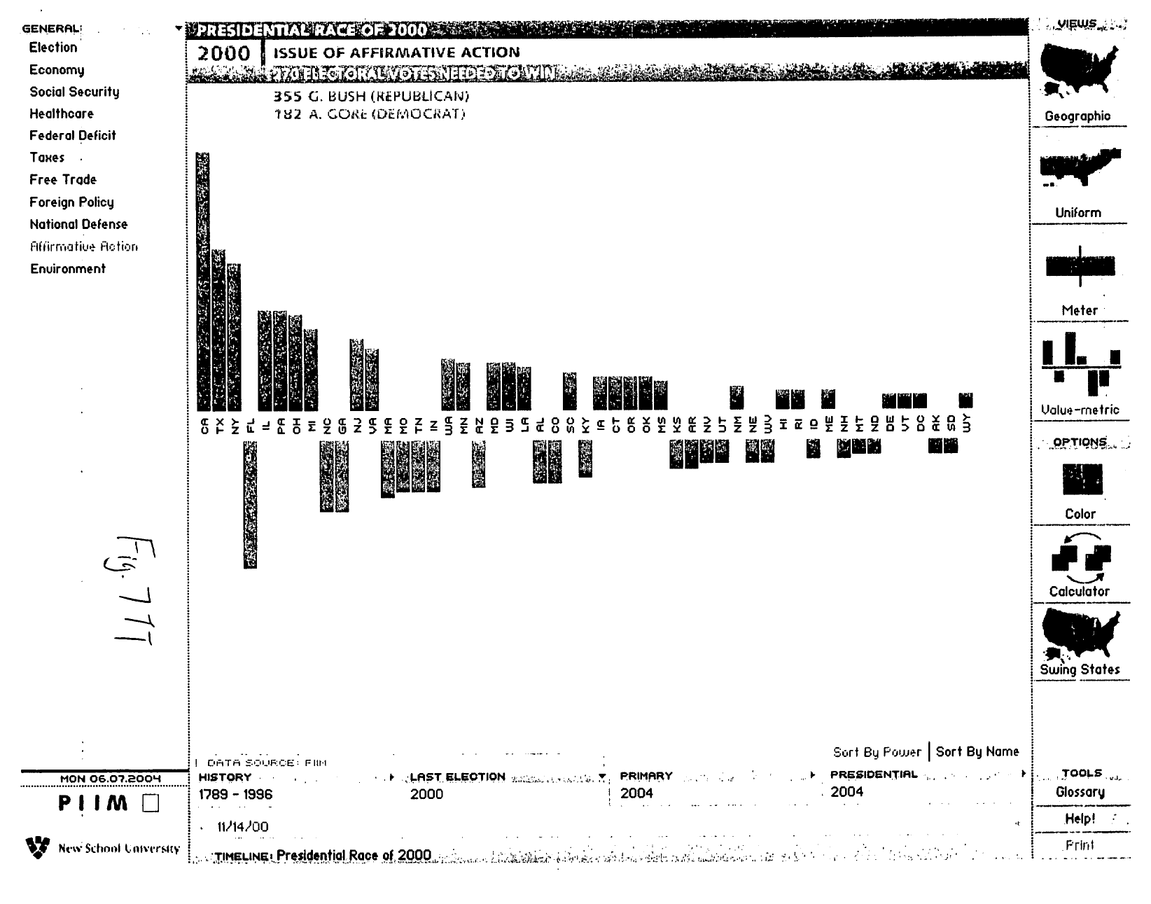

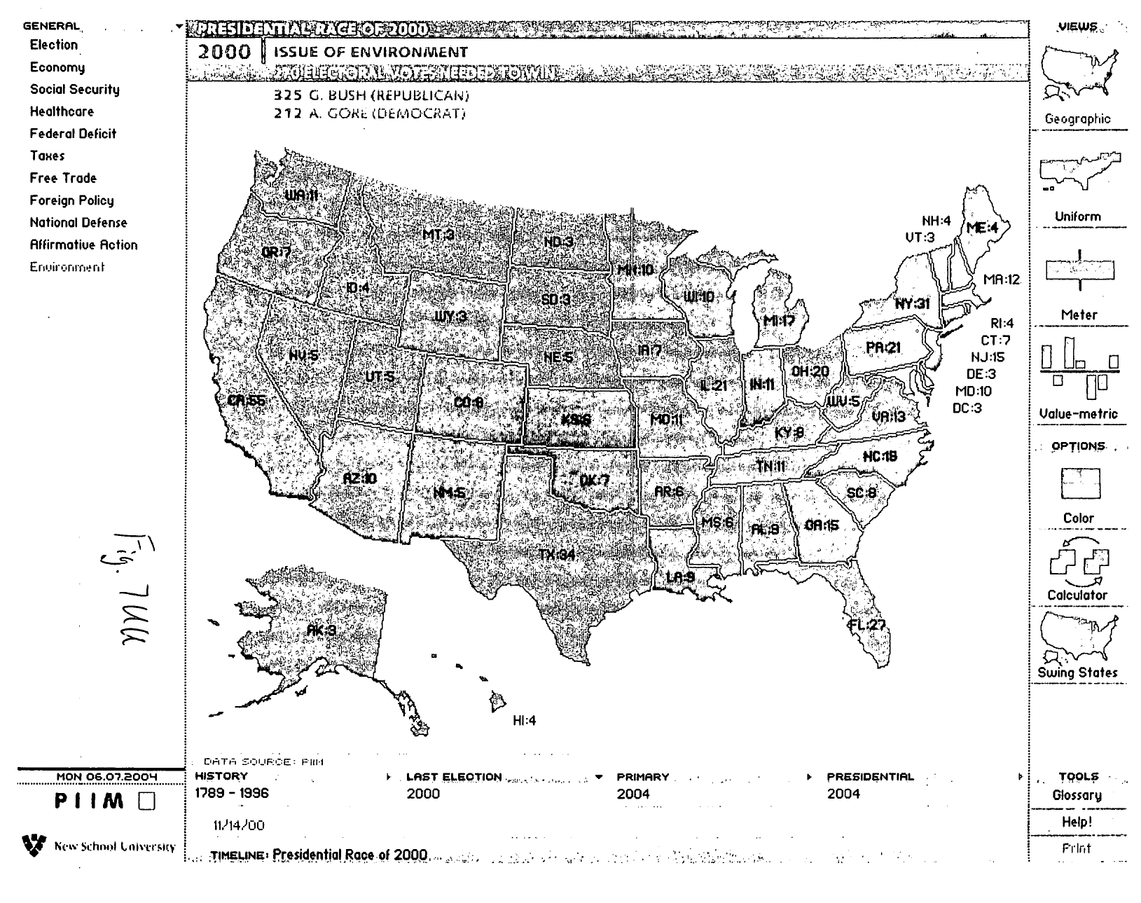

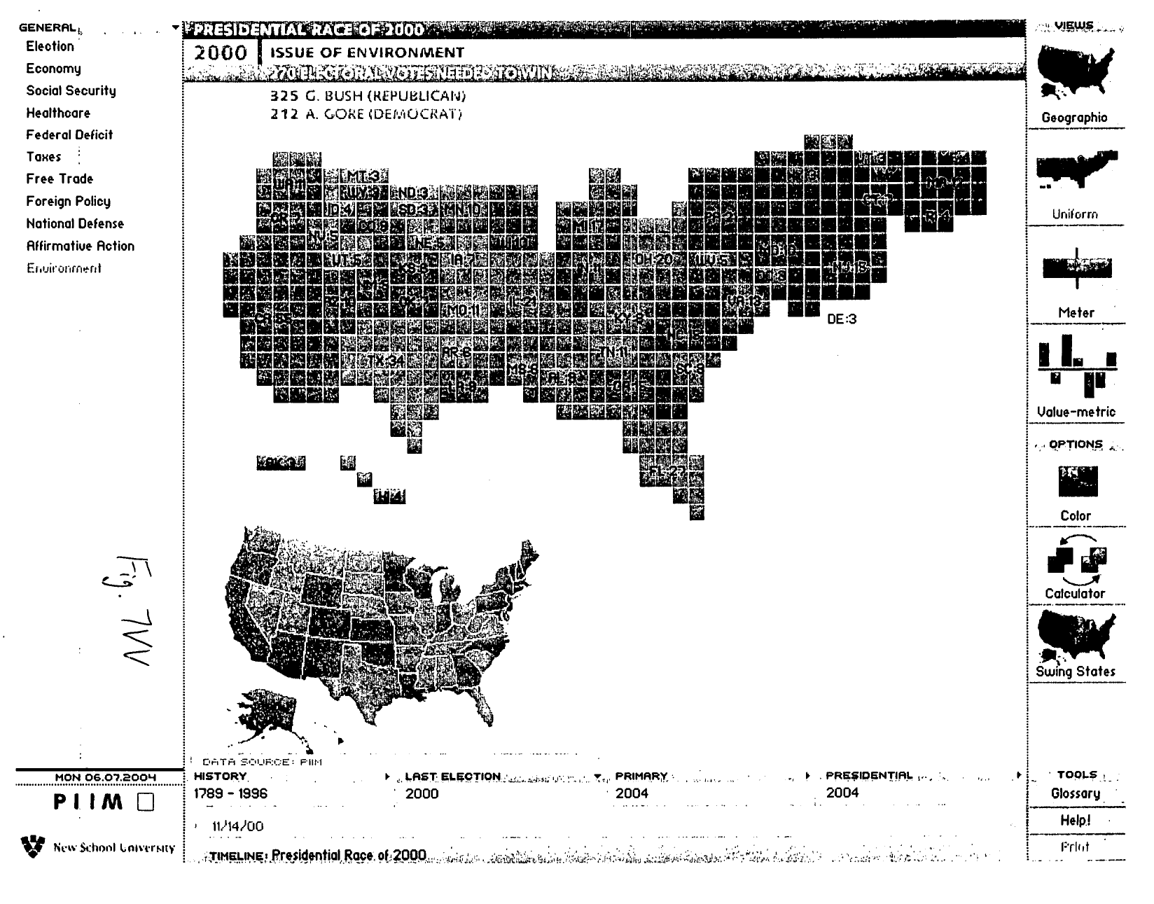

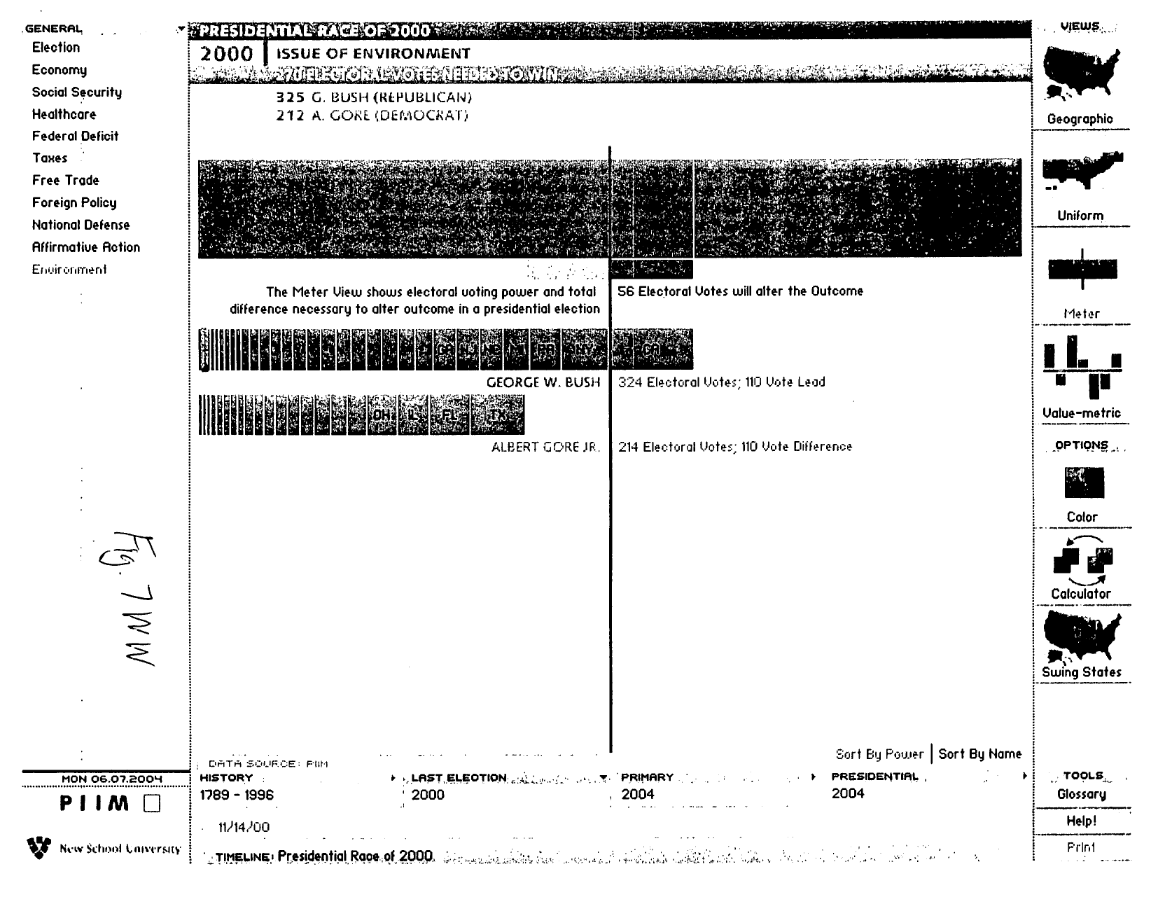

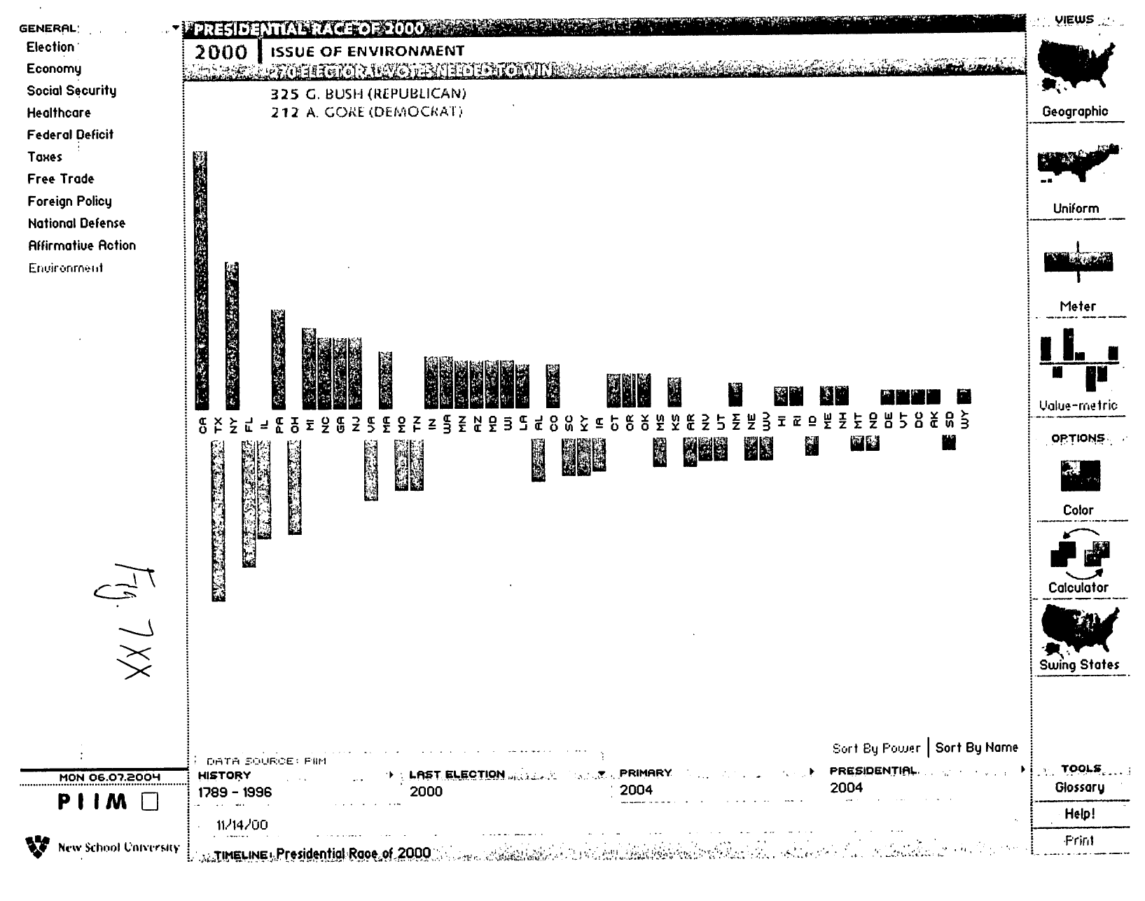

FIGS. 6A-6Q are graphical visualizations in accordance with certain aspects of the invention of the presidential race of 2004 and certain historical elections, focusing on “swing states.” These figures illustrate on how a user can focus in on swing states, or, more generally, other components of the display that might be distinguished in some manner.

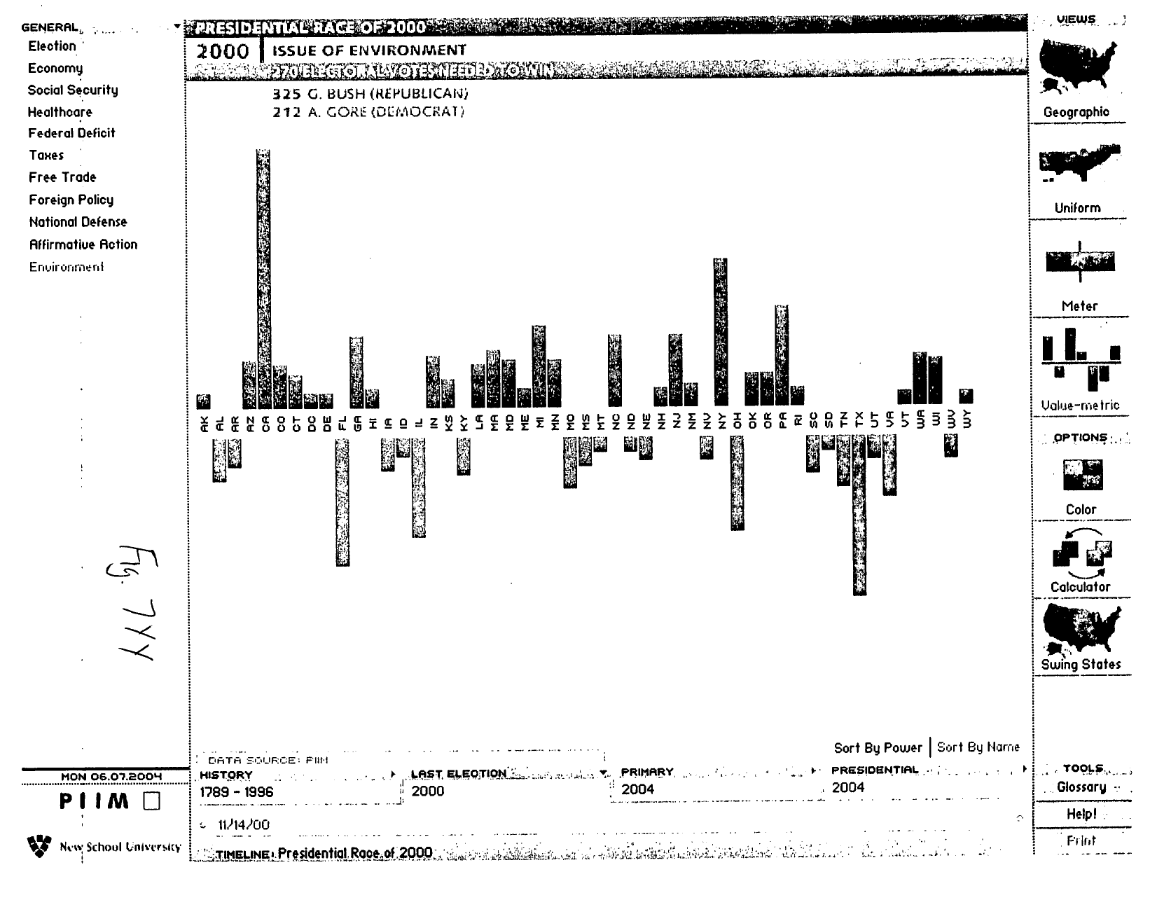

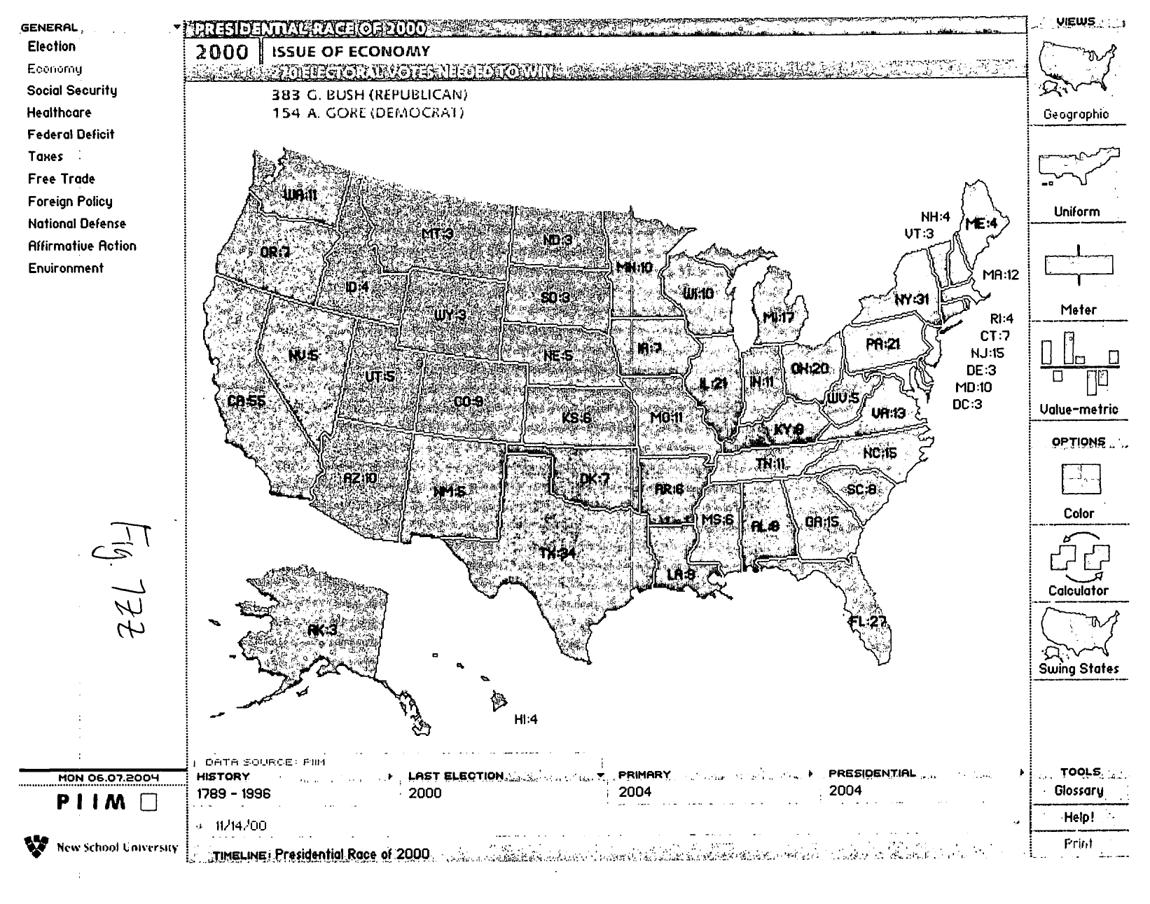

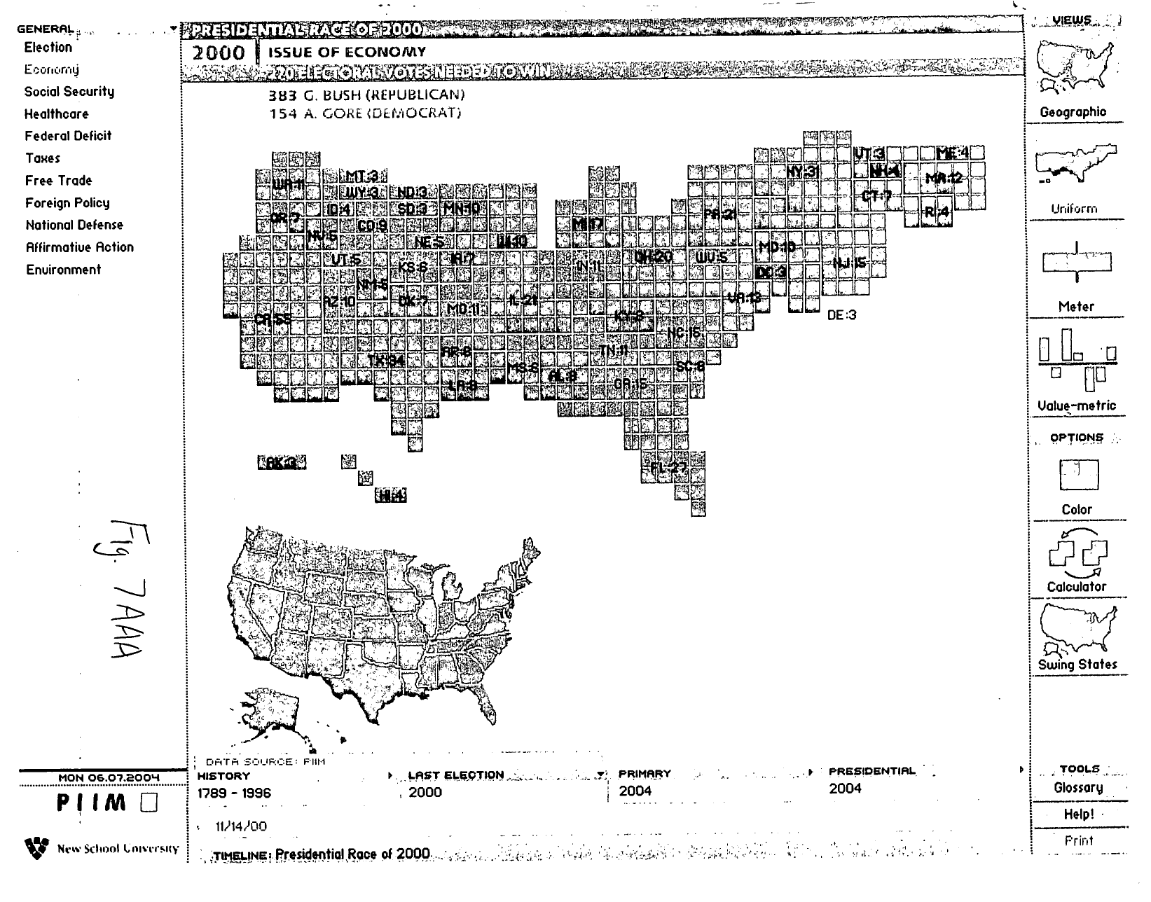

FIGS. 7A-7AAA are graphical visualizations in accordance with certain aspects of the invention of the presidential race of 2000. These figures show the general results, together with analysis in accordance with ten different factors, including factors such as the economy, healthcare, taxes, foreign policy, affirmative action and the environment.

### Appendix A

### Methodology for Analyzing Historical Elections, 1789-2000

1789

This was the first ever presidential election. Numerous different voting methods, many involving no popular participation, made for a chaotic quilt that was compensated for by the fact that there was only one serious contender: George Washington, the hero of the Revolutionary War.

There was no real campaign, and no particularly salient issues, except to the extent that the election could be seen as a ratification of the new constitution. North Carolina and Rhode Island had not yet ratified the constitution, and therefore did not participate. New York was slated to participate, but its 8 electoral votes were lost en-route to Washington.

1792

The second presidential election returned Washington to office by unanimous vote. However, the election of vice-president (then still elected directly as the second-place finisher for president) registers more opposition, with the new-party-in-formation of the Republicans uniting behind the ticket of George Clinton/Thomas Jefferson, particularly in the south.

The New England/North vs. South dynamic that is to play out through the 19th Century first begins to manifest in the second election, with Federalist economic policy as its focus here. Kentucky, North Carolina, Rhode Island and Vermont, having ratified the constitution since 1789, all participate in this election.

1796

The first serious challenge by an opposition party (the Republicans) erodes the power of the Federalist Party (now led by John Adams). Federalist hostility towards France alienates the increasingly Republican south, which, under the leadership of Thomas Jefferson, attacks the Federalist as aristocrats overly favorable to the English.

Also, heavy federal taxation of the whiskey trade angers the planter class in both south and west, and leads to a “Whiskey Rebellion” in the summer of 1794. The Republicans are able to capitalize on such discontent to a great enough extent that Jefferson is in fact elected as vice-president to Adams' president, making for the only time in American history that two opposed parties have shared the presidency. Tennessee enters the union.

1800

The Republicans take New York and Pennsylvania along with the south, and thus take the presidency from the Federalists. Federalist foreign policy towards France and the imposition of the draconian Alien and Sedition Acts, generates strong opposition throughout the country, and only a strong set of common economic interests keep New England and certain coastal Middle States (such as New Jersey and Maryland) tied to the Federalists.

Despite the decisive victory of the Republicans over the Federalists, the election is decided by Congress, since both Thomas Jefferson and Aaron Burr (both Republicans) tie for president with 73 electoral votes each. The House decides for Jefferson over Burr by a vote of ro10 to 4. Georgia enters the union.

1804

The Republicans continue to consolidate their power, all-but-routing the Federalists, who are marginalized even in New England. Republican rule, and Jefferson in particular, is so popular that nobody in the party notices Jefferson's violation of his own stated principles (of strict constructionism) in the Louisiana Purchase of 1803. It is left, in fact, to the Federalists (from their New England stronghold) to unsuccessfully oppose the expansion of the union, against their own principles as well. Ohio enters the union.

1808

Anger by merchants towards a heavy-handed trade embargo against the British (imposed in 1807) leads to a mild resurgence for the Federalists. Also, a rebellion within the Republican Party led by John Randolph of Georgia concerning a land-settlement in that state leads to a certain defection of purist-Republicans throughout the country. However, the Republicans, now led by James Madison, remain the dominant party and win the 1808 presidential elections with minimal opposition.

1812

An insurgent movement among Republican representatives (the so-called “War Republicans”) leads to a polarization of political sentiment concerning foreign policy. Hostility from England leads to the imposition of a heavy trade embargo, that is popular everywhere but in New England and Maryland, areas heavily dependent on foreign trade.

Southern Republicans in Congress openly call for war with England, and are opposed by a somewhat larger (but in the end, losing) coalition of New England and Middle States likely to suffer in a conflict with England. Madison attempts initially to tread a more cautious line in foreign policy, but largely has his hand forced by an increasingly hawkish party-line in Congress. When he converts, he is rewarded by strong showings in the 1812 polls, which all but ensure that war will come soon. Louisiana enters the union.

1816

The successful repulsion of the British and generally popular conduct of the War of 1812 all but destroys what remains of the Federalist Party. Ironically, the economic hardships produced by the war in New England in particular instigates a neo-loyalist movement to succeed New England from the union. Indeed, a group of Federalist politicians gather in Hartford in 1814 to discuss the possibility of secession, and eventually to demand state “nullification” rights. However, Federalist politicians arrive in Washington, D.C. to the news of Andrew Jackson's victories against the British at New Orleans, and in the new atmosphere of victory and triumph, return to New England without having issued any demands.

The presidential election of 1820 is barely contested, and the Federalists don't even field any candidates. Thus is continued the period of American political history known as the “era of good feelings” inaugurated by the end of the War of 1812, and presided over by James Monroe in a spirit of non-partisan consensus. While presidential politics becomes placid, however, the Republican-dominated Congress becomes increasingly divided along sectional lines.

The question of Missouri's entry into the union as a slave state sparks the first open conflict between North and South over this issue, with only Vermont and Maryland dissenting from their sectional blocs. The purchase of Florida, on the other hand, produces near-unanimous agreement by heading off Spanish claims on the continent. Illinois, Mississippi, Alabama, Maine (as a free state) and eventually Missouri (as a slave state) enter the union at this time.

1824

The presidential election of 1824 brings the “era of good feelings” to contentious halt, as the inability of the Republican Party to agree on any single caucus to choose a nominee produces 4 credible candidates from within the same party, each representing a different coalition of sectional and class interests. The two strongest contenders are John Quincy Adams, representing a north-eastern “Whigish” economic nationalism, and Andrew Jackson, representing a southern and western populism. However, both were undercut by the insurgent campaigns of long-time Republicans William Crawford and Henry Clay, the former a vehement proponent of states' rights and the latter the champion of what he called the “American System” of internal improvements and vigorous economic nationalism.

Despite the fact that 1824 marked the first presidential election in which electoral votes were determined by universal white-male suffrage (at least in some states), turn-out was low, and ultimately, no candidate was able to capture the 131 votes necessary to win. As a result, the election was resolved in Congress between the top three contenders, Adams, Jackson and Crawford. However, it was Clay who (as Speaker of the House and a man of great influence) decided the election by throwing his support behind Adams, largely as a way of preventing Jackson from taking office. Thus the final result was 87 (Congressional) votes for Adams, 71 for Jackson and 54 for Crawford. Jackson and his supporters viewed the result as a “corrupt bargain” between Clay and Adams, particularly when the latter named the former his Secretary of State. Indiana joins the union during this period.

1828

The presidential election of 1828 saw the final fragmentation of the original Republican Party into Democratic and National factions, the former coalescing around Andrew Jackson, the latter around John Quincy Adams. These splinters would, by the next election, become the Democratic Party proper, and the new Whig Party, respectively. The election of 1828 was also the first truly popular election, with every state but South Carolina generating a popular vote. Turnout was also much higher than in 1824, at 57%. Andrew Jackson was also the first truly populist leader, representing himself as the anti-elite candidate of the common man. The message proved popular in the south and west, which he swept, and the more populous middle states like New York and Pennsylvania.

Adams swept the remaining north-east, but it was not enough to keep him in office. Aside from a discourse of “the people vs. the elite”, there were few issues that received any great hearing during the campaign (which was characterized by personal attacks on both sides), and thus it is hard to gage the popular sentiment on bills considered by Congress between 1824 and 1828, since popular and elite opinion may well have been at odds with each other. However, the one serious issue to come before Congress during this time that might have been decided along lines common to both elite and popular opinion, was the Tariff of 1828 (popularly known as the “Tariff of Abominations”), despised in the south and with (eventually, after many negotiations) strong support in the north and the west.

1832

Jackson's first term saw the first round in his “war against the bank”, a struggle which, while popular among the newly enfranchised electorate, pitted him against established interests in both the business community and in Congress. However, the Bank of the United States, and Jackson's attempt to marginalize it became a major issue during the 1832 campaign, so there is reason to believe that the election returns that year serve as a strong popular approval for at least this aspect of Jacksonian economic policy. Other, more traditional issues, such as economic protectionism, broke down along sectional divides in Congress.

However, potentially the most dramatic development of Jackson's first term was the Nullification Crisis, which saw Vice-President John C. Calhoun (already estranged from Jackson) lead a campaign for the nullification (by southern state legislatures, particular in his home state of South Carolina) of the both the Tariff of 1828 and the Tariff of 1832. While initially popular in the south (as witnessed by the success of “nullificationist” candidates in state elections that year), the momentum behind the movement largely evaporated by the time of the presidential election, especially after Jackson made it clear that he believed the idea of nullification to be treasonous. When Congress re-convened in 1833 to consider a bill introduced by Jackson's followers to enforce the Tariff Acts, only the representatives of South Carolina dissented. Here, I assume that support (particularly popular support) had eroded considerably, but not totally by the time of the 1832 Presidential election.

was hostile towards the bank and largely wed to the Democratic Party. Arkansas and Michigan join the union during this period.

1836

The hand-off from Jackson to his hand-picked successor in Martin Van Buren saw a significant gain in Whig Party standing, which might have been stronger had the Whigs united behind a single candidate (instead they ran 3 different candidates in different areas) and had not the country been experiencing a speculation-led boom in economic activity. It was of course precisely this speculative bubble, and Jackson's outgoing attempt to restrain it (being opposed to credit and speculation) by forcing banks to call back species payments that led to the Panic of 1837 and the financial ruination of many banks and cotton plantations.

During the period of Jackson's second term, support for his “war against the bank”, began to sour somewhat, as the President of the Bank of the United States, Nicholas Biddle, sought the support of influential “soft-money” men among the Whigs, such as Daniel Webster and Henry Clay. Concern also mounted in the business and professional communities about Jackson's heavy-handed use of the power of the presidency to destroy the bank. Van Buren's candidacy was buoyed, on the other hand, by a strong working class movement, in population centers like New York City, Philadelphia and Boston, that

1840

1840 sees the first Whig victory. The panic of 1837 an <ˆ the lackluster response by Van Buren to the depression that followed gave the Whigs all the ammunition they needed to lead a populist anti-incumbent revolt against the Democrats. Beyond economic management, the first and only Van Buren presidency raised a number of issues to the national stage, including the annexation of Texas and the creation of an independent treasury. The campaign of 1840, however, was largely devoid of any substantive debate, thanks in great part to a manipulative Whig bid to present their party, not as the party of conservative east coast elites, but as western populists. In the person of William Harrison, they produced the image of the self-made man, born in a log-cabin, an outsider to the Washington elite.

Indeed, the manipulation of Harrison's image (and the easy demonization of Van Buren as a corrupt backroom politician) was such a key element of the Whig campaign, that it became known as the “Log-Cabin” campaign, which each side trying to establish their populist bonafides before a popular audience in the press. Between the character assassination and the bleak economic outlook, Van Buren lost most of the most populous states, retaining only 6 out of the original 15 states that Jackson had taken to victory in 1828.

1844

The election of 1844 shows only the most vague beginnings of what was to become the central conflict of the late nineteenth-century United States: the conflict between a Northern socioeconomic system based on small-scale farming, trade, and industrial development, and an aging Southern colonial-style system based on the use of slave labor in the large-scale production of export crops. As time passes, maps of electoral returns will begin to represent these regional distinctions more sharply.

Votes on bills in congress are taken to be representative of the attitudes of their voting constituents, thus representative of the views of the voting populations of their respective states. It is rare that an issue raised in a party platform on an election year cannot be found manifest in one bill or another. On some occasions where votes are obscurely presented or where record-keeping is vague, sampling is undertaken to approximate transitions from earlier to later vote patterns.

Sources: National Archives of the United States, Federal Register: US Electoral College; Voting Statistics; Congressional Records 1842-57, also statistics compiled in McPherson, Edward, Hand-Book of Politics for the years 1860-1888 (Washington D.C.).

1848

The election of 1848 saw the reappearance of former President Van Buren under the auspices of the “Free Soil” party, focused on land grants in the west for small-scale homesteaders. This issue was to ultimately become the basis for later conflicts around the issue of slayery, as homesteading was socioeconomically incommensurable with the type of plantation-based agriculture of the slaveholding South; its growth was seen by many Southerners as a threat to the already-fading plantation system. Though the “Free-Soilers” provided a formidable challenge, they failed to secure a majority in any state, and ended up splitting the potential Democratic vote in the Northeast, as a result of which Taylor, the last Whig president, was elected.

Votes on bills in congress are taken to be representative of the attitudes of their voting constituents, thus representative of the views of the voting populations of their respective states. It is rare that an issue raised in a party platform on an election year cannot be found manifest in one bill or another. On some occasions where votes are obscurely presented or where record-keeping is vague, sampling is undertaken to approximate transitions from earlier to later vote patterns.

Sources: National Archives of the United States, Federal Register: US Electoral College; Voting Statistics; Congressional Records 1842-57, also statistics compiled in McPherson, Edward, Hand-Book of Politics for the years 1860-1888 (Washington D.C.).

1852

Both major parties, Democrats and Whigs, stood in favor of the Compromise of 1850, which attempted to evenly divide the westward expansion of the country into free and slave states, although Democrats were more outspoken in this regard. Many historians have interpreted votes for Scott as dissatisfaction with the compromise, which would make sense especially insofar as Massachusetts and Vermont had strong abolitionist constituencies.

Votes on bills in congress are taken to be representative of the attitudes of their voting constituents, thus representative of the views of the voting populations of their respective states. It is rare that an issue raised in a party platform on an election year cannot be found manifest in one bill or another. On some occasions where votes are obscurely presented or where record-keeping is vague, sampling is undertaken to approximate transitions from earlier to later vote patterns.

Sources: National Archives of the United States, Federal Register: US Electoral College; Minutes of Party Conventions, 1852; Voting Statistics; Congressional Records 1850-52, also statistics compiled in McPherson, Edward, Hand-Book of Politics for the years 1860-1888 (Washington D.C.).

1856

Votes on bills in congress are taken to be representative of the attitudes of their voting constituents, thus representative of the views of the voting populations of their respective states. It is rare that an issue raised in a party platform on an election year cannot be found manifest in one bill or another.

Sources: Minutes of Party Conventions, 1860; Voting Statistics; Congressional Records 1860-65, compiled in McPherson, Edward, The Political History of the United States of America During the Great Rebellion: 1860-1865. (Washington D.C., originally appearing biennially as Hand-Book of Politics for the years 1860-65).

1860

Four separate candidacies won electoral votes in this election. This can probably be explained by the primacy of two issues: the expansion of slayery and the possibility of secession from the Union. The core Northern Republican impetus was for the preservation of the Union and the eventual end of slayery. The core Southern Democratic impetus advocated “popular sovereignty” or the right to secede from the Union and the expansion of slayery into new territories. John Bell's Constitutional Union Party, as well as Stephen Douglas's Northern splinter-Republican party, were in the middle ground of seeking to maintain both slayery and the integrity of the Union. Analyzing differences between these two candidacies might require attention to more subtle cultural issues than it is feasible to represent here.

Votes on bills in congress are taken to be representative of the attitudes of their voting constituents, thus representative of the views of the voting populations of their respective states. It is rare that an issue raised in a party platform on an election year cannot be found manifest in one bill or another.

Sources: Minutes of Party Conventions, 1860; Voting Statistics; Congressional Records 1860-65, compiled in McPherson, Edward, The Political History of the United States of America During the Great Rebellion: 1860-1865. (Washington D.C., originally appearing biennially as Hand-Book of Politics for the years 1860-65).

1864

Note: The continuation of the war was the overarching issue in this wartime election which excluded all states that had declared their intention to secede form the Union. MacLellan, former commander of the (Union) Army of the Potomac, ran on a single-issue platform: that of attempting to preserve the Union by acceding to the demands of the confederacy. Due to heavy losses of Union soldiers and substantial opposition to the draft in northern cities, his might have been a more viable platform prior to July 1963, after which the defeat of confederate forces at Vicksburg and Gettysburg made it appear unlikely that the confederacy had a chance of winning the war. The Union capture of Atlanta just before the election served to cement this point. It is more likely that the few states that voted for MacLellan were uncomfortable with President Lincoln's Emancipation Proclamation and the prospects of competition for jobs and land with the newly freed.

Primary Sources: Minutes of Party Conventions, 1864; Voting Statistics; Congressional Records 1860-65, compiled in McPherson, Edward, The Political History of the United States of America During the Great Rebellion: 1860-2865. (Washington D.C., originally appearing biennially as Hand-Book of Politics for the years 1860-65).

Methodology: Votes on bills in congress are taken to be representative of the attitudes of their voting constituents, thus representative of the views of the voting populations of their respective states. It is rare that an issue raised in a party platform on an election year cannot be found manifest in one bill or another.

1868

Note: The former confederate states of Texas, Virginia, and Mississippi were not at the time of the general election restored to the level of voting or representation in congress. Georgia was somewhat further in the process of restoration, and though not represented in congress, it belatedly contributed 9 electoral votes to Seymour, giving him a total of 80. It is likely that a primary factor influencing this election and unaccounted for in the list of major issues was the popularity of General Grant as a Union war hero.

Primary Sources: Minutes of Party Conventions, 1868; Voting Statistics; Congressional Records 1865-70, compiled in McPherson, Edward, The Political History of the United States of America During the Period of Reconstruction. (Washington D.C., originally appearing biennially as Hand-Book of Politics for the years 1865-7ø)—

Methodology: Votes on bills in congress are taken to be representative of the attitudes of their voting constituents, thus representative of the views of the voting populations of their respective states. It is rare that an issue raised in a party platform on an election year cannot be found manifest in one bill or another.

1872

Note: This election saw initial attempts by Labor and Liberal Republican parties, both emphasizing the need for anti-corruption measures; in the end both failed to mobilize viable candidates. A “Colored” convention endorsed the Republican platform. The Liberal Republican party endorsed the Democratic candidate, Horace Greeley, upon whose death the electoral vote from states he'd won was dispersed among four potential successors.

Primary Sources: Minutes of Party Conventions, 1872; Voting Statistics; Congressional Records 1870-74, compiled in McPherson, Edward, Hand-Book of Politics 1872-1876. (Washington D.C., originally appearing biennially).

Methodology: Votes on bills in congress are taken to be representative of the attitudes of their voting constituents, thus representative of the views of the voting populations of their respective states. It is rare that an issue raised in a party platform on an election year cannot be found manifest in one bill or another.

1876

Note: The elections in Louisiana and South Carolina were contested; the issue was never fully resolved and resulted in the military occupation of these states.

Primary Sources: Minutes of Party Conventions, 1876; Voting Statistics; Congressional Records 1873-77, compiled in McPherson, Edward, Hand-Book of Politics 1872-1876, 1878-1882 (Washington D.C., originally appearing biennially).

Methodology: Votes on bills in congress are taken to be representative of the attitudes of their voting constituents, thus representative of the views of the voting populations of their respective states. It is rare that an issue raised in a party platform on an election year cannot be found manifest in one bill or another.

1880

Note: It should be noted that Hancock never formally endorsed his parry's platform and, indeed, refrained from making statements concerning many of the issues it contained. It is most logical to conclude that Hancock, a popular Northern General (from Pennsylvania) in the civil war whose command is said to have inflicted more damage on Southern forces than any other in the army, was chosen by the Democratic party as a symbolic attempt at postwar reconciliation. In this case, the issues may be seen as secondary to the actual campaign, and would also account for Hancock's popularity outside the South. Both Hancock and Garfield and their respective parties took pains to distance themselves from the corruption plaguing the Grant administration; an anti-corruption bill aimed toward eliminating government subsidies for and bailouts of private corporations gained wide support from representatives of both major parties.

Primary Sources: Minutes of Party Conventions, 1880; Voting Statistics; Congressional Records 1879-1880, compiled in McPherson, Edward, Hand-Book of Politics 1878-1882 (Washington D.C., originally appearing biennially 1878-1882).

Methodology: Votes on bills in congress are taken to be representative of the attitudes of their voting constituents, thus representative of the views of the voting populations of their respective states. It is rare that an issue raised in a party platform on an election year cannot be found manifest in one bill or another. Whether the bills pass is another matter entirely.

1884

Note: By the i88os the emphasis on identity differences between North and South begins to be subordinated to more practical economic issues around industrialization, labor and antitrust legislation, for example. Populism in the 18903 can be seen similarly as an response to a rapidly industrializing area centered around the Great Lakes. As issues such as funding public schools and repealing grants to large railroad corporations become more mainstream, I have shifted emphasis to some of the more controversial issues contained in party platforms.

Primary Sources: Voting Statistics from National Archives of the United States, Federal Register: US Electoral College; Data on ethnicity and immigration from US Census Bureau; Issues taken from Minutes of Party Conventions, 1880-1900; Votes in congress compiled calculated from Congressional Records 1880-1900, also statistics compiled in McPherson, Edward, Hand-Book of Politics for the years 1880-1900 (Washington D.C.).

Methodology: Votes on bills in congress are taken to be representative of the attitudes of their voting constituents, thus representative of the views of the voting populations of their respective states. It is rare

that an issue raised in a party platform on an election year cannot be found manifest in one bill or another. On some occasions where votes are obscurely presented or where record-keeping is vague, sampling is undertaken to approximate transitions from earlier to later vote patterns.

1888

Note: By the i88os the emphasis on identity differences between North and South begins to be subordinated to more practical economic issues around industrialization, labor and antitrust legislation, for example. Populism in the 18903 can be seen similarly as an response to a rapidly industrializing area centered around the Great Lakes. As issues such as funding public schools and repealing grants to large railroad corporations become more mainstream, I have shifted emphasis to some of the more controversial issues contained in party platforms. In 1888 corporate subsidies are almost unanimously unpopular; the emphasis in this issue shifts to antimonopoly/antitrust legislation. Tariffs are perhaps the most divisive and controversial issue at this time.

Primary Sources: Voting Statistics from National Archives of the United States, Federal Register: US Electoral College; Data on ethnicity and immigration from US Census Bureau; Issues taken from Minutes of Party Conventions, 1880-1900; Votes in congress compiled calculated from Congressional Records 1880-1900, also statistics compiled in McPherson, Edward, Hand-Book of Politics for the years 1880-1900 (Washington D.C.).

Methodology: Votes on bills in congress are taken to be representative of the attitudes of their voting constituents, thus representative of the views of the voting populations of their respective states. It is rare that an issue raised in a party platform on an election year cannot be found manifest in one bill or another. On some occasions where votes are obscurely presented or where record-keeping is vague, sampling is undertaken to approximate transitions from earlier to later vote patterns.

1892

Note: By the 1880s the emphasis on identity differences between North and South begins to be subordinated to more practical economic issues around industrialization, labor and antitrust legislation, for example. Populism in the 18905 can be seen similarly as an response to a rapidly industrializing area centered around the Great Lakes. The central political divide in the 18905 will be between rural and urban/industrial interests. Possibly the issue most representative of this is the tariff, the support of which suggests industrial labor and capital were thought to have common interests to protect from foreign competition, whereas rural producers of export crops saw no such common interests. Silver is a wild card tied to far-Western development. As new Western states are inducted into the Union, a coherent voting bloc begins to develop as a counterweight to the older blocs constituting North and South.

Primary Sources: Voting Statistics from National Archives of the United States, Federal Register: US Electoral College; Data on ethnicity and immigration from US Census Bureau; Issues taken from Minutes of Party Conventions, 1880-1900; Votes in congress compiled calculated from Congressional Records 1880-1900, also statistics compiled in McPherson, Edward, Hand-Book of Politics for the years 1880-1900 (Washington D.C.).

Methodology: Votes on bills in congress are taken to be representative of the attitudes of their voting constituents, thus representative of the views of the voting populations of their respective states. It is rare that an issue raised in a party platform on an election year cannot be found manifest in one bill or another. On some occasions where votes are obscurely presented or where record-keeping is vague, sampling is undertaken to approximate transitions from earlier to later vote patterns.

1896

Note: Issues in the 1896 election are very similar to those in 1892. A central factor influencing this election, however, is the consolidation of Populist and Democratic politics culminating in the co-endorsement of Bryan. Though, McKinley aside, Bryan received more popular votes than any previous presidential candidate (including the victors), McKinley certainly outspent any known campaign in history, and many historians conclude that McKinley's money was decisive in this election.

Primary Sources: Voting Statistics from National Archives of the United States, Federal Register: US Electoral College; Data on ethnicity and immigration from US Census Bureau; Issues taken from Minutes of Party Conventions, 1880-1900; Votes in congress compiled calculated from Congressional Records 1880-1900, also statistics compiled in McPherson, Edward, Hand-Book of Politics for the years 1880-1900 (Washington D.C.).

Methodology: Votes on bills in congress are taken to be representative of the attitudes of their voting constituents, thus representative of the views of the voting populations of their respective states. It is rare that an issue raised in a party platform on an election year cannot be found manifest in one bill or another. On some occasions where votes are obscurely presented or where record-keeping is vague, sampling is undertaken to approximate transitions from earlier to later vote patterns.

1900

The election of 1900 pitted Republican candidate William McKinley, the incumbent President, against William Jennings Bryan, the outspoken agrarian populist. During the campaign four main issues rose to the forefront: American imperialism, the gold standard, monopolies and trusts and the state of the economy, in particular labor relations.

For the most part, the issues of imperialism and the gold standard dominated the debate between the two parties. The incumbent McKinley favored a robust foreign policy that included annexation of the Philippines and the further projection of American power overseas. Bryan took a somewhat nuanced stance, but made several anti-imperialist statements. He was generally regarded as the candidate of the large anti-imperialist movement of the day. On the question of the gold standard, McKinley favored maintaining gold as the standard measure of currency, while Bryan-reiterating an old theme-favored silver coinage.

For the most part, Bryan's stance on imperialism won few supporters outside of the Southern states. Pro-imperialist sentiment ran high in the West and the Mid-West. While there was some anti-imperialist sentiment in the North East, this sentiment never seemed to boil over into full-scale support for Bryan's position. Moreover, Bryan's stand on other issues scared away many voters in the industrial states.

The question of the gold standard had become, by the time of the election, a moot issue. In many ways Bryan's insistence on promoting silver coinage was seen as anachronistic and even annoying to many voters. Although Bryan's position won him the support of several Western mining states and most of the South, the North East, Mid-West and West all favored McKinley's position. Even most progressive agricultural states in the Mid-West did not support Bryan's silver stance, seeing it as a dead issue.

While in many ways it was these two issues that dominated the election, the questions of monopolies and trusts and economic reform (in particular labor relations) were also important. Although McKinley favored a non-interventionist stance in economic matters, this did not seem to hurt him too much in industrial states. Most workers had grown accustomed to rising prosperity under McKinley's first term and thus supported the Republicans in the election. Only the South and certain historically progressive states seem to have supported Bryan's other economic policies.

For the most part the election of 1900 was a regional affair. Although the South remained staunchly democratic, Bryan could gain only issue-by-issue support outside this region and as such he was resoundingly defeated by McKinley, who won 292 electoral votes compared to Bryan's 155. In brief, foreign policy—in particular the issue of imperialism—dominated the election, with most Americans accepting McKinley's expansionist policies, this coupled with Bryan's stubborn refusal to let go of the silver issue ultimately spelled his defeat Sources:

Walter LaFeber, “The Election of 1900” in Arthur Schlesinger and Fred L. Israel, eds., History of American Presidential Elections, vol. □1892-1908. (New York: Chelsea House Publishers) 1985.

Yanek Mieczkowski, The Routledge Atlas of American Presidential Elections. (New York; Routledge) 2001.

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1972. (Chicago: University of Illinois Press) 1975.

1904

In the election of 1904, Theodore Roosevelt ran as the incumbent Republican, having succeeded William McKinley following the latter's assassination at the hands of an anarchist in 1901. After being sworn in as President, Roosevelt became a progressive reformer and actually began to take on the trusts and monopolies, filing several suits against large corporations under the Sherman Anti-Trust law, effectively reviving the latter. In this, he reversed previous Republican laissez-faire policies and actually seemed to adopt part of William Jennings Bryan's Democratic reform platform from the election campaign of 1900. Roosevelt's anti-trust actions were part of his larger reform package, which he dubbed the “Square Deal.” This package also included the progressive reform of labor laws and an ambitious program of nature conservation, including the strengthening of the national park system. In many ways, the “Square Deal” reforms became a symbol of Roosevelt's personal leadership and a referendum on his Presidency. Moreover, Roosevelt had a liberal view on white/black race relations and he even invited Booker T. Washington, a prominent African American leader, to the White House. However, if Roosevelt reversed important aspects of previous Republican administrations, annoying many in the industrial and financial establishments of the Northeast and Mid-West, he maintained the policy of overseas expansion, championing an imperialist attitude towards the Philippines and the construction of the Panama Canal. For the most part, although Roosevelt seemed like a loose canon to many in the Republican establishment, the country's prosperity and Roosevelt's personal popularity ensured he would be nominated for a second term.

The Democrats on the other hand, were reeling following their resounding defeat in 1900. The “Reorganizes” faction seized control of the party and proceeded to eliminate the influence of progressivism and populism associated with William Jennings Bryan's faction. The Democrats decided to nominate Alton B. Parker, a conservative New York judge with little notoriety outside of his home state. The new Democratic platform of 1904 championed the gold

standard and although the party maintained anti-imperialist and certain anti-monopoly rhetoric in its platform, Parker himself came out in favor of a laissez-faire approach to industrial regulation. Moreover, the Democratic Party, playing to its traditional Southern constituency, came out against “Negro enfranchisement” and actually criticized Roosevelt's meeting with Booker T. Washington.

The campaign that preceded the election was somewhat uneventful and even dull in some commentators' estimation. Six issues dominated the campaign: Imperialist expansion, with the question of independence for the Philippines being an important issue in and of itself; monopoly regulation, the protective tariff, and Negro enfranchisement. But most importantly, both parties framed Roosevelt's “Square Deal” reforms as a referendum on Roosevelt's leadership itself.

Nevertheless, the election of 1904 was a landslide victory for Roosevelt and the Republicans. Only the South gave electoral votes to Parker (here the issue of Negro enfranchisement was paramount), while Roosevelt won all other sections of the country even winning such Border States as Missouri and West Virginia. He lost Maryland by only 53 popular votes, resulting in a split electoral vote from that key state. For the most part, the country's economic prosperity won over voters from all the prosperous classes, while Roosevelt's reforms won him favor with the industrial working class and many non-Southern agricultural sectors. For the most part, this election reflected a North/South regional division almost to the letter on each issue, with the exception of the Border States and Texas, where a considerable sentiment for imperialist expansion was evident.

Sources:

Richard C. Bain and Judith H. Parris, Conventions, Decisions and Voting Records. (Washington, D.C.: The Brookings Institution) 1973.

William H. Harbaugh, “1he Election of 1904” in Arthur Schlesinger and Fred 1. Israel, eds., History of American Presidential Elections, vol. V (New York: Chelsea House Publishers) 1985.

Donald Bruce Johnson and Kirk H. Porter, National Party Platforms, 1840-1972. (Chicago: University of Illinois Press) 1975.

Yanek Mieczkowski, The Routledge Atlas of American Presidential Elections. (New York; Routledge) 2001.

1908

In this election, William Howard Taft—the incumbent Secretary of War and former Governor General of the Philippines—approached Election Day as Theodore Roosevelt's designated successor. Roosevelt, the incumbent President, had already announced his intentions not to seek a third term and he made it clear to his own party that he wished Taft to receive the nomination. Taft was generally more acceptable to the Eastern “old guard” elements in the Republican Party and as such he won the nomination without much contest. Taft made it clear that if elected he intended to continue many of Roosevelt's progressive reforms, including filing suit against dangerous monopolies, instituting nature conservation programs, etc. Moreover, Taft came out in favor of protective tariff reductions, federal government regulation of the railroads, and many other reform minded policies. In proposing to follow the path already laid out by Theodore Roosevelt, Taft was continuing the Republican Party's recuperation of what had previously been mostly Democratic reform positions. Nevertheless, Taft was still somewhat more reserved than Roosevelt and his somewhat conservative stance on labor relation issues made him acceptable to the party's financial and industrial constituency. Nevertheless, the Republican Party's platform of 1908 was largely a progressive one, such that the Democrat William Jennings Bryan remarked that much of it had been lifted from the Democrats.

Reeling from its resounding defeat in the 1904 election, the Democratic Party once again switched tracks, and feeling the rising tide of progressivism in the country, it decided to scrap its conservative platform of 1904 and revert back to its progressive program of 1896 and 1900. After some internal factional wrangling, William Jennings Bryan was once again the party's nominee for the Presidency, putting the populist, progressive Western faction of the party clearly in control and banishing the conservative “reorganizes” of 1904 to the rear. Bryan devoted most of his energy during the campaign to attempting to appear more progressive than the Republicans. He advocated the prohibition of private monopolies, strict federal government regulation of the railroads, direct election of U.S. senators, and spoke out against the Federal Court's abuse of its injunction powers to prohibit strikes and other industrial actions. The Democrats once again put the question of imperialism on the agenda, and this was symbolized in the campaign by the question of Filipino independence. The Democrats stood unabashedly against imperialism and urged the granting of Filipino independence as soon as practicable.

Nevertheless, as this election occurred during the height of what historians have called the Progressive era, both parties tended to champion very similar programs. Other than on the question of the Philippines, where the Republicans advocated maintaining direct colonial control, the party platforms seem to have differed only in regard to degree and nuance. Where the Democrats favored a prohibition on public monopolies, the Republicans advocated only their reasonable regulation. If the Democrats championed federal regulation of the railroads, the Republicans preferred a milder, but nonetheless regulatory approach; where the Democrats sought to eliminate protective tariffs, the Republicans nevertheless saw the need to lower them.

For the most part, the Republican platform, probably due to its moderation, seemed to ring true with most voters. The Democrats once again could only count on the “Solid South” and a few Rocky Mountain states. While the issue of railroad regulation won the democrats some considerable support in Mid Western agricultural states and their pro-labor judicial reform plank won them increasing support in industrial states, this was not enough to override the economic prosperity of the era and most of the populous states of the North East and Mid West voted Republican.

While the south remained solidly Democratic, the party's position on strengthening federal regulatory power was not a popular position in most southern states.

In this election, we see a tendency towards convergence in the two party platforms. While the election was a resounding victory for Taft and the Republicans, the Democrats began to garner the important sympathy of labor in the North and populist interests in the Mid West. In many respects, this election is important, in that it sees a trend to regional disassociation, where the previously solid regional party affiliations began to break down on certain important issues, such as labor relations and federal regulatory power.

Sources:

Richard C. Bain and Judith H. Parris, Conventions, Decisions and Voting Records. (Washington, D.C.: The Brookings Institution) 1973.

Paolo E. Colette, “The Election of 1908” in Arthur Schlesinger and Fred 1. Israel, eds., History of American Presidential Elections, vol. (New York: Chelsea House Publishers) 1985.

Donald Bruce Johnson and Kirk H. Porter, National Party Platforms, 1840-1972. (Chicago: University of Illinois Press) 1975.

Yanek Mieczkowski, The Rautledge Atlas of American Presidential Elections. (New York; Routledge) 2001.

1912

The 1912 Presidential Election was a three-way contest between the Republicans, Democrats and Theodore Roosevelt's new Progressive or “Bull Moose” Party. This election is significant in that it marks the strongest electoral showing of a third party in the twentieth century. The Progressive Party actually claimed the electoral vote of several states and as such, its presence deeply affected the outcome of the election.

During the administration of William Howard Taft (1908-1912), the reigning Republican Party began to drift from the progressive track it had been pushed towards under the previous administration of Theodore Roosevelt. Although Taft instituted many important progressive reforms, such as filing suits against private monopolies, etc. His policies were not seen as sufficiently progressive for a number of insurgent Republican progressives. Under the leadership of Theodore Roosevelt, many of these insurgent Republicans broke with their party and set up the new Progressive Party. The new party adopted positions very close to the Republicans, but which were seen as taking the old party's Progressive reforms to their logical conclusion.

In many ways, it was the contest between the Republicans and the Progressives that defined the campaign of 1912. Although their positions were very close on the Tariff and Monopoly issues, both preferring a reduction in the protective tariff and close regulation of private monopolies—they also differed on the question of women's suffrage and the establishment of presidential primaries. The latter issue was of utmost importance to the Progressives. While still within the Republican Party structure, the maneuverings of the national party convention prevented Theodore Roosevelt from securing the party's nomination and led to the split.

In contrast, the Democratic Party nominated New Jersey Governor Woodrow Wilson as its candidate. During the campaign the Democrats played a conservative card, but they retained their traditional planks favoring the elimination of protective tariffs and the break-up of private monopolies. Traditionally strong in the South, the Democrats favored state's rights and made no mention of women's suffrage in their platform.

The split in the Republican Party was of tremendous significance for the outcome of this election. While the Democrats secured a majority of the popular vote in their traditional Southern strongholds, they did not poll well elsewhere. Nevertheless, the split in the Republican Party meant that while a majority of voters seem to have favored the very similar positions of the Republicans and Progressives, the Democratic Party would win the electoral vote in many states without a majority. Thus, while the Democrats won an overwhelming electoral victory in this election, it would appear that outside the South they ran a loosing campaign on the issues.

So, while a Democrat would now occupy the White House for the first time in many years, the rising tide of progressivism in the country at the time is evidenced by the poll results and this was a situation that Woodrow Wilson could not ignore. Having run a largely conservative campaign, Wilson quickly felt the need to adopt progressive polices while in office. Thus, the election of 1912 stands out as an illustration of the effect of the Electoral College. While the Democratic platform was largely rejected outside the South, they were still able to win many electoral votes based on the split in the Republican Party.

Sources:

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1972. (Chicago: University of Illinois Press) 1975.

George E. Mowry “The Election of 1912” in Arthur Schlesinger, Fred L. Israel and William P. Hansen eds., The Coming to Power: Critical Presidential Elections in American History (New York: Chelsea House Publishers) 1985.

Yanek Mieczkowski, The Routledge Atlas of American Presidential Elections. (New York; Routledge) 2001.

1916

In the 1916 election, the incumbent Democrat Woodrow Wilson was a minority President uncertain of his chances for reelection. During his tenure in office he had enacted a good deal of reform legislation, geared towards both labor and agricultural interests. In many respects, he had taken over the progressive banner and his domestic policies proved to be popular in the South, West and many northern Industrial cities as well. Nevertheless, in the northern industrial states, the lure of the old Republican Party and its policy of maintaining high protective tariffs on imported goods were still strong. As such, despite the popularity of many of Wilson's reforms, he did not fare well in the North East in this election.

Nevertheless, as the First World War dragged on in Europe, Wilson's policy of maintaining neutrality towards the belligerent parties was very popular in the country. While many northern industrialists and financial interests had a clear stake in a British victory and therefore tended to favor a pro-British policy, many Germans and Irish immigrants sought to maintain neutrality. Moreover, the traditional tendency towards isolationism in the South and Mid West also tended to lead toward support of Wilson's policy of neutrality in these areas as well. Nevertheless, the burning question of intervention in revolutionary Mexico was also a very hot topic of debate in the campaign. While Wilson did send troops into Mexico to pursue the fugitive Pancho Villa, he nevertheless balked on armed intervention south of the border and tended to favor a policy of negotiation with the new Mexican government. Wilson's Mexico policy proved to be not as popular as his stance towards the Great War, as many wealthy northerners had interests in Mexico to protect and many in the South West naturally favored a strong policy towards Mexico.

Moreover, in enacting his package of progressive domestic reforms, Wilson inaugurated the specter of a federal government vastly enlarged in its scope and powers. This reality was acknowledged in the Democratic Party's platform. This policy, while it seems to have been geared again towards labor and Mid-Western agriculture, was nevertheless treated with some skepticism in the South where a traditional fear of the Federal Government remained an ever-present reality. In addition, industrial and financial interests also regarded the threat of a new progressive federal government armed with new regulatory powers with some disdain.

Running against Wilson's record, the Republicans nominated the Supreme Court Justice Charles Hughes. Hughes was, nevertheless, a difficult man to get a grip on and as such it many said he lacked a stand on the issues. Going after Wilson's foreign policy, Hughes talked tough towards Mexico and at times seemed to favor intervening in Europe. While the Republican platform officially called for neutrality, Hughes was nevertheless forced to try to differentiate himself from Wilson and as such he seemed to many to be militaristic, while to others he seemed pro-German. Domestically, Hughes was conciliatory toward progressive ideas, but offended labor by criticizing some of Wilson's more pro-union reforms. Nevertheless, Hughes and the Republicans remained popular in the North West and the industrial Mid West and polled impressively in these areas during the election.

However, as the main issue of this election was the war in Europe and the country for the most part tended towards isolationism, Wilson won a close election largely based on his stance towards the war. This is of course a huge irony, as it was Wilson, faced with the German renewal of unrestricted submarine warfare in the Atlantic, who led the United States into the first World War only 6 months after having won the election on a slogan of “He kept us out of war!”

Sources:

Richard C. Bain and Judith H. Parris, Conventions, Decisions and Voting Records. (Washington, D.C.: The Brookings Institution) 1973.

Arthur S. Link and William M. Leary,” The Election of 1916“in William P. Hansen eds., The Coming to Power: Critical Presidential Elections in American History (New York Chelsea House Publishers) 1985.

Yanek Mieczkowski, The Routledge Atlas of American Presidential Elections. (New York; Routledge) 2001.

Donald Bruce Johnson and Kirk H. Porter, National Party Platforms, 1840-1972. (Chicago: University of Illinois Press) 1975.

1920

In this election, the two term incumbent Democrat Woodrow Wilson fell ill during his last year in office and his party thus passed the torch to James Cox, the Governor of Ohio, making him its nominee for 1920. This election followed in the wake of the First World War and the radical reorientation of American politics that occurred during these years under the Wilson administration. While Wilson ran in 1916 on a “no war ticket,” Germany's resumption of unrestricted submarine warfare only six months later, brought the United States into the war on the allied side. Following the conclusion of the hostilities, Wilson became an active participant in the Paris peace negotiations and was instrumental in the plans to set up the post-war League of Nations. Wilson saw to it that plans for this international mediating body were included in the Versailles Treaty that ended the war. While Wilson was cool to many aspects of this treaty, in particular its harsh treatment of Germany, he nevertheless asked the Senate to ratify the treaty as is, since it included plans for the League of Nations. In many ways, Wilson's engagement with the Versailles treaty marked an internationalist turn in American foreign policy characterized by strong presidential activism in the international arena. Wilson did not consult with Republican members of the Senate before signing his name to the treaty.

In this context, much of the campaign of 1920 was oriented around Wilson's foreign policy, symbolized the Senate's unwillingness to endorse the Versailles Treaty and separately by the question of whether or not the country should join the League of Nations. Senate Republicans were furious with Wilson for failing to consult with them regarding the treaty. Nevertheless, for the most part, the treaty was popular with most Americans, except among Irish and German immigrants and the traditionally isolationist South. The issue of the League of Nations itself was, however, a different story. Weary with the hardships and deprivations of the war, most Americans were tired of foreign entanglements and instead sought to focus on specifically American problems.

As such, although the 1920 campaign tended to focus on international questions, several domestic issues were also of key importance. The expansion of presidential power and authority that had occurred under Wilson was a topic of heated debate. While there was some sympathy for a strong interventionist federal government in the agricultural Mid West, which depended on government subsidies, etc., outside of this region there was not much support. In the South, a traditional fear of federal authority led to some dissatisfaction with the Democrats, while in the industrial cities of the North, the infamous Palmer raids of the time against labor leaders and others, were looked upon with suspicion. Another domestic issue of prime importance in the campaign was the economy. The war had led to much economic dislocation. Inflation and unemployment were both running high. While many Americans desired some sort of economic recovery program, the Wilson administration balked at the idea. Moreover, the issue of the prohibition of alcoholic beverages was also on the table in 1920. While there was a good deal of support for prohibition across the country, northern industrial states tended to resent the idea and as such many urban voters turned against the Democrats over the question of prohibition.

Sensing the Wilson administration's difficulties, the Republican Party prepared for an easy victory in the 1920 election. They named a compromise candidate Warren G. Harding for the job. The Republicans also sought to make the campaign a verdict on international affairs. Promising a return to “normalcy,” Harding seemed to offer Americans a return to a simpler time. Arguing that the Democrats had “failed to prepare for the peace” following the war, the Republicans blasted Wilson's economic policies and insinuated a distrust for the Versailles treaty and the League of Nations.

The election itself was a landslide in favor of Harding. The Democratic candidate, Cox, could win only the Deep South. He was resoundingly defeated elsewhere, including even in Tennessee, the first time a Republican had ever won the state since Reconstruction. This election marked Americans' profound rejection of internationalism and a desire to focus on American issues.

Sources:

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1972. (Chicago: University of Illinois Press) 1975.

Yanek Mieczkowski, The Routledge Atlas of American Presidential Elections. (New York; Routledge) 2001.

1924

Warren G. Harding's Republican administration had been hit hard by numerous scandals, not least of which was the corruption surrounding the Teapot Dome affair. Nevertheless, Harding died in office of a sudden heart attack and was succeeded by his Vice President Calvin Coolidge. This did a great deal to diffuse the scandals rocking the Republican Party. Coolidge was considered by most Americans to be an upright and honest man and he was not personally implicated in any of the Harding administration's scandals. Thus, the Republican Party easily nominated Coolidge for President once again in 1924. While in office, Coolidge had pursued a laissez-faire attitude to the economy and the boom and posterity of the early “roaring twenties” meant that many Americans were experiencing a rise in their living standards. As such, Coolidge's campaign in 1924 centered on the country's prosperity and the Republicans urged Americans to “keep it cool with Coolidge”.

The Democratic Party on the other hand, was rocked by internal dissension and strife. The growth of the Ku Klux Klan in the early twenties was prominent in the party's traditional areas of support in the South and parts of the West. There was a very pronounced pro-Klan faction within the party, but eastern Democrats, who resented the xenophobic orientation of the Klan, resisted this. The Democratic convention was a tumultuous affair and after numerous ballots the Democrats finally settled on John W. Davis a conservative businessman from West Virginia, as their presidential nominee. The Democrats tried to make the corruption of previous Republican administrations a campaign issue, but few outside the South bought into this. Coolidge was an honest fellow and most Americans were not swayed by references to previous acts of corruption under Republican presidents. Only in the South, with its traditional suspicion of Republicans, did this campaign seem to carry much weight.

Nevertheless, as both major parties had a conservative orientation. The progressive senator from Wisconsin Robert La Follette organized his own Progressive Party and he was nominated as that party's candidate for President. The Progressive's pushed a heavy program of economic reforms, centered on increased government regulation of monopolies, etc. While the Progressive party ran strong in many Mid Western states, it could capture the electoral votes of only Wisconsin, La Follete's home state.

Another important issue in the campaign was immigration restrictions. Buoyed by prosperity, few Americans were interested in sharing their newfound wealth with outsiders. As such the Republican Party plank calling for immigration quotas was very popular. While some states with sizable immigrant populations rejected the call to limit immigration, this idea was popular throughout the country.

Nevertheless, the main issues in this campaign were domestic ones. With the economy booming, few saw any reason to make a change at the top and most trusted the Coolidge administration to maintain prosperity. As such the election was a landslide victory for Coolidge and the Republicans. While La Follette and the Progressives polled strong in certain states, their message was drowned out by the booming economy and as such the Republican's dominance of the white House would continue for at least four more years.

Sources:

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1972. (Chicago: University of Illinois Press) 1975.

Yanek Mieczkowski, The Routledge Atlas of American Presidential Elections. (New York; Routledge) 2001.

1928

In 1928, the American economy continued to boom and the increasing prosperity was welcomed by the incumbent Republican administration of Calvin Coolidge as vindication of the his largely “hands-off” approach to the economy. The Republicans therefore expected to ride the wave of prosperity and win another term in control of the executive mansion. Nevertheless, Coolidge declined to run for another term and so the Republican convention passed the mantle to one of his cabinet members Herbert Hoover. An austere, bright and educated, self-made man, Hoover did not have a dynamic personality, but his seriousness attracted many voters.

The Democrats, reeling from he debacle of 1924, selected Alfred Smith the Catholic governor of New York. Immediately, Smith's religion became a factor in the campaign; and although Hoover never sanctioned using Smith's religion against him, that is nevertheless what occurred. Protestant ministers across the country spread rumors that if elected Smith would consult with the Pope and sell the national interest to the Vatican. While Smith's confession was of profound help to his campaign in many Catholic ethnic communities in Northern cities—in fact, this seems to have helped him win Massachusetts—he could never overcome the anti-Catholic sentiment in much of the country.

Moreover, in adoption to being Catholic, Smith also was personally against the prohibition of alcoholic beverages. While the Democratic platform contained a prohibition plank, Smith was personally against this. This was another flaw that he had trouble living down, even in traditionally Democratic states in the South. As such, many Southern states defected from the Democratic Party and actually voted Republican, including Texas.

On more substantive issues, the Democrats backed farm subsides, which helped win them some support in agricultural states. Nevertheless, on Election Day, Smith and the Democrats could not live down the religion and prohibition scandals and they were resoundingly defeated.

The election of 1928 was another Republican landslide, confirming the twenties as a period of conservative presidents. Nevertheless, this election also marked a profound realignment in American politics. Many urban workers voted for Smith, while many conservative Southerners deserted the Democrats for Hoover, fearing the infiltration of the Northern ethnic element in the party.

As such, the election of 1928 was a particularly nasty and ugly affair. The religious baiting that went on symbolized the growing culture of intolerance in the country, which saw the rise and predominance of the Ku Klux Klan as a national organization. Lacking substance, the campaign of 1928 has gone down in the annals of American history as a campaign wherein real issues were ignored for spectacle and intolerance.

Sources:

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1972. (Chicago: University of Illinois Press) 1975.

Yanek Mieczkowski, The Routledge Atlas of American Presidential Elections. (New York; Routledge) 2001.

Donald Bruce Johnson and Kirk H. Porter, National Party Platforms, 1840-1972. (Chicago: University of Illinois Press) 1975.

1932

The incumbent Republican Herbert Hoover did not have much time to enjoy his landslide victory in the election of 1928. In the fall of 1929, the stock market crashed, setting off the worst economic catastrophe the nation had ever known. The Great Depression, as it is now called, sent unemployment rates soaring and economic misery and suffering spread rapidly. Many workers found themselves out of a job, while agricultural interests were threatened with a contraction of the market as well as a drought. All across the country, shantytowns were springing up. Nicknamed “Hoovervilles” by the people who inhabited them, these shantytowns symbolized the nation's desperation. As the Republican Party had sold itself as the parry of prosperity in the election campaign of only a year before, the Great Depression was resoundingly blamed on Hoover and the Republicans. Unsurprisingly, it became the central issue in the presidential campaign of 1932. While Hoover did take some measures attempting to intervene in the economy, the general laissez-faire attitude of Republican ideology meant that his actions barely made a dent in solving the country's economic woes. Nevertheless, as an incumbent President, the Republicans had little choice but to re-nominate him for the Presidency in 1932.

Realizing that the Depression left the door wide open for them to capture the Presidency, the Democrats sprung into action in order to find a nominee suitable to the country. After some internal wrangling, they settled on Franklin Delano Roosevelt, the Party's Vice Presidential candidate in 1920 and a distant cousin of former Republican President Theodore Roosevelt. Roosevelt was Governor of New York when the Depression began and he showed great initiative and creativity in attempting to address the crisis. He set up relief programs in New York that had some considerable success in meeting the immediate needs of many impoverished families in his home state. In this, his actions represented something new and bold in American politics, a theme that rang true with many Americans in the election of 1932.

Essentially, the campaign centered on the record of the two candidates. As such, Hoover stood little chance of being reelected. While the Republicans tried their best to cast dispersions at Roosevelt's interventionist tactics in New York, and this line had some echo in the North East and in the South, for the most part the American public was ready for something new. If this meant an interventionist federal government, they did not seem to mind. While Hoover claimed that Roosevelt's record brought him close to socialism, the voters did not seemed frightened by the demagoguery.

The prohibition issue once again raised its head in this election. While both parties took moderate views on this issue, preferring to see the question devolve back to the states, there was considerable attention paid to the prohibition plank in each Party's platform. As it appeared that most industrial states in the North East and upper Mid West favored an end to prohibition, Roosevelt came out in favor of repealing the i8th amendment, even if he did not emphasize this particular issue very often.

Another important issue developed when many World War I veterans, anxious to claim a service bonus scheduled to be paid them in 1945, marched on Washington setting up encampments around the city. Hoover sent in the army to disperse them, thereby riling the anger of many military veterans all over he country. While his actions ensured the propertied classes of his commitment to law and order, the repression of the “bonus army” was not popular with the public at large and helped secure Hoover's defeat.

Thus, in the election of 1932, the issues were very much centered on the candidates' records. Hoover's dismal performance meant the American public was anxious to try something new and different. They thus elected Roosevelt in another landslide victory. While conservative Republicans lamented the coming of Roosevelt's “nascent socialism” the American people were ready for the “New Deal” they had been

promised during the campaign. Although Roosevelt still had not worked out the concrete details of how he would address the economic crisis, it was clear that the federal government would have a large role to play in securing welfare and social services for the nation's needy.

Sources:

Richard C. Bain and Judith H. Parris, Conventions, Decisions and Voting Records. (Washington, D.C.: The Brookings Institution) 1973.

Frank Freidel,” The Election of 1932” in William P. Hansen eds., The Coming to Power: Critical Presidential Elections in American History (New York Chelsea House Publishers) 1985.

Donald Bruce Johnson and Kirk H. Porter, National Party Platforms, 1840-1972. (Chicago: University of Illinois Press) 1975.

Yanek Mieczkowski, The Rautledge Atlas of American Presidential Elections. (New York; Routledge) 2001.

1936

Following his landslide victory over Herbert Hoover in the 1932 election, Franklin D. Roosevelt, the first Democratic president since Woodrow Wilson, felt he had a clear mandate to attempt to solve the nation's economic crisis using his own preferred tactics. While these tactics had been somewhat ambiguous in 1932, by the time of his reelection campaign in 1936, they had become clear. Roosevelt would bring the full power of the Federal Government to bear in his attempt to end the Great Depression. Roosevelt set up numerous federal recovery agencies, whose task it was to jump-start the economy. These agencies provided jobs and the government expenditure involved pumped some spending power back into the economy. While these so-called “New Deal” reforms had some success in pulling the nation up from the bottom, they had not yet led to prosperity by 1936. Nevertheless, Roosevelt's energy and zeal were popular in the country and the sense was that most Americans approved of the New Deal.

Sensing this, Republicans nominated Alfred Landon to oppose Roosevelt. Landon himself had a background as a progressive and he even looked with admiration at some of Roosevelt's programs. Nevertheless, seeking some ground upon which to distinguish himself from the President, Landon occasionally invoked fiscal responsibility to criticize Roosevelt's spiraling use of public funds to finance the New Deal. He also decried the over-centralization of government power at the Federal level. While Landon himself stayed away from the most offensive jibes, others in his party labeled the New Deal “socialistic” and even “communistic.” Some extremists even argued Roosevelt was taking orders from Moscow itself. Nevertheless, despite the demagoguery, the New Deal remained very popular in the country.

While the Republicans' campaign against Roosevelt's strengthening of the Federal Government had some echo in the South and the wealthy financial centers of the North East, for the most part this was not enough to override the President's popularity. Some employers attempted to portray the new Social Security bill as a measure that would take cash out of workers' pockets and turn them into slaves of the Federal Government. Nevertheless, few working class voters bought into the propaganda and the Social Security bill was very popular.

Thus, Roosevelt once again won handily at the polls. He routed Landon across the country loosing only the traditional Republican bastions of Maine and Vermont. In this, the election of 1936 was the most lopsided since 1820. Moreover, this election marks a clear shift in electoral alignments in American history. While prior to the New Deal era, electoral blocs tended to be regional, they now took on a class aspect. Northern workers, as well as Southern and Western farmers voted en masse for Roosevelt and his New Deal, a program marketed towards the common man. While this angered wealthy industrialists and some conservatives who likened the President's policies to Marxism, their numerical inferiority in the electorate rendered their opposition moot.

The election of 1936 was in most of its aspects a referendum on Roosevelt's New Deal, a test that the President passed with flying colors. He now possessed a mandate to expand-his programs and deepen the reforms he had begun. He had also built a broad new coalition of Democratic voters, organized primarily around social class interests.

Sources:

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1972. (Chicago: University of Illinois Press) 1975.

Yanek Mieczkowski, The Routledge Atlas of American Presidential Elections. (New York; Routledge) 2001.

1940

In 1940, Europe had already plunged into the horror of World War Two, France and the Low Countries had been overrun and the Battle of Britain was underway as the Nazi Blitzkrieg stormed across the European continent. In the United States, the Great Depression was dragging on and despite Franklin Roosevelt's ambitious New Deal reform policies, the economy actually worsened following the 1936 election.

As such, there was a growing discontent with the New Deal in the country, particularly in the plains states and the traditional Republican bastions of the North East. However, the President remained popular and most Americans' appreciated his efforts to alleviate the economic crisis and they tended to stand by the New Deal. Nevertheless, the President's growing use of the Federal Government and his increasingly personalistic style of leadership were rubbing some segments of society the wrong way and there was some fear that the President was starting to take on the characteristics of a dictator.

In this context, the Republican convention of 1940 named Wendell Wilkie to contest for the Presidency. Wilkie was a political novice who had actually been a Democrat up to 1939. As such, he was a bit of dark-horse candidate and many Republicans had difficulty distinguishing his ideas from Roosevelt's.

When the Democrats re-nominated Roosevelt for the Presidency, Wilkie swung into full gear attacking his policies and sounding the alarm of a third term President, an unprecedented event in American history. While the prospect of a third term President with increasing powers worried some, this issue was largely a non-starter, and it did not seem to affect the outcome of the election. Moreover, the President's popularity won him many votes, as he was still able to personally sell his New Deal policies to the public.

Nevertheless, events in Europe played the most dramatic part in the campaign. Although Roosevelt expressed his desire to remain out of the war, Wilkie attacked his sincerity. He claimed that a vote for Roosevelt was a vote for war. Most American's favored remaining out of the war, but they also tended to side with the allied cause and there was considerable public support for Roosevelt's policy of providing material aid to the British.

In the election itself, Roosevelt lost some of the momentum he had gained in 1936 and Wilkie won several Northern and Mid Western states away from the Democrats. Nevertheless, the gain in electoral votes for the Republicans was negligible and Roosevelt still coasted to an easy victory in this election. The New Deal had been vindicated once again and Roosevelt's stand towards the war proved to be popular. While most American's favored the allied cause they did not want to loose their sons to another European war.

It is another irony of history that with the Japanese attack on Pearl Harbor in 1941, Roosevelt would be the second Democratic President in the twentieth to lead the country into World War, after having run for election on a “no war” platform. Nevertheless, when

the call came, the country stood united behind their popular President and patriotically followed their leader in war.

Sources:

Richard C. Bain and Judith H. Parris, Conventions, Decisions and Voting Records. (Washington, D.C.: The Brookings Institution) 1973.

Robert E. Burke, “The Election of 1940” in Arthur Schlesinger, Fred L. Israel and William P. Hansen eds., The Coming to Power: Critical Presidential Elections in American History (New York: Chelsea House Publishers) 1985.

Donald Bruce Johnson and Kirk H. Porter, National Party Platforms, 1840-1972. (Chicago: University of Illinois Press) 1975.

Yanek Mieczkowski, The Routledge Atlas of American Presidential Elections. (New York; Routledge) 2001.

1944

In 1944, the country faced its first Presidential Election during wartime since the Civil War. Some in the country wondered if the fierce fighting in both theatres would cause the incumbent Democratic President Franklin D. Roosevelt to postpone the elections until after the conclusion of the war. Already in his third term, most Americans had grown used to Roosevelt in office and many saw little need to change President's before the war had been brought to a successful conclusion. Nevertheless, respecting the Constitution, it never occurred to Roosevelt to interfere with the scheduled election and the campaign began in earnest when the Republicans nominated Thomas Dewey, Governor of New York, for the Presidency.

Nevertheless, as a wartime President leading a successful war effort, Roosevelt remained incredibly popular throughout the country. Despite the wartime economic deprivations of rationing and inflation, most Americans blamed Hitler and Tojo, not Roosevelt, for the hardships. Moreover, fearful of appearing unpatriotic, the Republicans saw little use in attempting to attack Roosevelt's handling of the war. As such, the war itself was never really an issue in the campaign. However, this did not stop the Republicans from pointing a finger at the economic conditions at home, and this was blamed on democratic inefficiency, mismanagement and the New Deal's assault on freedom of enterprise. Nevertheless, despite employing the typically Republican themes of free enterprise and small government, Dewey found very little to run on. He even endorsed many of Roosevelt's New Deal reforms, as they remained very popular among the broad masses of the so-called “Democratic coalition,” which regrouped labor and agricultural interests.

Having little of substance with which to persuade the electorate, Dewey's campaign turned personal. He chided Roosevelt for seeking a 4th term, implying that the President was seeking dictatorial control of the country and he assuaged the President's relationship with the Soviet Unions as evidence of the supposed socialistic roots of the New Deal. While these themes may have had some echo in some of the more conservative sections of the country, they were not very persuasive to the electorate as a whole. Needing something else to ran on, Dewey championed himself as an alternative to the status quo, arguing that the country needed a change and that the old Democratic administration had become tired and corrupt. He also stressed the need for fiscal conservatism and criticized excessive government expenditure. He also chided the Roosevelt's administration's close relationship with labor, implying that the labor unions had obtained too much influence with the President. This was of course another reference to “socialism” in the administration. Dewey finally attempted to make an issue out of Roosevelt's health. However, the President's personal doctor reassured the country that the Commander in Chief was perfectly.

Lacking in substantive issues, the campaign of 1944 was totally overshadowed by the Second World War. While the Republicans scored some headway in traditionally Republican areas in the North East and Mid West, they could not put together enough electoral votes to come close to defeating the President. The American people were comfortable with the man they had elected thrice before. He had led them out of the Great Depression and he was now fighting a successful war. As such, the election was another landslide in Roosevelt's favor. Although this was the closest contest of his career, The President still coasted to a comfortable victory in 1944. Nevertheless, belying his doctor's pronouncements to the nation during the campaign. In April of 1945 Roosevelt suffered a stroke and passed away a short time later, turning the reigns of a wartime state over to his Vice President Harry S Truman.

Sources:

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1972. (Chicago: University of Illinois Press) 1975.

Yanek Mieczkowski, The Routledge Atlas of American Presidential Elections. (New York; Routledge) 2001.

1948

The Democratic incumbent in the 1948 election, Harry S Truman, was not a very popular President. Although he had been Roosevelt's Vice President and he had led the country successfully through the final months of World War II, his post-war accomplishments were few and far between. Relations with the Soviet Union had deteriorated and the “Cold War” had begun in earnest. While Truman inaugurated the policy of containment to deal with the growing communist threat, many on both the right and the left criticized his stance. For the right containment was not enough to challenge the communist threat, they preferred a policy of active rollback. On the left, Truman's policies seemed to be punishing a former wartime ally. Despite the polarization of this issue, most Americans probably favored Truman's policy of containment. However, this did not prevent the issue from being an important part of the campaign of 1948.

In addition to troubles in foreign affairs, Truman also faced serious domestic turmoil. The post-war process of industrial reconversion was not going smoothly and there were many labor actions across the country. Unemployment, inflation and the cost of living were on the rise across the nation and many began to blame the President for the troubles. Thus, Truman's postwar economic record would be a major issue in the campaign of 1948.

Sensing the Democrats' weakness, the Republicans nominated Thomas E. Dewey once again for the Presidency. Nevertheless, Dewey's campaign was somewhat low key as most Republicans expected) a cakewalk at the polls. Sensing his own trouble though, Truman embarked on an aggressive campaign. He traveled the country extensively, where he put most of the blame for the country's economic woes on the Republican controlled Congress. In order to illustrate his point, he proposed a number of extensive social reforms, including labor and civil rights legislation that the Congress refused to pass. While these measures, dubbed the “Fair Deal,” failed to get past the Republican Congress, Truman had proved his point, scoring a major campaign victory, as he was able to paint the Republicans as the party of wealth and privilege.

Nevertheless, Truman's reforms also had repercussions within his own party. Incensed by the mention of limited civil rights legislation, many prominent Democrats in the South walked out of the party and set up their own “States' Rights Democratic Party” to contest the election, naming James Strom Thurmond as their candidate for President. Unsurprisingly, the State's Rights Party had only regional appeal. Nevertheless, many Democrats worried about the loss of the South's usually solid Democratic electoral votes.

On the left, another splinter party, the Progressive Party, disliked Truman's strong stand towards the Soviet Union. Although the Progressive Party failed to get any electoral votes, its presence in the election helped to differentiate the Democrat's social reform program from socialism and communism, as many American Communists entered the Progressive Party.

Truman picked up steam as Election Day neared, but few expected he would be able to defeat Dewey. The country was just in too much turmoil and most prognosticators predicted the country would make a change. On election night, many newspapers predicted a Dewey victory. However, when the votes were tallied the American people had legitimated Truman and the Democratic Party one last time. Truman retained much of the South and although he lost many key states in the North East and Mid West he was able to hold much of the West. While this election was far from a landslide, it was never as close as most had predicted and have claimed since. Moreover, the Democrats had also won back both houses of Congress. Truman's “Fair Deal” no longer faced any legislative barriers.

This election is also important as it showed a shift of part of the South away from the Democratic Party. Truman's stance on civil rights, as mild as it was, had alienated many Southerners. On the obverse of this though, it also confirmed the Democratic Parry as the party of progress in the eyes of many African Americans. Long supporters of the Republicans, the election of 1948—with the emergence of the States' Rights Democratic Party or “Dixiecrats” as they were known—saw the definitive shift in the African American electorate toward the Democrats.

Sources:

Richard C. Bain and Judith H. Parris, Conventions, Decisions and Voting Records. (Washington, D.C.: The Brookings Institution) 1973.

Donald Bruce Johnson and Kirk H. Porter, National Party Platforms, 1840-1ˆ2. (Chicago: University of Illinois Press) 1975.

Yanek Mieczkowski, The Routledge Atlas of American Presidential Elections. (New York; Routledge) 2001.

1952

In the election of 1952, the incumbent Democratic President Harry S Truman, sensing his increasing unpopularity, declined to run again. His party thus nominated Adlai Stevenson, Governor of Illinois, to run in his stead. From the start, the 1952 campaign looked bad for the Democrats. Most of the ill feeling was due to the military stalemate in Korea. Truman's policy of limited engagement in Korea had many detractors among the Republicans. Some advocated a fall scale engagement with the Chinese in Asia, while others argued that if the administration believed an all out land war in Asia was fruitless, it should just bring the troops home and end the senseless waste of life in an un-winnable war.

The Korean War symbolized a larger issue of the 1952 campaign: namely the Democratic administration's handling of Communism in general. Many in the Republican Party accused the Democrats of being “soft on communism.” They claimed that Stevenson would appease the communist threat. These themes even led to much speculation that communists had infiltrated the Democratic administration itself and when Mao Zedong successfully seized power in China, many conservatives believed there might be betrayal at work. This gave rise to a growing concern over Communist infiltration of the Federal Government and many conservatives in the Republican Party were prepared to make this a major campaign issue.

Nevertheless seeking an electable candidate, the Republican convention rejected old guard conservatives and decided instead on the World War II hero, Dwight D. Eisenhower. Eisenhower, like most war heroes, proved to be a very popular candidate and opinion polls quickly swung in the Republican's favor. While Eisenhower initially stuck a softer tone towards his opposition, his Vice Presidential nominee, Richard M. Nixon, came out firing, attacking the democratic administration's record on Communism and its prosecution of the Korean War. He also raised the specter of communist infiltration in the Federal Government and American society at large. The Republican campaign complimented these themes by emphasizing traditional conservative moral and family values. They also hit hard on the issue of corruption, promising to clean up a Washington that had been dominated for a generation by the Democratic machine.

Many of these themes hit home with voters and the Democratic candidate Stevenson could do little to fight them off. The coup de grace came when Eisenhower pledged to go to Korea himself virtually promising to end the Korean War. While Stevenson flirted with making a similar announcement, he could not compete with the prestige of the World War II hero.

On Election Day, the outcome was a resounding victory in Eisenhower's favor. He carried every state outside of the South and was even able to whittle away at this Democratic stronghold by wining states such as Texas and Florida. In many respects, the Democratic administration's' record was the main issue in this campaign. While there was little unanimity about just what to do in Korea, most Americans were sure that the Democrats did not have the right answer. They thus turned out the Party that had led the country for the previous twenty years and ended the threat of a one-party monopoly of American politics, a threat that seemed very real to many Republicans at the time.

Sources:

Richard C. Bain and Judith H. Parris, Conventions, Decisions and Voting Records. (Washington, D.C.: The Brookings Institution) 1973.

Barton J. Bernstein, “The Election of 1952” in Arthur Schlesinger, Fred L. Israel and William P. Hansen eds., The Coming to Power: Critical Presidential Elections in American History (New York: Chelsea House Publishers) 1985.

Yanek Mieczkowski, The Routledge Atlas of American Presidential Elections. (New York; Routledge) 2001.

Donald Bruce Johnson and Kirk H. Porter, National Party Platforms, 1840-1072, (Chicago: University of Illinois Press) 1975.

1956

For this election, I primarily used referential sources from the Bobst Library at New York University, combined with facts and information from the Internet. U.S. politics and elections: A Guide to Information Sources by David J. Maurer (1978) offered valuable bibliographic information. Congressional Quarterly's guide to U.S. elections, edited by John L. Moore, Jon P. Preimesberger, and David R. Tarr offered additional assistance in researching thematic issues in U.S. general elections. My researches methods also included several key Internet sites: Elections Central at www.multied.com/elections supplied some general information on election themes. David Leip's Atlas of U.S. Presidential Elections under www.uselectionsatias.org was another Internet tool specifically dealing with states and Electoral College outcomes.

1960

Resulting for a state primary, five electors on the general election ballot were Democratic loyalists pledged to Kennedy and the remaining six were independent electors, not pledged to the Democratic national ticket These six so-called Free electors cast their ballots for the presidential ticket of Harry Byrd/Strom Thurmond. In another curious event, one Free elector from Oklahoma cast his vote for a possible Harry Byrd/Barry Goldwater ticket. In an expression of internal party grievances, Byrd and other so-called Dixiecrats, attempted to realign the Democratic party on issues of segregation and inequality.

For the 1960 Presidential election, several sources were employed to produce my final results. Similar the 1956 election, Congressional Quarterly's Guide to U.S. Elections was a fundamental part of the referential literature. In addition to the Internet sites (Election Central and Atlas of U.S. Presidential Elections) as sources for finding out the salient election issues, I found Arthur Schlesinger's The Cycle of American History to be of significant help in distinguishing further themes in the domestic and international realms.

1964

In the wake of President Kennedy's assassination in November of 1963 and the subsequent landslide Democratic victory of Lyndon Johnson, the nation's brooding electorate was in little mood for deliberative campaigns. As a result, only a limited number of resources were required to produce accurate results. Among these were the Internet sites of Election Central, which highlighted the general campaign themes, and U.S. Election Atlas, which provided accurate state and electorate outcomes. The Congressional Quarterly's Guide to U.S. Elections and U.S. Presidential Primaries and the Caucus-convention System: a Sourcebook by James W. Davis were also supporting literatures on the 1964 elections.

1968

With internal problems within the Democratic camp, Nixon had an easy time defeating Vice-President Humphrey. The predominant issues of Vietnam engagement and the Cold War, as well as the economy, were well documented in most referential and Internet sites. Again, Schlesinger's The Cycle of American History highlights some important issues surrounding this election cycle. In addition to this, Elections Central and U.S. Atlas of Presidential Elections provided instrumental background information and state-based results.

1972

Nixon's victory against nominal Democratic opposition guaranteed him a second term. Background and more detailed information on this election was retrieved from referential sources at the Bobst Library at New York University, as well as several Internet sites. The Congressional Quarterly's Guide to U.S. Elections combined again with Schlesinger's The Cycles of American History and the websites (ˆElections Central and the U.S. Atlas of Presidential Elections were my main sources of information on this election.

1976

After the fallout of the Watergate affair, American voters were most concerned with levels of political corruption in the White House. As a result, virtual Democratic unknown Jimmy Carter of Georgia came from the back of the pack to win the party's nomination and general election against Gerald Ford. For this election, I primarily used the Congressional Quarterly's Guide to U.S. Elections, U.S. Presidential Primaries and the Caucus-convention System: A Sourcebook and the Internet sites of Elections Central and U.S. Atlas of Presidential Elections to produce my final results.

1980

Californian Governor Ronald Reagan was able to capitalize on issues dealing with defense spending, the Cold War and the economy to defeat Carter's second bid for the White House. The results for this election were produced by looking at several sources: Skowronek's The Politics Presidents Make and Neustadt's Presidential Power and the Modern Presidents offered excellent support on the salient campaign themes, as well as the political platforms of the particular parties. Additionally, the Congressional Quarterly's Guide to U.S. Elections and the U.S. Presidential Primaries and the Caucus-convention System: A Sourcebook were further guides of the 1980 elections. Finally, the more statistical research (state outcomes, Electoral College and popular results, level of participation) came from the website U.S. Atlas of Presidential Elections.

1984

Walter Mondale's Democratic bid against the incumbent Reagan proved to be weak with Reagan securing a landslide win for the White House. Much like the 1980 data set, I relied on a mixture of academic publications, referential sources and elections websites for my results. Publications included Skowronek's The Politics Presidents Make and Neustadt's Presidential Power and the Modern Presidents, which offer excellent in-depth reviews of Reagan's strengths and weaknesses leading up to his re-election bid. I coupled the thematic research with the websites of Elections Central and U.S. Atlas of Presidential Elections for the more statistical aspects.

1988

George Bush Sr.'s clear victory over Massachusetts's Governor Mike Dukakis continued the Republican hold on the White House. For this election, I turned to some more academic articles on the 1988 elections. Garand and Parent's Representation, Swing and Bias in U.S. Presidential Elections, 1872-1988 appeared in the American Journal of Political Science (Vol. 35, No. 41991). This provided interesting information on the relationship between popular and electoral college results. Skowronek's The Politics Presidents Make and Neustadt's Presidential Power and the Modern Presidents proved again to be excellent sources on the salient campaign issues. Lastly, the websites of Elections Central and U.S. Atlas of Presidential Elections were helpful for the more statistical outcomes.

1992

Democratic candidate Bill Clinton made a late drive for his party's nomination and was then able to defeat incumbent Bush on predominantly economics-based issues. Thomas Holbrook's Campaigns, National Conditions and U.S. Presidential Elections, which appeared in the American Journal of Political Science (Vol. 38, No. 4 Nov. 1994), proved to be an excellent source on the relationship between economic and related issues to presidential outcomes. The Congressional Quarterly's Guide to U.S. Elections and U.S. Presidential Primaries and the Caucus-convention System: A Sourcebook were additional sources for my results. Again, the websites of U.S. Atlas of Presidential Elections and Elections Central were additional sources for statistical, Electoral College, state and regional outcomes.

1996

Incumbent Clinton was able to remain in power over the Republican candidate Bob Dole. Skowronek's The Politics Presidents Make was excellent sources on the salient campaign issues and the party platforms of each candidate, as well as the strengths and weaknesses of each's abilities. The Effect of TV Ads and Candidate Appearances on Statewide Presidential Votes, 1988-96 by Daron R. Shaw, which appeared in The American Political Science Review (Vol. 93, No. 2 Jun. 1999), was an additional academic resource further highlighting some of the major themes in presidential campaigns. Congressional Quarterly's Guide to U.S. Elections and the U.S. Presidential Primaries and the Caucus-convention System: A Sourcebook were further guides of the 1996 elections. I continued to use the website of U.S. Atlas of Presidential Elections for statistical information.

2000

G. W. Bush's controversial victory over Democratic candidate Al Gore became the centerpiece of scholarly and medial attention before, during and long after the Supreme Court's decision to stop further re-count efforts in the state Florida. My results for this election originated predominately from first-hand news reports from around the country. Here, I used the available archival pages from The New York Times, USA Today, The LA. Times, and The Washington Post to locate the salient issues in particular regions and states. Some of these I was able to locate through Proquest.com text searches, which also yielded further information results. Additionally, the websites of Elections Central and U.S. Atlas of Presidential Elections provided pertinent background and electoral count information.

While the presently preferred embodiments have been described in detail, it will be apparent to those skilled in the art that the principles of the invention are realizable by other systems and methods without departing from the scope and spirit of the invention, as defined in the following claims.

I claim:

1. A method for presenting a visualization of a quantitative overall result in a modeled domain, said result having a plurality of possible outcomes, wherein said domain is comprised of components and each component has a subresult, and said subresults may be aggregated to calculate said overall result, each component having a weight in relation to said result, comprising
representing each of said components in visual proportion to its weight, and
representing the outcome of said overall result as a function of said aggregation.

2. The method of claim 1, wherein each of said components has an initial, unweighted geometrical relation with respect to said domain, and wherein the representation of said component preserves one or more geometric aspects of said initial relation.

3. The method of claim 1, wherein said components are represented as segments of a bar shape, each said segment having a width proportionate to the weight of the corresponding component.

4. The method of claim 1, wherein said components are represented as upper and lower sets of substantially parallel, generally vertically aligned shapes, each shape emanating upward or downward from the general vicinity of a common baseline area, the size of each shape being in proportion to the weight of the corresponding component, and the upward or downward orientation of each shape being in accordance with whether the corresponding component contributes to said aggregation either for or against the represented outcome.

5. The method of claim 1 further comprising providing the viewer of said representation the option to select among the visualizations described in any of claims 2, 3 or 4.

6. The method of claim 1, further comprising providing a plurality of factors which may be measured with respect to each component, providing the ability to select one or more of said factors, and in which each subresult is a function of the measurements of the one or more selected factors.

7. The method of claim 6, in which said function of the measurements of the one or more selected factors comprises a correlation of each said factor with a quantity sought to be measured in said overall result.

8. The method of claim 1, wherein a distinguishing visual attribute is applied to those components whose subresults are within a specified range from the dividing point between one outcome or another.

9. The method of claim 1, further comprising a facility for the viewer of said visualization to alter selected ones of said subresults and recalculating said overall result based upon said alterations.

10. The method of claim 1, wherein each subresult has a breakdown of constituent subelements, further comprising visually representing within each component plurality of subareas whose sizes are proportionate to a quantification of said subelements.

11. The method of claim 10, further comprising presenting a series of said visualizations, each having more subresults represented therein than in the previous visualization.

12. The method of claim 3, wherein said segments are ordered in accordance with a rule selected from the following set of possibilities: (a) by weight, or (b) collation order of their respective identifiers.

13. The method of claim 4, wherein said shapes are arranged are in accordance with a rule selected from the following set of possibilities: (a) by weight, or (b) collation order of their respective identifiers.

14. The method of claim 1, wherein said overall result is an election, said domain is the unit for which the election is being held, said components are voting subunits within said unit, said weights are respective weights of the subunits, said subresults are the outcome of the vote in each subunit, and said overall result is the outcome of said election.

15. The method of claim 14, wherein said election is a U.S. presidential election, said domain is the United States, said components are states, said weights are electoral votes, said subresults are the outcome of the popular vote in each state, and said outcome is the winner of said election.

16. The method of claim 15, wherein said visualization is presented in accordance with claim 2, and said states are visually represented as each having a shape similar to the shape it possesses in said initial, unweighted visual representation, while preserving the approximate overall arrangement of said states and keeping said states substantially contiguous in said arrangement, such the visual representation of the United States, while distorted by said weighting, remains recognizable.

17. The method of claim 10, wherein said overall result is the accumulated number of delegates in the U.S. presidential primaries, each component is a state, said weights are number of delegates for the state, and subresults are the candidate tallies for the state.

18. The method of claim 17, wherein each state is represented as a pie chart whose sectors represent the delegate breakdown for the state among candidates in accordance with said state's primary.
